(19) United States
(12) Patent Application Publication
(10) Pub. No.: US 2009/0180788 A1
(43) Pub. Date: Jul. 16, 2009

(54) Image forming apparatus, and image forming method

(75) Inventors: Nozomu Tamoto, Numazu-shi (JP); Hiromi Tada, Numazu-shi (JP); Takafumi Iwamoto, Numazu-shi (JP); Yoshinori Inaba, Numazu-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD., TOKYO (JP)

(21) Appl. No.: 12/319,628

(22) Filed: Jan. 9, 2009

(30) Foreign Application Priority Data
Jan. 10, 2008 (JP) 2008-003115
Jul. 24, 2008 (JP) 2008-190965

(51) Int. Cl. G03G 15/00

(52) U.S. Cl. 399/48; 399/159

(57) ABSTRACT

An image forming apparatus including an image bearing member bearing an electrostatic latent image thereon, a charging device charging the image bearing member, a light irradiating device irradiating the charged image bearing member with light to form the electrostatic latent image, and a developing device developing the electrostatic latent image to form a toner image, wherein the charging time determined by dividing the width of a charging area charged by the charging device in units of mm by the linear velocity of the image bearing member in units of mm/msec is not shorter than the transit time of the image bearing member. The transit time is defined as the time at which an inflection point is firstly observed in a curve showing relationship of the interval between light irradiation and measurement of potential of an irradiated portion with the potential of the irradiated portion, when the interval is shortened.

### BACKGROUND OF THE INVENTION

1. Field of the Invention

The present invention relates to an image forming apparatus, and an image forming method, in which an image is formed on an image bearing member using electrophotography.

2. Discussion of the Related Art

Recently, electrophotographic image forming apparatus such as laser printers and digital copiers have been widely used because of being capable of stably producing high quality images. Image bearing members used for such image forming apparatus have a function of forming an electrostatic latent image thereon by being charged and then exposed to imagewise light, and bearing a visual image (such as toner image) which is formed thereon by developing the electrostatic latent image with a developer including a toner. Electrophotographic photoreceptors are typically used as image bearing members. Hereinafter such image bearing members are sometimes referred to electrophotographic photoreceptors or photoreceptors.

Among the photoreceptors, organic photoreceptors using an organic material have been widely used because of having advantages in cost, productivity, material selectivity and environmental friendliness. Organic photoreceptors typically include a photosensitive layer including an organic material, and are broadly classified into photoreceptors including a single-layered photosensitive layer including both a charge generation function and a charge transport function, and functionally separated photoreceptors including a layered photosensitive layer such as combinations of a charge generation layer having a charge generation function and a charge transport layer having a charge transport function.

The mechanism of forming an electrostatic latent image in a functionally separated photoreceptor is as follows. When light irradiates a charged photoreceptor, light passes through the charge transport layer and is absorbed by the charge generation material in the charge generation layer, thereby forming a pair of charges. One of the (positive and negative) charges is injected to the charge transport layer at the interface between the charge generation layer and the charge transport layer, and then the charge is moved through the charge transport layer due to the electric field formed on the photoreceptor. When the charge reaches the surface of the photoreceptor, the charge neutralizes the charges formed on the photoreceptor by charging, thereby reducing the potential of the light irradiated portion, resulting in formation of an electrostatic latent image. Since the functionally separated photoreceptors have advantages in durability and stability of electrostatic properties, the functionally separated photoreceptors have been mainly used for electrophotographic image forming apparatus.

Not only photoreceptors, but also developers and image forming apparatus themselves have been improved. Therefore, qualities of images formed by recent image forming apparatus using organic photoreceptors have been considerably improved. Therefore, electrophotographic image forming apparatus have been used for various applications, and the request levels (such as color image formation and high speed image formation) for electrophotographic image forming apparatus increase more and more. For example, a need exists for electrophotographic image forming apparatus, which can be used for high speed printing field. In addition, it is desired to reduce the size of image forming apparatus and to shorten the waiting time of from an order to form an image forming operation output of the image.

In order to increase the printing speed of an image forming apparatus, the linear speed of the photoreceptor used therefor has to be increased while improving the photosensitivity of the photoreceptor. In addition, in order to reduce the size of the image forming apparatus, the outside diameter of the photoreceptor has to be decreased. Particularly, full color image forming apparatus produce full color images by overlaying four color toner images, and therefore full color image forming apparatus are required to perform high speed printing while having a compact size. In recent years, high speed full color image formation can be realized by tandem color image forming apparatus in which four sets of image forming units each including at least a photoreceptor and a developing device are provided. Since four photoreceptors have to be arranged in such image forming apparatus, the image forming apparatus tend to be jumboized. Therefore, a need exists for a small-sized tandem color image forming apparatus.

In addition, users are unsatisfied with the waiting time. It is preferable for users to produce a copy without idling the photoreceptor after ordering an image forming operation. In order to shorten the waiting time, it is necessary to shorten the temperature rising time of the fixing device and to use a photoreceptor capable of producing a high quality image without idling (i.e., a photoreceptor capable of producing a high quality image even at the first revolution thereof).

However, it is difficult to fulfill these needs at the same time, and techniques fulfilling these needs have not yet been established. Specifically, when the linear speed of a photoreceptor is increased, the charging properties and transfer properties of the photoreceptor deteriorate. The same problems occur when the outside diameter of a photoreceptor is decreased. In addition, small-size photoreceptors restrict arrangement of the devices to be set around the photoreceptor, and therefore it is difficult to provide a spare charging device and a spare transfer device. Further, the interval between a light irradiation process to a development process has to be shortened. Therefore, a need exists for a photoreceptor having good response to charging and light irradiation.

In addition, deterioration of electrostatic properties of photoreceptors after repeated use exacerbates the problems. Specifically, when a photoreceptor is repeatedly used and thereby the electrostatic properties of the photoreceptor are deteriorated (for example, residual potential increases, photosensitivity deteriorates or charging ability deteriorates), response of the photoreceptor to charging and light irradiation seriously deteriorates. Further, oxidizing gasses such as ozone and NOx deteriorate the electrostatic properties of the photoreceptor, resulting in deterioration of resolution of images produced by the photoreceptor. Photoreceptors used for high speed image forming apparatus are required to have a relatively long life. Namely, such photoreceptors are requested to have a good combination of abrasion resistance and resistance to electrostatic fatigue and oxidizing gasses.

Among the problems concerning deterioration of electrostatic properties, the urgent problem, which is considered to be most important, is that when a photoreceptor, which is electrostatically fatigued because of being repeatedly used in an image forming apparatus, starts to be rotated and charged, the photoreceptor has poor charging properties during the first one-revolution of the photoreceptor and the photoreceptor has good charging properties after the second revolution thereof. This phenomenon is sometimes referred to as a first one-revolution charge problem. In this regard, the greater electrostatic fatigue the photoreceptor has, the more serious first one-revolution charge problem the photoreceptor causes. When a protective layer is formed on a photoreceptor to improve the abrasion resistance thereof, the photoreceptor tends to cause a more serious first one-revolution charge problem.

Since electrophotographic image forming apparatus are thus used for various applications, the performances and characteristics required for the photoreceptors used for the image forming apparatus become diversified. Among the performances and characteristics, the need for quick formation of full color images increases. Specifically, a strong need exists for an image forming apparatus, which can stably produce high quality full color images at a high speed and which has a small-size. In addition, not only electrophotographic image forming apparatus are used as copiers and printers for use in offices, but also the apparatus start to be used for the print industry. Therefore, photoreceptors are requested to stably produce high quality images even when used for such high speed image forming apparatus. In order that a photoreceptor has a long life and an image forming apparatus using the photoreceptor has a long life, the photoreceptor has to have a good abrasion resistance and stable electrostatic properties. Among various needs, a strong need exists for a photoreceptor, which stably maintains improved electrostatic properties even after long repeated use and which never causes the first one-revolution charge problem.

The first one-revolution charge problem, which is recently exposed because photoreceptors are used for high speed image formation while having a small outside diameter, is a problem in that the photoreceptor is electrostatically fatigated after long repeated use. The amount of decrease in charge (potential) of a photoreceptor at the first one-revolution of the photoreceptor increases as the time period during which the photoreceptor is electrostatically fatigated increases. Even when the photoreceptor does not cause the problem (i.e., even when the photoreceptor recovers a good charging property) after the first one-revolution, the photoreceptor causes again the problem if image formation is performed after the photoreceptor is allowed to settle. Thus, the first one-revolution charge problem is not a temporary phenomenon, and is a recurrent phenomenon. It is found that the longer the time period during which a photoreceptor causing the first one-revolution charge problem is allowed to settle, the larger the amount of decrease in charge (potential) of the photoreceptor at the first one-revolution in the next image forming process. In addition, the higher the linear speed of the photoreceptor, the larger the amount of decrease in charge of the photoreceptor at the first one-revolution.

When the potential of a photoreceptor in the first one-revolution of the photoreceptor decreases, a background fouling problem in that the background area of an image is soiled with toner particles (i.e., a large amount of toner particles are present on a background area of a toner image formed on the photoreceptor) is caused, resulting in deterioration of image quality. In this case, an intermediate transfer medium, which receives the toner image from the photoreceptor, is soiled with toner particles, thereby soiling the receiving material on which the image is transferred. In order to prevent occurrence of the first one-revolution charge problem, a technique in that the photoreceptor is rotated before forming the first image, and another technique in that a second charger is provided to charge the photoreceptor at the first one-revolution together with a first charger have to be used. Thus, the first one-revolution charge problem is a serious problem, which not only deteriorates the image qualities, but also prevents high speed image formation, full color printing and miniaturization of the apparatus, and shortening of waiting time of from an order to form an image to output of the image. However, the causes therefor are not yet clarified, and an effective countermeasure is not yet discovered.

In attempting to prevent occurrence of the first one-revolution charge problem, the following techniques have been disclosed.

Specifically, published unexamined Japanese patent application No. (hereinafter referred to as JP-A) 10-63015 discloses a mechanism of the problem such that carriers generated in the charge generation layer of a photoreceptor before a charging process due to irradiation of weak light or heat excitation are trapped in the charge transport layer. In attempting to solve the problem, the application proposes to decrease the difference in ionization potential between the charge generation layer and the charge transport layer to enhance the mobility of holes and to increase the electric resistance of the undercoat layer to enhance the probability of recombination of charges. However, as described therein, an undercoat layer having a high electric resistance increases residual potential of the photoreceptor. In this case, the charges tend to be easily trapped. Therefore, the technique is not a fundamental solution. In addition, with respect to the mobility of the charge transport material, only the method for determining the mobility is disclosed, and it is not disclosed at what stage in the charge transport process the mobility of the charge transport material is measured. Further, it is described therein that increase of mobility of the charge transport material decreases the hole trapping probability. However, the relationship therebetween is not clearly described therein.

JP-A 2002-162763 discloses a technique to use a photoreceptor for image formation at a process speed of not lower than 100 mm/sec, wherein the ionization potential of the charge transport layer of the photoreceptor is greater than that of the charge generation layer thereof and the charge transport layer has a specific charge transport material/binder resin ratio and a specific mobility at a specific electric field strength. It is certain that when the ionization potential of the charge transport layer of a photoreceptor is greater than that of the charge generation layer thereof, the charges tend to be easily trapped, and thereby occurrence of the charge delay phenomenon caused by releasing of the charges at the beginning of the charging process can be prevented apparently. However, when the ionization potential of the charge transport layer of a photoreceptor is greater than that of the charge generation layer thereof, residual potential of the photoreceptor increases. Therefore, the stability of electrostatic properties of the photoreceptor deteriorates. In addition, with respect to the mobility of the charge transport material, only the method for determining the mobility is disclosed, and it is not disclosed at what stage in the charge transfer process the mobility of the charge transport material is measured. Namely, the mobility disclosed therein does not relate to the transit time to be discussed in the present application.

JP-A 2000-194145 discloses a technique in that the activation energy needed for depolarization of a charge generation layer is controlled to be not greater than 0.32 eV, and proposes a mechanism such that the first one-revolution charge problem is caused because the molecules in the photosensitive layer are in a disordered state at the first revolution of the photoreceptor and a relatively long time is needed for orienting the molecules by charging. In this application, distyryl benzene derivatives are used as charge transport materials, but the charging time is not described in the method of evaluating the resultant photoreceptors and only the activation energy for depolarization of the charge generation layer is described. Therefore, JP-A 2000-194145 is considered to be different from the present invention mentioned below.

JP-A 2000-66432 corresponding to U.S. Pat. No. 6,143,453 discloses a photoreceptor, which includes a polyamide resin, a specific carboxylic acid salt and a titanium oxide in the intermediate layer thereof, and includes an X-form or τ-form metal free phthalocyanine in the charge generation layer thereof. It is described therein that the cause for the first one-revolution charge problem is considered to be charges generated by phthalocyanine left in a dark place, and the problem can be solved (i.e., the photoreceptor can have a good charging property even at the first revolution) by forming an intermediate layer including a specific carboxylic acid salt and a titanium oxide. However, in examples in the specification of the application, only the first revolution charge property of the initial photoreceptors is evaluated and the first revolution charge property of the photoreceptors after repeated use is not evaluated.

JP-A 2000-321805 discloses a photoreceptor having an undercoat layer including a charge transport material and having a specific electron mobility. Distyrylbenzene derivatives are described as charge transport materials in the application, but the relationship between hole mobility and charging time is not described therein.

JP-A 10-186703 discloses a photoreceptor, which has an undercoat layer including a binder resin and a semiconductive material having a band gap of not less than 2.2 eV, and a charge generation layer including a phthalocyanine compound. It is described therein that the cause for the first one-revolution charge problem is considered to be storage of charges generated by phthalocyanine in a dark place, or injection of charges from a substrate or an undercoat layer into a charge generation layer. Although the example photoreceptors have a relatively improved resistance to the first one-revolution charge problem compared to comparative photoreceptors, the improving effect is small. Therefore, the technique is not an effective solution.

JP-A 2001-350329 discloses a method in which the charging time for a photoreceptor is controlled to be from 50 to 1000 msec. It is described therein that when the charging time is not longer than 50 msec, the potential of the charged photoreceptor cannot be stabilized, and therefore the charging time is needed to be not shorter than 50 msec. However, the transit time is not described therein.

JP-A 08-36301 discloses an image forming method in which a first image is formed without subjecting the photoreceptor to a light discharging process, and second and later images are formed while subjecting the photoreceptor to a light discharging process. It is described therein that the first one-revolution charge problem is specific to phthalocyanine compounds. The application proposes the following mechanism for the first one-revolution charge problem. Specifically, when a photoreceptor is subjected to a light discharging process, an excessive amount of carriers are formed in the photoreceptor. When electron traps are present in the charge generation layer, the carriers are temporarily caught by the traps. Part of the thus trapped carriers is released in the next charging process, resulting in occurrence of the problem. It is described therein that even when a light discharging process is not performed at the first image forming operation, the image qualities are not affected thereby. However, if a light discharging process is not performed, abnormal images such as background fouling and ghost images tend to be formed particularly when the photoreceptor is rotated at a relatively high linear speed. Therefore, the technique is not a fundamental solution.

JP-A 2002-268335 discloses a technique in that the photoreceptor used has an intermediate layer including a particulate N-form semiconductor material, and a charge generation layer including a phthalocyanine pigment; and a preliminary charging process, a light discharging process, and a charging process are performed on the photoreceptor in this order when the image forming apparatus starts a first image forming operation. It is effective to perform such a preliminary charging process for preventing occurrence of the problem because the charging ability of the photoreceptor can be improved. However, since a preliminary charger has to be arranged in the vicinity of the photoreceptor, a photoreceptor having a small outside diameter cannot be used as the photoreceptor. In addition, since acidic gasses are generated by the preliminary charger and a main charger, the amount of acidic gasses increases, resulting in acceleration of deterioration of electrostatic properties of the photoreceptor.

As mentioned above, various attempts, i.e., attempts on the photoreceptor side (such as approaches from the charge transport layer, charge generation layer and undercoat layer) and attempts on the other sides (such as approaches from the machine side) have been made to solve the first one-revolution charge problem. In other words, the first one-revolution charge problem is an important problem to be solved. However, as mentioned above, various mechanisms have been proposed for the problem. This means that the problem has various factors or the mechanism is not yet determined. In fact, some of the prior techniques cannot produce good improving effects, and some of the prior techniques produce side effects such as increase of residual potential and jumboization or complication of the image forming apparatus. Further, some of the prior techniques cannot be used for high speed image forming apparatus although the techniques can be used for low speed image forming apparatus. Thus, a technique capable of solving the first one-revolution charge problem without producing side effects has not yet developed.

Because of these reasons, a need exists for an image forming apparatus or method, which can prevent occurrence of the first one-revolution charge problem without producing side effects (such as deterioration of the electrostatic properties of the image bearing member and deterioration of qualities of images produced by the apparatus or method).

### SUMMARY OF THE INVENTION

As an aspect of the present invention, an image forming apparatus is provided, which includes:

an image bearing member configured to bear an electrostatic latent image thereon, wherein the image bearing member includes an electroconductive substrate, a photosensitive layer located overlying the electroconductive substrate, and a protective layer located overlying the photosensitive layer;

a charging device configured to charge the image bearing member;

a light irradiating device configured to irradiate the charged image bearing member with light to form the electrostatic latent image on a surface of the image bearing member; and

a developing device configured to develop the electrostatic latent image with a developer including a toner to form a toner image on the surface of the image bearing member,

wherein the image forming apparatus satisfies the following relationship (1):

T1<T2 (1),

wherein T1 represents the transit time of the image bearing member, and T2 represents the charging time.

The transit time is determined as follows. The image bearing member is charged and then irradiated with light, and the potential of an irradiated portion of the image bearing member is measured with a surface potential meter. This procedure is repeated while shortening the interval between the light irradiation and the potential measurement to obtain a curve showing the relationship between the interval and the potential of the irradiated portion. The transit time is defined as the time at which an inflection point is firstly observed in the curve when the curve is drawn while shortening the interval. The charging time is defined by the following equation (2):

T2 (msec)=W (mm)/LV (mm/msec) (2),

wherein W represents the width of the area charged by the charging device in units of millimeter, and LV represents the linear velocity of the image bearing member in units of millimeter per millisecond.

The photosensitive layer may be a single-layered photosensitive layer or a layered photosensitive layer such as combinations of a charge generation layer and a charge transport layer.

As another aspect of the present invention, an image forming method is provided, which includes:

charging an image bearing member;

irradiating the image being member with light to form an electrostatic latent image on a surface of the image bearing member; and

developing the electrostatic latent image with a developer including a toner to form a toner image on the surface of the image bearing member,

wherein the above-mentioned relationship (1) is satisfied.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a graph for explaining the transit time of an image bearing member (photoreceptor) having a rectangular photocurrent waveform;

FIG. 2 is a graph for explaining the transit time of another image bearing member (photoreceptor) having a dispersed photocurrent waveform;

FIG. 3 is a graph for explaining the transit time of yet another image bearing member (photoreceptor) having another photocurrent waveform;

FIG. 4 is a schematic view illustrating an instrument for use in measuring the transit time;

FIG. 5 illustrates a light-decay curve of potential of an image bearing member, which is obtained by using the instrument illustrated in FIG. 4;

FIG. 6 is a graph used for determining the transit time of an image bearing member;

FIG. 7 is a schematic view for explaining the charging width of a scorotron charger;

FIG. 8 is a schematic view for explaining the charging width of a contact charging roller;

FIG. 9 is a schematic view illustrating a short-range charging roller;

FIG. 10 is a schematic view illustrating the main portion of an example of the image forming apparatus of the present invention;

FIG. 11 is a schematic view illustrating a multi-beam light irradiating device for use in the image bearing member of the present invention;

FIG. 12 is a schematic view illustrating a lubricant applying device for use in the image forming apparatus of the present invention;

FIG. 13 is a schematic view illustrating the main portion of another example of the image forming apparatus of the present invention;

FIG. 14 is a schematic view illustrating an example of the process cartridge for use in the image forming apparatus of the present invention;

FIGS. 15-18 are schematic views illustrating the layer structures of image bearing member for use in the image forming apparatus of the present invention; and

FIG. 19 is the X-ray diffraction spectrum of a charge generation material (titanyl phthalocyanine) used for preparing an image bearing member for use in the image forming apparatus of the present invention.

### DESCRIPTION OF THE PREFERRED EMBODIMENTS

The image forming apparatus of the present invention will be explained in detail by reference to drawings.

As mentioned above, the requests for image forming apparatus are as follows.
(1) to produce high quality images;
(2) to produce full color images;
(3) to perform high speed image formation;
(4) to have a small size (i.e., to save space);
(5) to shorten the waiting time of from an order to form an image to output of the image;
(6) to be easy to handle; etc.

The above-mentioned first one-revolution charge problem has to be solved to fulfill the requests (3), (4) and (5).

When the linear speed of an image bearing member is increased or the outside diameter of an image bearing member is decreased, the charging ability of the image bearing member deteriorates, and thereby the first one-revolution charge problem tends to be caused. A technique such that the image bearing member is idled by one revolution before starting an image forming operation is proposed in attempting to solve the problem. However, this technique has a drawback in that the waiting time increases. Since it is necessary to increase the waiting time every image forming operation, a huge amount of time is wasted therefor.

A technique of using a preliminary charger has a drawback in that the number of devices provided in the vicinity of an image bearing member increases, and thereby a small-size image bearing member cannot be used, resulting in jumboization of the image forming apparatus. In addition, the technique has another drawback in that the image bearing member suffers accelerated electrostatic fatigue. Therefore, the technique is not a fundamental solution.

When full color image formation is performed, four color toner images have to be overlaid, i.e., four image forming units or at least four developing devices have to be used. Therefore, a strong need exists for a high speed image forming apparatus having small-sized image forming units. In particular, in tandem image forming apparatus, which can perform high speed image formation and in which four image forming units each including at least an image bearing member and a developing device, the image bearing member preferably has a small-size. Therefore, by solving the first one-revolution charge problem, all the requests mentioned above can be fulfilled at the same time. Therefore, it is desired to establish a technique of solving the problem.

Even when the first one-revolution charge problem is solved by a technique, the technique is not a fundamental solution if the electrostatic properties of the image bearing member deteriorate (for example, the residual potential of the image bearing member increases, the photosensitivity thereof decreases, and/or charging ability thereof deteriorates). This is because, in this case, abnormal images such as low density images, images with background fouling, images with poor color reproducibility are formed. In addition, the first one-revolution charge problem is worsen when the electrostatic fatigue of the image bearing member increases. Therefore, stabilization of the electrostatic-properties of the image bearing member is necessary for preventing occurrence of the first one-revolution charge problem.

As a result of our study for preventing occurrence of the first one-revolution charge problem while maintaining stable electrostatic properties of the image bearing member, it is found that it is effective to allow almost all the holes, which are present in the image bearing member and cause the first one-revolution charge problem, to reach the surface of the image bearing member at the beginning of a charging process.

As mentioned above, the first one-revolution charge problem is considered to be caused by holes, which are trapped in a photosensitive layer or a charge generation layer of an image bearing member due to electrostatic fatigue of the image bearing member, and then thermally relaxed so as to be releasable after the image bearing member is left. Therefore, in order to allow almost all the holes to reach the surface of the image bearing member, it is necessary to enhance the mobility of the charge transport layer or prolong the charging time. However, lengthening the charging time increases the time needed for outputting an image, and thereby high speed image formation cannot be performed. In addition, when the outside diameter of the image bearing member is decreased, the charging time has to be shortened. Therefore, when lengthening the charging time, a small-size image bearing member cannot be used and thereby miniaturization of the image forming apparatus cannot be realized. Thus, it is necessary for the image bearing member to have a high mobility such that holes, which are stored in the photosensitive layer of the image bearing member and which are the cause for the first one-revolution charge problem, can reach the surface of the image bearing member in such a short charging time.

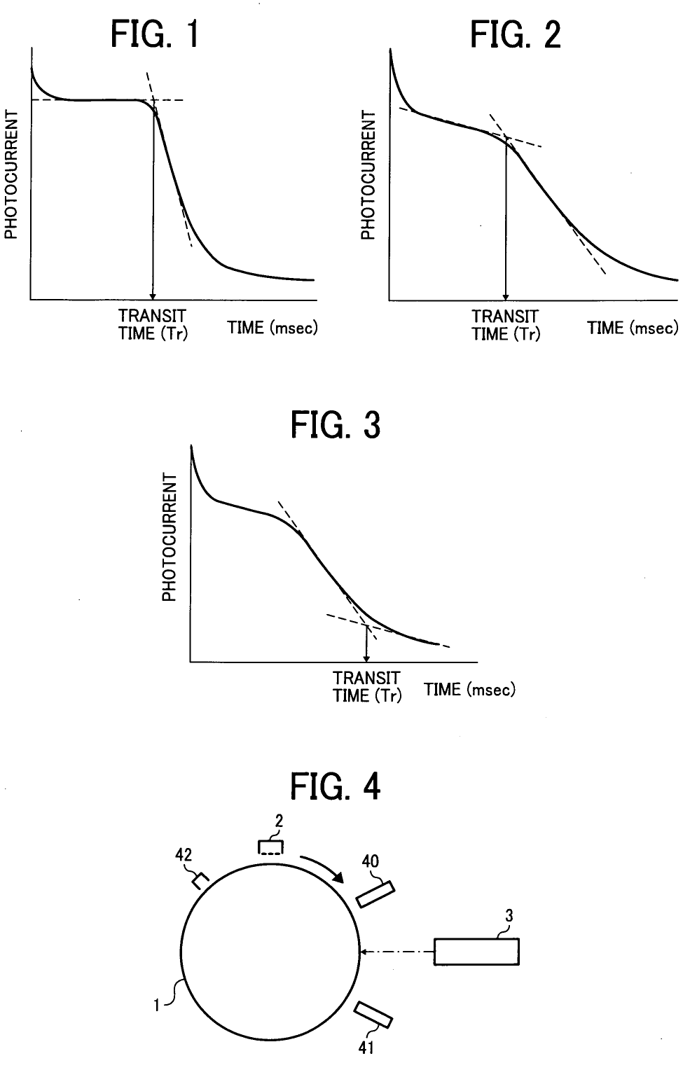

There are some background arts disclosing that it is preferable to use a charge transport material having a high mobility for preventing the first one-revolution charge problem. Almost all the background arts refer to the transit time determined by calculation using the Time-of-flight (TOF) method. The TOF method is useful when designing image bearing members, and has been broadly used. Specifically, the transit time is defined as the time during which almost all the photo-carriers generated in an image bearing member move through the image bearing member along the external electric field. More specifically, in such a curve as illustrated in FIG. 1 showing the dependence of photocurrent of an image bearing member on time, the time at the inflection point is defined as the transit time of the image bearing member. In this regard, the transit time depends on the thickness of the photosensitive layer of the image bearing member. Therefore, it is typical to use the drift mobility determined by the following equation (5):

μ=d²/(Tr·V) (5)

wherein μ represents the drift mobility of an image bearing member in units of cm²/V·sec; d represents the thickness of the photosensitive layer thereof in units of cm; Tr represents the transit time thereof in units of sec; and V represents the voltage of the external electric field in units of volt.

FIGS. 1 and 2 illustrate dependencies of photocurrents of image bearing members on time. The curve illustrated in FIG. 1 has a rectangular photocurrent waveform, in which the time of from the start of movement of charges to the completion of movement of the charges is relatively short compared to that in the curve illustrated in FIG. 2 having a dispersed photocurrent waveform, in which the time of from the start of movement of charges to the completion of movement of the charges is relatively long, namely, movement of charges has large variation. It is clear from FIGS. 1 and 2 that the transit time determined from such inflection point is not considered to be the time needed for moving almost all the charges generated in the image bearing member through the image bearing member. In particular, the transit time determined from such a dispersed photocurrent waveform as illustrated in FIG. 2 is largely different from the time needed for moving almost all the charges generated in the image bearing member through the image bearing member.

As a result of the present inventors' study, it is found that it is necessary to move almost all the holes, which are present in the photosensitive layer of an image bearing member and which cause the first one-revolution charge problem, to the surface of the image bearing member within such a short charging time. Therefore, even when the transit time determined as the inflection point of such a curve as illustrated in FIG. 1 or 2 is short, or the determined mobility of holes is high, occurrence of the first one-revolution charge problem cannot be well prevented if the time needed for moving almost all the charges generated in the image bearing member through the image bearing member is long.

In addition, methods in which the transit time is determined as the time at which the photocurrent is reduced to one half or one tenth of the maximum photocurrent in such a curve as illustrated in FIG. 1 or 2, or a method, which is disclosed in JP-A 2003-195536 and in which the transit time is determined as illustrated in FIG. 3. By using these methods, the transit time is considered to be near the time needed for almost completing charge transporting. However, since the region of the curve near the transit time has large noise, it is difficult to precisely determine the transit time.

Further, the methods for determining the transit time using the TOF method have following drawbacks. For example, when an image bearing member is used in an image forming apparatus, the strength of electric field formed on the image bearing member changes when the image bearing member is exposed to imagewise light. However, in the TOF method, the transit time is determined without changing the strength of electric field. Therefore, the transit time thus determined by the TOF method is not accurate. In addition, the light source used for the TOF method is typically different from those used for light irradiating devices of image forming apparatus. In these cases, it is possible that the behavior of the charge transport material included in the image bearing member is influenced by the light source used for the TOF method, and for example, new trap sites are formed in the image bearing member. Therefore, the transit time determined by the TOF method is not accurate. Further, in the TOF method, the charge transport layer is sandwiched by two electrodes to measure the mobility (or transit time). Therefore, the behavior of charges at the interface between the charge generation layer and the charge transport layer (to which the charges are injected from the charge generation layer) is not considered by the TOF method. Thus, the TOF method is useful for comparing mobilities of charge transport materials, but is not useful for determining the transit time of image bearing members used for image forming apparatus, particularly when the image bearing members have layered photosensitive layer (including, for example, a combination of a charge generation layer and a charge transport layer).

As mentioned above, it is preferable to transport almost all the holes, which are present in the photosensitive layer and which cause the first one-revolution charge problem, to the surface of the image bearing at the beginning of a relatively short charging time. Therefore, it is effective to use a charge transport layer having a high mobility. However, since conventional methods for determining the transit time of an image bearing member typically use the TOF method, which does not consider the behavior of charges in the image bearing member, the relationship between the thus determined transit time and the first one-revolution charge problem is not clear (i.e., it is difficult to solve the first one-revolution charge problem using the transit time thus determined by the TOF method).

In the present application, the method disclosed in JP-A 2000-275872 is used for determining the time (i.e., the transit time) needed for allowing almost all the charges, which are present in the image bearing member and which cause the first one-revolution charge problem, to reach the surface of the image bearing member. The method will be explained in detail.

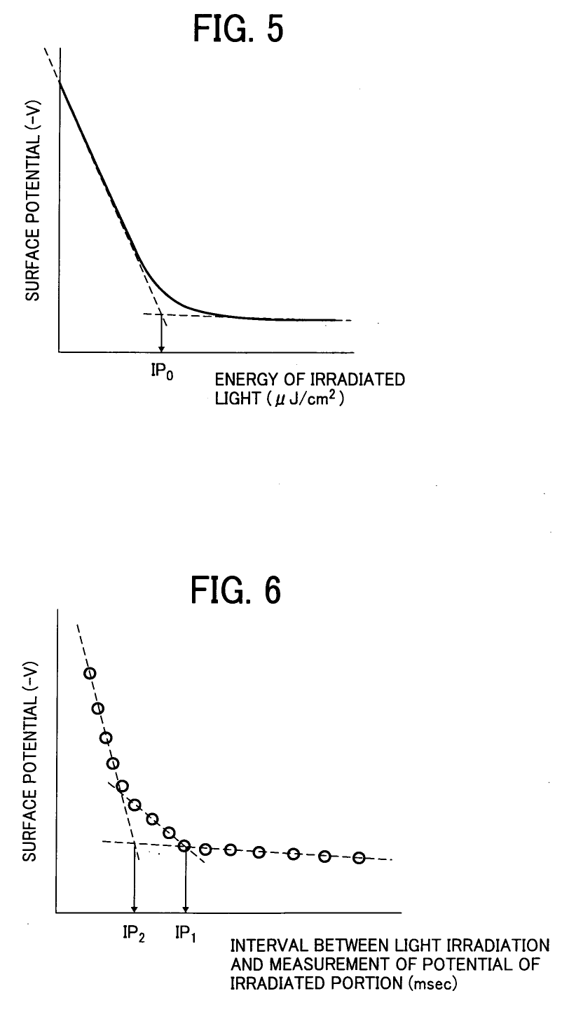

The method uses such an instrument as illustrated in FIG. 4. Referring to FIG. 4, an image bearing member 1 is charged with a charging device 2, and the potential of a non-irradiated portion of the charged image bearing member, which is not exposed to light, is measured with a first surface potential meter 40. Next, a light irradiating device 3 irradiates the charged image bearing member 1 with light, and the potential of an irradiated portion of the image bearing member 1 is measured with a second surface potential meter 41. The procedure is repeated while changing the light intensity to obtain such a light-decay curve as illustrated in FIG. 5. In FIG. 4, numeral 42 denotes a discharging device configured to reduce charges remaining on the image bearing member even after light irradiation.

In this instrument, the position of the second surface potential meter 6 can be changed, i.e., the angle between the light irradiating device 3 and the second surface potential meter 6 can be freely changed to change the interval between light irradiating and measurement of potential of a light-irradiated portion. Therefore, when the procedure mentioned above is repeated while changing the interval between light irradiation and measurement of potential of a light-irradiated portion and controlling the light intensity at a predetermined light intensity, such a curve as illustrated in FIG. 6, which shows the relationship between the interval between light irradiating and measurement of a light-irradiated portion and the potential of the light-irradiated portion, can be obtained. In this regard, the predetermined light intensity means the light intensity at which the light-decay curve has the inflection point in FIG. 5. In the curve illustrated in FIG. 6, as the interval between light irradiation and measurement of potential of a light-irradiated portion is shortened, at first, the potential is linearly changed, and then a first inflection point IP₁, at which the slope of the light-decay curve is changed, is observed. As the interval is further shortened, a second inflection point IP₂, at which the slope of the light-decay curve is also changed, is observed.

In the present application, it is necessary to determine the time (i.e., the transit time) needed for allowing almost all the holes, which are present in the image bearing member and which cause the first one-revolution charge problem, to reach the surface of the image bearing member. The transit time is defined as the time (i.e., interval between light irradiation and measurement of potential of light-irradiated portion) at which the first inflection point IP₁ is observed. By using this method, the transit time of an image bearing member in a real image forming apparatus can be precisely determined because measurements are performed under almost the same image forming conditions and environmental conditions as those in the real image forming apparatus. Hereinafter this transit time is sometimes referred to as the real transit time. Therefore, it becomes possible to prevent occurrence of the first one-revolution charge problem using this method.

Therefore, if the real transit time can be shortened, occurrence of the first one-revolution charge problem can be prevented, and thereby the margin for high speed image formation and miniaturization of image forming apparatus can be increased. However, even when the real transit time can be shortened, occurrence of the first one-revolution charge problem cannot be prevented if the charging time is shorter than the real transit time or the image bearing member is unevenly charged. Therefore, it is preferable to use a charging device capable of uniformly charging an image bearing member for a charging time not shorter than the transit time of the image bearing member.

Any charging devices, which can charge an image bearing member for a time not shorter than the real transit time of the image bearing member, can be used for the image forming apparatus of the present invention. Specific examples of the charging devices include charging devices using corona discharging such as corotron and scorotron charging devices, which use a wire to which a high voltage is applied; charging devices using a solid charging method, which use, instead of wires, an insulating plate sandwiched by two electrodes to which a high voltage is applied; contact roller charging devices using a roller, which is contacted with the surface of an image bearing member and to which a high voltage is applied; short-range roller charging devices using a roller, which is arranged in the vicinity of an image bearing member with a gap of not less than 100 μm therebetween and to which a high voltage is applied; contact charging devices using a charging member such as brushes, films and blades, which is contacted with the surface of an image bearing member and to which a high voltage is applied; etc.

Among these charging devices, corona charging devices are preferably used for the present invention. Corona charging devices are such that a high voltage is applied to a wire having a diameter of from 50 to 100 μm to ionize the air in the vicinity of the wire and to transport the ionized air to the surface of an image bearing member, resulting in charging of the image bearing member. Corona charging devices are broadly classified into corotron charging devices and scorotron charging devices. Corotron charging devices include a wire. Scorotron charging devices include a wire and a screen electrode called as a grid, which is arranged at a pitch of from 1 to 3 mm and which is arranged 1 to 2 mm apart from the wire. Scorotron charging devices have an advantage such that even when the charging time is long, the potential of the charged image bearing member can be controlled by controlling the voltage (grid voltage) applied to the grid, namely, the potential of the image bearing member is saturated at a predetermined potential. Thus, the potential of the image bearing member can be controlled by controlling the grid voltage, and thereby the image bearing member can be evenly charged. Therefore, it is preferable to use a scorotron charging device for the image forming apparatus of the present invention because the image bearing member can be evenly charged, resulting in prevention of occurrence of the first one-revolution charge problem, thereby increasing the margin of the image forming apparatus for high speed image formation and miniaturization. Thus, scorotron charging devices are suitable for producing high quality images.

In order to perform high speed image formation, double-wire scorotron charging devices in which two wires are arranged in parallel are more preferably used. Double-wire scorotron charging devices, in which a partition is arranged between the two wires, are also preferably used. In such double-wire scorotron charging devices, a gap is formed between the two wires and between a wire and a casing to prevent occurrence of discharging therebetween. The gap is preferably not less than 1.5 mm when the voltage applied to the wire is 1 kV. Namely, the gap (G) preferably satisfies the following relationship:

G(mm)≧1.5×V

wherein G represents the gap, and V represents the voltage applied to the wire in units of kV.

Since double-wire scorotron charging devices have wide charging width, the charging time can be prolonged, resulting in increase in margin for prevention of the first one-revolution charge problem, thereby enabling the image forming apparatus to perform further high speed image formation.

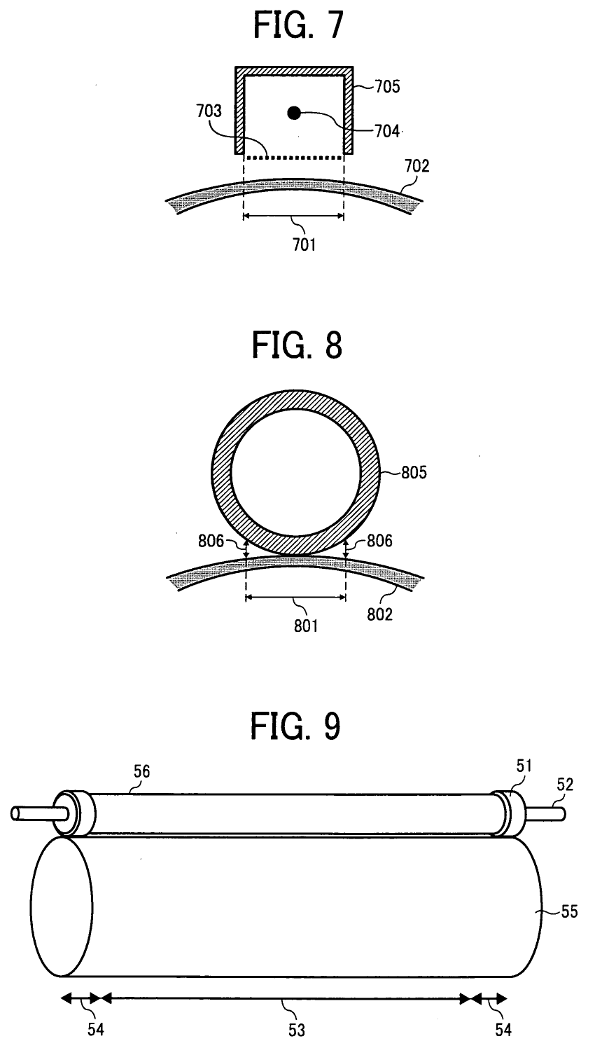

The charging width of a corotron charging device is the same as the width of an opening 701 of a casing 705 as illustrated in FIG. 7. Corotron charging devices have a drawback in that the charging current in the vicinity of a wire 704 tends to be different from that in other regions, resulting in uneven charging. In contrast, since scorotron charging devices have a grid, the image bearing member can be evenly charged, resulting in prevention of occurrence of the first one-revolution charge problem. Referring to FIG. 7, the charging width 701, within which an image bearing member 702 is charged, is the same as the width of a grid 703. The casing 705 typically has a form of box or cylinder, but the form is not limited thereto. Even when corotron or scorotron charging devices have casings in different forms, the charging width of the charging devices is determined depending on the width of the casings or the width of the grids.

The charging time is defined by the following equation (2):

CT (msec)=W(mm)/LV (mm/msec) (2)

wherein CT represents the charging time in units of millisecond, W represents the charging width in units of mm, and LV represents the linear velocity of the image bearing member in units of mm/millisecond.

Therefore, when a corotron or a scorotron charging device is used for the image forming apparatus of the present invention, the charging time can be determined by dividing the width of the opening of the casing of the corotron charging device or the width of the grid of the scorotron charging device by the linear velocity of the image bearing member.

In contrast, in contact roller charging devices, a voltage is applied to an electroconductive roller contacted with the surface of the image bearing member to charge the image bearing member. The roller charging devices have advantages in that (1) the applied voltage is relatively low; (2) the charging device is small-sized, and thereby the image forming apparatus can be miniaturized; and (3) the amount of ozone generated by the charging device is small, but have drawbacks in that when used for high speed image forming apparatus, the charging roller is contaminated or the charging ability of the roller deteriorates due to expiration of life of the roller. Therefore, roller charging devices are preferably used for small-size image forming apparatus using a small-size image bearing member rather than image forming apparatus in which the image bearing member is rotated at a high linear speed.

FIG. 8 illustrates a contact roller charging device. As illustrated in FIG. 8, the image bearing member 802 can be charged not only by charge transportation at the contacted portion but also by discharging in an air gap 806 in the vicinity of the contacted portion of a charging roller 805. Specifically, discharging occurs when the air gap 806 is not greater than 300 μm. Numeral 801 denotes the charging width of the charging roller 805. In addition, when a DC voltage on which an AC voltage is superimposed is applied, the image bearing member 802 can be more evenly charged. Therefore, charging using a DC voltage on which an AC voltage is superimposed is useful for preventing occurrence of the first one-revolution charge problem and for high speed image formation and miniaturization of image forming apparatus.

Short-range roller charging devices can also be used for the image forming apparatus of the present invention. Using these charging devices can prevent occurrence of problems in that (1) the charging roller is contaminated with developers and paper dust, resulting in deterioration of the charging ability of the charging roller and deterioration of image qualities (or formation of abnormal images); and (2) the charging roller and the image bearing member is abraded due to contact thereof. In order to form a gap between a charging roller and an image bearing member, a method in which a gap forming member is provided on both end portions of the roller or the image bearing member is typically used. For example, as illustrated in FIG. 9, a gap forming tape 51 is wound around both end portions of a charging roller 56 (i.e., portions corresponding to non-image forming regions 54 of an image bearing member 55) to form a gap between the roller 56 and the image bearing member 55. In FIG. 9, numerals 52 and 53 respectively denote a metal shaft of the charging roller 56, and an image forming region of the image bearing member 55. The gap is preferably as small as possible, and is preferably not greater than 100 μm, and more preferably not greater than 50 μm.

Since the charging roller is not contacted with the image bearing member in short-range roller charging devices, discharging is performed relatively unevenly compared to contact roller charging devices. In order to prevent uneven charging of the image bearing member, it is preferable to apply a DC voltage on which an AC voltage is superimposed. In this case, stability in charging can be dramatically enhanced. In addition, by using a DC voltage on which an AC voltage is superimposed, a problem specific to roller charging methods using only a DC voltage such that discharging occurring at the entrance of the charging region of the image bearing member is different from discharging occurring at the exit of the charging region can be avoided, resulting in enhancement of the first one-revolution charge problem preventing effect.

In these roller charging devices, the charging time is determined by dividing the charging width 801 by the linear velocity of the image bearing member 802. As mentioned above, when the air gap 806 is not greater than 300 μm, discharging occurs between the charging roller 805 and the image bearing member 802, resulting in charging of the image bearing member. The charging width can be determined by calculation of direct measurement.

In short-range roller charging devices, the charging width is relatively narrow compared to that of contact roller charging devices having the same charging roller because a small gap is formed between the charging roller and the image bearing member. However, the drawback can be remedied by applying a DC voltage on which an AC voltage is superimposed. Therefore, short-range roller charging devices can also be used for the image forming apparatus of the present invention.

In addition, it is possible to use two or more of these charging devices. In this case, the charging time can be dramatically decreased, and therefore the technique is preferably used for high speed image formation. When plural charging devices are provided, the sum of the charging times is the total charging time. Although use of plural charging devices is effective for high speed image formation, it is not preferable for miniaturization of the image forming apparatus. Therefore, it is preferable that whether or not to use plural charging devices is determined depending on the image forming apparatus.

The real transit time has dependence on the strength of electric field formed on the image bearing member. Specifically, the higher the strength of electric field, the smaller the real transit time. More specifically, when the photosensitive layer of the image bearing member is thinner, the real transit time of the image bearing member is shorter. In addition, as the potential of a non-irradiated portion of the image bearing member at the development position increases, the real transit time of the image bearing member decreases. On the other hand, the strength of electric field formed when charging the image bearing member for the predetermined charging time in the real image forming apparatus influences the occurrence of the first one-revolution charge problem. Therefore, it is preferable that when the real transit time is measured using the instrument illustrated in FIG. 4, the strength of electric field is controlled to be the same as the strength electric field in the real image forming apparatus.

The image forming apparatus satisfies the following relationship (1):

T1<T2 (1),

wherein T1 represents the real transit time of the image bearing member, and T2 represents the charging time.

As mentioned above, when the real transit time is longer than the charging time, all the holes stored in the photosensitive layer cannot reach the surface of the image bearing member. In this case, the potential of the charged image bearing member is decreased by the holes remaining in the photosensitive layer. Therefore, the real transit time has to be not greater than the charging time.

In order to merely prevent occurrence of the first one-revolution charge problem, conventional techniques such that (1) a large charging device having a wide charging width is used; (2) plural charging devices are used; (3) the linear velocity of the image bearing member is decreased; etc., can be used. However, when using such conventional techniques, other problems such that the image forming apparatus is jumboized, a small-size image bearing member cannot be used, etc. occur.

In the present invention, when the relationship (1) is satisfied, occurrence of the first one-revolution charge problem can be prevented without causing problems such as decrease of the image forming speed and jumboization of the image forming apparatus. The first one-revolution charge problem is remarkably caused when the rotation speed of the image bearing member is not lower than 80 rpm, and as the rotation speed of the image bearing member increases, the problem is caused more easily and seriously. However, by using the technique of the present invention, the first one-revolution charge problem preventing effect can be well produced even when the rotation speed of the image bearing member increases. Namely, the faster the rotation speed of the image bearing member, the better effect the technique of the present invention can produce.

The image forming apparatus and method of the present invention will be explained in detail by reference to drawings.

### <Image Forming Apparatus>

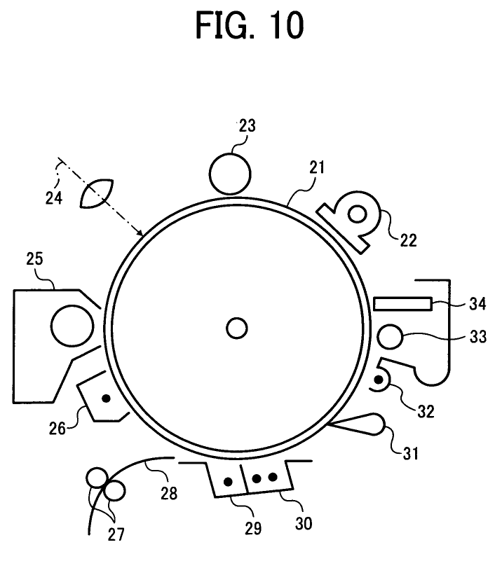

FIG. 10 is a schematic view illustrating an example of the image forming apparatus of the present invention. The image forming apparatus of the present invention is not limited to the image forming apparatus illustrated in FIG. 10, and includes, for example, the modified versions mentioned below.

The image forming apparatus includes an image bearing member 21, which will be explained later in detail. Although the image bearing member 21 has a drum-form, the shape is not limited thereto and sheet-form and endless belt-form image bearing members can also be used.

The image forming apparatus further includes a discharging lamp 22 configured to discharge charges remaining on the image bearing member 21; a charging device 23 configured to charge the image bearing member 21; a light irradiating device 24 configured to irradiate the charged image bearing member 21 with imagewise light to form an electrostatic latent image on a surface of the image bearing member 21; a developing device 25 configured to develop the latent image with a developer including a toner to form a toner image on the surface of the image bearing member 21; and a cleaning device including a fur brush 33 and a cleaning blade 34 configured to clean the surface of the image bearing member 21.

The image forming apparatus further includes a transferring device, which includes a pair of a transfer charger 29 and a separating charger 30 and which is configured to transfer the toner image formed on the image bearing member to a receiving material 28 fed by a pair of registration rollers 27; and a separating pick 31 configured to separate the receiving paper 19 having the toner image thereon from the image bearing member 21. The image forming apparatus of the present invention optionally includes a pre-transfer charger 26 configured to charge the toner image and image bearing member 21 before transferring the toner image, and a pre-cleaning charger 32 configured to charge the image bearing member 21 before cleaning the surface of the image bearing member.

The image forming apparatus of the present invention includes at least an image bearing member, a charging device, a light irradiating device, and a developing device, and optionally includes a transferring device, a fixing device configured to fix the toner image on the receiving material, a cleaning device, a discharging device, etc. In addition, the image forming apparatus can include other devices.

The charging device is explained above. Hereinafter, the light irradiating device, developing device, transferring device, fixing device, cleaning device and discharging device will be explained.

Any devices capable of emitting light which can be absorbed by the charge generation material included in the image bearing member can be used for the light irradiating device. Specifically, when light irradiation is performed on a charged image bearing member and the light is absorbed by the charge generation material therein, a pair of charges having different polarities are formed in the image bearing member. One of the pair of charges moves toward the surface of the image bearing member, thereby decaying the charges on the surface of the charged image bearing member, resulting in formation of an electrostatic latent image on the image bearing member.

Light sources such as light emitting diodes (LEDs), laser diodes (LDs), light sources using electroluminescent lamps (EL), tungsten lamps, halogen lamps, mercury lamps, fluorescent lamps, sodium lamps, etc. can be used if the light sources satisfy the above-mentioned conditions. Among these light sources, light emitting diodes (LEDs) and laser diodes (LDs) can be preferably used because of having advantages such that the light irradiating device can be miniaturized, high speed image formation can be performed, and the effect of the present invention can be well produced. In addition, in order to obtain light having a desired wave length range, filters such as sharp-cut filters, band pass filters, near-infrared cutting filters, dichroic filters, interference filters, color temperature converting filters and the like can be used for the light irradiating device.

A multi-beam light irradiating device, particularly, vertical-cavity surface-emitting laser, is preferably used for the light irradiating device of the image forming apparatus of the present invention. In order to perform high speed image formation, the image scanning frequency in the sub-scanning direction has to be increased by increasing the revolution of the polygon mirror serving as a rotating polyhedral mirror. However, the revolution of polygon mirrors has a limit. Therefore, multi-beam light irradiating devices are preferably used. In multi-beam light irradiating devices, plural light beam sources are arranged in the sub-scanning direction to perform multi-beam scanning such that one main scanning operation is performed using plural light-beams (i.e., a multi-beam recording head). When n pieces of light beams are used, the revolution of the polygon mirror can be decreased by 1/n in order to perform image formation at the same speed as that in a case where one light beam is used. In other words, image formation can be performed at a speed n-times that in a case where one light beam is used. In addition, since the scanning speed can be decreased in multi-beam scanning, the scanning density can be increased. Therefore, high quality images can be formed at a high speed.

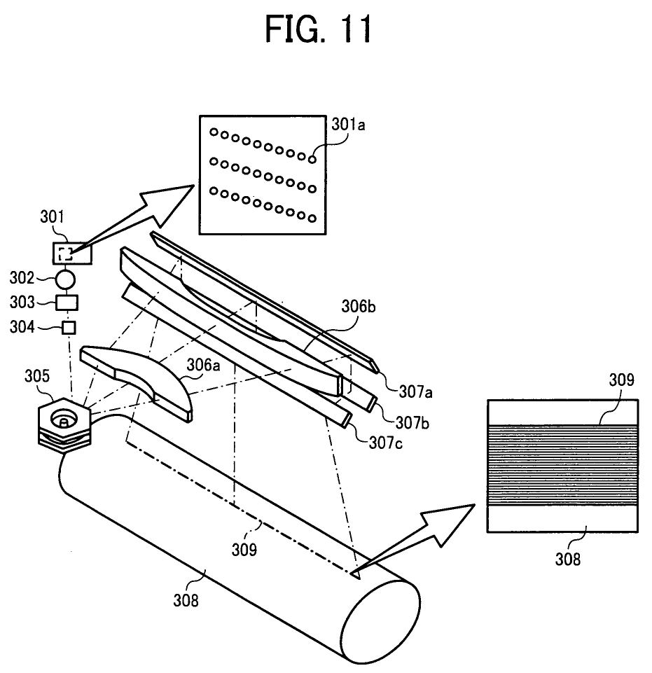

FIG. 11 illustrates an example of the multi-beam light irradiating device for use in the image forming apparatus of the present invention. The light irradiating device includes a light source 301 in which plural light emitting points 301a are arranged in one or two dimensional direction to emit plural laser beams. The emitted laser beams are changed to parallel light beams or substantially parallel light beams by a collimator lens 302. After passing through a cylindrical lens 303 and an aperture 304, the laser beams are deflected in a main scanning direction by a polygon mirror 305. The thus deflected laser light beams are allowed to converge by a first scanning lens 306a and a second scanning lens 306b, and are then focused on the surface of an image bearing member 308 through reflecting mirrors 307a, 307b and 307c. Thus, the laser light beams scan the surface of the image bearing member 308 in the main scanning direction. Numeral 309 denotes scanning lines of the laser beams. Suitable light sources for use in the multi-beam light irradiating devices include edge emitting lasers and vertical-cavity surface-emitting lasers. Among these light sources, vertical-cavity surface-emitting lasers are preferably used because of being capable of forming laser arrays in which light emitting points are arranged in the two-dimensional direction, and therefore the vertical-cavity surface-emitting lasers are effective for high speed image formation, miniaturization of image forming apparatus and improvement of resolution of images. The combination of the collimator lens 302, cylindrical lens 303 and aperture 304 is called as a coupling optical system. In FIG. 11, a portion of the light source 301 is enlarged to clearly illustrate the light emitting points 301a. In addition, FIG. 11 includes another schematic enlarged view illustrating scanning lines 309 of the laser beams on the surface of the image bearing member 308 although the lines are not visible in reality.

By using such a multi-beam light irradiating device, the image bearing member can be rotated at a high speed independently of the rotation speed of the polygon mirror. In addition, the chance of overlapping of adjacent scanning lines can be reduced. Therefore, a multi-beam light irradiating device is preferably used for the image forming apparatus of the present invention.

In the developing process, an electrostatic latent image formed on the image bearing member is developed with a developer including a toner to form a toner image on the surface of the image bearing member. When using a toner having a charge with the same polarity as that of the charge formed on the image bearing member, a negative image is formed on the image bearing member (i.e., reverse development is performed). When using a toner having a charge with a polarity opposite to that of the charge formed on the image bearing member, a positive image is formed on the image bearing member. Development methods are classified into one-component developing methods using a one-component developer including only a toner and two-component developing methods using a two-component developer including a toner and a carrier. Both the one-component developing methods and two-component developing methods can be used for the image forming apparatus of the present invention. When plural color images are formed on the image bearing member while overlaid to form a full color image, it is preferable not to contact the developer with the image bearing member to prevent the former toner images from being damaged by the developer used for forming another color image thereon. Therefore, non-contact developing methods such as jumping developing methods are preferably used.

In the transfer process, a toner image formed on the image bearing member is transferred onto a receiving material such as paper sheets. For example, chargers are used as the transferring device. More specifically, the transfer charger 29 (illustrated in FIG. 10) and a combination of the transfer charger 29 with the separation charger 30 can be preferably used. The transfer methods are classified into direct transfer methods in which an image is directly transferred to a receiving material and intermediate transfer methods in which an image is transferred to an intermediate transfer medium, and the image is then transferred to a receiving material. Both the transfer methods can be used for the image forming apparatus of the present invention. Since the intermediate transfer methods have an advantage in that high quality images can be formed, the methods are preferably used for full color image forming apparatus. However, the intermediate transfer methods are disadvantageous in high speed image formation and miniaturization of image forming apparatus. Therefore, it is preferable to use a proper transfer method depending on the application of the image forming apparatus.

In addition, the transfer methods are classified into constant-voltage transfer methods, and constant-current transfer methods. Both the transfer methods can be used for the image forming apparatus of the present invention. However, constant-current transfer methods are preferably used because the amount of transferred charges is constant, and thereby the transfer process can be stably performed. As the transfer current increases, the transferability of toner images improves. When the linear speed of the image bearing member increases, the transferability deteriorates. In this case, it is preferable to increase the transfer current. In addition, it is preferable to increase the transfer current because the amount of charges flowing through the image bearing member in the discharging process can be decreased, resulting in reduction of electrostatic fatigue of the image bearing member. However, when the transfer current is so high that the image bearing member is positively charged, the charges on the image bearing member cannot be fully decayed in the following discharging process. When the image bearing member in such a state is charged under the same charging conditions, a problem in that the potential of the image bearing member is lower than the predetermined potential occurs. Therefore, it is preferable to apply a proper transfer current in order to prevent occurrence of the first one-revolution charge problem.

In the fixing process, a toner image transferred on a receiving material is fixed thereto. Any fixing methods can be used for the image forming apparatus of the present invention as long as toner images can be fixed on receiving materials. Among various fixing methods, heat/pressure fixing methods in which a toner image is fixed on a receiving material upon application of heat and pressure thereto are preferably used. Specifically, fixing devices having a combination of a heat roller and a pressure roller, or a combination of a heat roller, a pressure roller and an endless belt can be preferably used.

In the cleaning process, foreign materials present on the surface of the image bearing member, such as toner particles remaining on the surface of the image bearing member without being transferred to an intermediate transfer medium or a receiving material, are removed with a cleaning device. Any cleaning devices can be used as long as foreign materials can be removed thereby. Specifically, cleaning devices using a fur brush or a blade, or a combination thereof can be preferably used. In addition, other cleaning devices using a magnetic brush, an electrostatic brush or a magnetic roller can also be used.

When the surface of the image bearing member is contaminated not only with residual toner particles but also with other materials such as components included in the developer, dust produced by receiving paper sheets, and products of discharging caused by the charging process, the qualities of images deteriorate. In the cleaning process, these foreign materials are removed by a cleaning device. However, after long repeated use, the foreign materials tend to be adhered to the surface of the image bearing member, resulting in deterioration of image qualities or formation of abnormal images. In order that foreign materials are not easily adhered to the image bearing member (resulting in prevention of occurrence of such an adhesion problem), it is preferable to include a lubricant in the surface portion of the image bearing member or to apply a lubricant on the surface of the image bearing member.

Applying a lubricant on the image bearing member offers another advantage in that the friction between the surface of the image bearing member and a cleaning blade can be reduced, resulting in stabilization of behavior of the cleaning blade, thereby preventing occurrence of defective cleaning. In addition, abrasion loss of the surface of the surface of the image bearing member caused by the friction can be reduced. Further, the excess of the lubricant applied on the surface of the image bearing member can be removed by the cleaning blade. In this case, foreign materials adhered to the surface can also be removed together with the excess lubricant, resulting in prevention of a filming problem in that the foreign materials form a film on the surface of the image bearing member. Particularly when the image bearing member has a protective layer (i.e., an outermost layer) including a filler, a lubricant can be evenly applied on the surface of the image bearing member, and thereby the cleanability, and resistance to abrasion and scratches of the image bearing member can be improved. Therefore, it is preferable to apply a lubricant on the surface of the image bearing member.

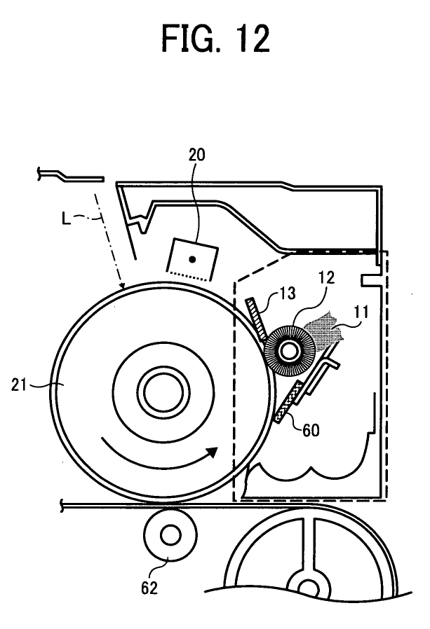

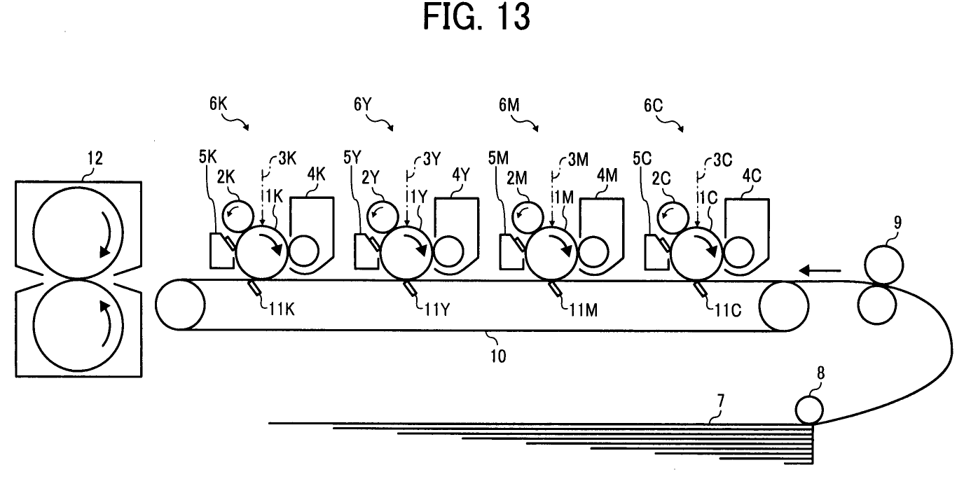

An example of the lubricant applying device for use in the image forming apparatus of the present invention is illustrated in FIG. 12.

FIG. 12 illustrates a lubricant applying device and a lubricant spreading device for use in the image forming apparatus of the present invention.

Referring to FIG. 12, a lubricant applying device including a lubricant applying member 12 configured to apply a lubricant 11 to the surface of the photoreceptor 21 is provided on a downstream side from a cleaning blade 60 configured to clean the surface of the photoreceptor 21 relative to the rotation direction of the image bearing member indicated by an arrow. In addition, a lubricant spreading device including a lubricant spreading member 13 is provided on a downstream side from the lubricant applying member 12.

Referring to FIG. 12, a toner image, which is formed on the photoreceptor 21 using a scorotron charger 20, imagewise light L and developing device (not shown), is transferred to an intermediate transfer medium by a transfer member 62 applying a bias to the intermediate transfer medium. Toner particles and foreign materials remaining on the photoreceptor 21 even after the primary transfer operation are removed therefrom by the cleaning blade 60.

The lubricant applying member 12, which is rotated by a driving device (not shown), rotates and scrapes the lubricant 11, which is pressure-contacted with the lubricant applying member 12. The scraped lubricant is applied to the surface of the photoreceptor 10 by the rotated lubricant applying member 12. The thus applied lubricant is spread by the lubricant spreading member 13, which is contacted with the photoreceptor 21 so as to counter the photoreceptor. Thus, the lubricant 11 is evenly applied to the surface of the photoreceptor 21, and thereby the adhesiveness of the toner to the photoreceptor can be reduced, resulting in prevention of the filming problem.

By applying a lubricant on the surface of the image bearing member, occurrence of a problem in that the tip of the cleaning blade is turned in the opposite direction, resulting in defective cleaning can be prevented. In addition, applying a lubricant prevents the surface of the image bearing member from deteriorating. Therefore, the life of the image bearing member can be prolonged and the qualities of images produced by the image bearing member can be improved. Therefore, it is preferable to apply a lubricant on the surface of the image bearing member because the resistance of the image bearing member to abrasion and scratches; and cleanability thereof can be improved without deteriorating resistance to the first one-revolution charge problem and stability of electrostatic properties of the image bearing member.

As mentioned above, a lubricant applying method in which a solid lubricant is scraped with a brush, and the scraped lubricant is contacted with the surface of the image bearing member is preferably used. In addition, it is possible to use a developer including a lubricant powder. In this case, the lubricant is applied on the surface of the image bearing member in the developing process. Other lubricant applying methods can also be used as long as a lubricant can be applied to the surface of the image bearing member by the methods.

In addition, it is preferable to spread the applied lubricant with a blade as illustrated in FIG. 12. In this case, the blade may be the cleaning blade or an exclusive blade for lubricant application. It is preferable to perform the lubricant applying process after the cleaning process, i.e., it is preferable to provide a lubricant applying device after the cleaning device.

Any lubricants can be used for the lubricant applying device as long as the lubricants are evenly adhered to the surface of the image bearing member, and impart a lubricating property to the image bearing member.

Specific examples of the materials for use as the lubricants include waxes such as ester waxes having an ester bond (e.g., natural waxes such as carnauba waxes, candelilla waxes and rice waxes, and montan waxes); olefin waxes (such as polyethylene waxes, and polypropylene waxes); fluorine-containing resins (such as PTFE, PFA and PVDF); silicone resins; polyolefin resins; fatty acid metal salts (such as zinc stearate, zinc laurate, zinc myristate, calcium stearate, and aluminum stearate); etc. Among these materials, zinc stearate is preferably used.

In the discharging process, charges, which remain on the image bearing member even after the transfer process and which cause ghost images or uneven images, are removed (or reduced) with a discharging device. Any discharging devices can be used therefor as long as the devices can emit light which can be absorbed by the charge generation material included in the image bearing member. Specific examples of the light sources of the discharging device include light emitting diodes (LEDs), laser diodes (LDs), electroluminescence devices (EL), tungsten lamps, halogen lamps, xenon lamps, mercury lamps, fluorescent lamps, sodium lamps, etc. These light sources can be used in combination with one or more of the optical filters mentioned above for use in the light irradiating device, if desired. When a discharging process using light is performed, electrostatic fatigue of the image bearing member tends to be accelerated. In addition, by setting a discharging device, the image forming section is jumboized. Even though discharging devices have such disadvantages, it is still preferable to use a discharging device because formation of ghost images and uneven images, and occurrence of the first one-revolution charge problem can be prevented.

Not only the light discharging devices, but also charging devices which apply the image bearing member with a bias having a polarity opposite to that of the residual charges can be used as the discharging device. The charging devices have an advantage such that electrostatic fatigue of the image bearing member can be reduced.

The present invention is very effective for preventing the first one-revolution charge problem, and for high speed image formation (i.e., shortening of image outputting time) and miniaturization of image forming apparatus. Therefore, the present invention can be preferably used for tandem image forming apparatus, which are required to fulfill the requirements for high speed image formation and miniaturization of image forming apparatus.

Tandem image forming apparatus have plural image forming units (such as yellow, magenta, cyan and black image forming units), each of which includes at least an image bearing member and a developing device and which concurrently produce respective color toner images. The thus prepared plural color images are overlaid to form a full color image. Therefore, tandem image forming apparatus can produce full color images at a speed much higher than that in color image forming apparatus using only one image bearing member and plural developing devices.

FIG. 13 is a schematic view illustrating an embodiment of the image forming apparatus (a tandem type image forming apparatus) of the present invention, which includes plural image forming units.

In FIG. 13, the tandem type image forming apparatus has a cyan image forming unit 6C, a magenta image forming unit 6M, a yellow image forming unit 6Y and a black image forming unit 6K. Drum photoreceptors (image bearing members) 1C, 1M, 1Y and 1K, each of which is the image bearing member of the present invention, rotate clockwise. Around the photoreceptors 1C, 1M, 1Y and 1K, charging devices 2C, 2M, 2Y and 2K, developing devices 4C, 4M, 4Y and 4K, and cleaning devices 5C, 5M, 5Y and 5K are arranged in this order in the clockwise direction.

Light irradiating devices 3C, 3M, 3Y and 3K irradiate the surface of the respective photoreceptors 1 at locations between the charging devices 2 and the developing devices 4 with laser light to form an electrostatic latent image on the respective photoreceptors. The four image forming units 6C, 6M, 6Y and 6K are arranged along a transfer belt 10. The transfer belt 10 contacts the photoreceptors 1C, 1M, 1Y and 1K at image transfer points at locations between the respective developing devices 4 and the respective cleaning devices 5 to receive color images formed on the photoreceptors. At the backsides of the image transfer points of the transfer belt 10, transfer members 11C, 11M, 11Y and 11K are arranged to apply a transfer bias to the transfer belt 10. The image four forming units have the same configuration except that the colors of the toners are different.

The image forming process will be explained referring to FIG. 13.

At first, in each of the image forming units 6C, 6M, 6Y and 6K, the photoreceptor 1C, 1M, 1Y or 1K is charged with the charging device 2C, 2M, 2Y or 2K which rotates in the direction indicated by an arrow. Next, a light irradiating device (not shown) irradiates the photoreceptors 1C, 1M, 1Y and 1K with respective laser light 3C, 3M, 3Y and 3K to form electrostatic latent images on the respective photoreceptors.

The electrostatic latent images thus formed on the photoreceptors 1 are developed with the respective developing devices 4C, 4M, 4Y and 4K including respective color toners C, M, Y and K to form color toner images on the respective photoreceptors. The color toner images thus formed on the photoreceptors are transferred onto a receiving material 7 fed from a paper tray.

The receiving material 7 is fed by a feeding roller 8 and stops at a pair of registration rollers 9. The receiving material 7 is then timely fed to the transfer belt 10 by the registration rollers 9 so that the color toner images formed on the photoreceptors are transferred onto the proper positions of the receiving material 7. The color toner images on the photoreceptors 1 are transferred onto the receiving material 7 at the contact points (i.e., the image transfer points) of the photoreceptors and the receiving material 7.

The toner image on each photoreceptor 1 is transferred onto the receiving material 7 due to an electric field, which is formed due to the difference between the transfer bias voltage and the potential of the photoreceptor. After passing through the four transfer points, the receiving material 7 having the color toner images thereon is then transported to a fixing device 12 so that the color toner images are fixed onto the receiving material 7. Then the receiving material 7 is then discharged from the main body of the image forming apparatus. Toner particles, which remain on the photoreceptors even after the transfer process, are collected by respective cleaning devices 5C, 5M, 5Y and 5K.

In the tandem image forming apparatus, the image forming units 6C, 6M, 6Y and 6K are arranged in this order in the receiving material feeding direction, but the order is not limited thereto. In addition, although the color toner images are directly transferred onto a receiving material in this image forming apparatus, the toner images can be transferred to a receiving material via an intermediate transfer medium.

When a black image is formed, the other image forming units 6C, 6M and 6Y may be stopped. In addition, in FIG. 13, the charging devices 2C, 2M, 2Y and 2K contact the respective photoreceptors 1C, 1M, 1Y and 1K, but the chargers may be short-range charges in which a proper gap of from 10 to 200 μm is formed between the charging members and the respective photoreceptors. Such short-range chargers have advantages such that the abrasion of the photoreceptors and the charging members can be reduced, and in addition occurrence of a problem in that a toner film is formed on the charging members can be prevented.

The image forming units 6C, 6M and 6Y can be detachably set in the image forming apparatus (such as copiers, facsimiles and printers) as process cartridges. As mentioned above, the process cartridge includes the image bearing member (photoreceptor) of the present invention and at least one of a charging device, a light irradiating device, a developing device, a transferring device, a cleaning device and a discharging device.

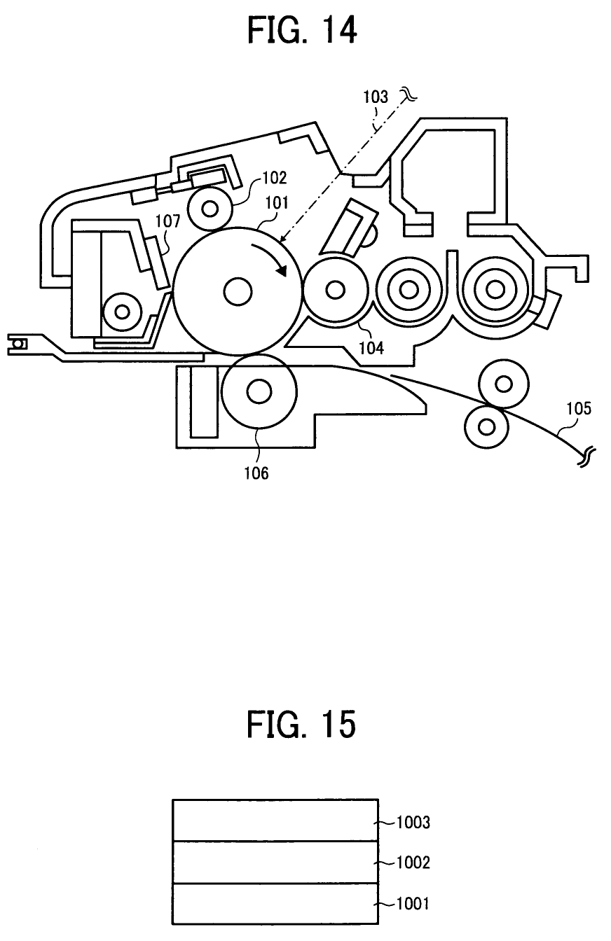

One example of the process cartridge for use in the present invention is illustrated in FIG. 14.

In FIG. 14, the process cartridge includes a photoreceptor 101 which is the image bearing member mentioned above, a charging device 102 configured to charge the photoreceptor 101, a light irradiating device 103 configured to irradiate the photoreceptor 101 with imagewise light to form an electrostatic latent image on the photoreceptor, a developing device 104 which includes a developing sleeve and which is configured to develop the electrostatic latent image with a toner to form a toner image on the photoreceptor 101, a transfer device 106 configured to transfer the toner image onto a receiving paper 105, and a cleaning device 107 configured to clean the surface of the photoreceptor 101.

FIGS. 15-18 illustrate cross-sections of examples of the image bearing member (photoreceptor) for use in the image forming apparatus of the present invention. The layer structure of the image bearing member is not limited thereto. The image bearing member includes plural layers including at least a photosensitive layer and a protective layer overlying the photosensitive layer.

The photoreceptor illustrated in FIG. 15 has an electroconductive substrate 1001, a photosensitive layer 1002 located on the substrate 1001, and a protective layer 1003 located on the photosensitive layer 1002.

The photoreceptor illustrated in FIG. 17 has an electroconductive substrate 1021, an undercoat layer 1024, a photosensitive layer 1022 located on the substrate 1021, and a protective layer 1023 located on the photosensitive layer 1022. Further, an intermediate layer (a resin layer) may be formed between the substrate 1021 and the undercoat layer 1024, if desired.

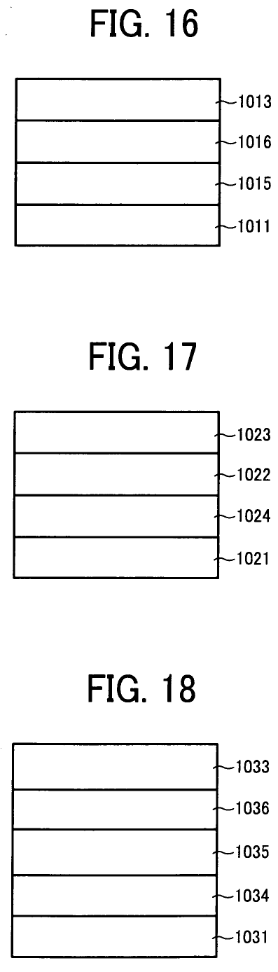

The photoreceptor illustrated in FIG. 16 has an electroconductive substrate 1011, a charge generation layer 1015 located on the substrate 1011, a charge transport layer 1016 located on the charge generation layer 1015, and a protective layer 1013 located on the charge transport layer 1016.

The photoreceptor illustrated in FIG. 18 has an electroconductive substrate 1031, an undercoat layer 1034 located on the substrate 1031, a charge generation layer 1035 located on the undercoat layer 1034, a charge transport layer 1036 located on the charge generation layer 1035, and a protective layer 1033 located on the charge transport layer 1036. Further, an intermediate layer (a resin layer) may be formed between the substrate 1031 and the undercoat layer 1034, if desired.

In order to prevent occurrence of the first one-revolution charge problem, an undercoat layer is preferably formed. In addition, the image bearing member preferably has a layered photosensitive layer (such as combinations of a charge generation layer and a charge transport layer) because of having good durability.

Suitable materials for use as the electroconductive substrate include materials having a volume resistivity not greater than 10¹⁰ Ω·cm. Specific examples of such materials include plastic cylinders, plastic films or paper sheets, on the surface of which a layer of a metal such as aluminum, nickel, chromium, nichrome, copper, gold, silver, and platinum, or a metal oxide such as tin oxides, and indium oxides, is formed using a deposition or sputtering method. In addition, a plate of a metal such as aluminum, aluminum alloys, nickel and stainless steel can be used as the electroconductive substrate. A metal cylinder can also be used as the electroconductive substrate, which is prepared by tubing a metal such as aluminum, aluminum alloys, nickel and stainless steel by a method such as impact ironing or direct ironing, and then subjecting the surface of the tube to cutting, super finishing, polishing and the like treatments. Further, endless belts of a metal such as nickel, and stainless steel can also be used as the electroconductive substrate.

Furthermore, substrates, in which a coating liquid including a binder resin and an electroconductive powder is coated on the supports mentioned above, can be used as the electroconductive substrate. Specific examples of such an electroconductive powder include carbon black, acetylene black, powders of metals such as aluminum, nickel, iron, nichrome, copper, zinc, and silver, and metal oxides such as electroconductive tin oxides, and ITO. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins, etc.

Such an electroconductive layer can be formed by coating a coating liquid in which an electroconductive powder and a binder resin are dispersed or dissolved in a proper solvent such as tetrahydrofuran, dichloromethane, methyl ethyl ketone, toluene and the like solvent, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubber and fluorine-containing resins (such as polytetrafluoroethylene), with an electroconductive material, can also be used as the electroconductive substrate.

Among these materials, cylinders made of aluminum or an aluminum alloy are preferable because aluminum can be easily anodized. Suitable aluminum materials for use as the substrate include aluminum and aluminum alloys such as JIS 1000 series, 3000 series and 6000 series.

Anodic oxide films can be formed by anodizing metals or metal alloys in an electrolyte solution. Among the anodic oxide films, alumite films which can be prepared by anodizing aluminum or an aluminum alloy are preferably used for the photoreceptor of the present invention. This is because the resultant photoreceptor hardly causes undesired images such as black spots and background fouling when used for reverse development (i.e., nega-posi development).

The anodizing treatment is performed in an acidic solution including an acid such as chromic acid, sulfuric acid, oxalic acid, phosphoric acid, boric acid, and sulfamic acid. Among these acids, sulfuric acid is preferably used for the anodizing treatment in the present invention. It is preferable to perform an anodizing treatment on a substrate under the following conditions:
(1) concentration of sulfuric acid: 10 to 20%
(2) temperature of treatment liquid: 5 to 25° C.
(3) current density: 1 to 4 A/dm²
(4) electrolyzation voltage: 5 to 30 V
(5) treatment time: 5 to 60 minutes.
   However, the treatment conditions are not limited thereto.

The thus prepared anodic oxide film is porous and highly insulating. Therefore, the surface of the substrate is very unstable, and the physical properties of the anodic oxide film change with time. In order to avoid such a problem, the anodic oxide film is preferably subjected to a sealing treatment. The sealing treatment can be performed, for example, by the following methods:
(1) the anodic oxide film is dipped in an aqueous solution of nickel fluoride or nickel acetate;
(2) the anodic oxide film is dipped in a boiling water; and
(3) the anodic oxide film is subjected to steam sealing.

Among these sealing treatments, the dipping method using an aqueous solution of nickel acetate is preferable.

After the sealing treatment, the anodic oxide film is subjected to a washing treatment to remove foreign materials such as metal salts adhered to the surface of the anodic oxide film during the sealing treatment. Such foreign materials present on the surface of the substrate not only affect the coating quality of a layer formed thereon but also produce images with background fouling because of typically having a low electric resistance. The washing treatment is performed by washing the substrate having an anodic oxide film thereon with pure water one or more times. It is preferable that the washing treatment is performed (or repeated) until the water used for the last washing treatment is as clean (i.e., deinonized) as possible. In addition, it is also preferable to rub the substrate with a washing member such as brushes in the washing treatment.

The thickness of the thus prepared anodic oxide film is preferably from 5 to 15 μm. When the anodic oxide film is too thin, the barrier effect cannot be well produced. In contrast, when the anodic oxide film is too thick, the time constant of the electrode (i.e., the substrate) excessively increases, resulting in increase of residual potential of the resultant photoreceptor and deterioration of response thereof.

Next, the photosensitive layer will be explained.

The photosensitive layer may be a single-layered photosensitive layer or a layered photosensitive layer. At first, the layered photosensitive layer will be explained.

The layered photosensitive layer includes at least a charge generation layer and a charge transport layer located overlying the charge generation layer.

### <Charge Generation Layer>

The charge generation layer includes a charge generation material as a main component. Known charge generation materials can be used for the charge generation layer.

Specific examples of the charge generation materials include azo pigments such as monoazo pigments, disazo pigments, asymmetric disazo pigments, trisazo pigments, azo pigments having a carbazole skeleton (disclosed in JP-A 53-95033), azo pigments having a distyrylbenzene skeleton (disclosed in JP-A 53-133445), azo pigments having a triphenyl amine skeleton (disclosed in JP-A 53-132347), azo pigments having a diphenyl amine skeleton, azo pigments having a dibenzothiophene skeleton (disclosed in JP-A 54-21728), azo pigments having a fluorenone skeleton (disclosed in JP-A 54-22834), azo pigments having an oxadiazole skeleton (disclosed in JP-A 54-12742), azo pigments having a bisstilbene skeleton (disclosed in JP-A 54-17733), azo pigments having a distyryloxadiazole skeleton (disclosed in JP-A 54-2129), and azo pigments having a distyrylcarbazole skeleton (disclosed in JP-A 54-14967); azulenium salt pigments, squaric acid methine pigments, perylene pigments, anthraquinone pigments, polycyclic quinone pigments, quinone imine-pigments, diphenylmethane pigments, triphenylmethane pigments, benzoquinone pigments, naphthoquinone pigments, cyanine pigments, azomethine pigments, indigoide pigments, bisbenzimidazole pigments, phthalocyanine pigments such as metal or metal-free phthalocyanine having the following formula (11), etc.

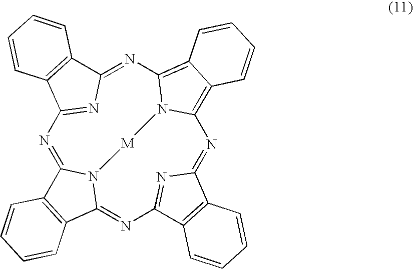

In formula (11), M represents a metal (center metal) element or a non-metal element (i.e., hydrogen).

Specific examples of the center metal of metal phthalocyanine include hydrogen, lithium, beryllium, sodium, magnesium, aluminum, silicon, potassium, calcium, scandium, titanium, vanadium, chromium, manganese, iron, cobalt, nickel, copper, zinc, gallium, germanium, yttrium, zirconium, niobium, molybdenum, technetium, ruthenium, rhodium, palladium, silver, cadmium, indium, tin, lead, barium, hafnium, tantalum, tungsten, rhenium, osmium, iridium, platinum, gold, mercury, thallium, lanthanum, cerium, praseodymium, neodymium, promethium, samarium, europium, gadolinium, terbium, dysprosium, holmium, erbium, thulium, ytterbium, lutetium, thorium, protactinium, uranium, neptunium, americium, combinations of these elements with other elements such as oxides, chlorides, fluorides, hydroxides, and bromides thereof, etc., but are not limited thereto.

Any phthalocyanine compounds having formula (11) can be used as charge generation materials for use in the photosensitive layer of the image bearing member. The compounds may be oligomers (such as dimers and trimers) and polymers, and may have a substituent in the main chain thereof. Among these phthalocyanine compounds, titanyl phthalocyanine having TiO as the center metal, metal-free phthalocyanine, chlorogallium phthalocyanine, and hydroxygallium phthalocyanine are preferably used because of having good properties such as photosensitivity. It is well known that these phthalocyanine compounds have several crystal forms. For example, titanyl phthalocyanine has several crystal forms such as α-form, β-form, γ-form, m-form, Y-form etc., and copper phthalocyanine has several crystal forms such as α-form, β-form and γ-form. It is well known that phthalocyamine compounds having the same center metal have different properties if they have different crystal forms. It is described in Journal of Electrophotography of Japan, vol. 29, No. 4, 1990 that photoreceptors including different phthalocyanine compounds having different crystal forms have different electrophotographic properties. Thus, the crystal form is a very important factor when selecting a phthalocyanine compound for a photoreceptor.

Among these phthalocyanine compounds, a titanyl phthalocyanine (hereinafter TiOPc), which has an X-ray diffraction spectrum such that a maximum peak is observed at a Bragg (2 θ) angle of 27.2°±0.2°; a main peak is observed at each of Bragg (2 θ) angles of 9.4°±0.20, 9.6±0.2° and 24.0±0.2°; a lowest angle peak is observed at an angle of 7.3°±0.2°; no peak is observed between the lowest angle peak and the 9.4° peak; and no peak is observed at a Bragg (2 θ) angle of 26.3°±0.2° when a Cu—K α X-ray having a wavelength of 1.542Å is used, is preferably used as charge generation materials for use in the charge generation layer because of having high charge generation efficiency, and good electrostatic properties, and producing high quality images with little background fouling. These TiOPcs can be used alone or in combination.

The charge generation materials to be included in the image bearing member preferably have a small particle size to enhance the effects thereof. In the case of phthalocyanine compounds, the average particle diameter thereof is preferably not greater than 0.25 μm, and more preferably not greater than 0.2 μm. The method for preparing phthalocyanine compounds having such an average particle diameter is that after a phthalocyanine compound is dispersed in a solvent, coarse particles having a particle diameter greater than 0.25 μm are removed from the dispersion. In this regard, the average particle diameter is the volume average particle diameter determined by an automatic particle diameter measuring instrument, CAPA-700 manufactured by Horiba Ltd. In this case, the 50% cumulative particle diameter (i.e., the median particle diameter) is defined as the average particle diameter. However, this method cannot often determine the amount of coarse particles having a particle diameter greater than 0.25 μm if the amount is small. Therefore, it is preferable to determine the particle diameter by a method using an electron microscope such that a powder or dispersion of a charge generation material is observed with an electron microscope to measure particle diameters of certain number of particles therein, and then averaging the particle diameters of the particles.

Next, the method of removing coarse particles from a charge generation material dispersion will be explained.

Specifically, at first a dispersion of a charge generation material having as small average particle diameter as possible is prepared. Then the dispersion is subjected to filtering using a proper filter. When preparing a dispersion, known dispersing methods can be used. For example, a charge generation material and an optional binder resin are dispersed in a proper solvent using a dispersing machine such as ball mills, attritors, sand mills, bead mills, and ultrasonic dispersing machines. In this regard, it is preferable to choose a proper binder resin and a solvent in consideration of the electrostatic properties of the resin and the wettability and dispersibility of the charge generation material in the solvent.

By using the coarse particle removing method mentioned above, a small amount of coarse particles remaining in a dispersion, which cannot be detected by a method using a particle diameter measuring instrument or visual observation, can be removed therefrom. In addition, this method has an advantage such that the resultant dispersion has a sharp particle diameter distribution. Specifically, it is preferable to perform filtering using a filter having an effective pore diameter of not greater than 5 μm, and preferably not greater than 3 μm. By using this method, a dispersion of a charge generation material having a desired average particle diameter (i.e., not greater than 0.25 μm and preferably not greater than 0.2 μm) can be prepared. By using such a dispersion, a photoreceptor, which can maintain good electrostatic properties (such as photosensitivity and chargeability) over a long period of time, can be prepared, and thereby the effect of the present invention can be produced.

When the dispersion to be filtered has a large average particle diameter or a broad particle diameter distribution, problems in that the amount of loss of the dispersion increases in the filtering operation; and the filter is clogged with coarse particles, thereby making it impossible to perform the filtering operation. Therefore, it is preferable to perform the dispersing operation to prepare a dispersion having a particle diameter distribution such that the average particle diameter is not greater than 0.3 μm and the standard deviation is not greater than 0.2 μm, before the filtering operation. When the average particle diameter of the dispersion is greater than 0.3 μm, a problem which occurs is that the amount of loss of the dispersion in the filtering operation increases. When the standard deviation is greater than 0.2 μm, a problem which occurs is that it takes a long time for the filtering operation.

The above-mentioned charge generation materials have a strong intermolecular hydrogen bond, which is specific to charge generation materials having a high sensitivity. Therefore, particles of a charge generation material in a dispersion have strong interaction. As a result, the dispersed particles tend to aggregate, for example, when the dispersion is diluted. By performing filtering using a proper filter on the dispersion as mentioned above, the aggregated particles can be removed from the dispersion. In this regard, since the dispersion tends to achieve a thixotropic state, not only particles having particle diameter not smaller than that of the effective pore diameter of the filter but also particles and aggregated particles having particle diameters slightly smaller than the effective pore diameter of the filter used can also be removed from the dispersion. In addition, a dispersion having a structural viscosity can be changed to a dispersion close to a Newtonian fluid by filtering. By removing coarse particles from a charge generation material dispersion, the effect of the present invention can be further enhanced.

Among the above-mentioned azo pigments for use as charge generation materials, azo pigments having the below-mentioned formula (10) can be preferably used. Particularly, asymmetric azo pigments having formula (10), in which the group Cp₁ is different from the group Cp₂, are preferably used as charge generation materials because of having advantages such that the pigments have a high carrier generation efficiency, and thereby the resultant photoreceptor can be used for high speed image formation; the pigments are effective for preventing occurrence of the first one-revolution charge problem; the pigments do not increase residual potential; and dependence on electric field strength is small.

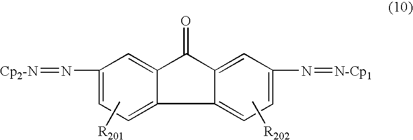

wherein R₂₀₁ and R₂₀₂ independently represent a hydrogen atom, a halogen atom, an alkyl group, an alkoxyl group, or a cyano group; and Cp₁ and Cp₂ independently represent a residual group of a coupler, wherein Cp₁ is different from Cp₂ and each of Cp₁ and Cp₂ has the following formula (10a):

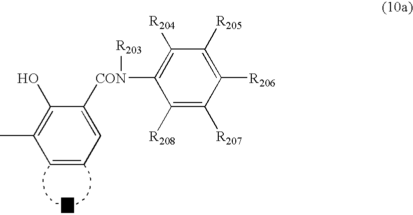

wherein R₂₀₃ represents a hydrogen atom, an alkyl group (such as methyl and ethyl groups), or an aryl group (such as phenyl group); R₂₀₄, R₂₀₅, R₂₀₆, R₂₀₇ and R₂₀₈ independently represent a hydrogen atom, a nitro group, a cyano group, a halogen atom (such as a fluorine atom, a chlorine atom, a bromine atom and an iodine atom), a halogenated alkyl group (such as trifluoromethyl group), an alkyl group (such as methyl and ethyl groups), an alkoxyl group (such as methoxy and ethoxy groups), a dialkylamino group or a hydroxyl group; and Z represents a group of atoms needed for forming a substituted or unsubstituted aromatic carbon ring or a substituted or unsubstituted aromatic heterocyclic ring.

These charge generation materials can be used alone or in combination.

Specific examples of the binder resins, which are optionally included in the charge generation layer coating liquid, include polyamide, polyurethane, epoxy resins, polyketone, polycarbonate, silicone resins, acrylic resins, polyvinyl butyral, polyvinyl formal, polyvinyl ketone, polystyrene, poly-N-vinylcarbazole, polyacrylamide, polyvinyl benzal, polyester, phenoxy resins, vinyl chloride-vinyl acetate copolymers, polyvinyl acetate, polyphenylene oxide, polyvinyl pyridine, cellulose resins, casein, polyvinyl alcohol, polyvinyl pyrrolidone, etc. Among the binder resins, polyvinyl butyral is preferably used. These resins can be used alone or in combination.

Specific examples of the solvent for use in dispersion and the charge generation layer coating liquid include organic solvents such as isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, and ligroin. Among these solvents, ketones, esters and ethers are preferably used. These solvents can be used alone or in combination.

The charge generation layer coating liquid is typically prepared by dispersing a charge generation material and an optional binder resin in a solvent using a dispersing machine such as ball mills, attritors, sand mills and ultrasonic dispersion machines. An optional binder resin is mixed with the charge generation material before or after the dispersing operation. The charge generation layer coating liquid includes a charge generation material, a solvent and a binder resin as main components, but can include additives such as sensitizers, dispersants, surfactants, silicone oils, and charge transport materials mentioned later. The added amount of a binder resin is from 0 to 500 parts by weight, and preferably from 10 to 300 parts by weight, per 100 parts by weight of the charge generation material used.

The charge generation layer is typically prepared by coating the above-prepared coating liquid on an electroconductive substrate with an optional undercoat layer therebetween, followed by drying. Suitable coating methods include known coating methods such as dip coating, spray coating, bead coating, nozzle coating, spinner coating and ring coating.

The charge generation layer preferably has a thickness of from 0.01 to 5 μm, and more preferably from 0.1 to 2 μm. The drying operation is typically performed using an oven, etc. The drying temperature is typically from 50 to 160° C. and preferably from 80 to 140° C.

### <Charge Transport Layer>

The charge transport layer includes a charge transport material and a binder resin as main components. Charge transport materials are classified into positive-hole transport materials and electron transport materials. Charge transport materials have a function of transporting charges to the surface of the image bearing member. Therefore, the charge transport material is an important material for shortening the transit time and increasing the image formation speed of the image forming apparatus.

Specific examples of the electron transport materials include electron accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetanitroxanthone, 2,4,8-trinitrothioxanthone, 2,6,8-trinitro-4H-indeno[1,2-b]thiophene-4-one, 1,3,7-trinitrodibenzothiophene-5,5-dioxide, condensed polycyclic quinines, diphenoquinone, benzoquinone, naphthalene tetracarboxylic acid diimide, aromatic ring compounds having a cyano group or a nitro group, etc.

Specific examples of the positive-hole transport materials include known materials such as poly-N-vinyl carbazole and its derivatives, poly-γ-carbazolylethylglutamate and its derivatives, pyrene-formaldehyde condensation products and their derivatives, polyvinyl pyrene, polyvinyl phenanthrene, polysilane, oxazole derivatives, oxadiazole derivatives, imidazole derivatives, monoarylamines, diarylamines, triarylamines, stilbene derivatives, α-phenyl stilbene derivatives, aminobiphenyl derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, etc.

These charge transport materials can be used alone or in combination.

Among these charge transport materials, compounds having a distyryl structure are preferably used. Particularly, distyryl compounds having the below-mentioned formula (1) are preferably used because the transit time of the image bearing member can be shortened. Specifically, the occurrence of the first one-revolution charge problem in that the potential of the photoreceptor (image bearing member) is relatively low at the first one-revolution (i.e., 360°) of the photoreceptor can be prevented, and thereby the output time of images can be shortened, and high quality images can be produced at a high speed while the image forming apparatus is miniaturized. This is because the distyryl compounds have very high mobility with little variation, and dependence of mobility on electric field strength is small.

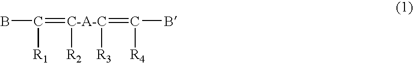

wherein R₁ to R₄ independently represent a hydrogen atom, an alkyl group having 1 to 4 carbon atoms, an alkoxyl group having 1 to 4 carbon atoms, or a phenyl group, which is optionally substituted with an alkyl group having 1 to 4 carbon atoms or an alkoxyl group having 1 to 4 carbon atoms, wherein R₁ to R₄ may be the same as or different from the others; A represents a substituted or unsubstituted arylene group or a group having the below-mentioned formula (1a); B and B′ independently represent a substituted or unsubstituted arylene group or a group having the below-mentioned formula (1b), wherein B and B′ may be the same as or different from each other;

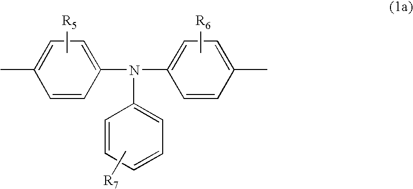

wherein R₅, R₆ and R₇ independently represent a hydrogen atom, an alkyl group having 1 to 4 carbon atoms, an alkoxyl group having 1 to 4 carbon atoms, or a phenyl group, which is optionally substituted with an alkyl group having 1 to 4 carbon atoms or an alkoxyl group having 1 to 4 carbon atoms.

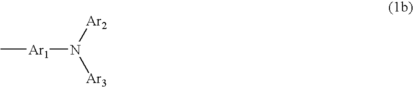

wherein Ar₁ represents an arylene group, which optionally has an alkyl group having 1 to 4 carbon atoms or an alkoxyl group having 1 to 4 carbon atoms; and Ar₂ and Ar₃ independently represent an aryl group, which is optionally substituted with an alkyl group having 1 to 4 carbon atoms or an alkoxyl group having 1 to 4 carbon atoms.

Among these distyryl compounds, distyryl compounds having the following formula (2) are preferably used because of producing good effects.

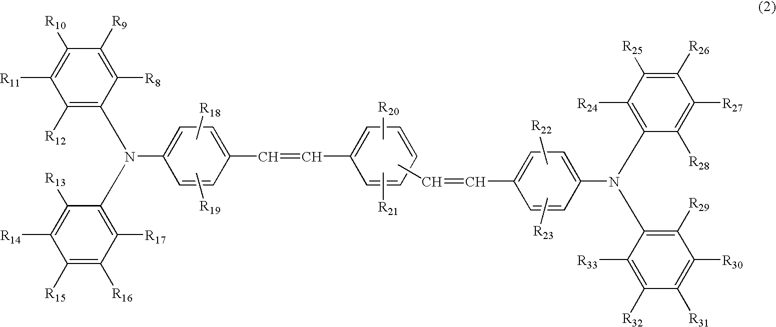

wherein R₈ to R₃₃ independently represent a hydrogen atom, an alkyl group having 1 to 4 carbon atoms, an alkoxyl group having 1 to 4 carbon atoms, or a substituted or unsubstituted phenyl group, wherein R₈ to R₃₃ may be the same as or different from the others.

In addition, charge transport materials having the following formula (3) are also preferably used for the image bearing member.

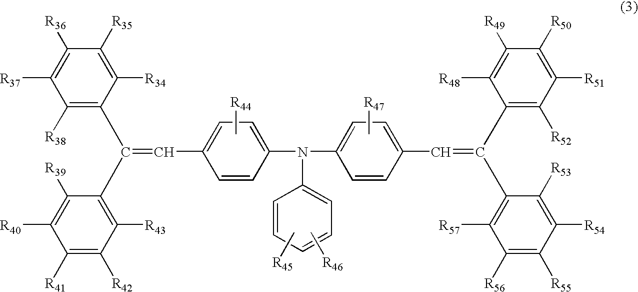

wherein R₃₄ to R₅₇ independently represent a hydrogen atom, an alkyl group having 1 to 4 carbon atoms, an alkoxyl group having 1 to 4 carbon atoms, or a substituted or unsubstituted phenyl group, wherein R₃₄ to R₅₇ may be the same as or different from the others.

The reason why these compounds can produce good effects is considered to be that the compounds have high mobility; the time needed for transporting almost all the charges to the surface of the image bearing member is short; and the charge transporting speed has little variation (i.e., the distribution thereof is represented by a rectangular pulse). The effects of the present invention can be produced because the charge transport material in the photoreceptor has high mobility, and in addition almost all the holes, which cause the above-mentioned first one-revolution charge problem, can be transported to the surface of the photoreceptor at a relatively high speed. The present inventors discover that distyryl compounds having formula (1), particularly formula (2) or (3), can produce the effects and are preferably used as the charge transport material. Since the molecules of these distyryl compounds have a large linear structure, in which the π conjugation system is included in the entire molecule, intramolecular charge transportation is mainly caused rather than intermolecular charge transportation, and thereby not only the mobility is improved, but also dependence of the mobility on the electric field strength is reduced.

Specific examples of the distyryl compounds, which can be preferably used for the charge transport layer of the photoreceptor, include the following compounds, but are not limited thereto.

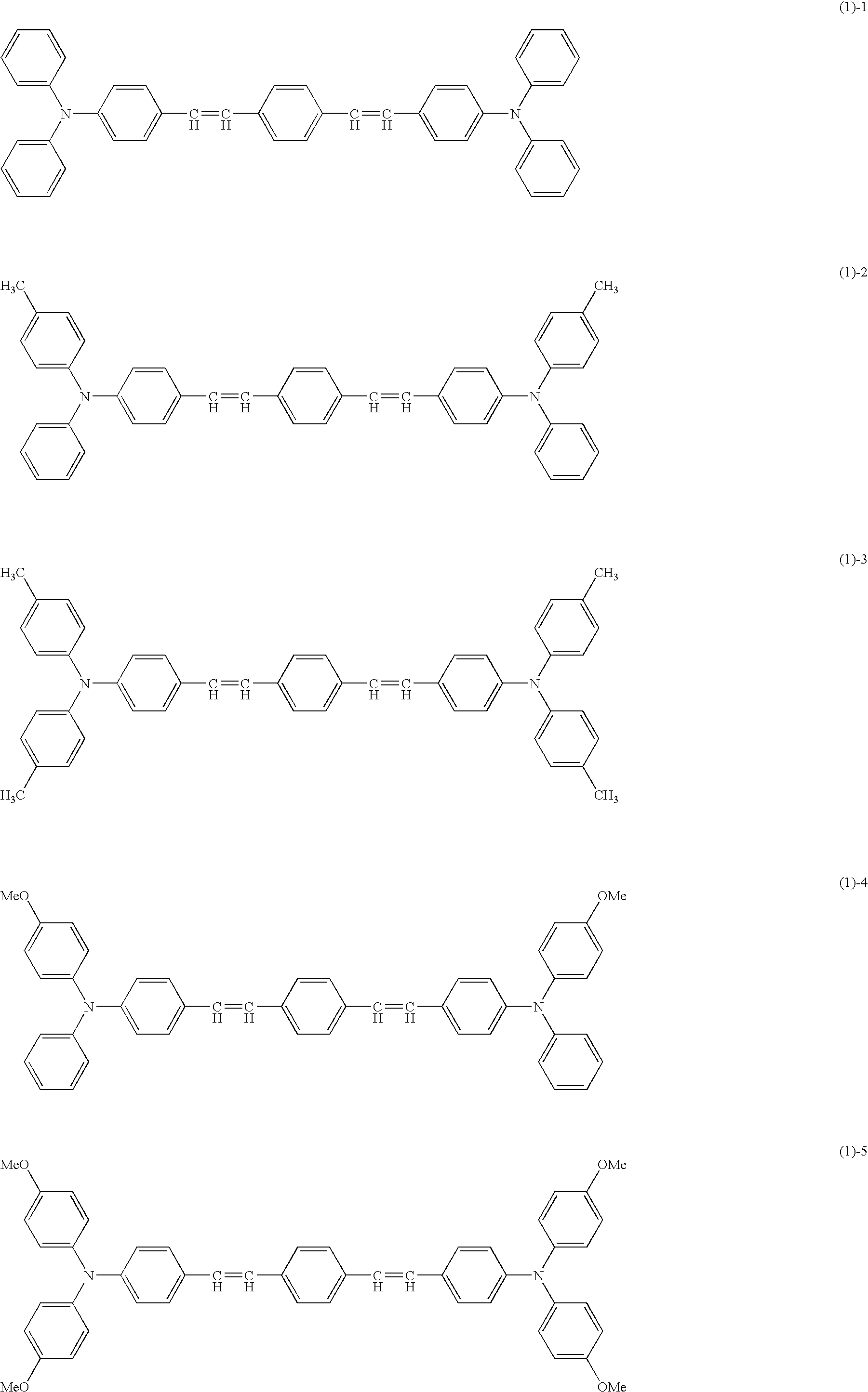

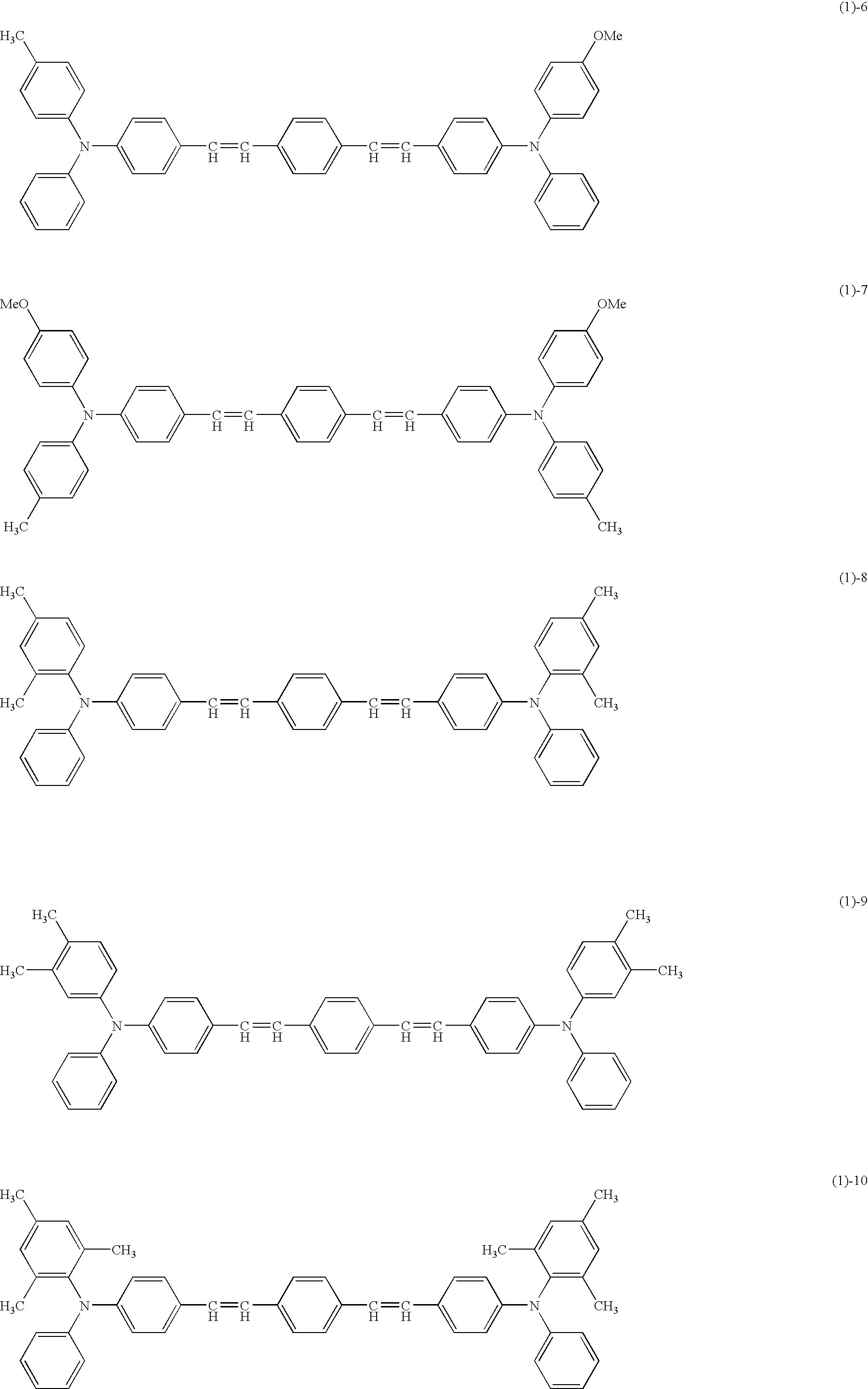

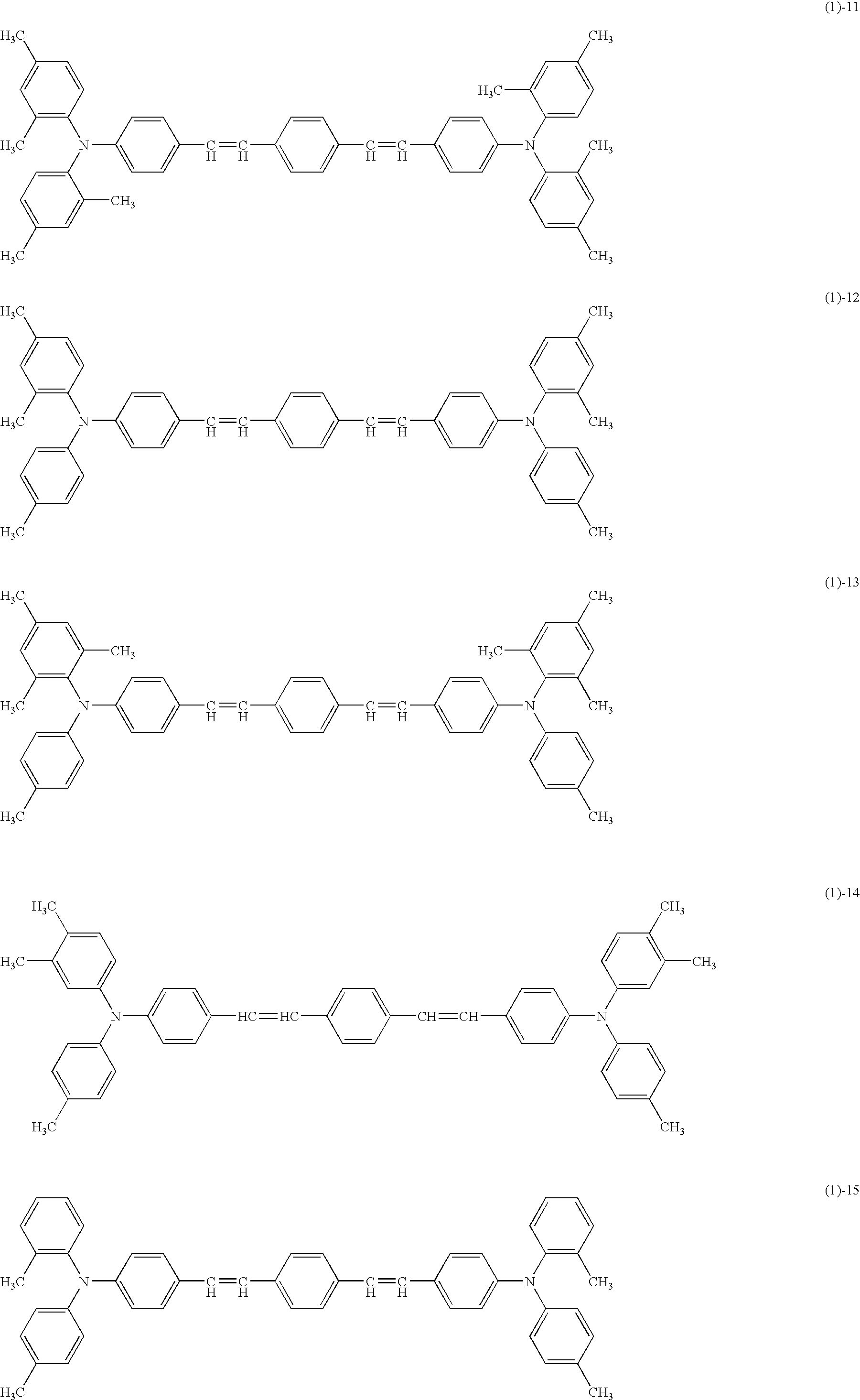

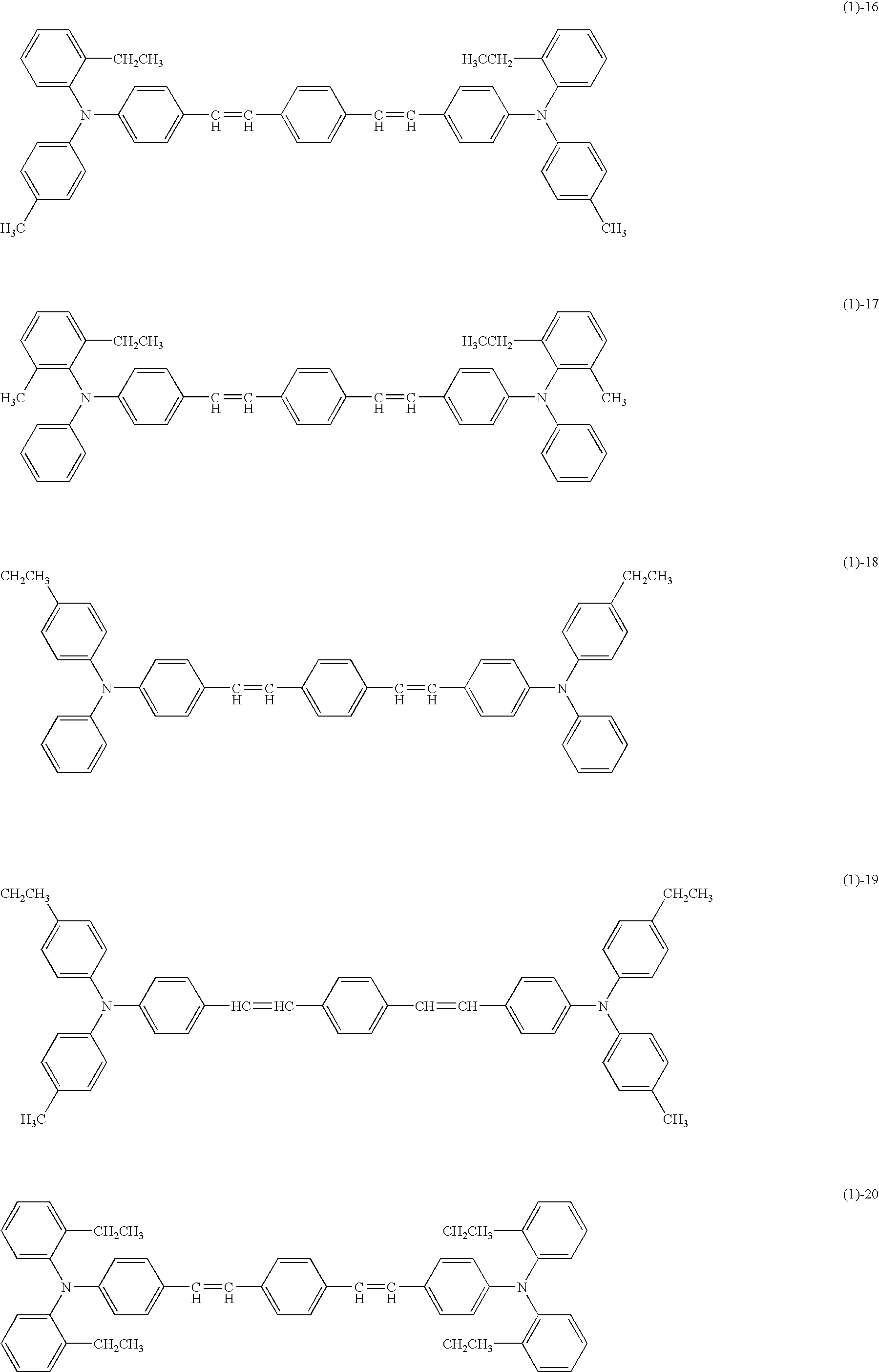

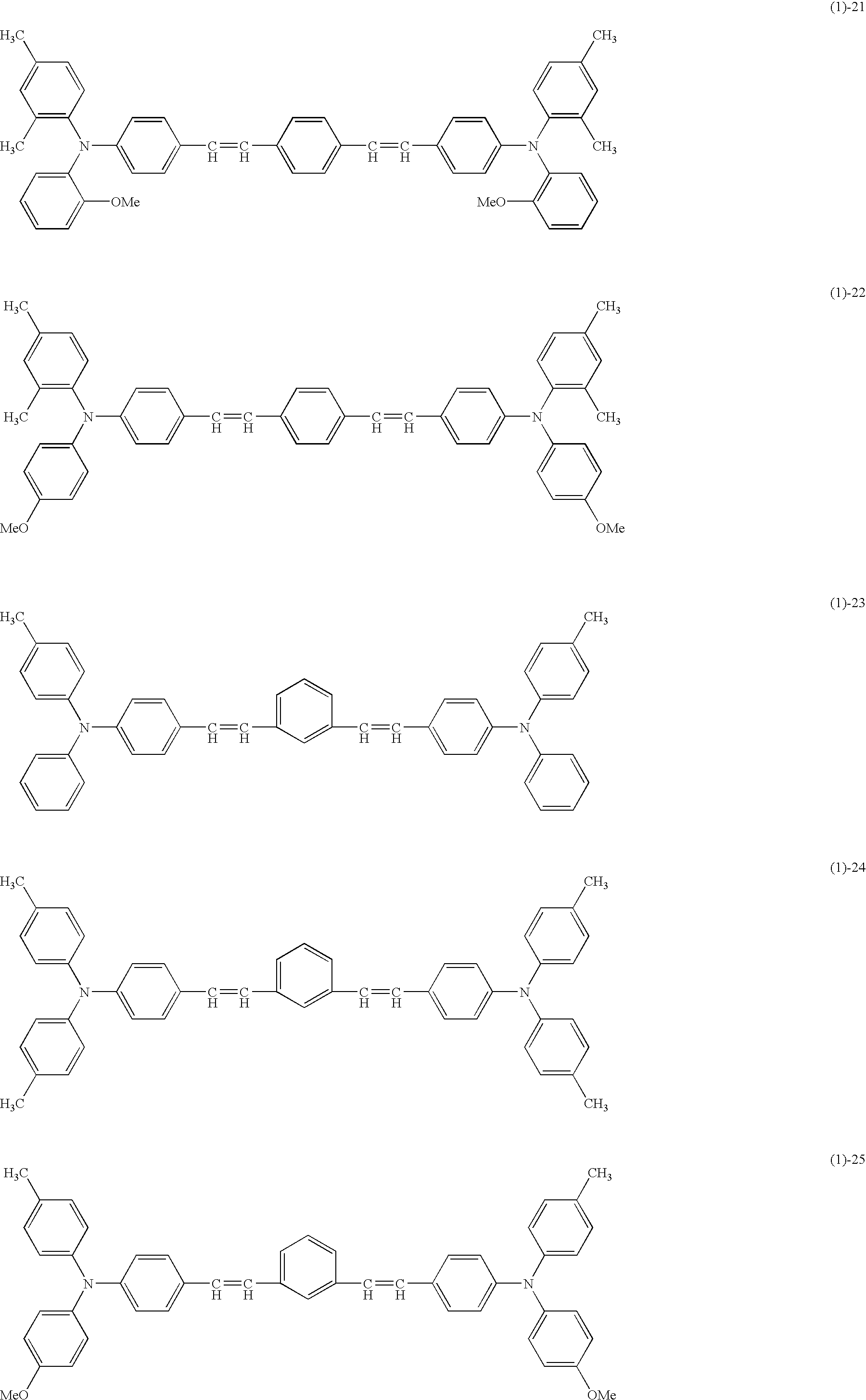

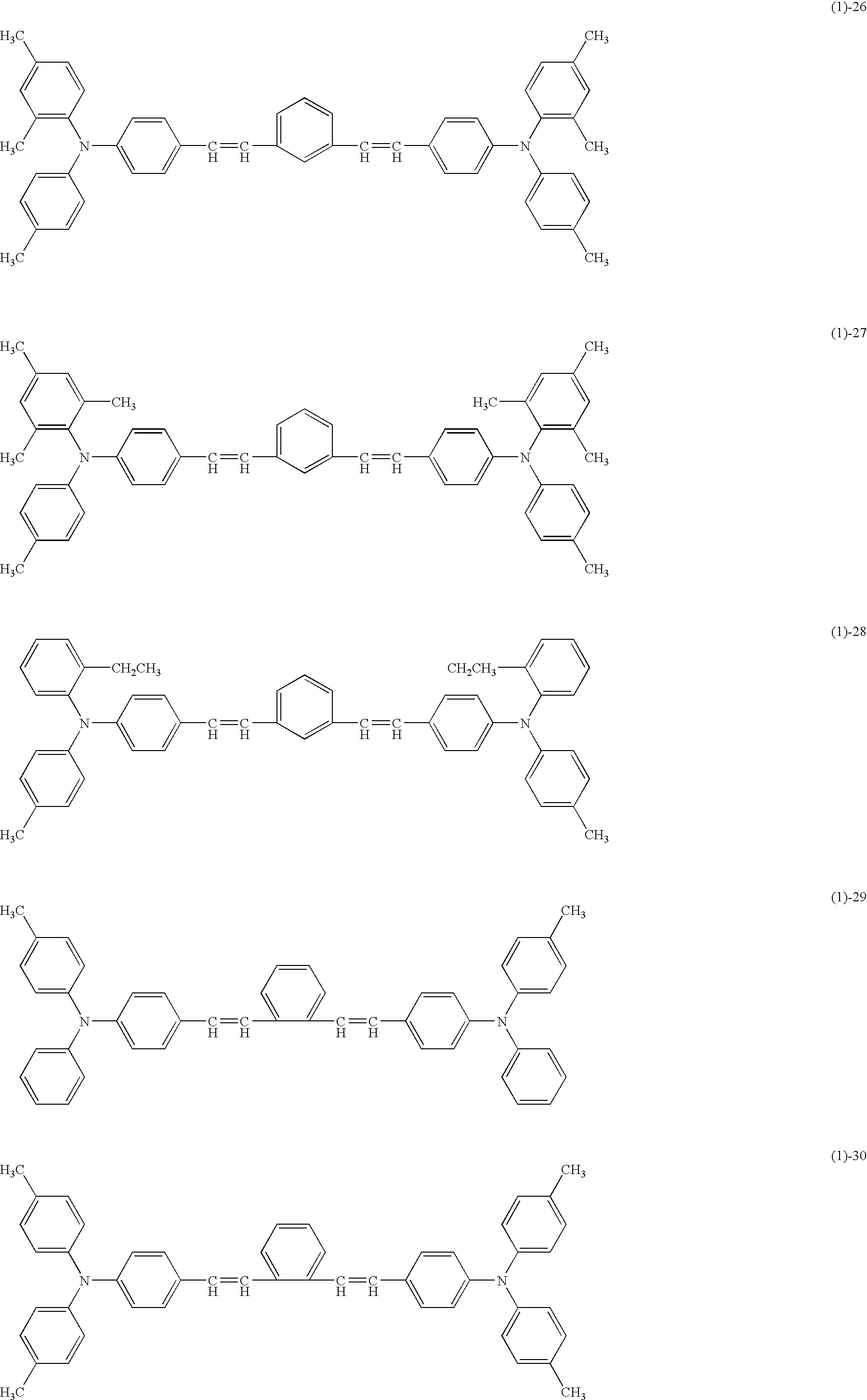

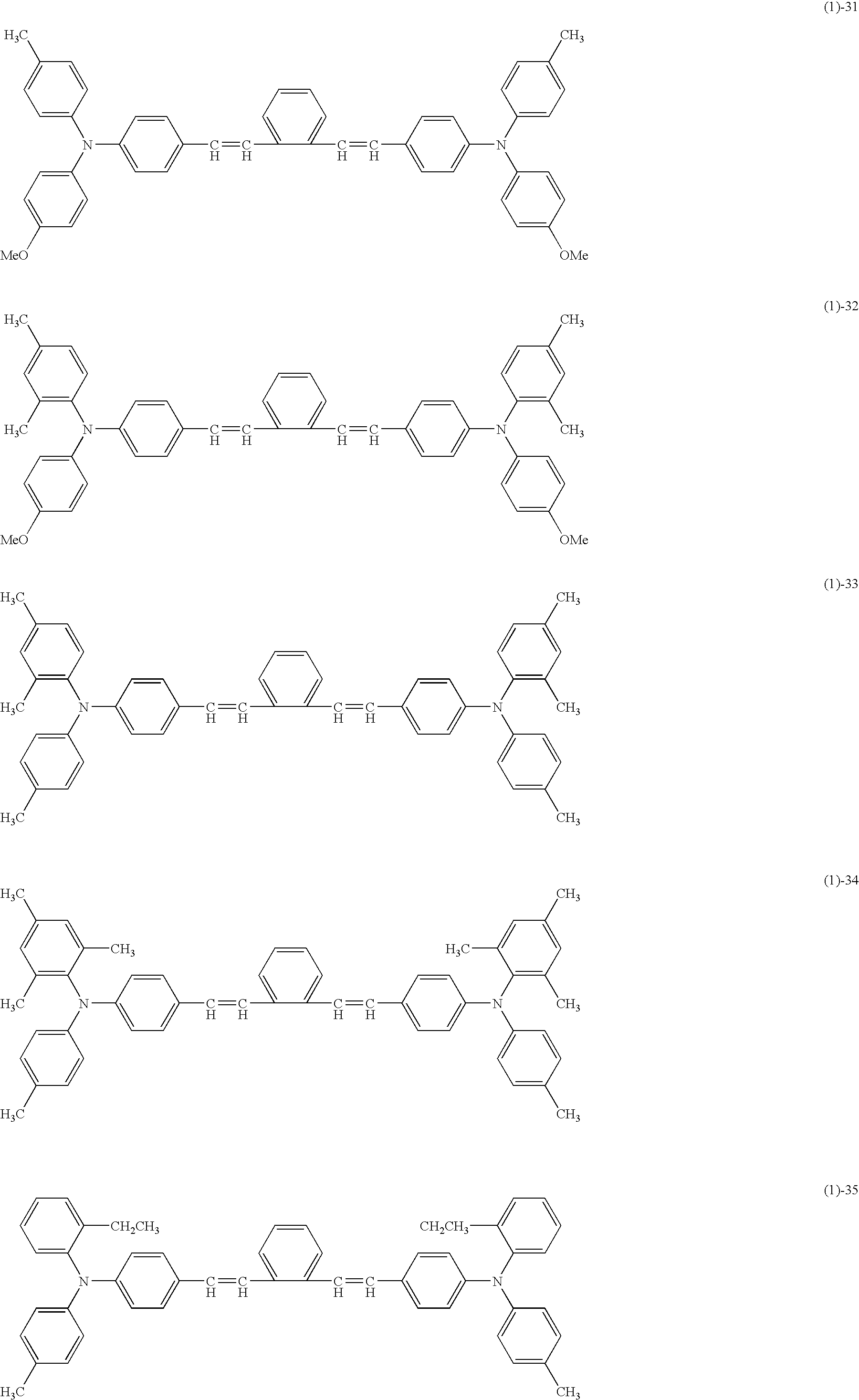

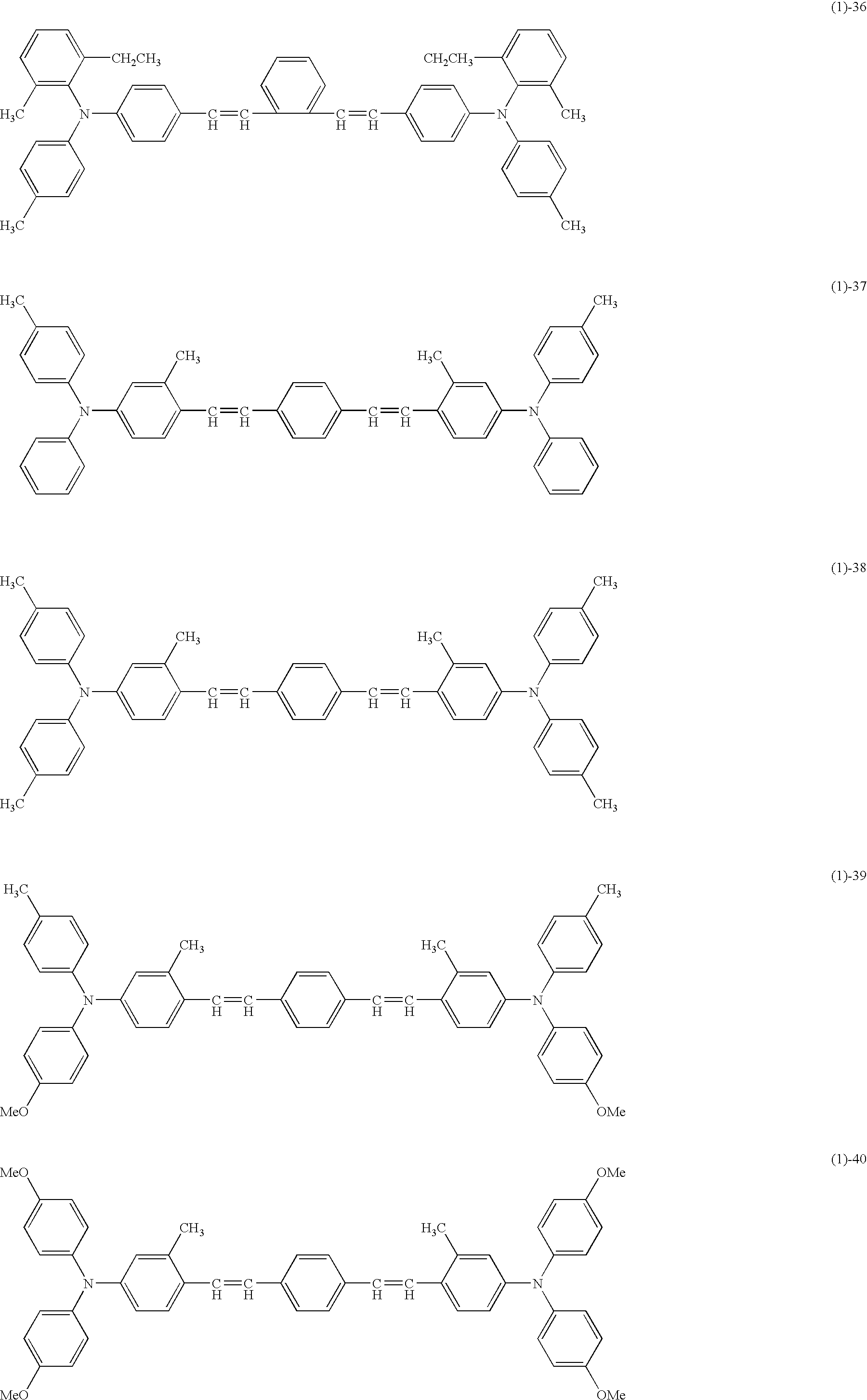

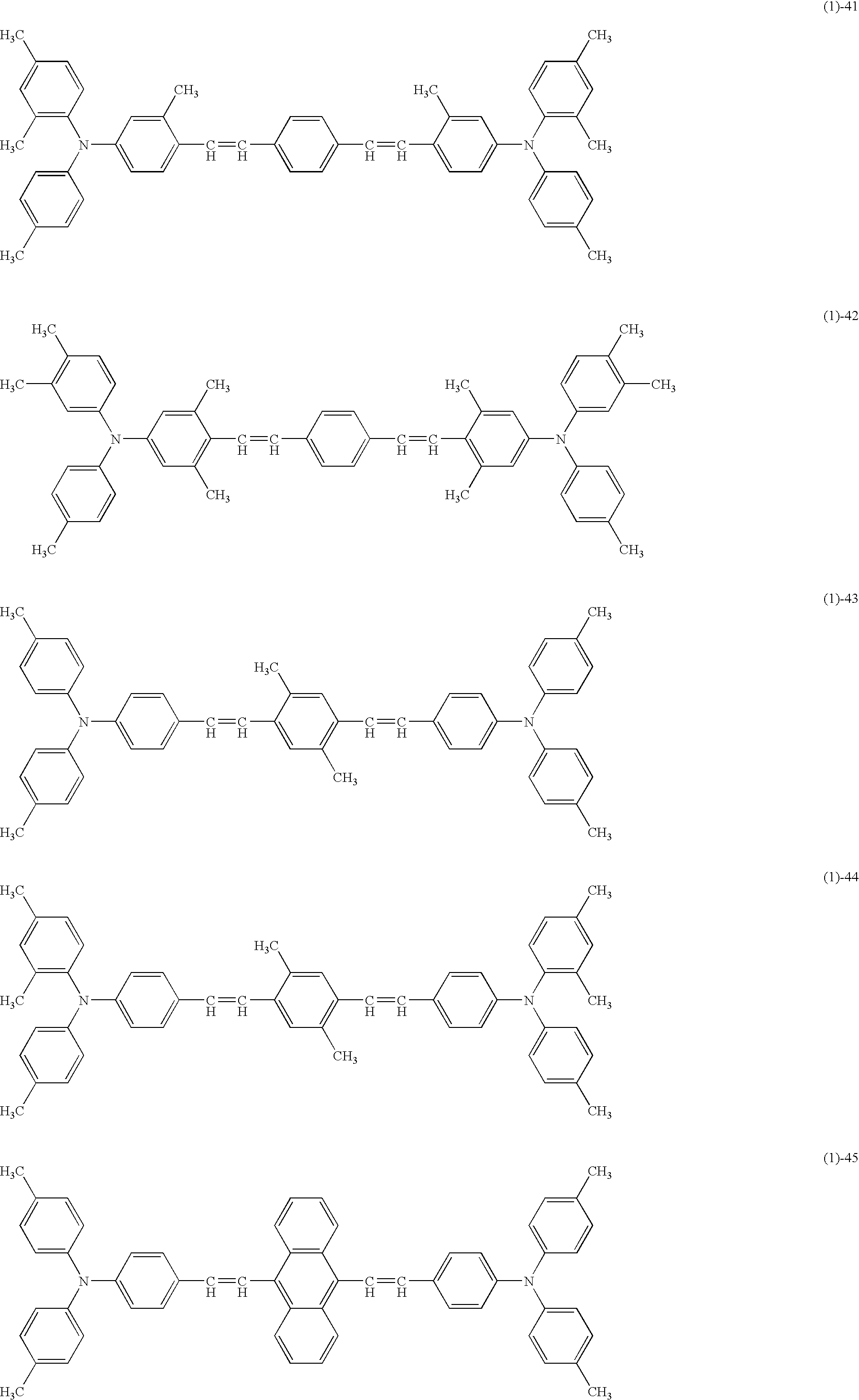

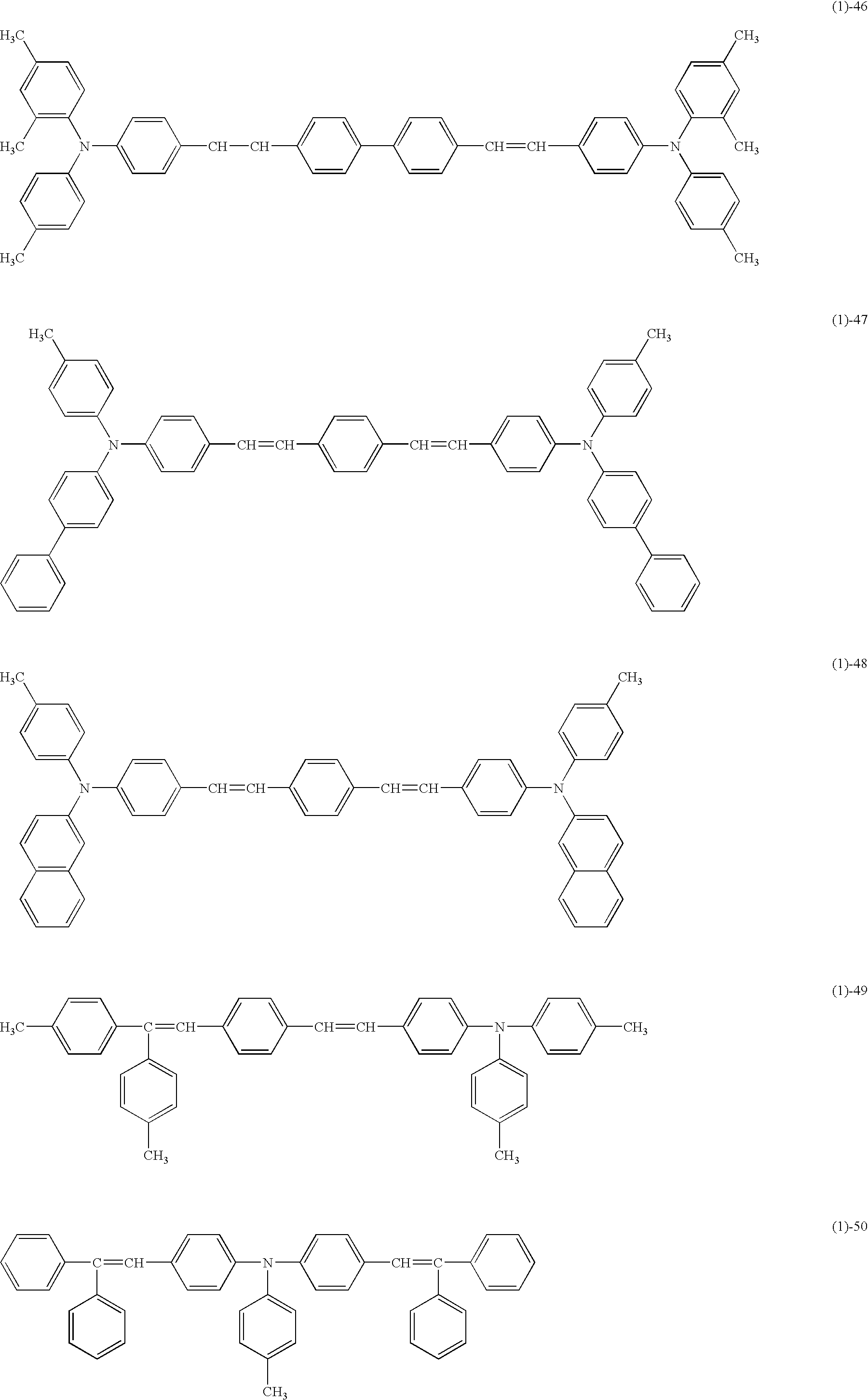

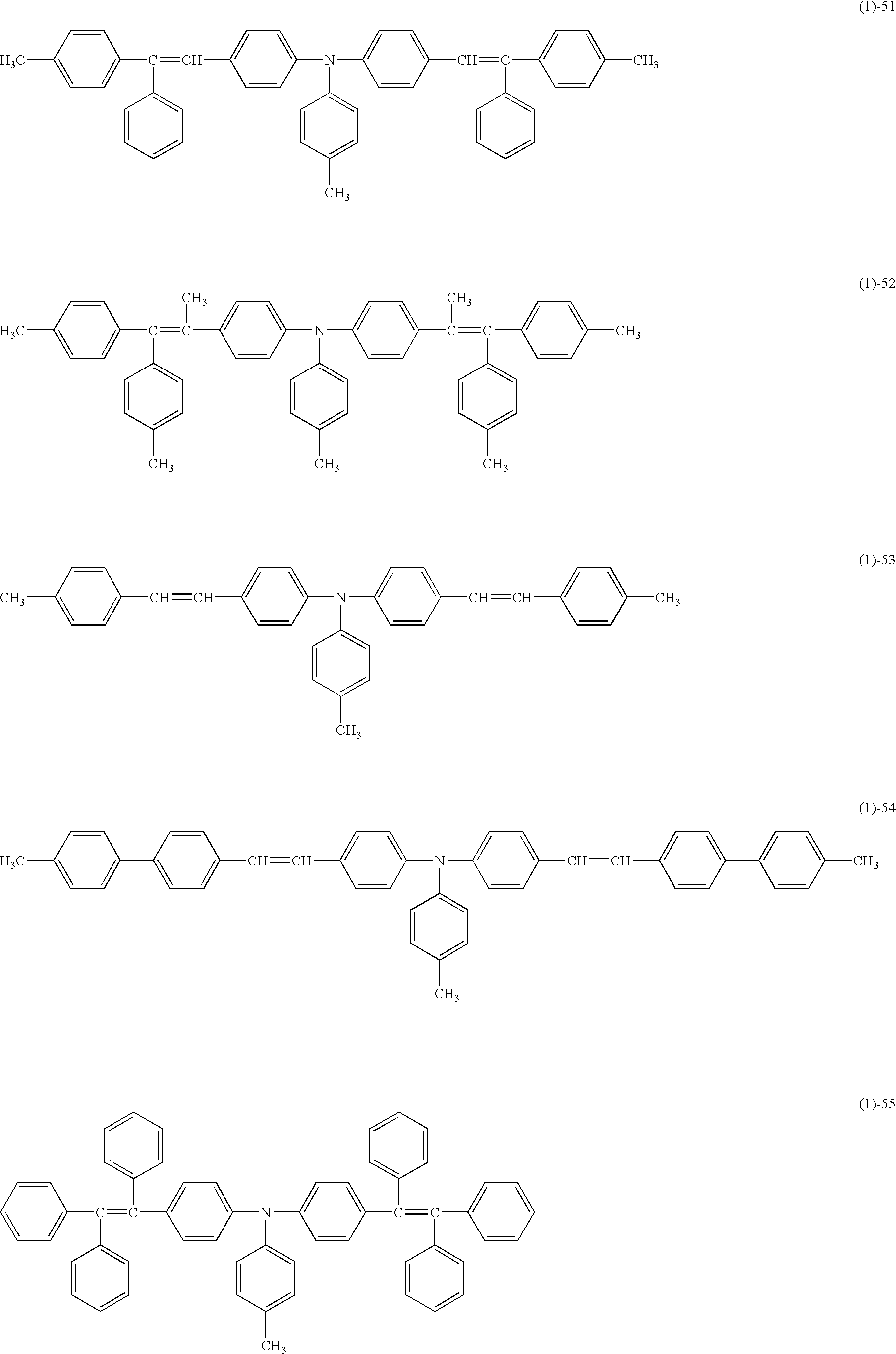

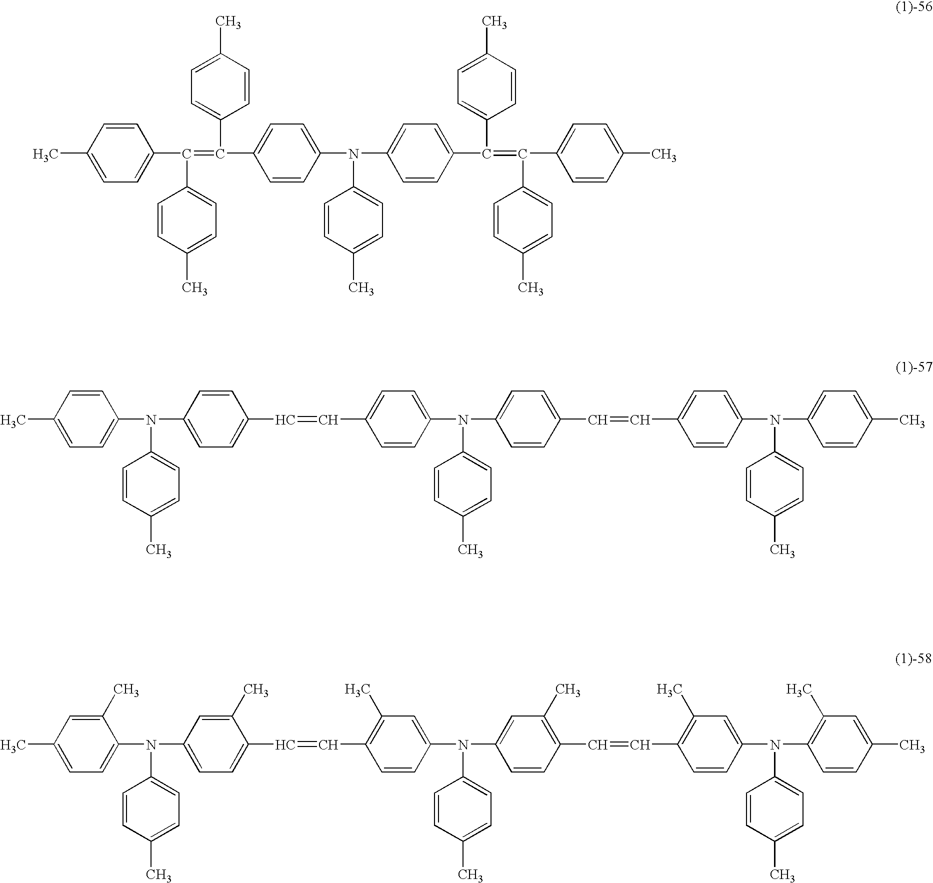

The photoreceptor for use in the image forming apparatus of the present invention preferably satisfies the following relationship (3):

IP_{CGM}−IP_{CTM}≧−0.1 (eV) (3)

wherein IP_{CGM} represents the ionization potential of the charge generation material included in the charge generation layer; and IP_{CTM} represents the ionization potential of the charge transport material included in the charge transport layer.

When the relationship (3) is satisfied, it becomes possible to reduce residual potential of the photoreceptor and to avoid increase of residual potential of the photoreceptor due to fatigue of the photoreceptor. This is because occurrence of hole trapping is prevented.

In this application, the ionization potential of a material is defined as an energy needed for taking one electron from an isolated atom of a material in the ground state. The ionization potential IP_{CGM} or IP_{CTM} can be determined by directly measuring the ionization potential of a material, but can be determined by measuring the ionization potential of a film of the charge generation layer or charge transport layer including the material. The method for determining the ionization potential of a material is as follows. In the atmosphere, ultraviolet light, which is obtained using a monochromator, irradiates the material while changing the energy of the light to determine the energy of the light at which photoelectrons start to be discharged therefrom due to photoelectric effect, resulting in determination of the ionization potential of the material. The surface analyzer, AC-1, AC-2 or AC-3 from Riken Keiki Co., Ltd., is used as the instrument for determining the ionization potential. In this case, the light intensity is controlled at 100 nW.

Specific examples of the binder resins for use in the charge transport layer include known thermoplastic resins and thermosetting resins, such as polystyrene, styrene-acrylonitrile copolymers, styrene-butadiene copolymers, styrene-maleic anhydride copolymers, polyester, polyvinyl chloride, vinyl chloride-vinyl acetate copolymers, polyvinyl acetate, polyvinylidene chloride, polyarylate, phenoxy resins, polycarbonate, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins, etc.

Not only selection of the charge transport material to be included in the charge transport layer but also selection of the binder resin to be included therein are important factors for shortening the transit time of the image bearing member of the image forming apparatus of the present invention. Even when a charge transport material having high mobility is used, the effect of the charge transport material is reduced depending on the property of the binder resin used for the charge transport layer. It is preferable to use a binder resin having a low dielectric constant for the charge transport layer. Among the resins having a low dielectric constant, polycarbonate, polyarylate, and polystyrene are preferably used as the binder resin of the charge transport layer because the transit time can be shortened.

Charge transport polymers, which have both a binder resin function and a charge transport function, can be preferably used for the charge transport layer because the resultant charge transport layer has good abrasion resistance and some of the polymers can shorten the transit time, resulting in prevention of occurrence of the first one-revolution charge problem mentioned above.

Suitable charge transport polymers include known charge transport polymer materials. Among these materials, polycarbonate resins having a triarylamine group in their main chain and/or side chain are preferably used. In particular, charge transport polymers having the following formulae of from (I) to (X) are preferably used.

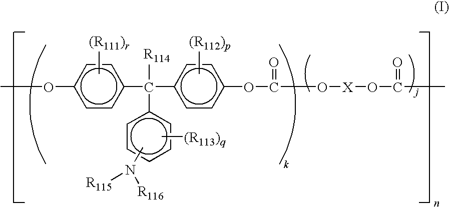

wherein R₁₁₁, R₁₁₂ and R₁₁₃ independently represent a substituted or unsubstituted alkyl group, or a halogen atom; R₁₁₄ represents a hydrogen atom, or a substituted or unsubstituted alkyl group; R₁₁₅, and R₁₁₆ independently represent a substituted or unsubstituted aryl group; r, p and q independently represent 0 or an integer of from 1 to 4; k is a number of from 0.1 to 1.0 and j is a number of from 0 to 0.9; n is an integer of from 5 to 5000; and X represents a divalent aliphatic group, a divalent alicyclic group or a divalent group having the following formula (I-a):

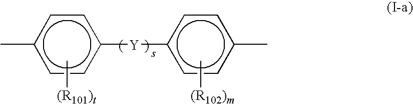

wherein R₁₀₁ and R₁₀₂ independently represent a substituted or unsubstituted alkyl group, a substituted or unsubstituted aryl group, or a halogen atom; t and m represent 0 or an integer of from 1 to 4; s is 0 or 1; and Y represents a linear alkylene group, a branched alkylene group, a cyclic alkylene group, —O—, —S—, —SO—, —SO₂—, —CO—, —CO—O-Z-O—CO— (Z represents a divalent aliphatic group), or a group having the following formula (I-b):

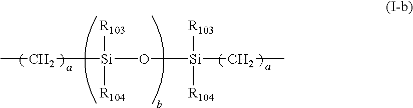

wherein a is an integer of from 1 to 20; b is an integer of from 1 to 2000; and R₁₀₃ and R₁₀₄ independently represent a substituted or unsubstituted alkyl group, or a substituted or unsubstituted aryl group, wherein R₁₀₁, R₁₀₂, R₁₀₃ and R₁₀₄ may be the same or different from the others.

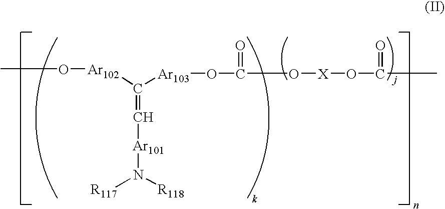

wherein R₁₁₇ and R₁₁₈ independently represent a substituted or unsubstituted aryl group; Ar₁₀₁, Ar₁₀₂ and Ar₁₀₃ independently represent an arylene group; and X, k, j and n are defined above in formula (I).

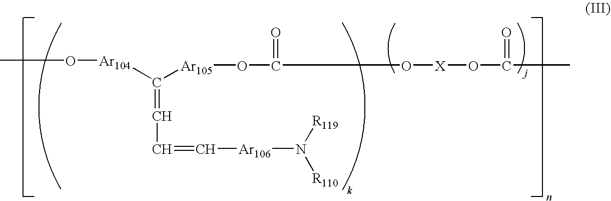

wherein R₁₁₉ and R₁₁₀ independently represent a substituted or unsubstituted aryl group; Ar₁₀₄, Ar₁₀₅ and Ar₁₀₆ independently represent an arylene group; and X, k, j and n are defined above in formula (I).

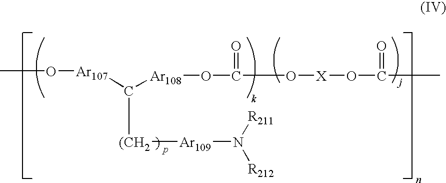

wherein R₂₁₁ and R₂₁₂ independently represent a substituted or unsubstituted aryl group; Ar₁₀₇, Ar₁₀₈ and Ar₁₀₉ independently represent an arylene group; p is an integer of from 1 to 5; and X, k, j and n are defined above in formula (I).

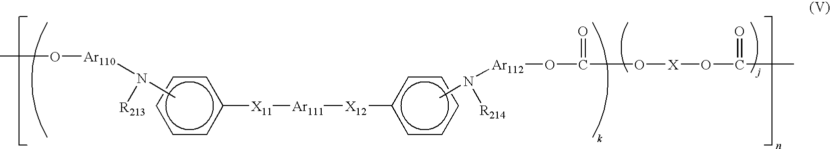

wherein R₂₁₃ and R₂₁₄ independently represent a substituted or unsubstituted aryl group; Ar₁₁₀, Ar₁₁₁ and Ar₁₁₂ independently represent an arylene group; X₁₁ and X₁₂ independently represent a substituted or unsubstituted ethylene group, or a substituted or unsubstituted vinylene group; and X, k, j and n are defined above in formula (I).

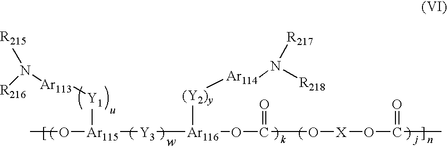

wherein R₂₁₅, R₂₁₆, R₂₁₇ and R₂₁₈ independently represent a substituted or unsubstituted aryl group; Ar₁₁₃, Ar₁₁₄, Ar₁₁₅ and Ar₁₁₆ independently represent an arylene group; Y₁, Y₂ and Y₃ independently represent a substituted or unsubstituted alkylene group, a substituted or unsubstituted cycloalkylene group, a substituted or unsubstituted alkyleneether group, an oxygen atom, a sulfur atom, or a vinylene group; u, v and w independently represent 0 or 1; and X, k, j and n are defined above in formula (I).

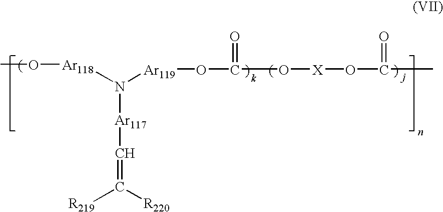

wherein R₂₁₉ and R₂₂₀ independently represent a hydrogen atom, or substituted or unsubstituted aryl group, and R₂₁₉ and R₂₂₀ optionally share bond connectivity to form a ring; Ar₁₁₇, Ar₁₁₈ and Ar₁₁₉ independently represent an arylene group; and X, k, j and n are defined above in formula (I).

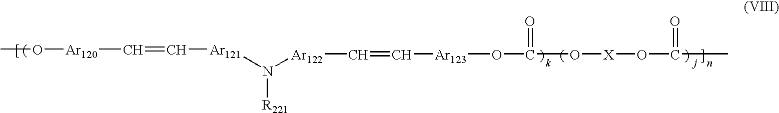

wherein R₂₂₁ represents a substituted or unsubstituted aryl group; Ar₁₂₀, Ar₁₂₁, Ar₁₂₂ and Ar₁₂₃ independently represent an arylene group; and X, k, j and n are defined above in formula (I).

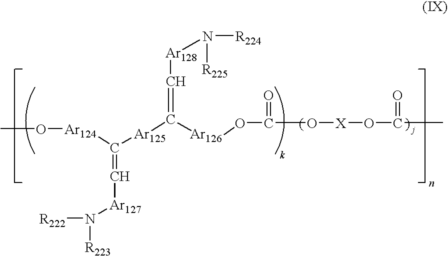

wherein R₂₂₂, R₂₂₃, R₂₂₄ and R₂₂₅ independently represent a substituted or unsubstituted aryl group; Ar₁₂₄, Ar₁₂₅, Ar₁₂₆, Ar₁₂₇ and Ar₁₂₈ independently represent an arylene group; and X, k, j and n are defined above in formula (I).

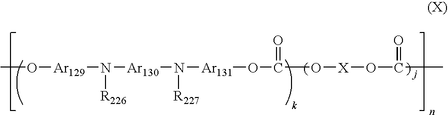

wherein R₂₂₆ and R₂₂₇ independently represent a substituted or unsubstituted aryl group; Ar₁₂₉, Ar₁₃₀ and Ar₁₃₁ independently represent an arylene group; and X, k, j and n are defined above in formula (I).

Formulae (1) to (10) are illustrated in the form of block copolymers, but the polymers are not limited thereto. The polymers may be random copolymers.

Specific examples of polycarbonates having a triarylamine structure in their main chain or side chains include compounds having the following formulae of from (PC-1) to (PC-34).

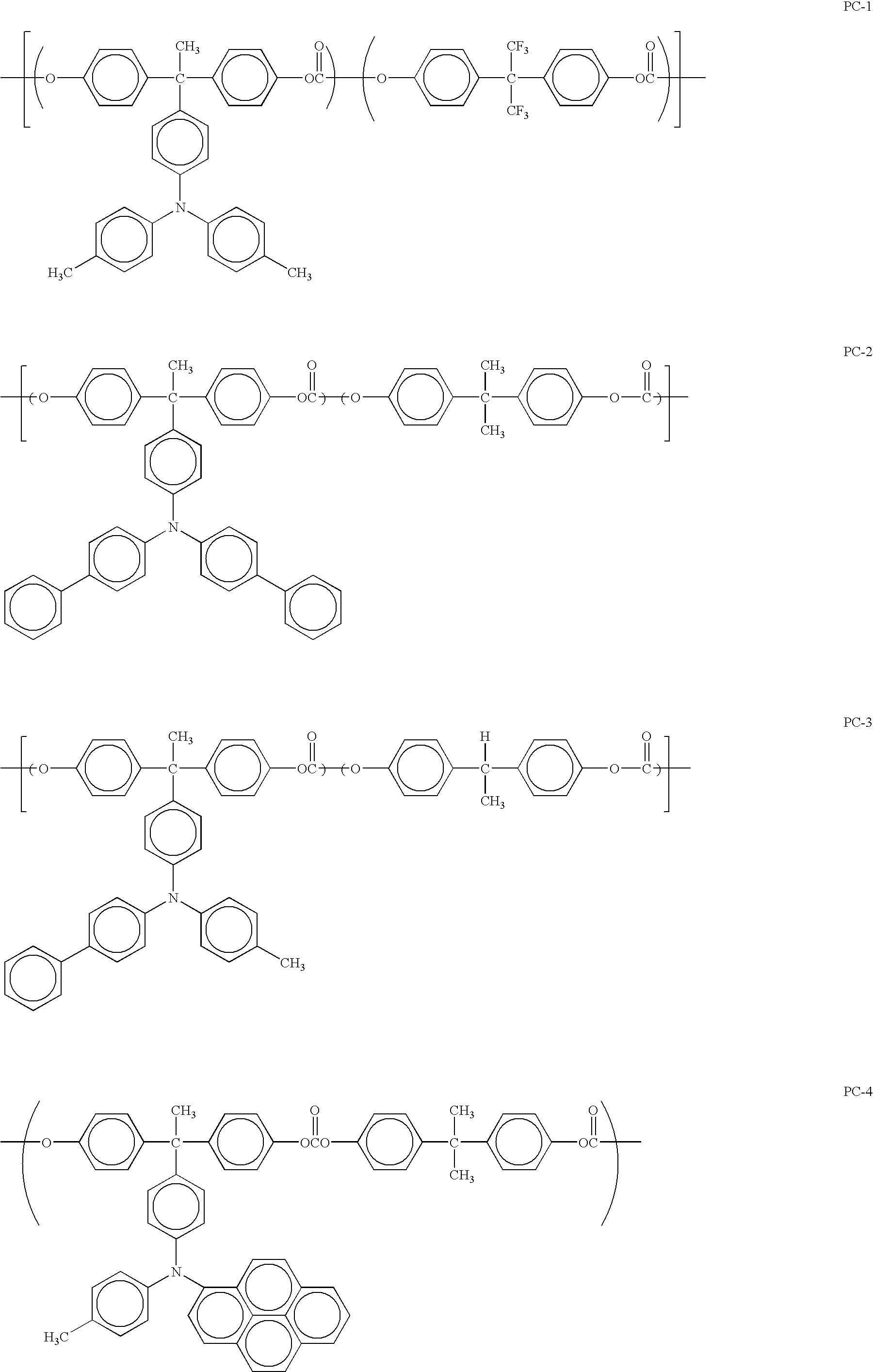

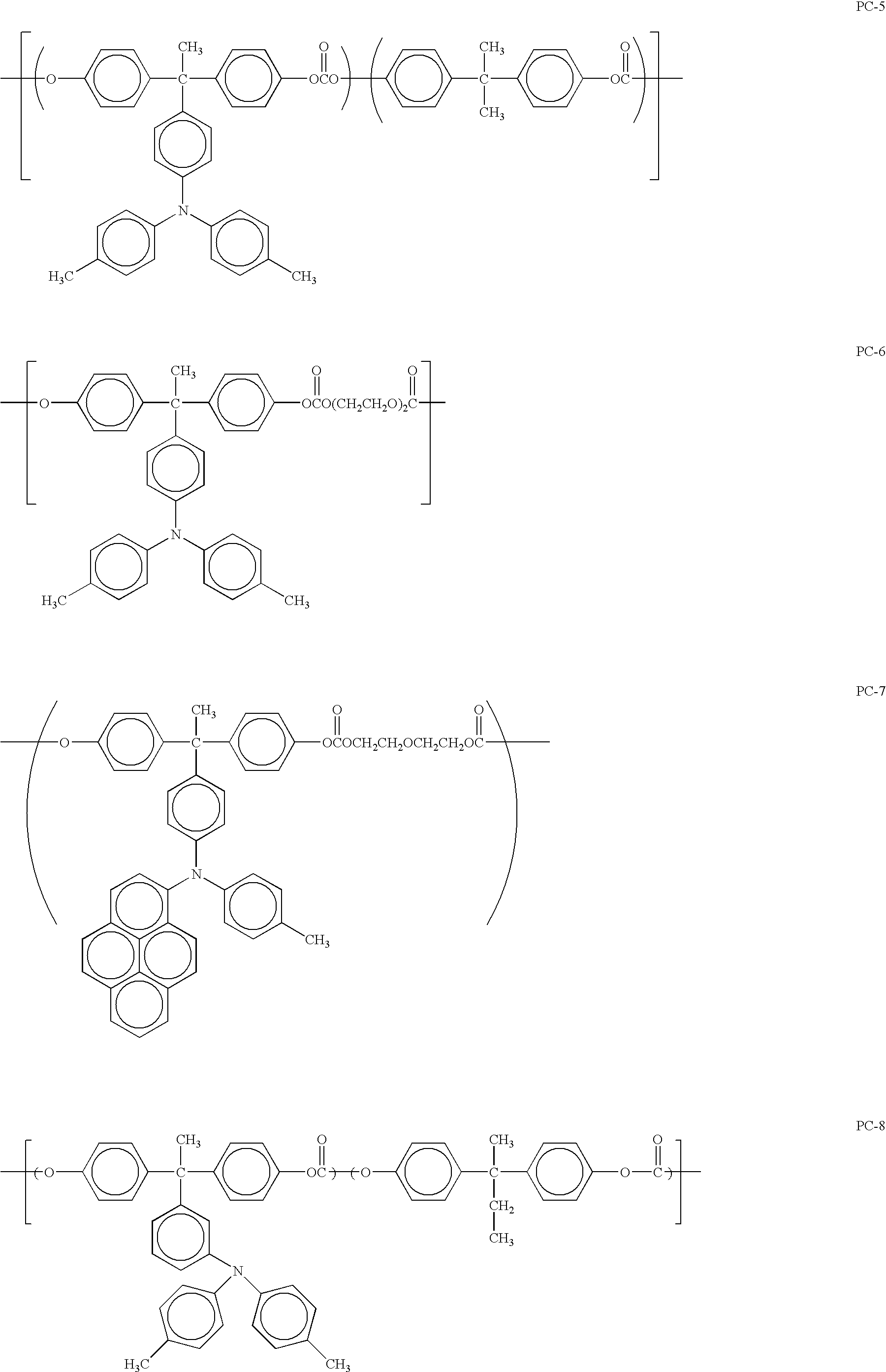

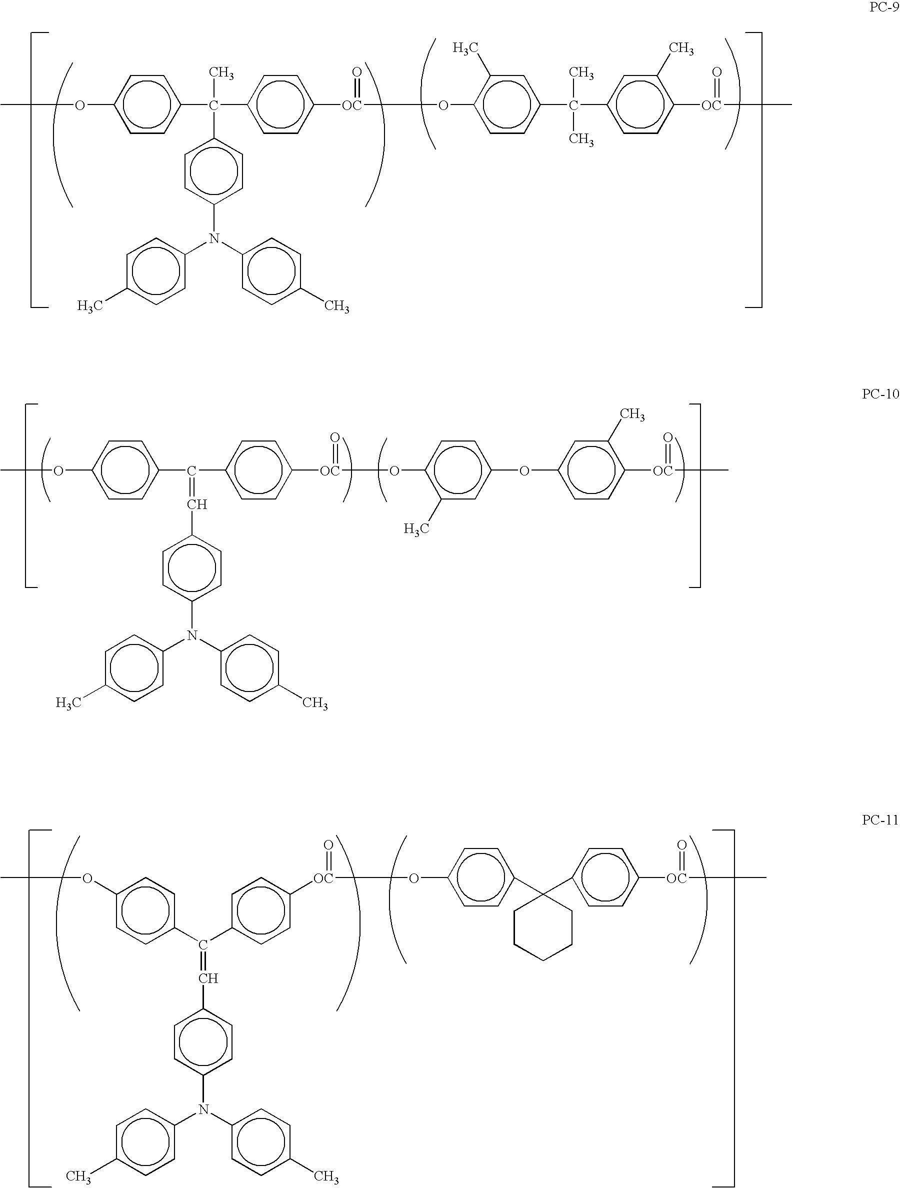

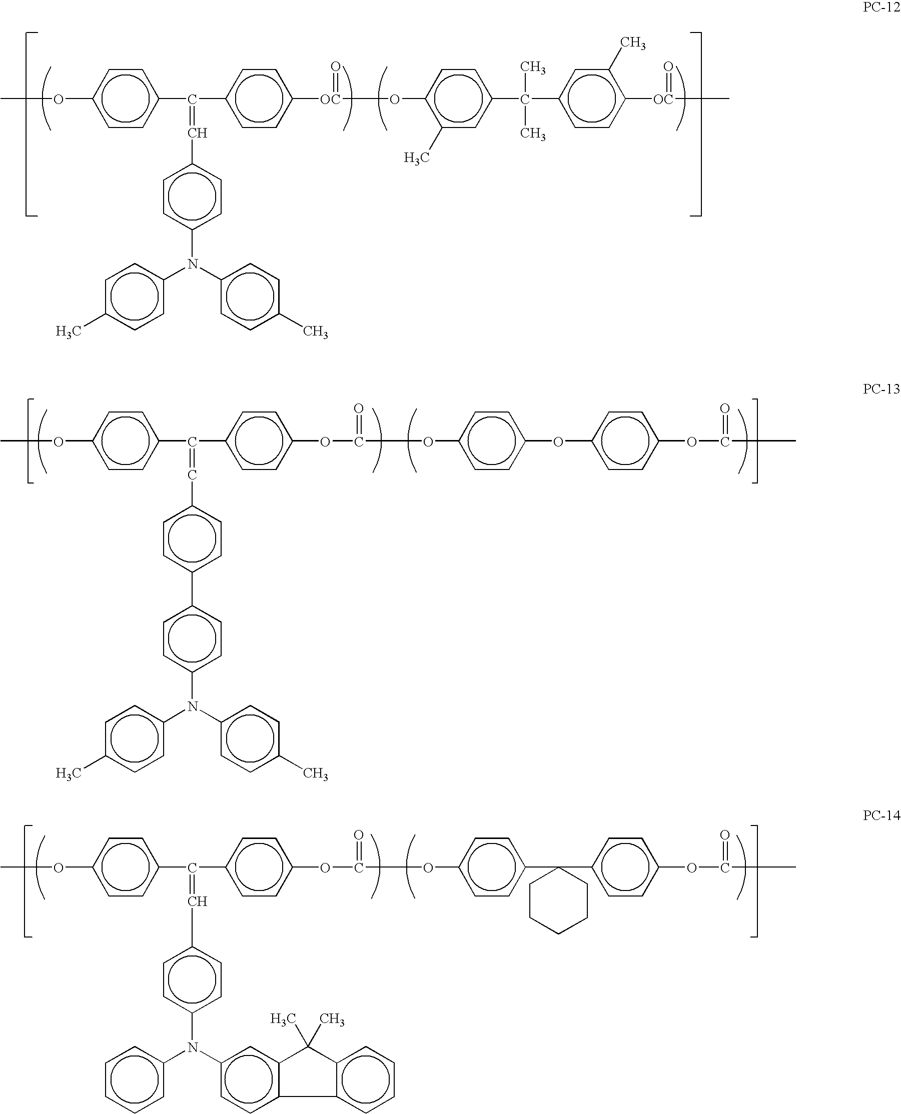

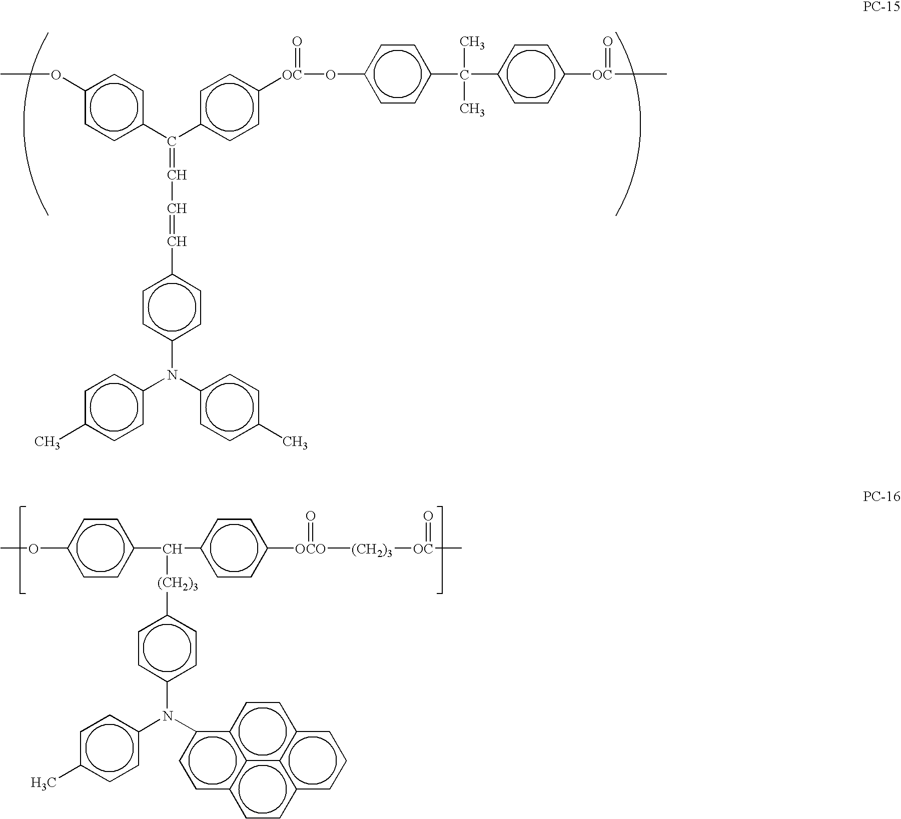

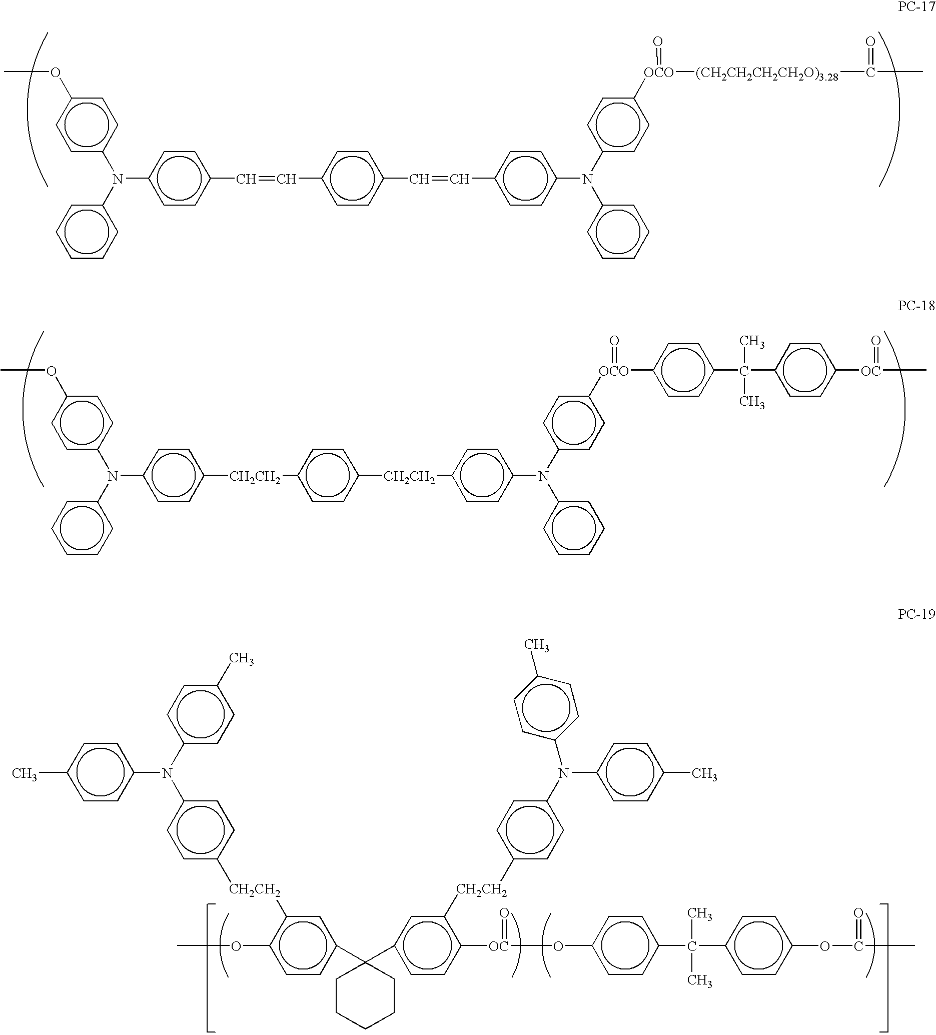

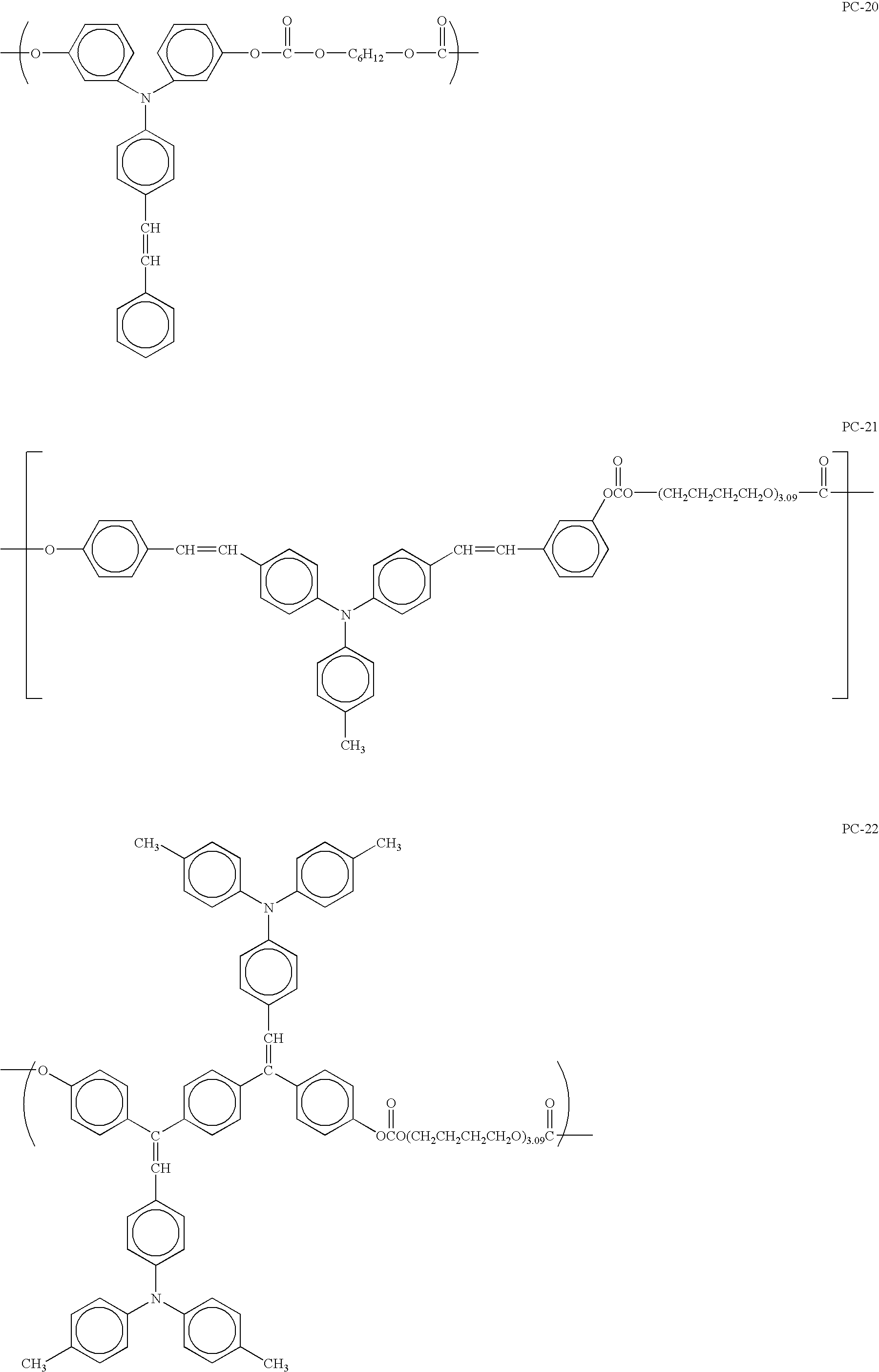

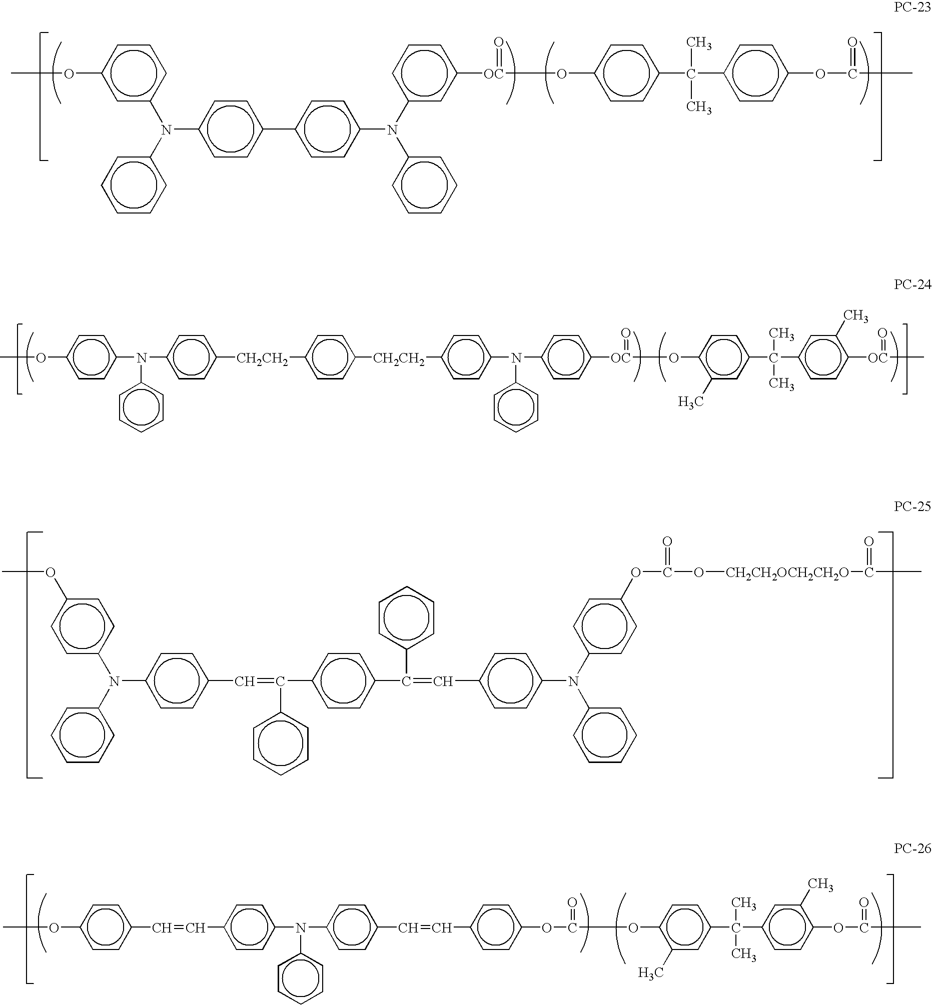

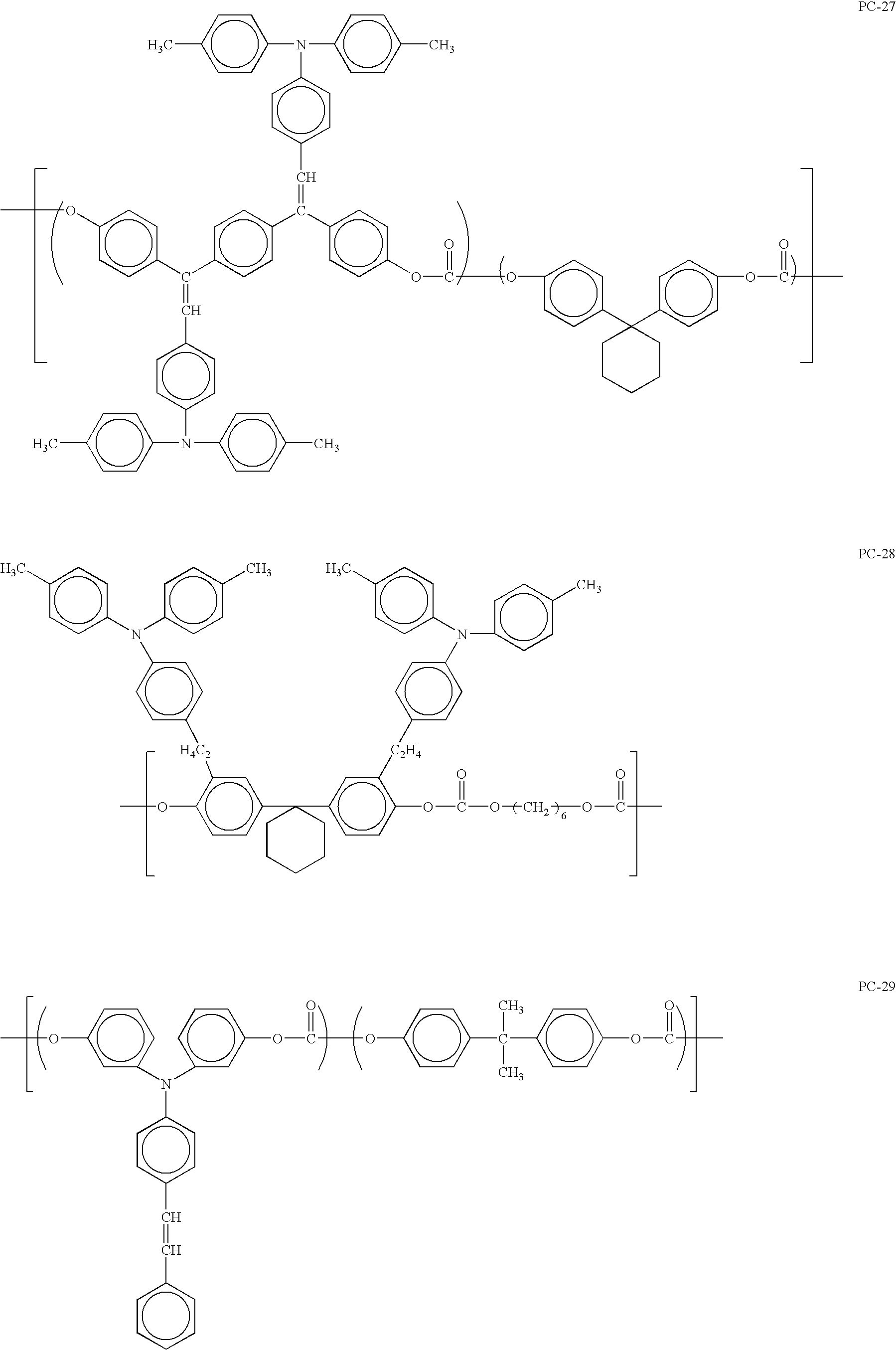

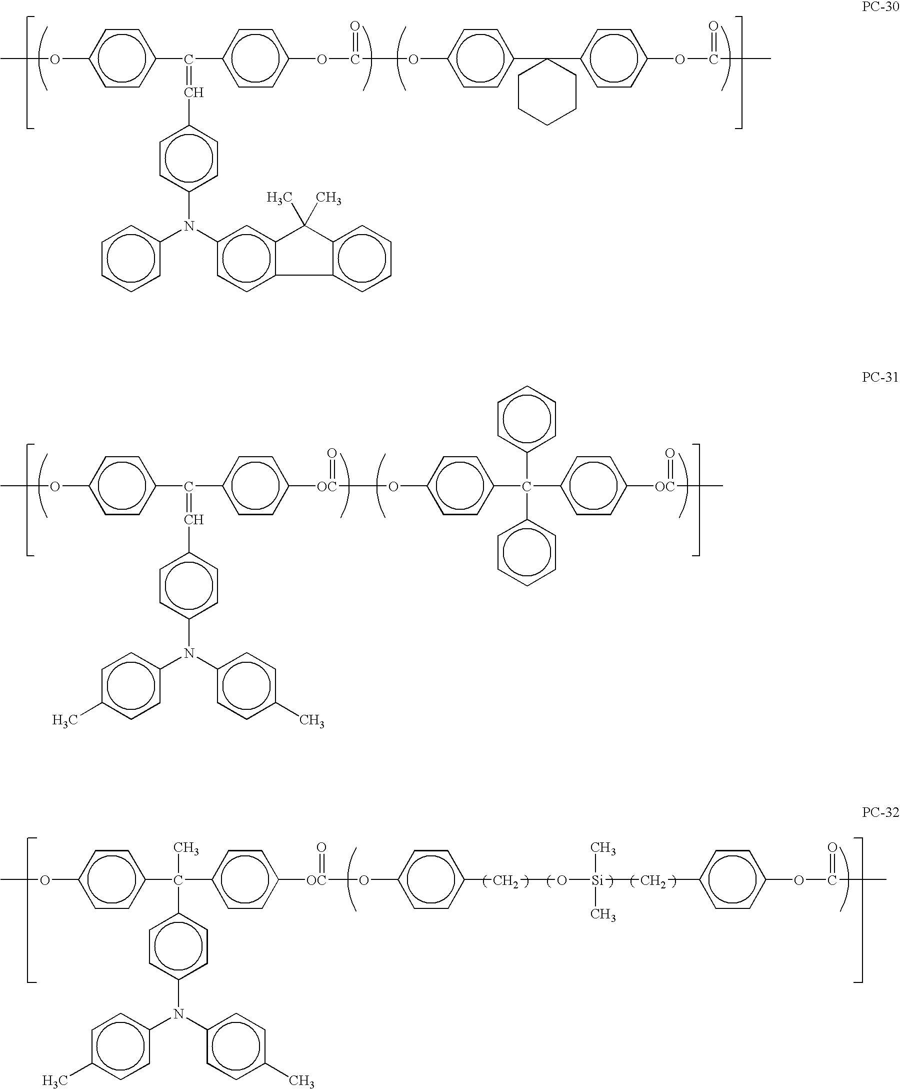

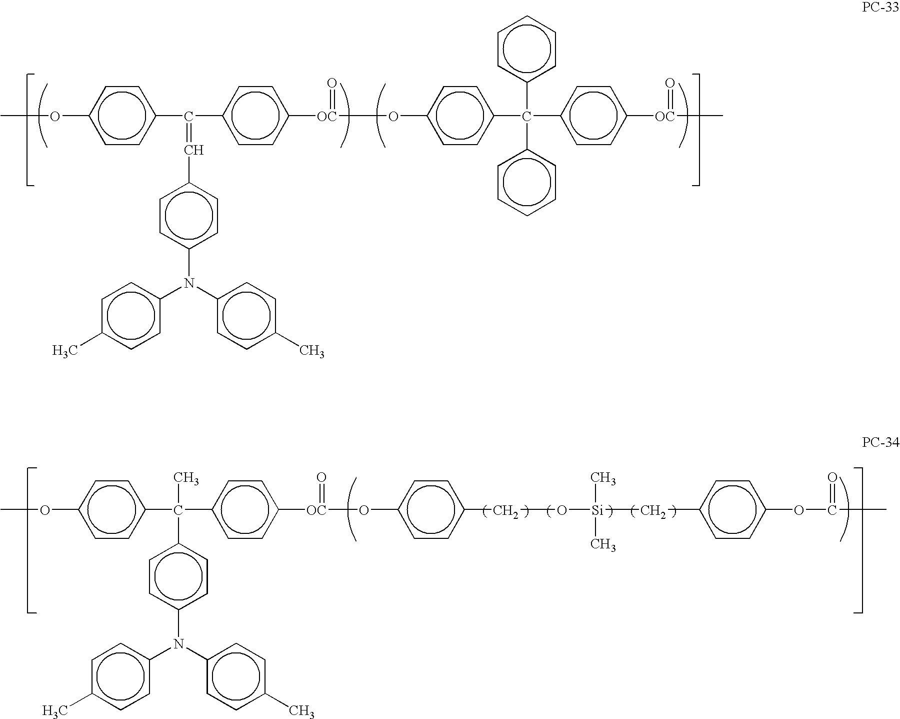

These charge transport polymers having a triarylamine structure in their main chains and/or side chains have a form of homopolymer, random copolymer, alternating copolymer, or block copolymer. Since these charge transport polymers are used as binder resins, the polymers preferably have a film forming ability. Specifically, the polymers preferably have a weight average molecular weight of from 10,000 to 500,000, and more preferably from 50,000 to 400,000.

These charge transport polymers are disclosed in JP-As 08-269183, 09-71642, 09-104746, 09-272735, 11-29634, 09-235367, 09-87376, 09-110976, 09-268226, 09-221544, 09-227669, 09-157378, 09-302084, 09-302085 and 2000-26590.

By using one or more of the above-mentioned charge transport polymers as the binder resin of the photosensitive layer of the photoreceptor while adding one or more charge transport material thereto, the transit time can be dramatically reduced and thereby occurrence of the first one-revolution charge problem can be prevented. However, when the ionization potential difference (IP_{CTM}−IP_{CGM}) between the ionization potential (IP_{CTP}) of the charge transport polymer used to the ionization potential (IP_{CGM}) of the charge generation material used is greater than 0.1 eV, the above-mentioned effects tend to be lessened and the residual potential tends to increase. Therefore, the ionization potential difference (IP_{CTM}−IP_{CGM}) is preferably not greater than 0.1 eV, and more preferably not greater than 0.05 eV. In this case, occurrence of the first one-revolution charge problem can be prevented, and the image forming apparatus can be miniaturized and can produce high quality images at a high speed (due to prevention of increase of residual potential).

The amount of one or more charge transport materials to be included in the photosensitive layer of the photoreceptor is from 20 to 300 parts by weight, and preferably from 40 to 150 parts by weight, per 100 parts by weight of one or more binder resins included in the photosensitive layer. Depending on the combination of two or more charge transport materials and/or two or more binder resins, occurrence of the first one-revolution charge problem can be prevented more effectively.

Suitable solvents for use in the charge transport layer coating liquid include tetrahydrofuran, dioxane, dioxolan, toluene, cyclohexanone, methyl ethyl ketone, xylene, acetone, diethyl ether, etc. These solvents can be used alone or in combination. In view of environmental protection, it is preferable not to use halogenated solvents such as dichloromethane, dichloroethane, and monochlorobenzene. Among these solvents, cyclic ethers such as tetrahydrofuran and dioxane, and aromatic hydrocarbons such as toluene and xylene are preferably used.

The charge transport layer coating liquid can optionally include additives such as plasticizers, leveling agents, antioxidants, and lubricants.

In general, a charge transport layer prepared by using a charge transport material, which has a large molecular structure and which is useful for shortening the transit time, tends to cause a peeling problem in that the layer is peeled from the lower layer of the photoreceptor or a cracking problem in that cracks are formed in the layer. Particularly, since charge transport materials having formula (1), (2) or (3) tend to have a high melting point, and a high crystallinity due to their large molecular structure including extended π electron conjugated system as well as low solubility, cracks are easily formed in the resultant charge transport layer when sebum is adhered to the charge transport layer, or stress is applied thereto. In this regard, when a plasticizer is added to the charge transport layer (coating liquid), occurrence of the peeling problem and cracking problem can be prevented while producing the effects of the present invention. Suitable plasticizers include dibutyl phthalate and dioctyl phthalate. The content of a plasticizer in the charge transport layer is from 0 to 30% by weight, and preferably from 1 to 10% by weight, based on the total weight of the binder resin included therein.

Compounds having an alkylamino group and the following formula (4) or (5) having can be preferably used for preventing occurrence of the cracking problem.

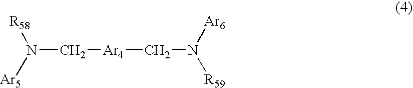

wherein Ar₄ represents a substituted or unsubstituted arylene group; Ar₅ and Ar₆ independently represent a substituted or unsubstituted aryl group, a substituted or unsubstituted alkyl group, or a substituted or unsubstituted aralkyl group; R₅₈ and R₅₉ independently represent a substituted or unsubstituted alkyl group, or a substituted or unsubstituted aralkyl group, wherein Ar₅ and R₅₈ optionally share bond connectivity to form a ring having a nitrogen atom, and Ar₆ and R₅₉ optionally share bond connectivity to form a ring having a nitrogen atom.

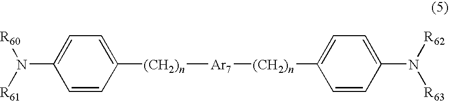

wherein Ar₇ represents a substituted or unsubstituted arylene group; R₆₀ to R₆₃ independently represent a substituted or unsubstituted alkyl group, or a substituted or unsubstituted aralkyl group; and n is 1 or 2.

In addition, compounds having formula (4) or (5) can prevent a blurred image problem in that blurred images are formed under environmental conditions such that oxidizing gasses are included at a high concentration. Since charge transport materials having formula (1), (2) or (3) tend to have poor resistance to oxidizing gasses because of having a distyryl structure. By using a combination of a charge transport material having formula (1), (2) or (3) with a compound having formula (4) or (5), occurrence of the blurred image problem can be prevented. Further, since compounds having formula (4) or (5) can prevent occurrence of decrease in potential of the charge photoreceptor due to electrostatic fatigue of the photoreceptor, the compounds are preferably used for stably producing high quality images. Furthermore, since compounds having formula (4) or (5) have a charge transport structure therein, residual potential of the photoreceptor is hardly increased and therefore the compounds can be added in a relatively large amount.

Specific examples of the compounds having formula (4) or (5) include compounds having the following formulae, but are not limited thereto.

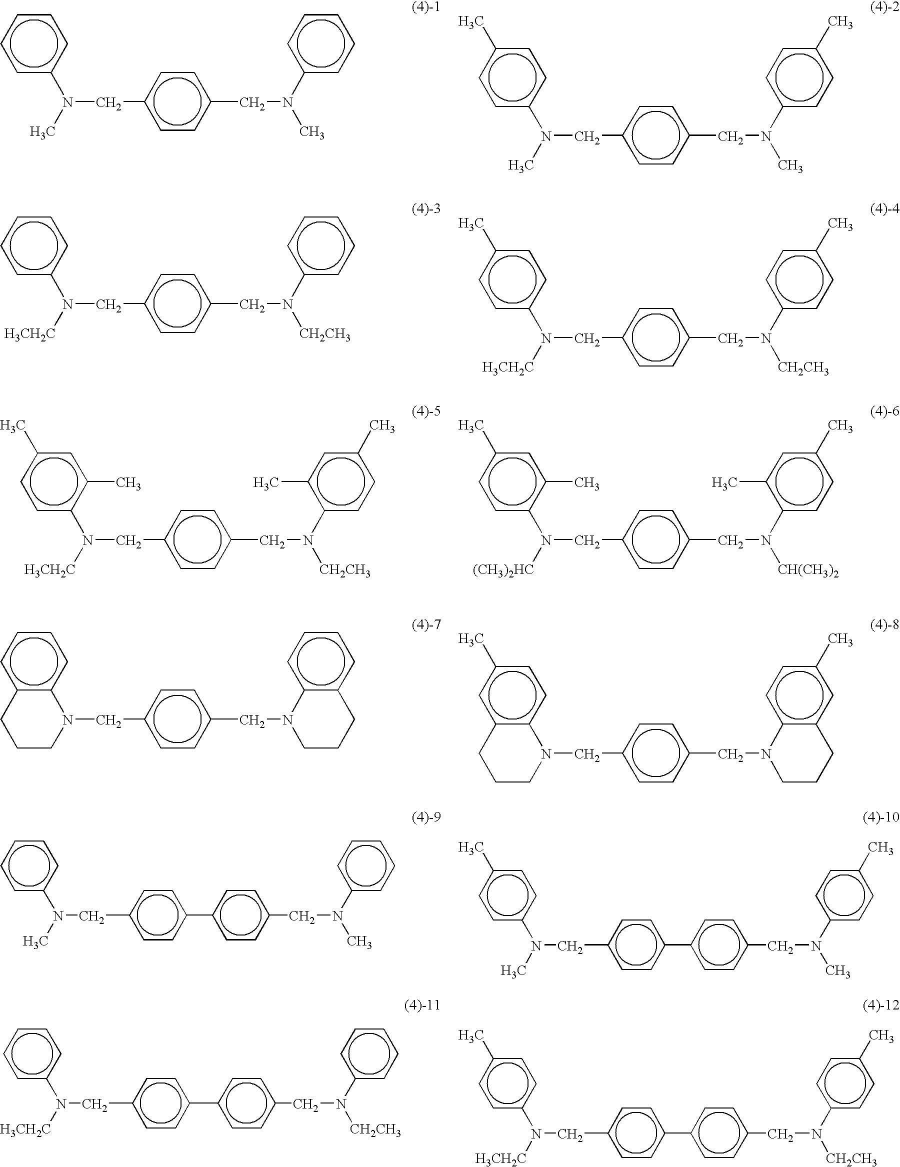

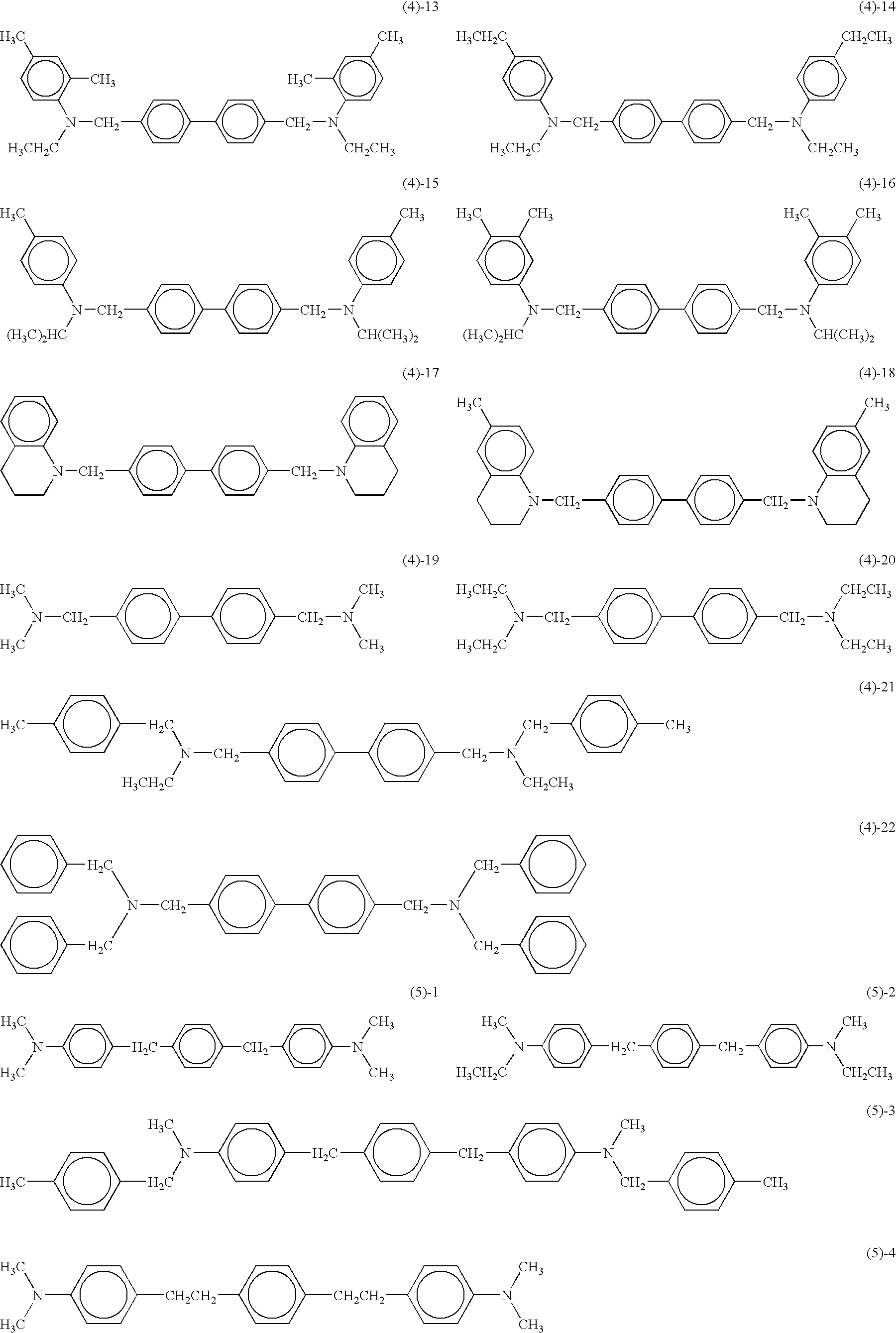

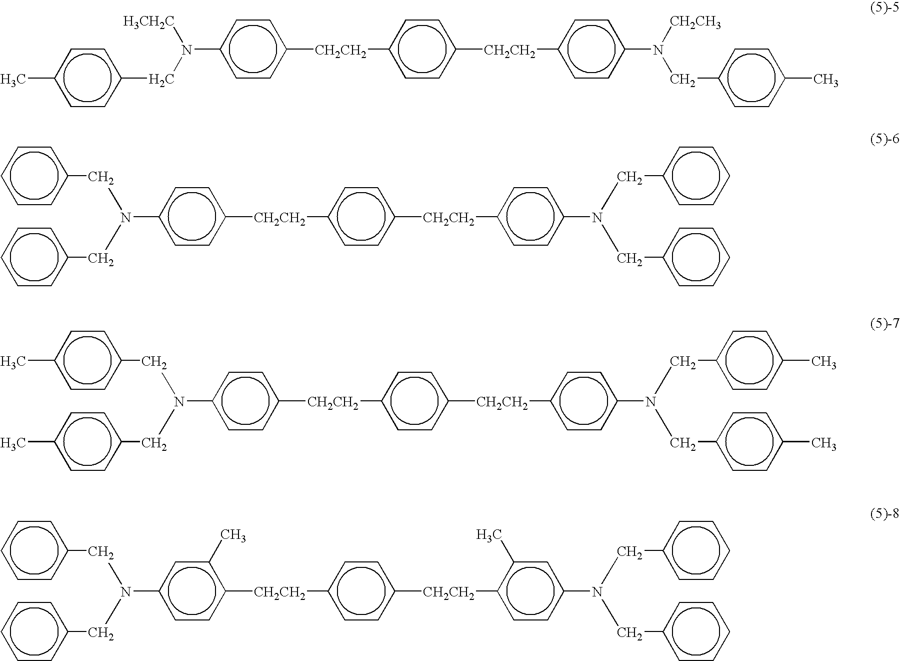

The added amount of a compound having formula (4) or (5) is generally from 0 to 30% by weight, and preferably from 1.0 to 15% by weight, based on the total weight of the charge transport material included in the photosensitive layer. When the added amount is too large, residual potential of the resultant photoreceptor tends to increase. In contrast, when the added amount is too small, the blurred image problem occurs in an atmosphere including oxidizing gasses at a high concentration and/or the cracking problem occurs when sebum is adhered to the layer.

The photosensitive layer of the photoreceptor can include an antioxidant such as phenolic compounds, paraphenylenediamine compounds, hydroquinone compounds, sulfur-containing organic compounds, phosphorous-containing organic materials, and hindered amine compounds. When an antioxidant is used, the resultant photoreceptor stably maintains good electrostatic properties. Among these antioxidants, antioxidants having the following formula (6), (7), (8) or (9) can produce good effects.

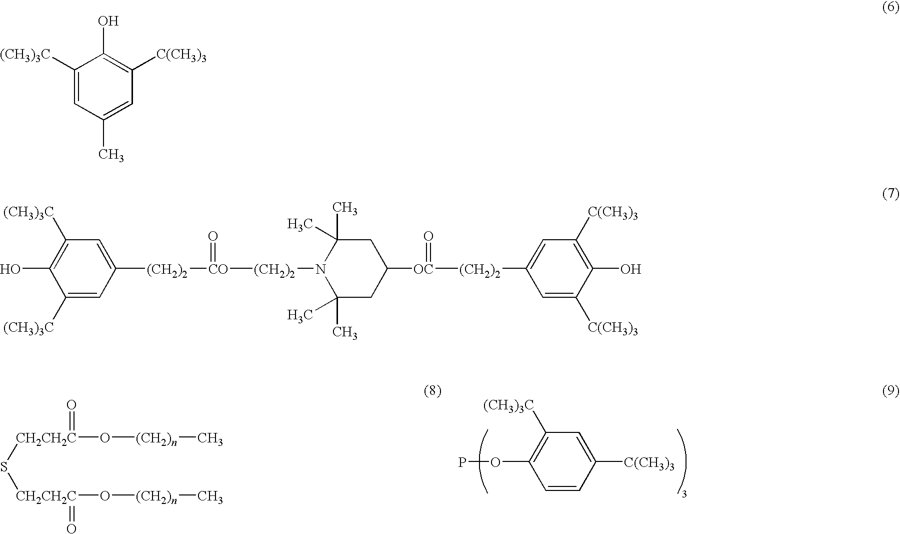

As mentioned above, charge transport materials having formula (1), (2) or (3) tend to have poor stability in an atmosphere including oxidizing gases at a high concentration. By adding an antioxidant to the charge transport layer, occurrence of the problem in that the potential of the charged photoreceptor decreases in an atmosphere including oxidizing gases at a high concentration can be prevented, resulting in prevention of the blurred image problem. Therefore, high quality images can be produced. When two or more antioxidants are used, better effects can be produced depending on the combination thereof.

In addition, when these antioxidants are used in combination of compounds having formula (4) or (5), better effects can be produced depending on the combination thereof. Therefore, such a technique is preferably used in the present invention. This is because the compounds have different structures, and therefore the compounds can produce different effects. Specifically, there are compounds having good resistance to ozone generated by charging devices, or NOx gasses; compounds capable of preventing a problem in that potential of the charged photoreceptor decreases due to release of charges stored in the photosensitive layer caused by electrostatic fatigue of the photoreceptor; compounds capable of preventing formation of blurred images; compounds capable of preventing deterioration of resolution of images; compounds capable of preventing formation of ghost images; etc. Therefore, by using two or more of these compounds, various kinds of effects can be produced. As a result, high quality images can be stably produced even when the environmental conditions vary.

The content of an antioxidant in the charge transport layer is from 0 to 20% by weight, and preferably from 0.1 to 10% by weight, based on the total weight of the charge transport material included in the layer. When the content is too high, residual potential of the photoreceptor seriously increases. When the content is too low, the effects mentioned above cannot be well produced.

The photosensitive layer coating liquid or charge transport layer coating liquid can include a leveling agent such as silicone oils (e.g., dimethylsilicone oils and methylphenylsilicone oils), and polymers and oligomers having a perfluoroalkyl group in a side chain thereof, to prevent formation of coating defects and to prepare a layer having smooth surface. The content of a leveling agent in the charge transport layer (or photosensitive layer) is from 0 to 1% by weight, and preferably from 0.01 to 0.5% by weight, based on the total weight of the binder resin included in the layer.

In addition, the charge transport layer coating liquid (or photosensitive layer coating liquid) can include a lubricant to improve the slipping property of the layer, thereby preventing adhesion of foreign materials on the surface of the layer. Specific examples of the lubricant include known lubricants such as silicone oils, particulate silicones, particulate fluorine-containing resins, and waxes. The content of a lubricant in the charge transport layer (or photosensitive layer) is from 0 to 30% by weight, and preferably from 1 to 20% by weight, based on the weight of the binder resin included in the layer.

The charge transport layer can be prepared by coating a charge transport layer coating liquid using a known coating method such as dip coating, spray coating, bead coating, nozzle coating, spinner coating, and ring coating, followed by first drying to dry the coated layer such that the dried layer is not adhered to fingers and second drying using an oven. The drying temperature is generally from 80 to 150° C., and preferably from 100 to 140° C., although the drying temperature is determined depending on the solvent used for the charge transport layer coating liquid. The thickness of the charge transport layer is generally from 10 to 50 μm. In the photoreceptor (image bearing member) for use in the present invention, the thickness of the charge transport layer greatly influences the transit time of the image bearing member. In order to securely prevent occurrence of the first one-revolution charge problem, the charge transport layer is preferably as thinner as possible. In this case, the electric field strength is increased. From this point of view, the thickness of the charge transport layer is preferably from 15 to 40 μm, and more preferably from 20 to 35 μm. Since the photoreceptor for use in the present invention has a protective layer overlying the charge transport layer, the durability of the photoreceptor hardly deteriorates even when the charge transport layer is relatively thin.

### <Single-Layered Photosensitive Layer>

The photoreceptor for use as the image bearing member of the image forming apparatus of the present invention may have a single-layered photosensitive layer instead of the multi-layered photosensitive layer mentioned above. The single-layered photosensitive layer can be prepared by coating a coating liquid, which is prepared by dissolving or dispersing components such as charge generation materials, charge transport materials and binder resins in a solvent, on an electroconductive substrate with an optional undercoat layer therebetween, and then drying the coated liquid. The charge generation materials and charge transport materials (electron transport materials and positive hole transport materials) mentioned above for use in the charge generation layer and charge transport layer can be used for the single-layered photosensitive layer. The resins for use in the charge transport layer can be used for the single-layered photosensitive layer optionally together with the resins for use in the charge generation layer. The content of the charge generation material in the photosensitive layer is from 5 to 40 parts by weight, and preferably from 10 to 30 parts by weight, per 100 parts by weight of the binder resin included in the photosensitive layer. The content of the charge transport material in the photosensitive layer is from 0 to 190 parts by weight, and preferably from 50 to 150 parts by weight, per 100 parts by weight of the binder resin included in the photosensitive layer.

The single-layered photosensitive layer is typically prepared by coating a coating liquid which is prepared by dissolving or dispersing at least a charge generation material, a charge transport material and a binder resin in a solvent such as tetrahydrofuran, dioxane, dichloroethane, cyclohexanone, toluene, methyl ethyl ketone, and acetone, using a coating method such as dip coating, spray coating, bead coating, and ring coating. If desired, additives such as plasticizers, leveling agents, antioxidants, and lubricants can be included in the coating liquid. The thickness of the single-layered photosensitive layer is typically from 5 to 25 μm. The single-layered photosensitive layer has an advantage such that the charge transport distance (i.e., the distance from charge generation points to the surface of the photosensitive layer) is relatively short compared to the case of the layered photosensitive layer mentioned above, but has a drawback such that since the charge generation material is dispersed in the entire photosensitive layer, the variation of charge transport distances is relatively large compared to the case of the layered photosensitive layer mentioned above. Therefore, the effect of the single-layered photosensitive layer for preventing the first one-revolution charge problem is not necessarily good. Therefore, a photoreceptor having a layered photosensitive layer (e.g., combination of a charge generation layer and a charge transport layer) is preferably used for-the image forming apparatus of the present invention because the photoreceptor is effective for preventing occurrence of the first one-revolution charge problem.

### <Protective Layer>

The photoreceptor (i.e., image bearing member) for use in the image forming apparatus of the present invention can include a protective layer, which serves as an outermost layer and which is located overlying the photosensitive layer or the charge transport layer. The main reason for forming a protective layer is to reduce abrasion loss of the photosensitive layer (or charge transport layer) of the photoreceptor caused by repeated use of the photoreceptor. When the photosensitive layer is abraded, the electrostatic properties of the photoreceptor deteriorate, and in addition the strength of the electric field for the photoreceptor increases, thereby causing defected images such as images with background fouling. In this case, the life of the photoreceptor expires depending on the abrasion loss of the photosensitive layer. By forming a protective layer on the surface of the photoreceptor, abrasion loss of the photoreceptor can be reduced, thereby prolonging the life of the photoreceptor.

When a protective layer is formed, and thereby the abrasion resistance of the photoreceptor is improved (i.e., the thickness of the photosensitive layer of the photoreceptor is hardly changed even after long repeated use), occurrence of the first one-revolution charge problem can be prevented and good electrostatic properties can be stably maintained over a long period of time, thereby stably producing high quality images. Therefore, the photoreceptor (image bearing member) and the image forming apparatus using the photoreceptor can have a long life.

However, a protective layer, which has a good abrasion resistance but which has drawbacks such that residual potential of the photoreceptor increases, and charges tend to diffuse in the lateral direction near the surface of the protective layer, resulting in formation of blurred images, is not preferable for the photoreceptor because the photoreceptor has poor durability. In other words, in order to impart good durability to the photoreceptor, the protective layer preferably has the following properties:
(1) hardly increasing the residual potential of the photoreceptor;
(2) hardly deteriorating the photosensitivity of the photoreceptor;
(3) hardly deteriorating the resolution of images; and
(4) having good abrasion resistance.

Known protective layers such as filler-dispersed protective layers and crosslinked protective layers including a crosslinked resin can be used as the protective layer of the photoreceptor. In addition, it is effective to use a charge transport polymer for the protective layer.

Several examples of the protective layer will be explained. At first, an example of the filler-dispersed protective layer will be explained. When a filler-dispersed protective layer is formed, the abrasion resistance of the photoreceptor can be improved by the filler included in the protective layer. The filler-dispersed protective layer typically includes a filler, and a binder resin, and optionally includes a charge transport material. Organic fillers and inorganic fillers can be used as the filler. Specific examples of the organic fillers include powders of fluorine-containing resins such as polytetrafluoroethylene, powders of silicone resins, powders of amorphous carbons, etc. Specific examples of the inorganic fillers include powders of metals such as copper, tin, aluminum, and indium; powders of metal oxides such as silica, tin oxide, zinc oxide, titanium oxide, alumina, zirconia, indium oxide, antimony oxide, bismuth oxide, calcium oxide, tin oxide doped with antimony, and indium oxide doped with tin; powders of metal fluorides such as tin fluoride, calcium fluoride, and aluminum fluoride; and powders of other inorganic materials such as potassium titanate, and boron nitride.

Among these fillers, inorganic fillers are preferably used because of having a good combination of hardness and light scattering property. Particularly, metal oxides are more preferably used because of having good abrasion resistance and producing high quality images. In addition, since a protective layer coating liquid including a metal oxide has good coating properties, the resultant protective layer has good film properties. Thereby, the abrasion resistance of the photoreceptor is improved, and the resultant photoreceptor can have a long life while producing high quality images.

In order to prevent formation of blurred images, the filler included in the protective layer preferably has high electric insulating property. When an electroconductive filler is included in the surface portion of the protective layer, charges formed on the surface of the protective layer (i.e., photoreceptor) flow in the lateral direction due to reduction of electric resistance of the surface of the protective layer, resulting in formation of blurred images. Therefore, the filler included in the protective layer preferably has a resistivity of not lower than 10¹⁰ Ω·cm in order to prevent deterioration of resolution of produced images. Specific examples of such preferable fillers include alumina, zirconia, titanium oxide and silica. Among these fillers, α-alumina, which has a hexagonal closed-pack structure, is preferable because of having a good combination of abrasion resistance, high resistivity (resulting in prevention of formation of blurred images), coating properties, and light transmission property.

Since tin oxide, indium oxide, antimony oxide, tin oxide doped with antimony, and indium oxide doped with tin tend to have a relatively low resistivity, the materials are not preferable for the protective layer of the photoreceptor for use in the image forming apparatus of the present invention because blurred images tend to be produced. However, since the resistivities of these materials change depending on the structure or other properties, whether or not to use a filler for the protective layer is preferably determined depending on the resistivity of the filler.

In addition, it is effective to use plural kinds of fillers for the protective layer, for example, in order to control the resistance of the protective layer.

The resistivity of a filler is determined using a powder-use resistivity measuring instrument. Specifically, a sample (filler) is contained in a cell while sandwiched by two opposed electrodes. A predetermined load is applied to the electrodes to compress the filler. In this regard, the amount of the sample is controlled so that the compressed filler has a thickness of about 2 mm. Next, a voltage is applied to the electrodes, and the current flowing the electrodes (sample) is measured. The resistivity is calculated from the current and the area of the surface of the sample contacted with the electrode and thickness of the sample.

In addition, the filler included in the protective layer can be subjected to a surface treatment to improve the dispersibility in a protective layer coating liquid. When a filler is not well dispersed in a coating liquid, the resultant protective layer tends to have low transparency and coating defects, and thereby the abrasion resistance of the protective layer is deteriorated or the resultant protective layer is unevenly abraded after long repeated use, resulting in formation of defected images. Therefore, the photoreceptor cannot have a long life and high quality images cannot be produced.

The average primary particle diameter of the filler included in the protective layer is preferably from 0.01 to 0.9 μm, and more preferably from 0.1 to 0.5 μm, in view of light transmission property and abrasion resistance of the protective layer. When the average primary particle diameter of the filler is too small, particles of the filler tend to aggregate, resulting in deterioration of the abrasion resistance. In contrast, when the average primary particle diameter is too large, the filler tends to precipitate in the coating liquid, resulting in formation uneven protective layer. In addition, such a large filler tends to deteriorate image qualities and form defected images.

The content of a filler in the protective layer is preferably from 0.1 to 50% by weight, and more preferably from 5 to 30% by weight, based on the total weight of the solid components included in the protective layer. When the content is too low, the abrasion resistance of the protective layer is hardly improved. In contrast, when the filler content is too high, problems such that residual potential of the resultant photoreceptor increases, blurred images are formed, and image qualities (e.g., resolution) deteriorate tend to occur. In addition, problems which occur are that interaction between particles of the filler increases, resulting in deterioration of dispersibility of the filler and/or the filler is easily released from the protective layer, resulting in deterioration of the abrasion resistance of the layer.

By including a filler in the protective layer, the abrasion resistance of the photoreceptor can be improved, but residual potential of the photoreceptor tends to increase. This is because the surface of the filler has charge trapping sites. Particularly, metal oxides having a hydrophilic property and a high electric resistance have this tendency. In order prevent increase of residual potential, it is effective to add a dispersant having an acid value to the protective layer. In this regard, the acid value is defined as the amount (in units of mg) of potassium hydroxide needed for neutralizing the carboxyl groups included in one gram of a sample (dispersant). When a dispersant having an acid value is added to the protective layer, the dispersant is adsorbed on the surface of the metal oxide, which has a hydrophilic property and is included in the protective layer, thereby filling in the trap sites. Therefore, even when a filler having a hydrophilic property and increasing residual potential is included in the protective layer, increase of residual potential can be prevented and the filler is well dispersed in the protective layer by adding a dispersant having an acid value thereto. These techniques are disclosed in Japanese patent No. 3802787.

The resins for use as the binder resin of the charge transport layer can be used for the protective layer, and proper resins are selected so that the filler to be used for the protective layer can be well dispersed therein. Specific examples of the resins for use as the binder resin of the protective layer include polyester, polycarbonate, polyethylene terephthalate, polybutylene terephthalate, polyarylate, polystyrene, olefin-vinyl monomer copolymers, chlorinated polyether, polyacetal, polyamide, polyamideimide, polyarylsulfone, polybutylene, polyether sulfone, polyethylene, polyimide, polymethylpentene, polypropylene, polyphenyleneoxide, polysulfone, butadiene-styrene copolymers, etc. Among these resins, polycarbonate and polyarylate are preferably used.

The filler-dispersed protective layer can include a charge transport polymer having both a charge transport function and a binder resin function. In this case, the abrasion resistance can be further improved, and the image qualities can be further improved. Known charge transport polymers can be used for the protective layer, and the charge transport polymers mentioned above for use in the charge transport layer are preferably used. Further, a combination of a charge transport polymer and a charge transport material can be used for the protective layer to prevent occurrence of the first one-revolution charge problem and increase of residual potential.

The filler-dispersed protective layer preferably includes a charge transport material such as the charge transport materials mentioned above for use in the charge transport layer. By including a charge transport material in a filler-dispersed protective layer, charge injection and charge transportation from the photosensitive layer (or charge transport layer) to the protective layer can be improved, resulting in prevention of increase of residual potential and deterioration of photosensitivity of the photoreceptor. Even when the mobility of the charge transport layer is improved, the transit time increases if the mobility of the protective layer is too low. Therefore, it is preferable to add a charge transport material in the protective layer to improve the mobility of the protective layer.

The filler-dispersed protective layer preferably has a thickness of from 0.1 to 10 μm, and more preferably from 2 to 6 μm. When the protective layer is too thin, good durability cannot be imparted to the photoreceptor. When the protective layer is too thick, problems in that residual potential of the resultant photoreceptor increases and resolution of the produced images deteriorates occur.

The filler-dispersed protective layer of the photoreceptor can optionally include additives such as dispersants, plasticizers, leveling agents, lubricants and antioxidants. Suitable dispersants include polycarboxylic acids. When polycarboxylic acids are used as dispersants, fillers can be well dispersed in binder resins, thereby preventing increase of residual potential. In addition, abrasion resistance, stability of electrostatic properties, cleanability and foreign material adhesion preventing property of the photoreceptor can be improved. Suitable antioxidants for use in the protective layer include known antioxidants, ultraviolet absorbing agents, and light stabilizers such as phenolic compounds, hindered phenol compounds, hindered amine compounds, paraphenylenediamine compounds, hydroquinone compounds, sulfur-containing organic compounds, phosphorous-containing organic materials, benzophenone compounds, salicylate compounds, benzotriazole compounds, and quenchers (metal complexes).

Among these antioxidants, compounds having a hindered phenol structure or a hindered amine structure are preferably used because of preventing deterioration of the photoreceptor caused by active gasses such as ozone and NOx even after long repeated use and improving the photoreceptor so as to stably producing high quality images over a long period of time.

The hindered phenol structure is a structure such that bulky groups are present at both the ortho positions of the hydroxide group of phenol. The hindered amine structure is a structure such that a bulky group is present at a position near the nitrogen atom of an amino group. Aromatic amine compounds and aliphatic amine compounds are classified into hindered amine compounds. More preferably, compounds having a 2,2,6,6-tetramethylpiperidine structure are used as hindered amine compounds. The behavior of these hindered phenol compounds and hindered amine compounds is not yet clarified but is considered as follows. Specifically, since such compounds have high steric hindrance property due to the bulky groups, thermal vibration of the nitrogen atom of the amino group and the hydroxyl group of the phenolic group is weakened, resulting in enhancement of stability of the radical state of the compounds. Thereby, influence of active gasses (such as ozone and NOx) on the photoreceptor can be prevented.

Compounds having both a hindered phenol structure and a hindered amine structure are preferably used as antioxidants. Among the compounds, 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpyridine is preferably used because of preventing deterioration of resolution of images caused by ozone and NOx.

In general, since the filler included in the filler-dispersed protective layer is present at an outermost portion of the photoreceptor, active gasses tend to be adsorbed on the filler, resulting in formation of blurred images. By including an antioxidant having both a hindered phenol structure and a hindered amine structure in the filler-dispersed protective layer, formation of blurred images can be prevented.

The filler-dispersed protective layer is typically prepared by coating a coating liquid on the photosensitive-layer, followed by drying. When the coating liquid is prepared, a filler is preferably dispersed in an organic solvent using a known dispersing device such as ball mills, attritors, sand mills, shakers, dispersing device utilizing ultrasound, etc. Specific examples of the organic solvents include organic solvents mentioned above for use in the charge generation layer coating liquid and charge transport layer coating liquid such as tetrahydrofuran, dioxane, toluene, dichloromethane, monochlorobenzene, dichloroethane, cyclohexanone, methyl ethyl ketone, acetone, etc. When dispersing a filler, a solvent having a high viscosity is preferably used while a solvent having a high volatility is preferably used when the coating liquid is coated. If there is no solvent having such properties, two or more kinds of solvents are used for the coating liquid. In this case, the dispersibility and stability of the filler can be improved and therefore the coating liquid has good coating properties.

The thus prepared coating liquid is coated by a known coating method. Among various coating methods, spray coating methods are preferably used because the thickness of the protective layer can be easily controlled and the dispersibility of the filler in the coating liquid can be well maintained without forming aggregates of the filler. Therefore, the resultant protective layer has good film properties and hardly causes uneven abrasion.

Next, the crosslinked protective layer will be explained. It is necessary for the crosslinked protective layer to transport charges while maintaining good abrasion resistance. Therefore, the crosslinked protective layer is preferably prepared by crosslinking a polymerizable compound having no charge transport structure and a polymerizable compound having a charge transport structure. In this case, the mobility and abrasion resistance of the protective layer can be improved. In addition, such a protective layer is effective for preventing occurrence of the first one-revolution charge problem, and stabilizing the electrostatic properties of the photoreceptor. In this regard, the term “polymerization” means chain polymerization when polymer production reactions are classified into chain polymerization and step polymerization. Specifically, polymerization means unsaturated polymerization, ring-opening polymerization, isomerization polymerization, etc., in which the reaction proceeds via an intermediate material such as radicals and ions. Polymerizable compounds mean compounds having a group capable of performing the above-mentioned reaction. In addition, crosslinking means a reaction such that monomers or oligomers having such a functional group as mentioned above cause intermolecular bonding (for example, covalent bonding) when receiving energy such as heat, light (e.g., visible light and ultraviolet light), and radiation (e.g., electron beams and y rays), and form a three-dimensional network structure.

Crosslinking resins are broadly classified into thermosetting resins, which can polymerize upon application of heat thereto, light crosslinking resins, which can polymerize upon application of light (such as visible light and ultraviolet light) thereto, and electron crosslinking resins, which can polymerize upon application of electron beams thereto. If desired, crosslinking agents, catalysts and initiators can be used for crosslinking resins.

In order to perform crosslinking, reactive compounds (such as monomers and oligomers) having a functional group capable of performing a polymerization reaction are used. Any functional groups capable of performing a polymerization reaction can be used as the functional group. However, unsaturated polymerizable functional groups and ring-openable functional groups are preferably used. Unsaturated polymerizable functional groups mean groups capable of performing polymerization using a radical or an ion. Specific examples thereof include groups such as C═C, C═C, C═O, C═N, and C≡N. Ring-openable functional groups mean groups having an unstable or distorted ring structure (such as carbon rings, oxo rings and nitrogen-containing hetero rings), which repeat polymerization when opening the ring, resulting in formation of a linear polymer. This reaction is mainly caused by ions. Specific examples of such functional groups include groups having a carbon-carbon double bond such as acryloyl, methacryloyl and vinyl groups, ring-opening groups such as silanol and cyclic ether groups, and groups in which two or more kinds of molecules are reacted. In the crosslinking reaction, when the number of functional groups present in a molecule of a reactive compound is larger, the resultant three-dimensional network structure becomes stronger. Therefore, compounds having three or more functional groups are preferably used. By using a compound having three or more functional groups, the crosslinking density is increased, and thereby a protective layer having high hardness, high elasticity, and smooth and uniform surface can be prepared. Therefore, the resultant photoreceptor has high durability and can produce high quality images. In particular, compounds having an acryloyloxy group or a methacryloyloxy group are preferable because the resultant photoreceptor has good abrasion resistance and low residual potential.

In the present invention, the crosslinked protective layer is a layer, which is prepared by crosslinking a polymerizable compound having no charge transport structure and a polymerizable compound having a charge transport structure, and any known polymerizable compounds can be used therefor. Specific examples of the crosslinking resins include phenolic resins, epoxy resins, melamine resins, alkyd resins, urethane resins, amino resins, polyimide resins, siloxane resins, acrylic resins, methacrylic resins, etc. Among these resins, urethane resins, phenolic resins, acrylic resins, methacrylic resins, siloxane resins, and epoxy resins are preferably used, and acrylic resins and methacrylic resins are more preferably used because of having good electrostatic properties, and easily producing the effect of the present invention. The crosslinked protective layer has a three-dimensional network structure, and is insoluble in organic solvents. Therefore, whether the protective layer is crosslinked can be determined by applying an organic solvent such as alcohol solvents on the layer and then confirming that the layer is not dissolved by the organic solvent.

In order to form a crosslinked protective layer, a polymerizable compound having no charge transport structure and a polymerizable compound having a charge transport structure are subjected to a crosslinking reaction to prepare a three-dimensionally developed network structure. In this case, by mixing a crosslinking agent, a catalyst and/or a polymerization initiator therewith, the crosslinking degree can be further enhanced and the resultant protective layer has an improved abrasion resistance. In addition, the amount of residual unreacted functional groups can be decreased, and thereby the abrasion resistance can be further improved and deterioration of electrostatic properties of the photoreceptor can be prevented. Further, since the crosslinking reaction is evenly performed, cracks and deformation are hardly caused in the protective layer, resulting in improvement of cleanability and durability of the photoreceptor and image qualities.

Any known materials having both a charge transport structure and a functional group capable of reacting with the above-mentioned polymerizable compound can be used as the polymerizable compound having a charge transport structure. The charge transport structure means structures that charge transport materials have and that have a charge transport property. The charge transport structure includes an electron transport structure and a hole transport structure. In the present invention, both the electron transport structure and hole transport structure are available.

Compounds having one of an electron transport structure and a hole transport structure can be used, but compounds having two or more of the structures are preferably used. In addition, polymerizable bipolar compounds having both the electron transport structure and hole transport structure in a molecule can also be used as the polymerizable compound having a charge transport structure.

Specific examples of the hole transport structures include structures having electron donating property such as poly-N-vinylcarbazole structure, poly-γ-carbazolylethylglutamate structure, pyrene-form aldehyde condensate structure, polyvinyl pyrene structure, polyvinyl phenanthrene structure, polysilane structure, oxazole structure, oxadiazole structure, imidazole structure, monoarylamine structure, diarylamine structure, triarylamine structure, stilbene structure, α-phenylstilbene structure, benzidine structure, diarylmethane structure, triarylmethane structure, 9-styrylanthrathene structure, pyrazoline structure, divinylbenzene structure, hydrazone structure, indene structure, butadiene structure, pyrene structure, bisstilbene structure, enamine structure, etc.

Specific examples of the electron transport structures include structures having electron accepting property such as chloranil structure, bromanil structure, tetracyanoethylene structure, tetracyanoquinodimethane structure, 2,4,7-trinitro-9-fluorenon structure, 2,4,5,7-tetranitro-9-fluorenon structure, 2,4,5,7-tetanitroxanthone structure, 2,4,8-trinitrothioxanthone structure, 2,6,8-trinitro-4H-indeno[1,2-b]thiophene-4-one structure, 1,3,7-trinitrodibenzothiophene-5,5-dioxide structure, condensed polycyclic quinine structure, diphenoquinone structure, benzoquinone structure, naphthalene tetracarboxylic acid diimide structure, aromatic ring structures having a cyano group or a nitro group, etc.

Next, acrylic resins serving as crosslinkable resins will be explained in detail.

Polymerizable compounds having no charge transport structure for use in preparing the crosslinked protective layer mean compounds, which have a polymerizable functional group and which do not have a charge transport structure such as hole transport structures (e.g., triarylamine structure, hydrazone structure, pyrazoline structure and carbazole structure) and electron transport structures (e.g., condensed polycyclic quinine structure, diphenoquinone structure, and aromatic ring structures having a cyano group or a nitro group). The polymerizable functional group includes polymerizable groups having a carbon-carbon double bond. Specific examples of the polymerizable functional group include 1-substituted ethylene groups and 1,1-substituted ethylene groups, which are explained below.

1-substituted ethylene Groups

Specific examples of the 1-substituted ethylene groups include the following group [5]:

CH₂═CH—X₁— [5]

wherein X₁ represents a substituted or unsubstituted arylene group (such as phenylene and naphthylene groups), a substituted or unsubstituted alkenylene group, a —CO— group, a —COO— group, a —CON(R₂₂₈) group (R₂₂₈ represents a hydrogen atom, an alkyl group (e.g., methyl and ethyl groups), an aralkyl group (e.g., benzyl, naphthylmethyl and phenetyl groups), or an aryl group (e.g., phenyl and naphthyl groups)) or a —S— group.

Specific examples of the groups having formula [5] include a vinyl group, a styryl group, 2-methyl-1,3-butadienyl group, a vinylcarbonyl group, an acryloyloxy group, an acryloylamide group, a vinylthioether group, etc.

1,1-substituted ethylene Groups

Specific examples of the 1,1-substituted ethylene groups include the following group [6]:

CH₂═C(Y₄)—(X₂)ₙ— [6]

wherein Y represents a substituted or unsubstituted alkyl group, a substituted or unsubstituted aralkyl group, a substituted or unsubstituted aryl group (such as phenyl and naphthyl groups), a halogen atom, a cyano group, a nitro group, an alkoxyl group (such as methoxy and ethoxy groups), or a —COOR₂₂₉ group (wherein R₂₂₉ represents a hydrogen atom, a substituted or unsubstituted alkyl group (such as methyl and ethyl groups), a substituted or unsubstituted aralkyl group (such as benzyl and phenethyl groups), a substituted or unsubstituted aryl group (such as phenyl and naphthyl groups) or a —CONR₂₃₀R₂₃₁ group (wherein each of R₂₃₀ and R₂₃₁ represents a hydrogen atom, a substituted or unsubstituted alkyl group (such as methyl and ethyl groups), a substituted or unsubstituted aralkyl group (such as benzyl, naphthylmethyl and phenethyl groups), a substituted or unsubstituted aryl group (such as phenyl and naphthyl groups)); X₂ represents a group selected from the groups mentioned above for use in X₁ and an alkylene group, wherein at least one of Y₄ and X₂ is an oxycarbonyl group, a cyano group, an alkenylene group or an aromatic ring group; and n is 0 or 1.

Specific examples of the groups having formula [6] include an α-chloroacryloyloxy group, a methacryloyloxy group, an α-cyanoethylene group, an α-cyanoacryloyloxy group, an α-cyanophenylene group, a methacryloylamino group, etc.

Specific examples of the substituents of the groups X₁, X₂ and Y₄ include halogen atoms, nitro groups, cyano groups, alkyl groups (such as methyl and ethyl groups), alkoxyl groups (such as methoxy and ethoxy groups), aryloxy groups (such as a phenoxy group), aryl groups (such as phenyl and naphthyl groups), aralkyl groups (such as benzyl and phenethyl groups), etc.

Among these functional groups, acryloyloxy and methacryloyloxy groups are preferable.

Polymerizable compounds (such as polymerizable monomers and oligomers) having two or more functional groups are preferably used, and polymerizable compounds having three or more functional groups are more preferably used. When a polymerizable monomer having three or more functional groups is crosslinked, a well-developed three-dimensional network can be formed. Therefore, a protective layer having high crosslinking density, high hardness, high elasticity, and even and smooth surface can be prepared. Therefore, the protective layer has good resistance to abrasion and scratches. However, depending on the crosslinking conditions and the properties of the materials used, cracks tend to be formed in the protective layer and/or the layer tends to be easily peeled from the lower layer due to internal stress caused by volume reduction of the layer, which is caused by a number of bonds formed at once in the crosslinking reaction. In order to prevent occurrence of such problems, polymerizable mono- or di-functional monomers are used in combination therewith.

Next, polymerizable compounds having three or more functional groups, which can be preferably used for improving the abrasion resistance of the photoreceptor, will be explained.

Compounds having three or more (meth)acryloyloxy groups can be prepared by subjecting (meth)acrylic acid (salts), (meth)acrylhalides and (meth)acrylates, which have three or more hydroxyl groups, to an ester reaction or an ester exchange reaction. When plural polymerizable groups are included in a polymerizable functional monomer, the groups may be the same as or different from the others therein.

Specific examples of the polymerizable compounds having three or more radically polymerizable functional groups include, but are not limited thereto, trimethylolpropane triacrylate (TMPTA), trimethylolpropane trimethacylate, trimethylolpropane alkylene-modified triacrylate, trimethylolpropane ethyleneoxy-modified triacrylate, trimethylolpropane propyleneoxy-modified triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin-modified triacrylate, glycerol ethyleneoxy-modified triacrylate, glycerol propyleneoxy-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol tetraacrylate, alkylated dipentaerythritol triacrylate, dimethylolpropane tetraacrylate (DTMPTA), pentaerhythritol ethoxytriacrylate, ethyleneoxy-modified triacryl phosphate, 2,2,5,5-tetrahydroxymethylcyclopentanone tetraacrylate, etc. These monomers are used alone or in combination.

In order to form a dense crosslinked network in the crosslinked protective layer, the ratio (Mw/F) of the molecular weight (Mw) of a polymerizable compound having no charge transport structure to the number of functional groups (F) included in a molecule of the compound is preferably not greater than 250. In this case, the abrasion resistance of the resultant photoreceptor can be improved. In addition, the charge transport property of the photoreceptor can be improved, resulting in prevention of the first one-revolution charge problem. When the number is too large, the resultant protective layer becomes soft and thereby the abrasion resistance of the layer slightly is deteriorated. In this case, it is not preferable to use only one monomer having a functional group having a long chain group when the monomer is modified with a group such as ethylene oxide, propylene oxide and caprolactone.

The content of the unit obtained from a polymerizable compound having no charge transport structure in the crosslinked protective layer is preferably from 20 to 80% by weight, and more preferably from 30 to 70% by weight, based on the total weight of the protective layer. When the content is too low, the three dimensional crosslinking density is low, and thereby abrasion resistance much better than that of conventional protective layers prepared by using a thermoplastic binder resin cannot be imparted to the protective layer. In contrast, when the content is too high, the content, of the charge transport compound decreases, and thereby the first one-revolution charge problem is caused and residual potential of the photoreceptor is increased. The targets of the abrasion resistance and electrostatic properties of the crosslinked protective layer are changed depending on the image forming processes for which the photoreceptor is used, and therefore, the thickness of the protective layer is also changed. Therefore, the content of the unit obtained from the polymerizable compound having no charge transport structure in the protective layer is not unambiguously determined, but the content is preferably from 30 to 70% by weight in order to balance both the properties.

Next, polymerizable compounds having a charge transport structure will be explained.

Polymerizable compounds having a charge transport structure for use in preparing the crosslinked protective layer include a positive hole transport structure (e.g., triarylamine, hydrazone, pyrazoline and carbazole structures) and/or an electron transport structure (e.g., electron accepting aromatic groups such as condensed polycyclic quinone structure, diphenoquinone structure, and cyano and nitro groups) as well as a polymerizable functional group.

Suitable functional groups for use as the polymerizable functional group include acryloyloxy and methacryloyloxy groups. The number of functional groups of polymerizable compounds for use in preparing the crosslinked protective layer is not particularly limited. However, monofunctional polymerizable compounds are preferably used in view of the stability of electrostatic properties of the layer and the properties of the film of the layer. When a di-functional compound is used, the compound is fixed in a crosslinked structure with plural bonds, and thereby the crosslinking density is increased. However, since the charge transport structure is very bulky, the crosslinked structure is strained, resulting in increase of internal stress in the layer. In addition, the intermediate structure (i.e., cation radicals) cannot be stably maintained during the charge transport process, thereby deteriorating the photosensitivity due to trapping of charges, and increasing the residual potential of the photoreceptor.

Any polymerizable compounds capable of imparting a charge transport function can be used as the polymerizable compound having a charge transport structure. Among the compounds, polymerizable compounds having a triarylamine structure are preferably used. For example, when compounds having the below-mentioned formula (12) or (13) are used, the mobility of the protective layer can be improved, and thereby occurrence of the first one-revolution charge problem can be prevented, and in addition the electrostatic properties (such as photosensitivity and residual potential) of the photoreceptor can be improved.

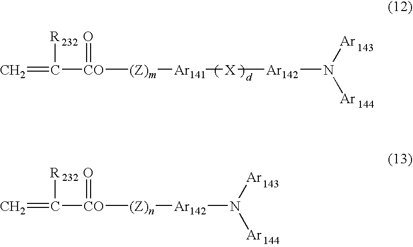

In formulae (13) and (14), R₂₃₂ represents a hydrogen atom, a halogen atom, a substituted or unsubstituted alkyl group, a substituted or unsubstituted aralkyl group, a substituted or unsubstituted aryl group, a cyano group, a nitro group, an alkoxyl group, a —COOR₂₄₁ group (wherein R₂₄₁ represents a hydrogen atom, a substituted or unsubstituted alkyl group, a substituted or unsubstituted aralkyl group and a substituted or unsubstituted aryl group), a halogenated carbonyl group or a —CONR₂₄₂R₂₄₃ (wherein each of R₂₄₂ and R₂₄₃ represents a hydrogen atom, a substituted or unsubstituted alkyl group, a substituted or unsubstituted aralkyl group and a substituted or unsubstituted aryl group); each of Ar₁₄₁ and Ar₁₄₂ represents a substituted or unsubstituted arylene group; each of Ar₁₄₃ and Ar₁₄₄ represents a substituted or unsubstituted arylene group; X represents a substituted or unsubstituted alkylene group, a substituted or unsubstituted cycloalkylene group, a substituted or unsubstituted alkylene ether group, an oxygen atom, a sulfur atom or a vinylene group; Z represents a substituted or unsubstituted alkylene group, a substituted or unsubstituted divalent alkylene ether group, or a substituted or unsubstituted divalent alkyleneoxy carbonyl group; each of m and n is 0 or an integer of from 1 to 3; and d is 0 or 1.

In formulae (12) and (13), specific examples of the alkyl, aryl, aralkyl, and alkoxyl groups for use in R₂₃₂ include the following.

### Alkyl Group

Methyl, ethyl, propyl and butyl groups.

### Aryl Group

Phenyl and naphthyl groups, etc.

### Aralkyl Group

Benzyl, phenethyl and naphthylmethyl groups.

### Alkoxyl Group

Methoxy, ethoxy and propoxy groups.

These groups may be substituted with a halogen atom, a nitro group, a cyano group, an alkyl group (such as methyl and ethyl groups), an alkoxyl group (such as methoxy and ethoxy groups), an aryloxy group (such as a phenoxy group), an aryl group (such as phenyl and naphthyl groups), an aralkyl group (such as benzyl and phenethyl groups), etc.

Among these groups, a hydrogen atom and a methyl group are preferable as R₂₃₂.

Suitable substituted or unsubstituted aryl groups for use as Ar₁₄₃ and Ar₁₄₄ include condensed polycyclic hydrocarbon groups, non-condensed cyclic hydrocarbon groups, and heterocyclic groups.

Specific examples of the condensed polycyclic hydrocarbon groups include compounds in which 18 or less carbon atoms constitute a polycyclic structure, such as pentanyl, indecenyl, naphthyl, azulenyl, heptalenyl, biphenilenyl, as-indacenyl, s-indacenyl, fluorenyl, acenaphthylenyl, preiadenyl, acenaphthenyl, phenarenyl, phenanthoryl, anthoryl, fluorantenyl, acephenanthorylenyl, aceanthorylenyl, triphenylenyl, pyrenyl, chrysenyl, and naphthasenyl groups.

Specific examples of the non-condensed cyclic hydrocarbon groups include monovalent groups of benzene, diphenyl ether, polyethylene diphenyl ether, diphenyl thioether, and diphenyl sulfone; monovalent groups of non-condensed polycyclic hydrocarbon groups such as biphenyl, polyphenyl, diphenyl alkans, diphenylalkenes, diphenyl alkyne, triphenyl methane, distyryl benzene, 1,1-diphenylcycloalkanes, polyphenyl alkans, polyphenyl alkenes; and ring aggregation hydrocarbons such as 9,9-diphenyl fluorenone.

Specific examples of the heterocyclic groups include monovalent groups of carbazole, dibenzofuran, dibenzothiophene, oxadiazole, and thiadiazole.

The aryl groups for use as Ar₁₄₃ and Ar₁₄₄ may be substituted with the following groups.
(1) Halogen atoms, and cyano and nitro groups.
(2) Linear or branched alkyl groups which preferably have from 1 to 12 carbon atoms, more preferably from 1 to 8 carbon atoms and even more preferably from 1 to 4 carbon atoms. These alkyl groups can be further substituted with another group such as a fluorine atom, a hydroxyl group, a cyano group, an alkoxyl group having 1 to 4 carbon atoms, and a phenyl group which may be further substituted with a halogen atom, an alkyl group having 1 to 4 carbon atoms, or an alkoxyl group having 1 to 4 carbon atoms. Specific examples of the alkyl groups include methyl, ethyl, n-propyl, iso-propyl, n-butyl, sec-butyl, t-butyl, trifluoromethyl, 2-hydroxyethyl, 2-ethoxyethyl, 2-cyanoethyl, 2-methoxyethyl, benzyl, 4-chlorobenzyl, 4-methylbenzyl and 4-phenylbenzyl groups.
(3) Alkoxyl groups (i.e., —OR₂₃₃). R₂₃₃ represents one of the alkyl groups defined above in paragraph (2). Specific examples of the alkoxyl groups include methoxy, ethoxy, n-propoxy, iso-propoxy, t-butoxy, n-butoxy, s-butoxy, iso-butoxy, 2-hydroxyethoxy, benzyloxy and trifluoromethoxy groups.
(4) Aryloxy groups. Specific examples of the aryl group of the acryloxy groups include phenyl and naphthyl groups. The aryloxy groups may be substituted with an alkoxyl group having from 1 to 4 carbon atoms, an alkyl group having from 1 to 4 carbon atoms, or a halogen atom. Specific examples of the aryloxy groups include phenoxy, 1-naphthyloxy, 2-naphthyloxy, 4-methoxyphenoxy, and 4-methylphenoxy groups.
(5) Alkylmercapto or arylmercapto group. Specific examples of the groups include methylthio, ethylthio, phenylthio, and p-methylphenylthio groups
(6) Groups having the following formula (14).

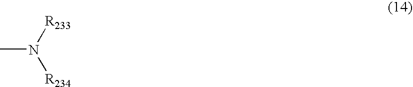

In formula (14), each of R₂₃₃ and R₂₃₄ represents a hydrogen atom, one of the alkyl groups defined in paragraph (2) or an aryl group (such as phenyl, biphenyl, and naphthyl groups). These groups may be substituted with another group such as an alkoxyl group having from 1 to 4 carbon atoms, an alkyl group having from 1 to 4 carbon atoms, and a halogen atom. In addition, R₂₃₃ and R₂₃₄ optionally share bond connectivity to form a ring.

Specific examples of the groups having formula (14) include amino, diethylamino, N-methyl-N-phenylamino, N,N-diphenylamino, N,N-di(tolyl)amino, dibenzylamino, piperidino, morpholino, and pyrrolidino groups.
(7) Alkylenedioxy or alkylenedithio groups such as methylenedioxy and methylenedithio groups.
(8) Substituted or unsubstituted styryl groups, substituted or unsubstituted β-phenylstyryl groups, diphenylaminophenyl groups, and ditolylaminophenyl groups.

Suitable groups for use as the arylene groups Ar₁₄₁ and Ar₁₄₂ include divalent groups delivered from the aryl groups mentioned above for use in Ar₁₄₃ and Ar₁₄₄.

The group X is a substituted or unsubstituted alkylene group, a substituted or unsubstituted cycloalkylene group, a substituted or unsubstituted alkylene ether, an oxygen atom, a sulfur atom, and a vinylene group.

Suitable groups for use as the substituted or unsubstituted alkylene group include linear or branched alkylene groups which preferably have from 1 to 12 carbon atoms, more preferably from 1 to 8 carbon atoms and even more preferably from 1 to 4 carbon atoms. These alkylene groups can be further substituted with another group such as a fluorine atom, a hydroxyl group, a cyano group, an alkoxyl group having 1 to 4 carbon atoms, and a phenyl group which may be further substituted with a halogen atom, an alkyl group having 1 to 4 carbon atoms, or an alkoxyl group having 1 to 4 carbon atoms. Specific examples of the alkylene groups include methylene, ethylene, n-propylene, iso-propylene, n-butylene, sec-butylene, t-butylene, trifluoromethylene, 2-hydroxyethylene, 2-ethoxyethylene, 2-cyanoethylene, 2-methoxyethylene, benzylidene, phenylethylene, 4-chlorophenylethylene, 4-methylphenylethylene and 4-biphenylethylene groups.

Suitable groups for use in the substituted or unsubstituted cycloalkylene groups include cyclic alkylene groups having from 5 to 7 carbon atoms, which may be substituted with a fluorine atom or another group such as a hydroxyl group, alkyl groups having from 1 to 4 carbon atoms, and alkoxyl groups having 1 to 4 carbon atoms. Specific examples of the substituted or unsubstituted cycloalkylene groups include cyclohexylidene, cyclohexylene, and 3,3-dimethylcyclohexylidene groups.

Specific examples of the substituted or unsubstituted alkylene ether groups include ethyleneoxy, propyleneoxy, ethylene glycol, propylene glycol, diethylene glycol, tetraethylene glycol, and tripropylene glycol groups. The alkylene group of the alkylene ether groups may be substituted with another group such as hydroxyl, methyl and ethyl groups.

Suitable groups for use as the vinylene group include groups having one of the following formulae.

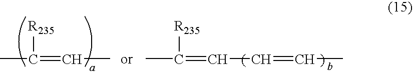

In the above-mentioned formulae, R₂₃₅ represents a hydrogen atom, one of the alkyl groups mentioned above for use in paragraph (2), or one of the aryl groups mentioned above for use in Ar₁₄₃ and Ar₁₄₄, wherein a is 1 or 2, and b is 1, 2 or 3.

In formulae (12) and (13), Z represents a substituted or unsubstituted alkylene group, a substituted or unsubstituted divalent alkylene ether group, a divalent alkyleneoxycarbonyl group. Specific examples of the substituted or unsubstituted alkylene group include the alkylene groups mentioned above for use as the group X. Specific examples of the substituted or unsubstituted alkylene ether group include the divalent alkylene ether groups mentioned above for use as the group X. Specific examples of the divalent alkyleneoxycarbonyl group include divalent groups modified by caprolactone.

More preferably, monomers having the following formula (16) are used as the polymerizable compound having a charge transport structure.

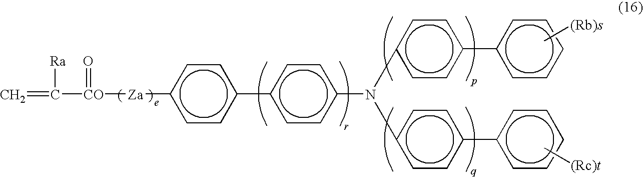

In formula (16), each of r, p and q is 0 or 1; Ra represents a hydrogen atom, or a methyl group; each of Rb and Rc represents an alkyl group having from 1 to 6 carbon atoms, wherein each of Rb and Rc can include plural groups which are the same as or different from each other; each of s and t is 0, 1, 2 or 3; e is 0 or 1; Za represents a methylene group, an ethylene group or a group having one of the following formulae.

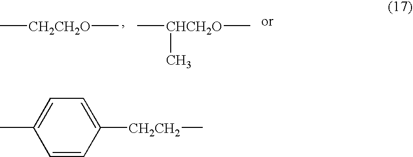

In formula (16), each of R_{b} and R_{c} is preferably a methyl group or an ethyl group.

The radical polymerizable monofunctional monomers having formula (12) or (13) (preferably formula (16)), have the following property. Specifically, a polymerizable monofunctional compound is polymerized while the carbon-carbon double bond of a molecule is connected with the double bonds of other molecules. Therefore, the compound is incorporated in a main chain (i.e., a crosslinking chain between two main chains), which is formed by the monomer and a radical polymerizable tri- or more-functional monomer. The crosslinking chain of the unit obtained from the monofunctional compound is present between two main polymer chains which are connected by crosslinking chains. In this regard, the crosslinking chains are classified into intermolecular crosslinking chains and intramolecular crosslinking chains.

In any case, the triarylamine group which is a pendant of the main chain of the unit obtained from the monofunctional compound is bulky and is connected with the main chain with a carbonyl group therebetween while not being fixed (i.e., while being fairly free three-dimensionally). Therefore, the crosslinked polymer has little strain, and in addition the crosslinked protective layer has relatively good charge transport property.

Specific examples of the polymerizable monofunctional compound having a charge transport structure include the following compounds Nos. 1-160, but are not limited thereto.

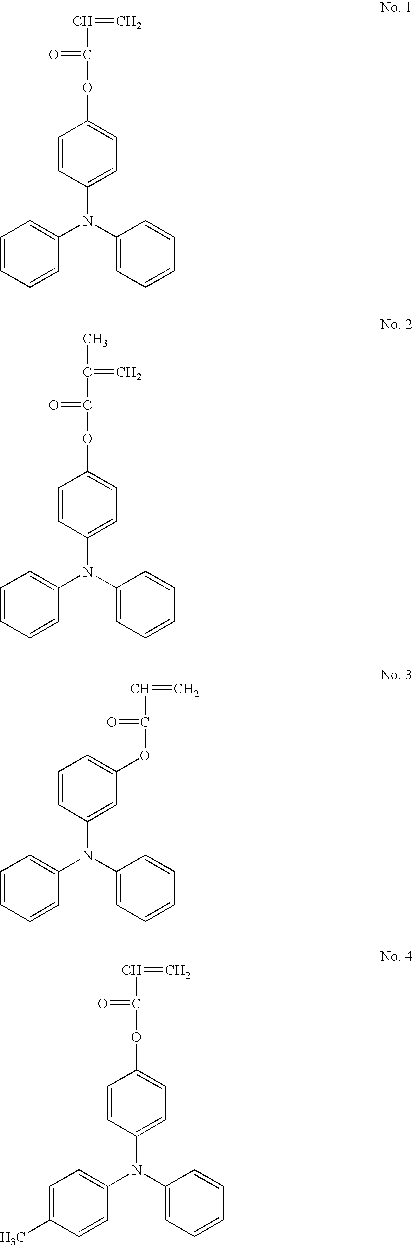

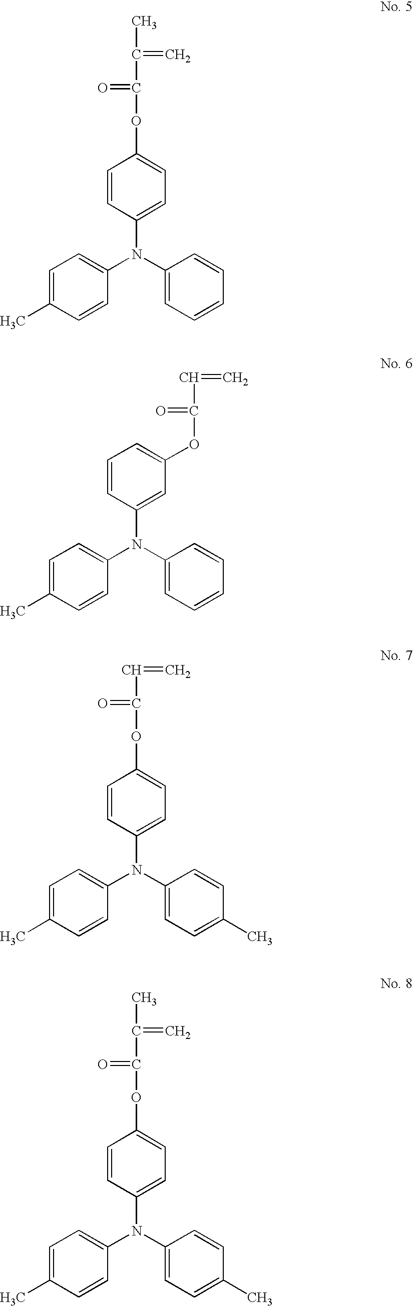

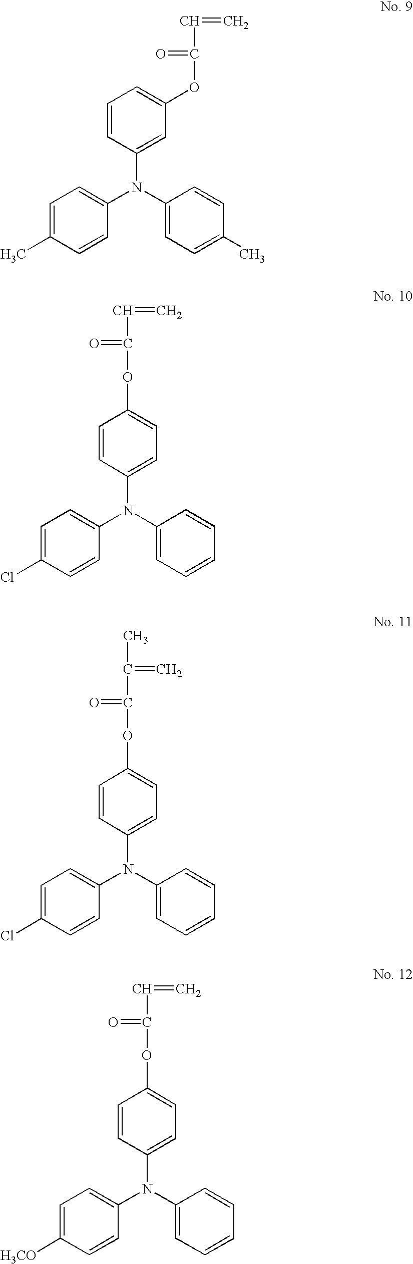

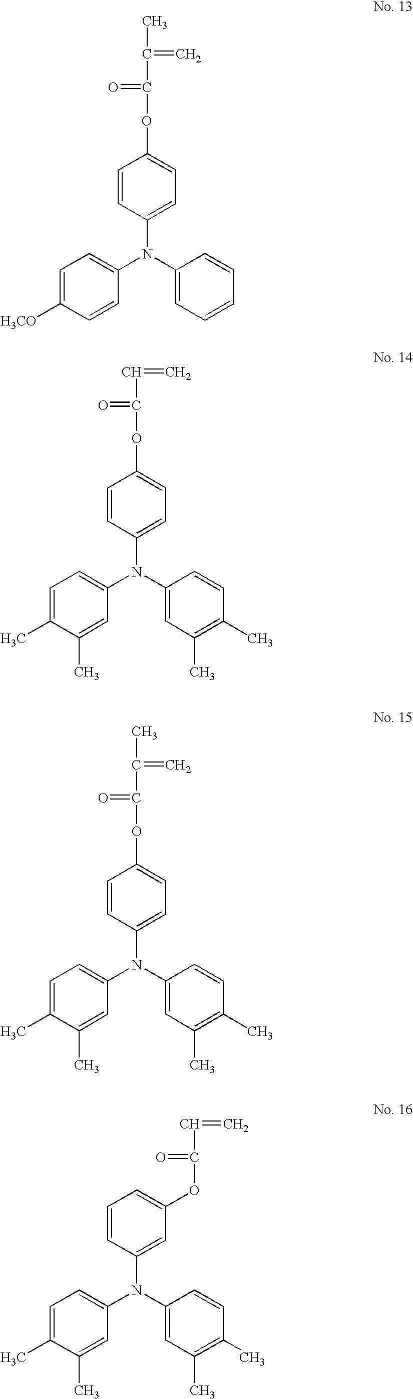

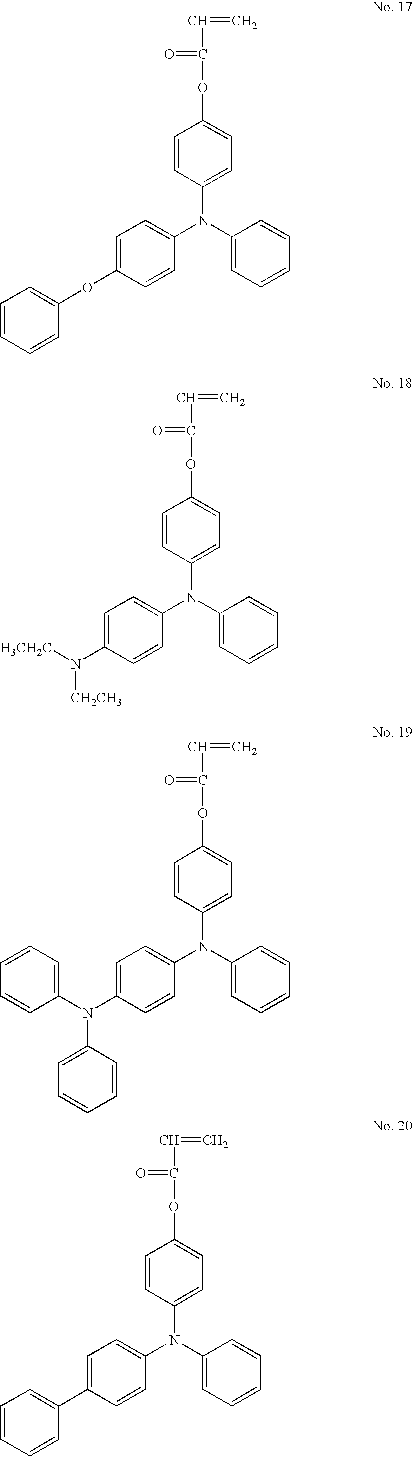

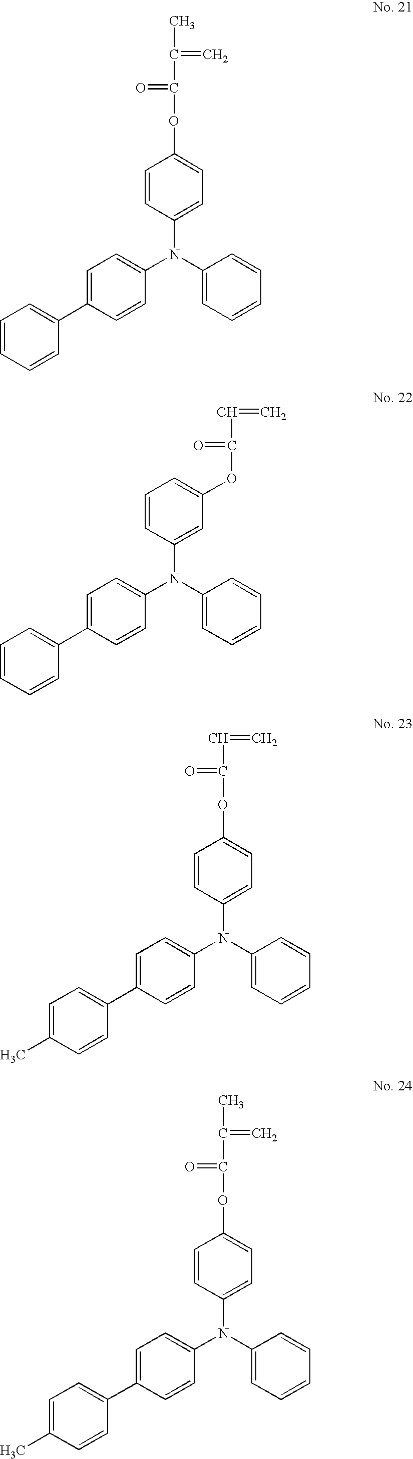

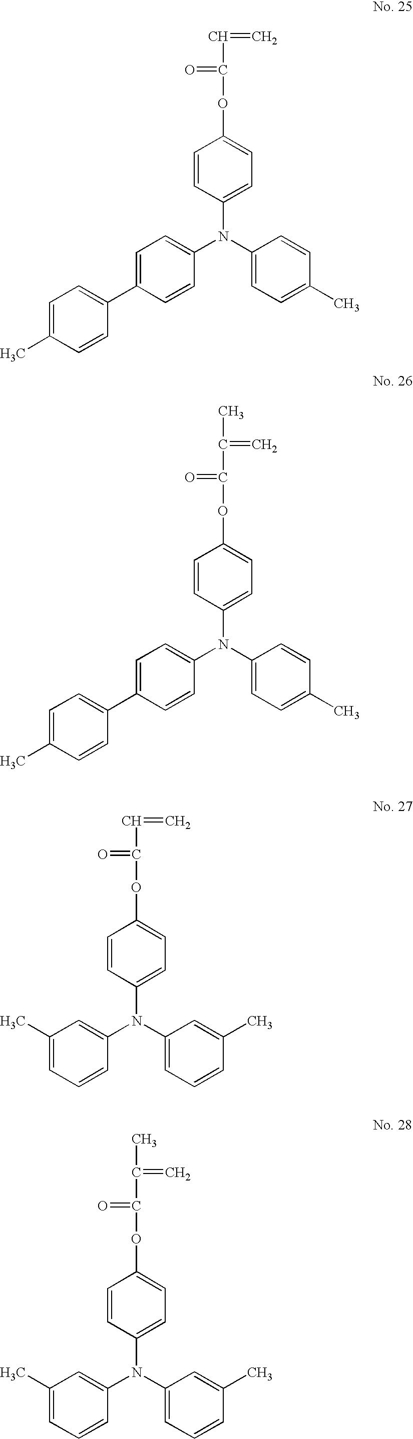

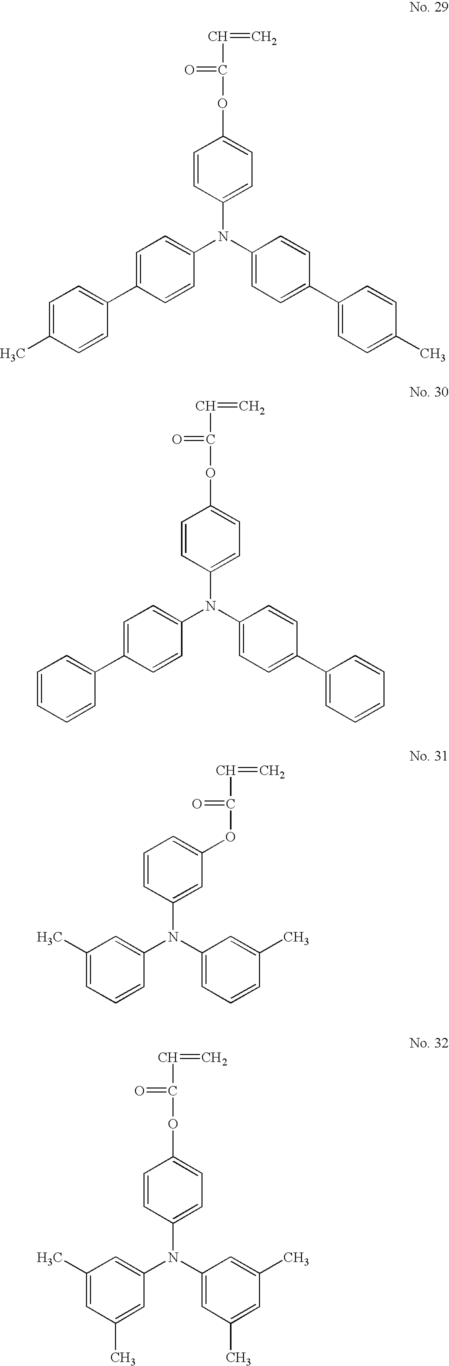

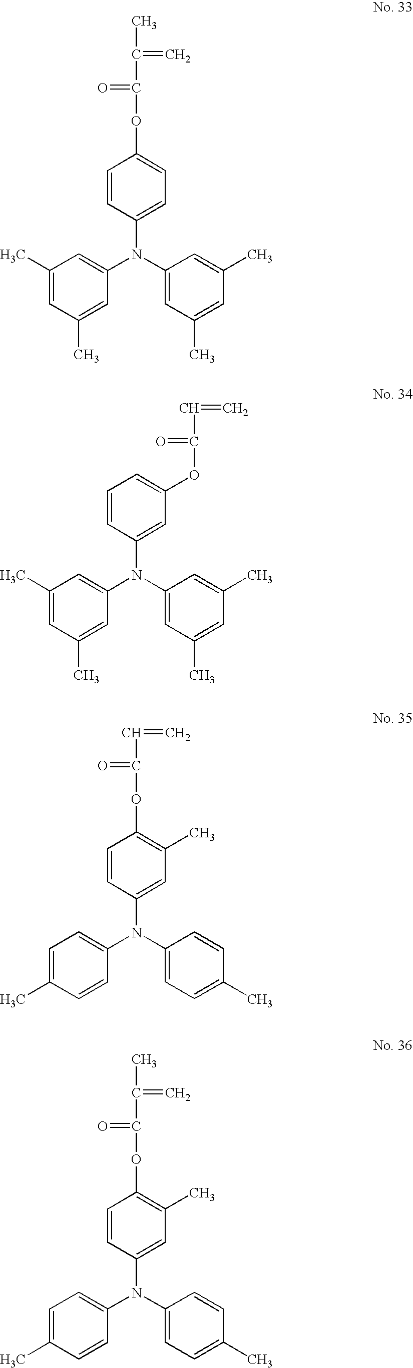

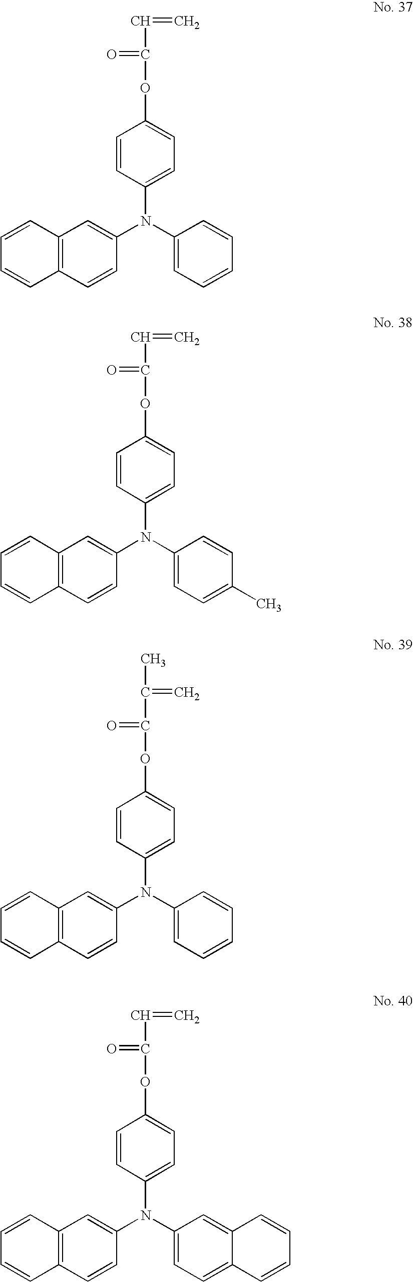

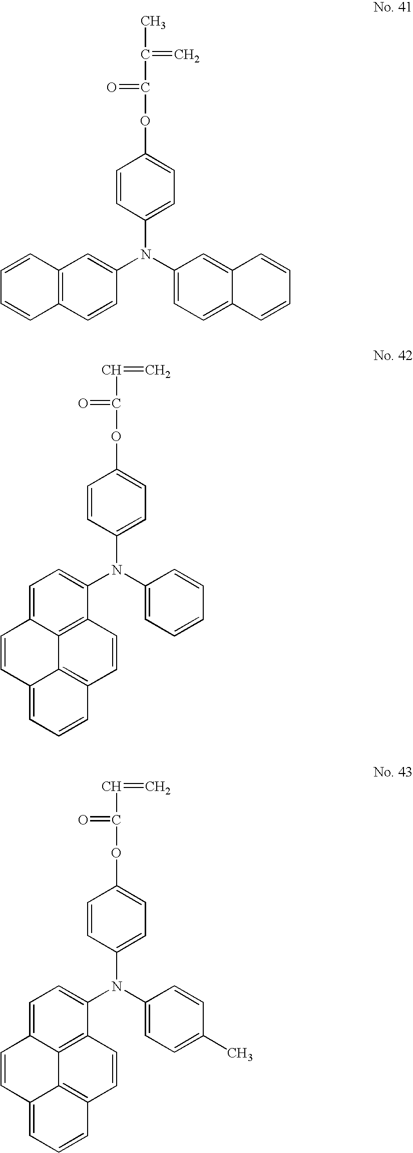

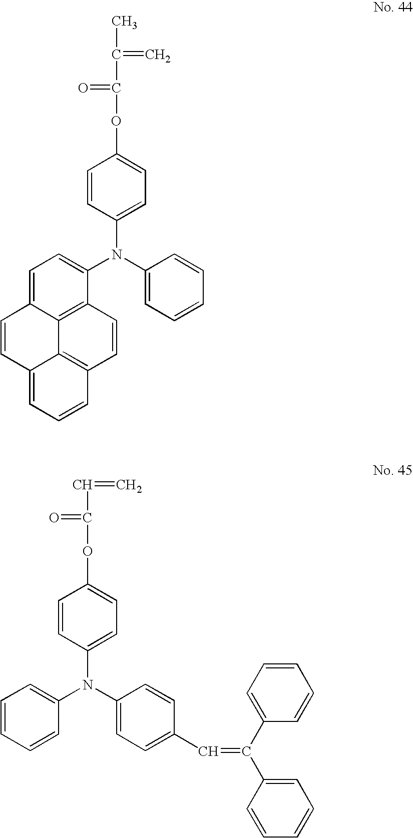

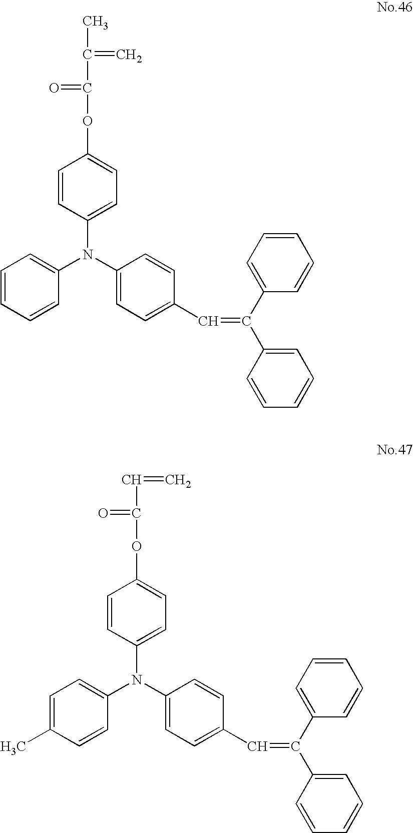

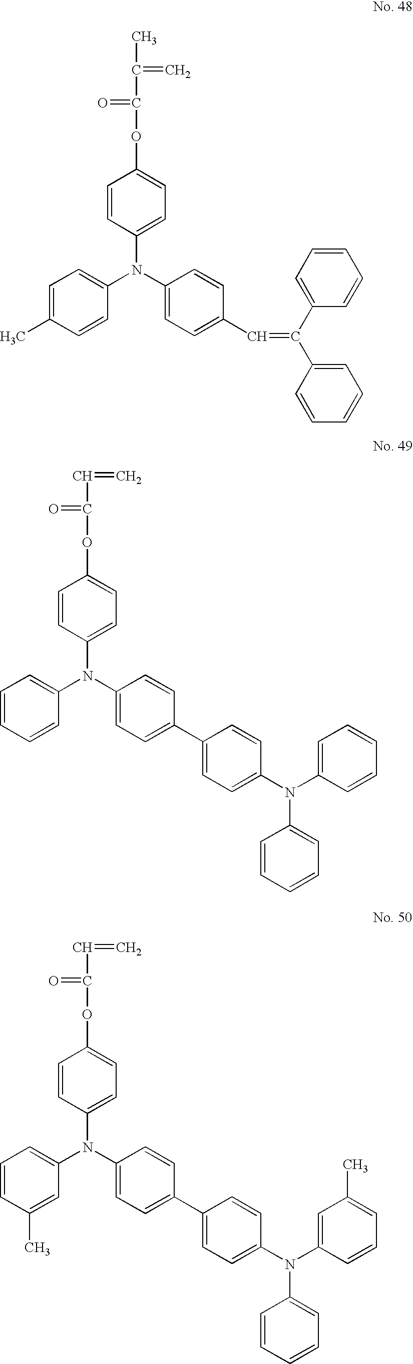

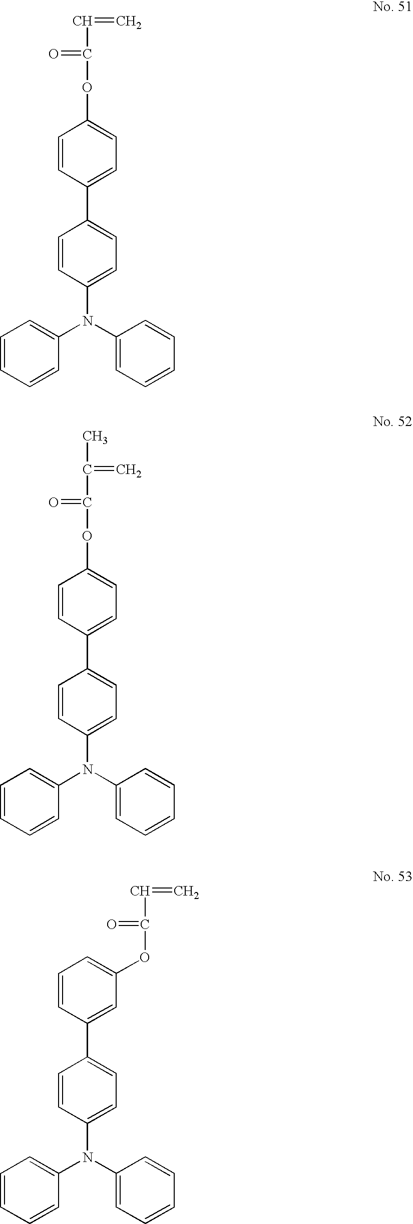

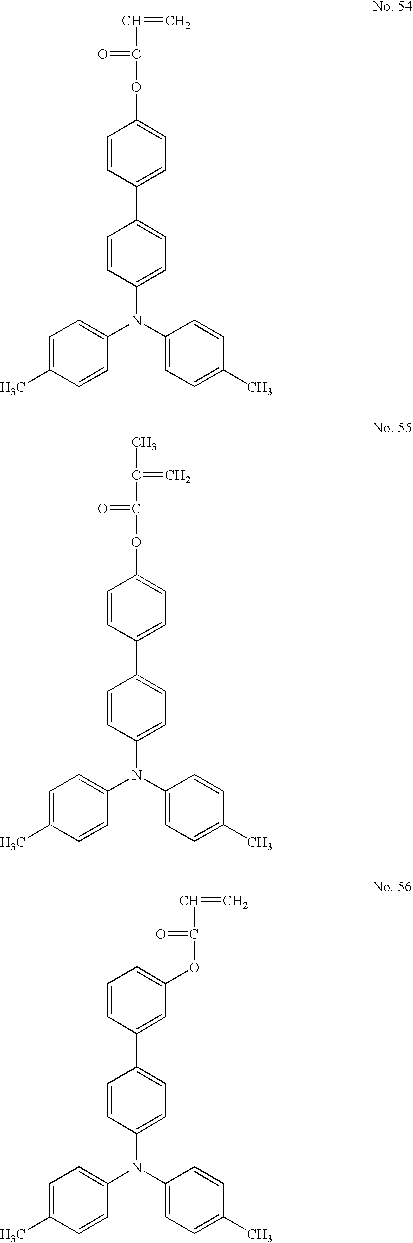

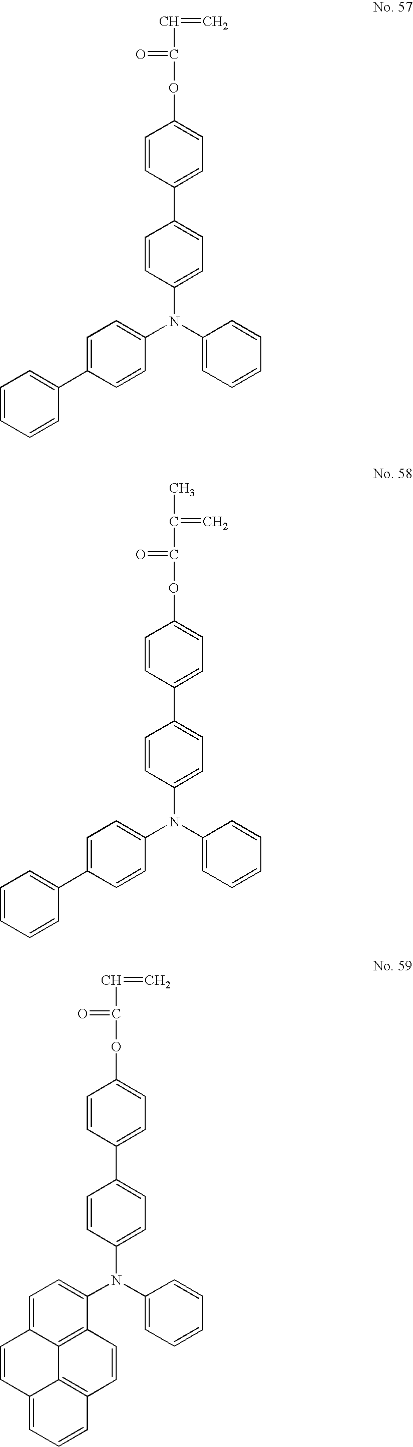

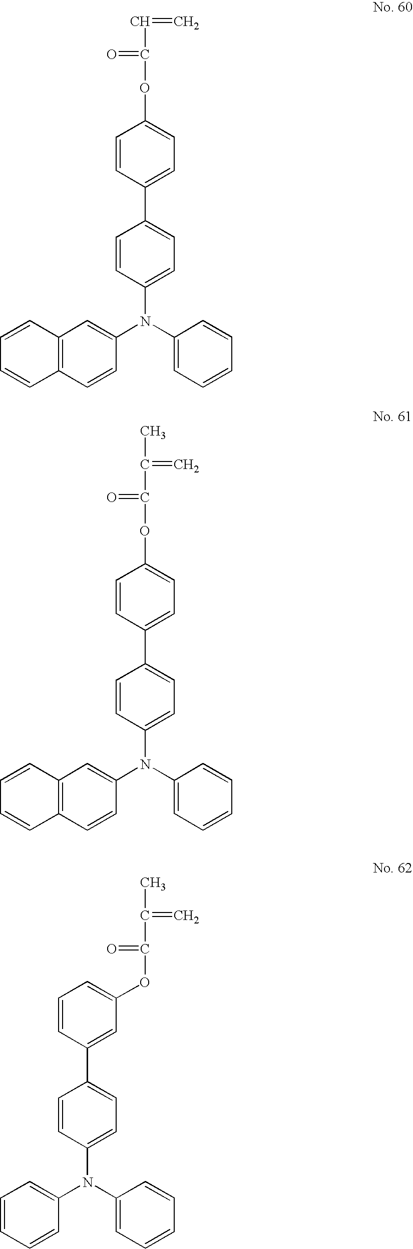

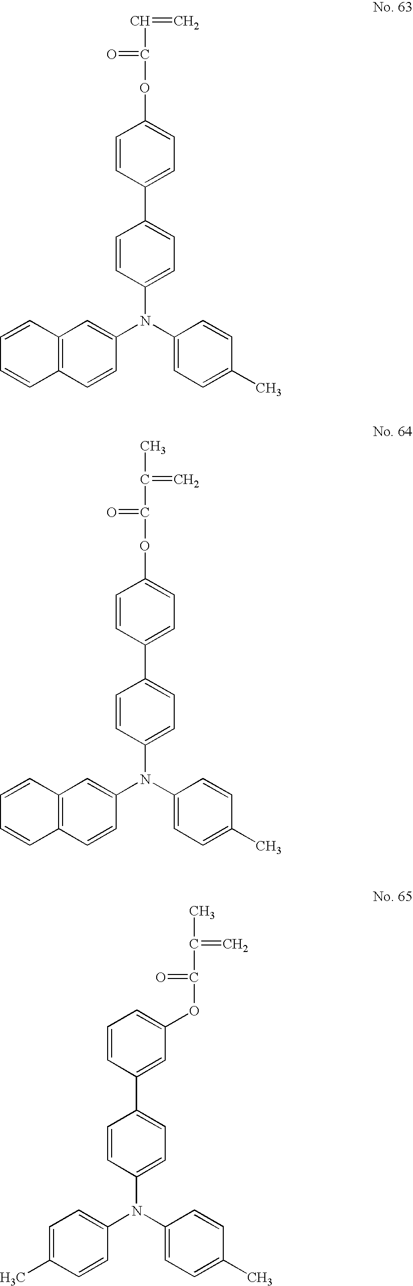

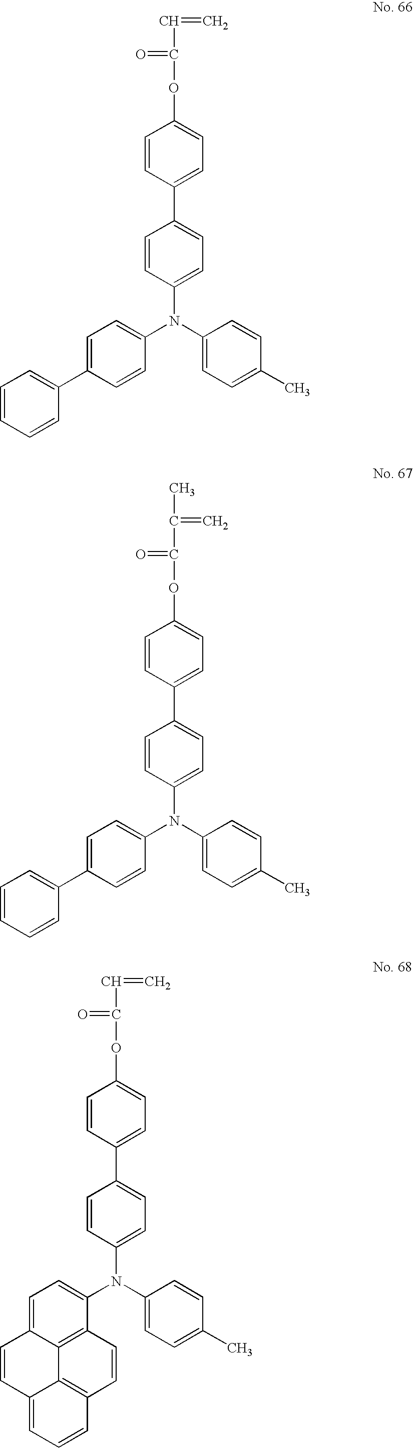

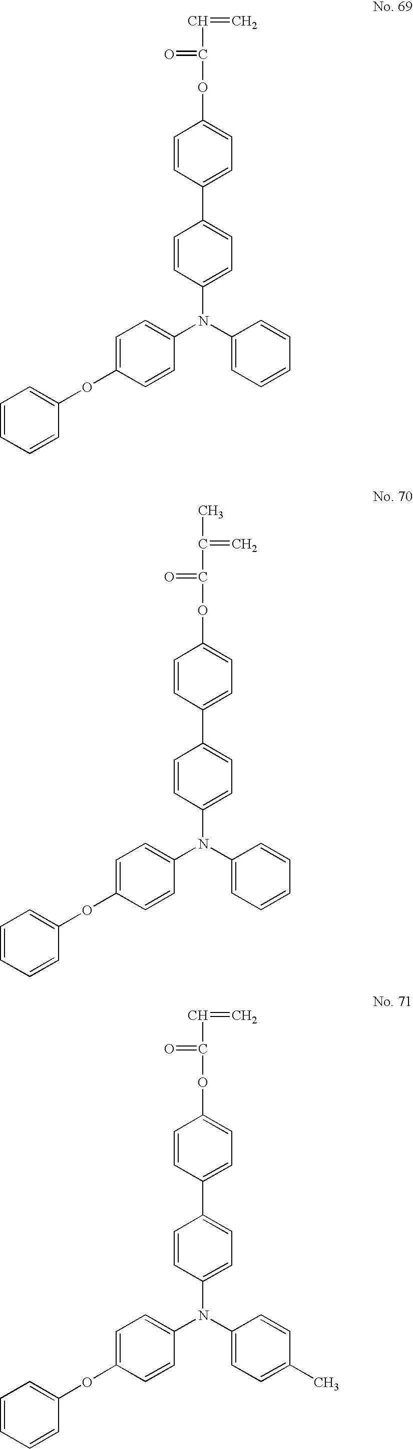

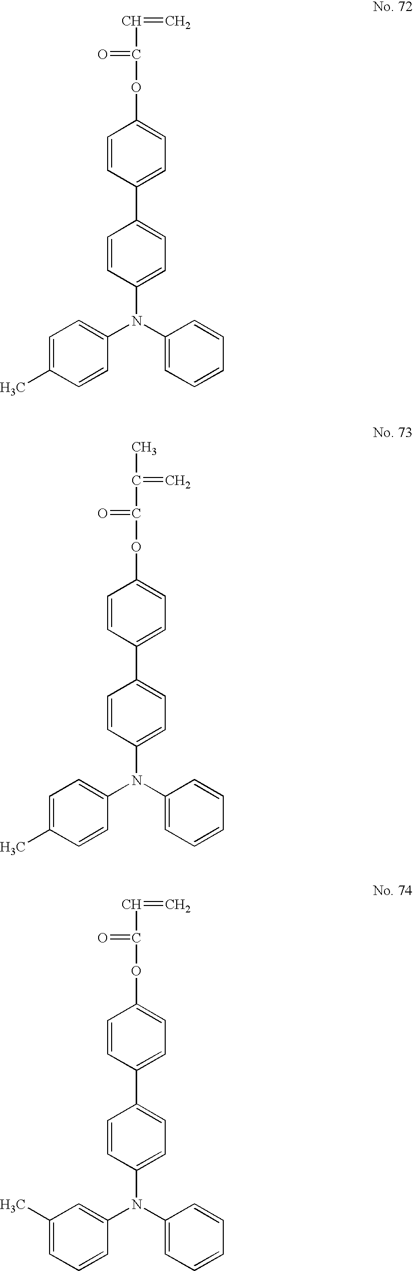

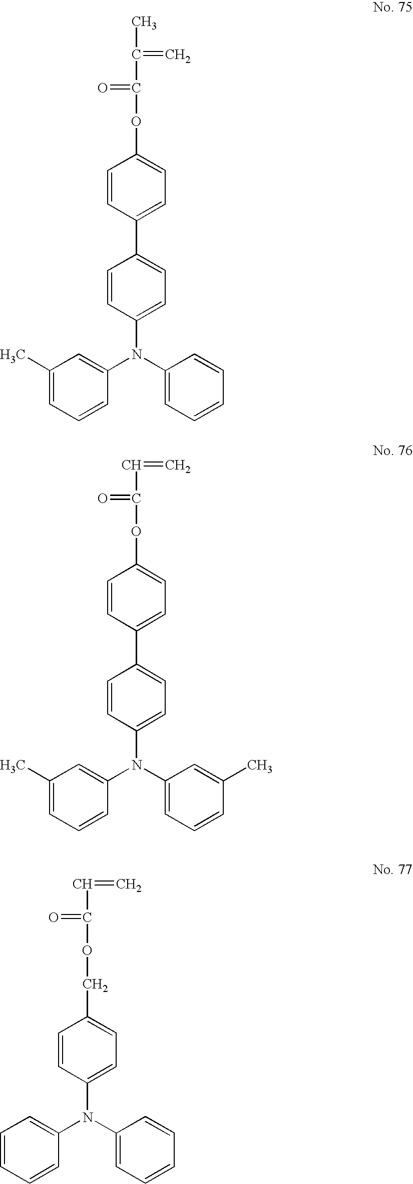

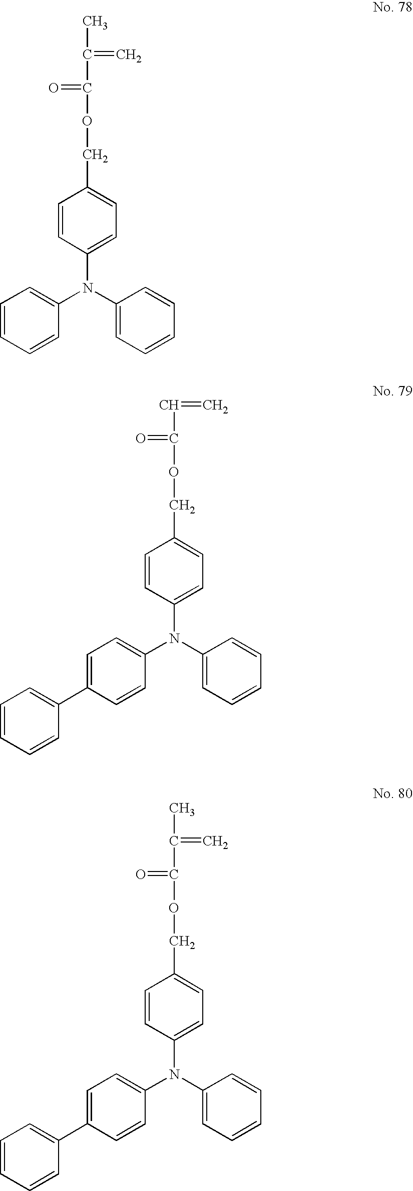

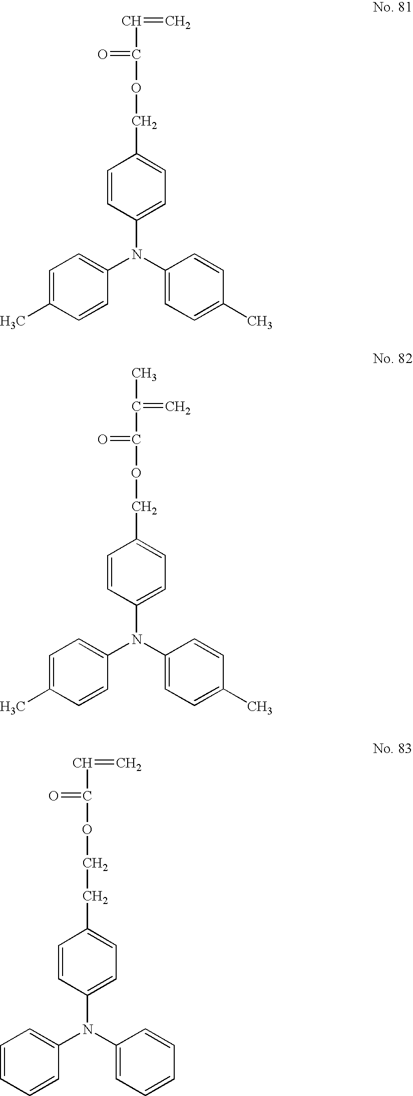

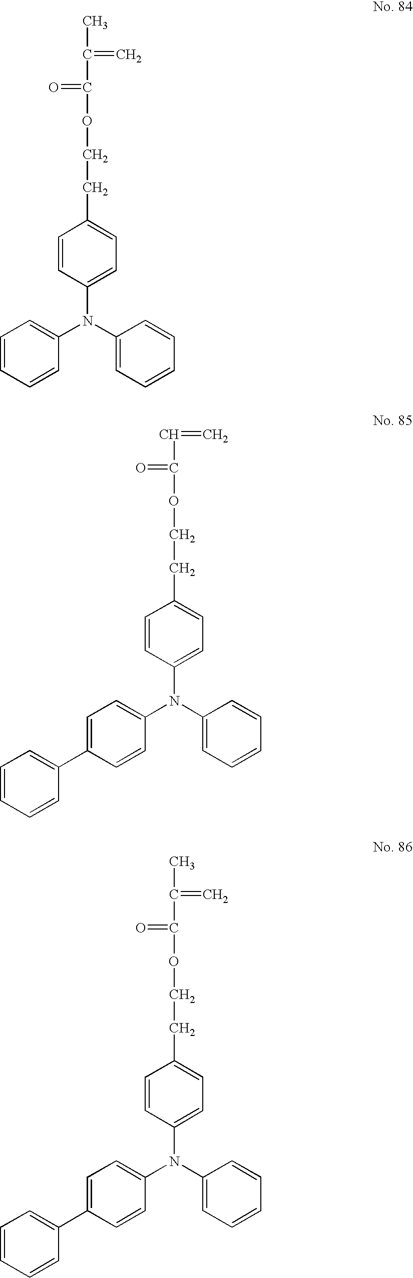

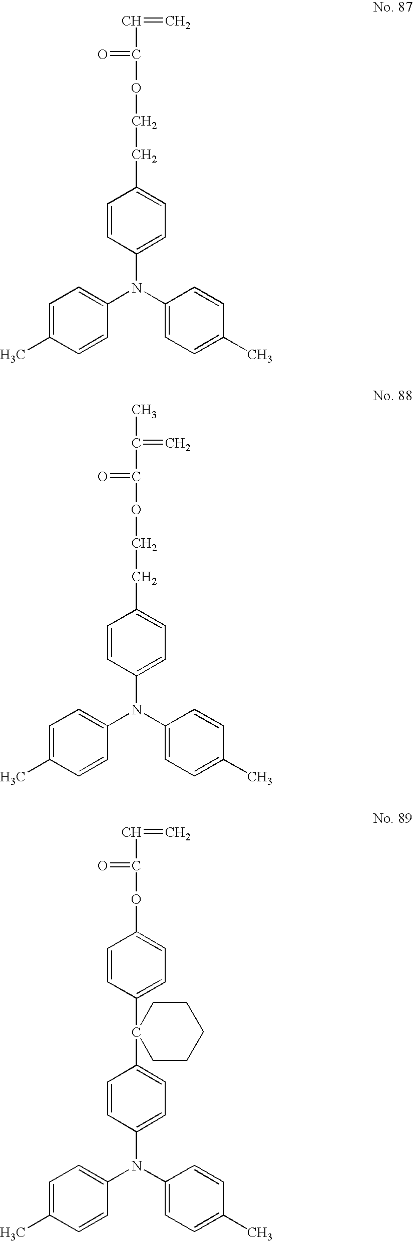

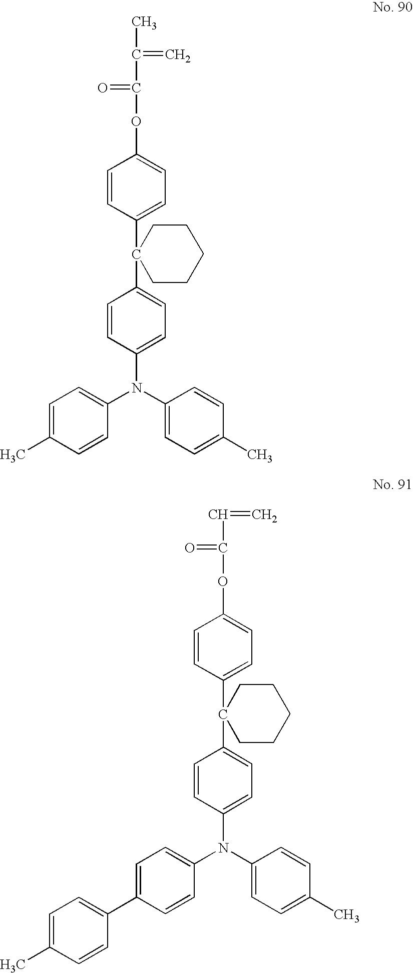

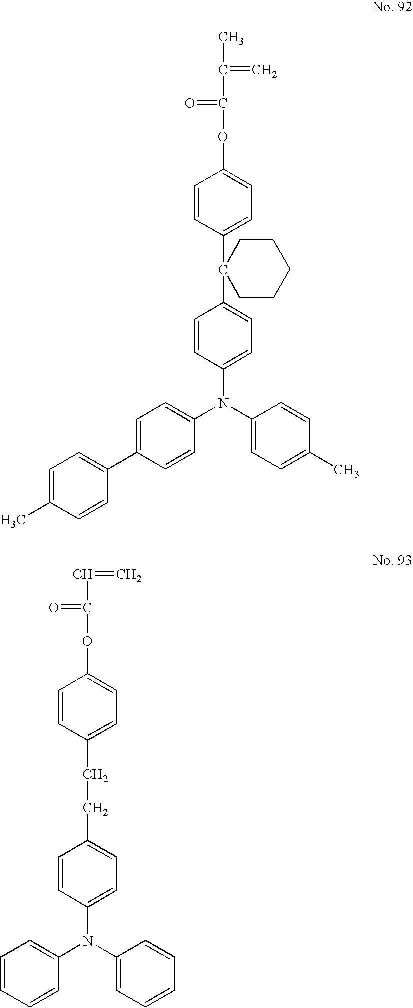

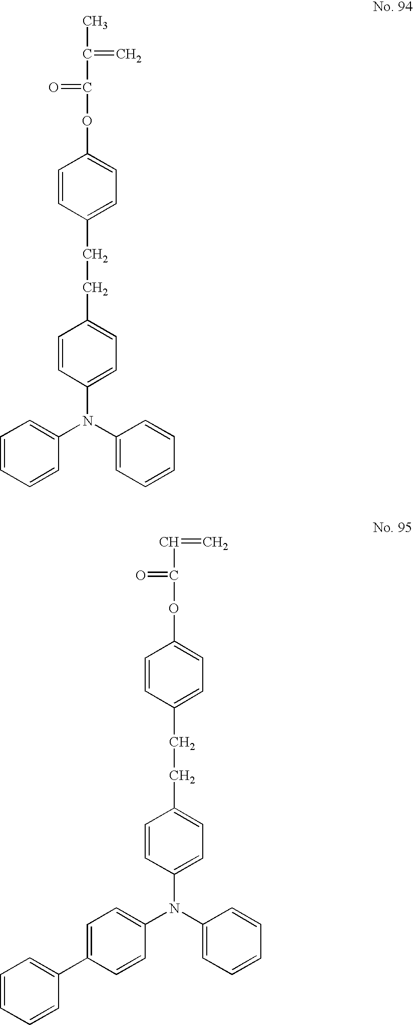

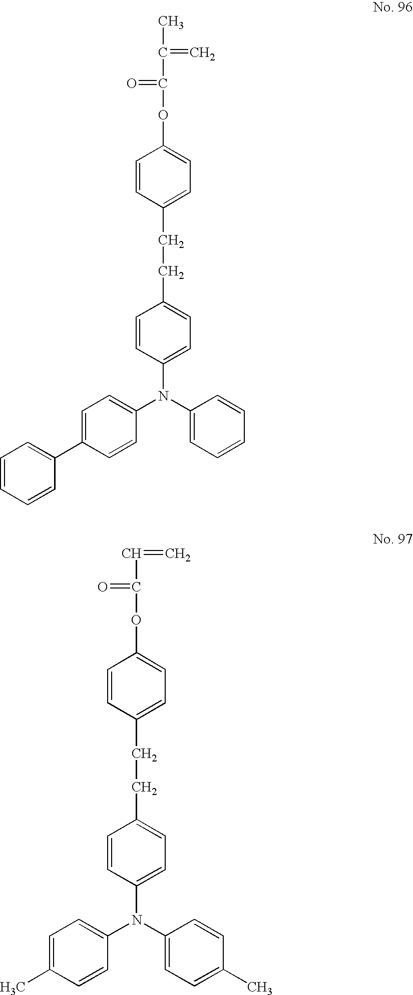

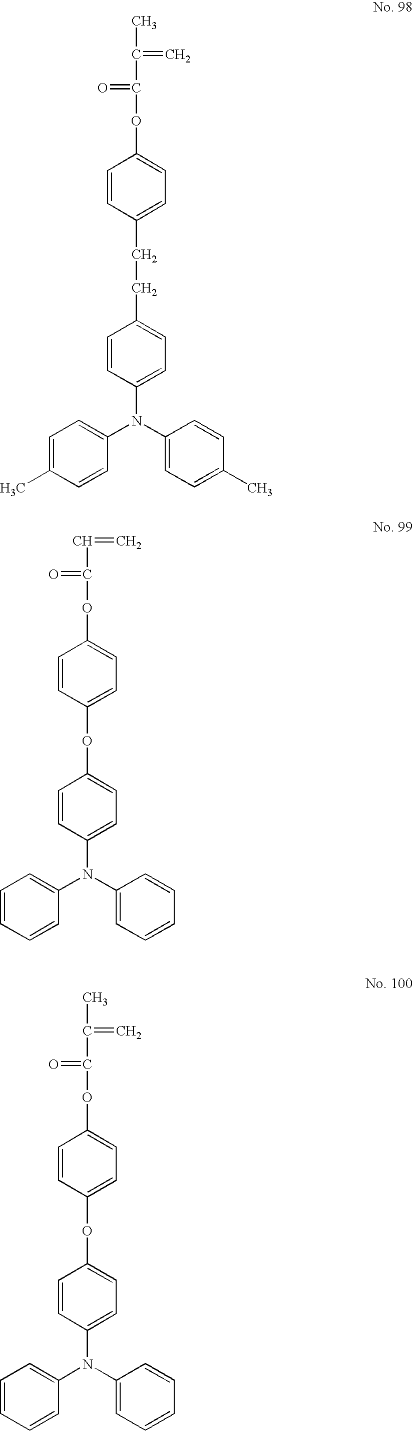

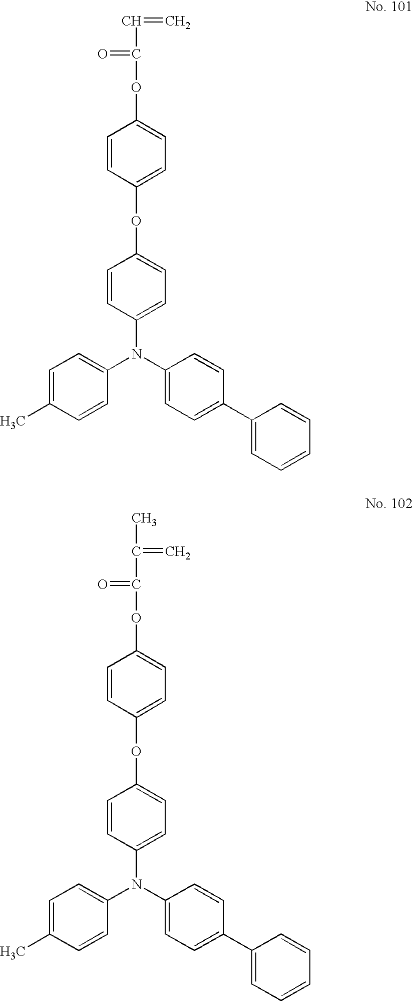

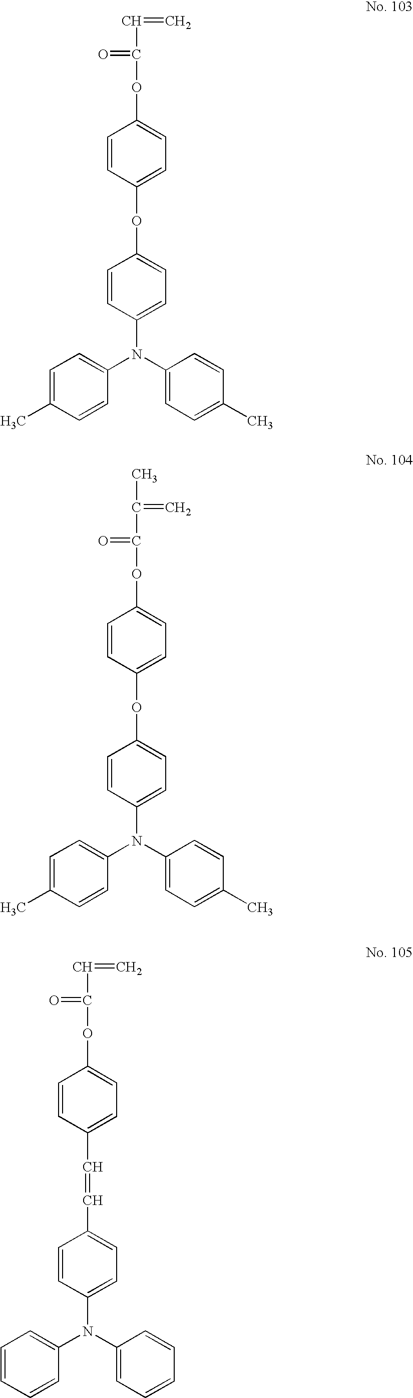

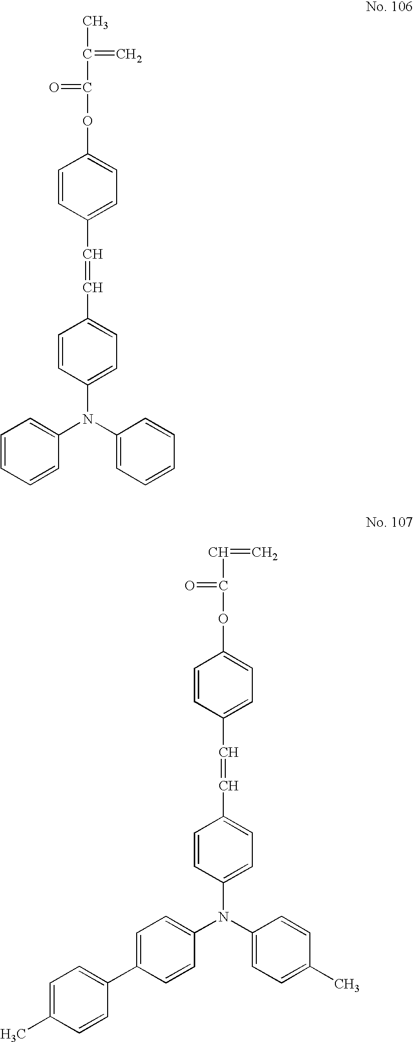

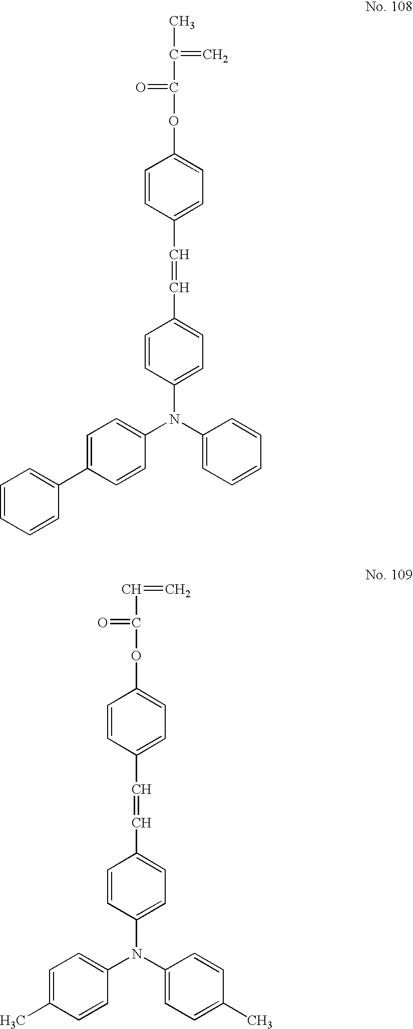

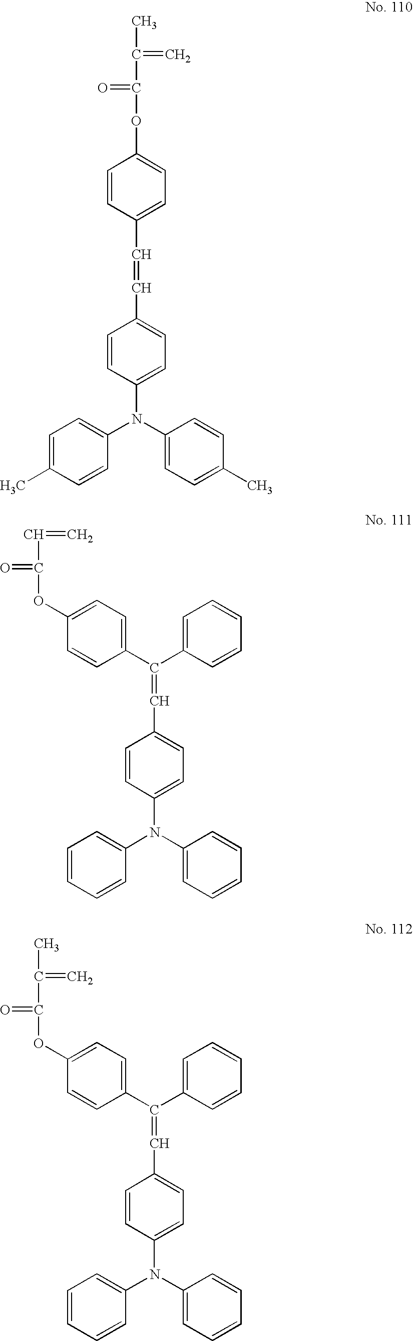

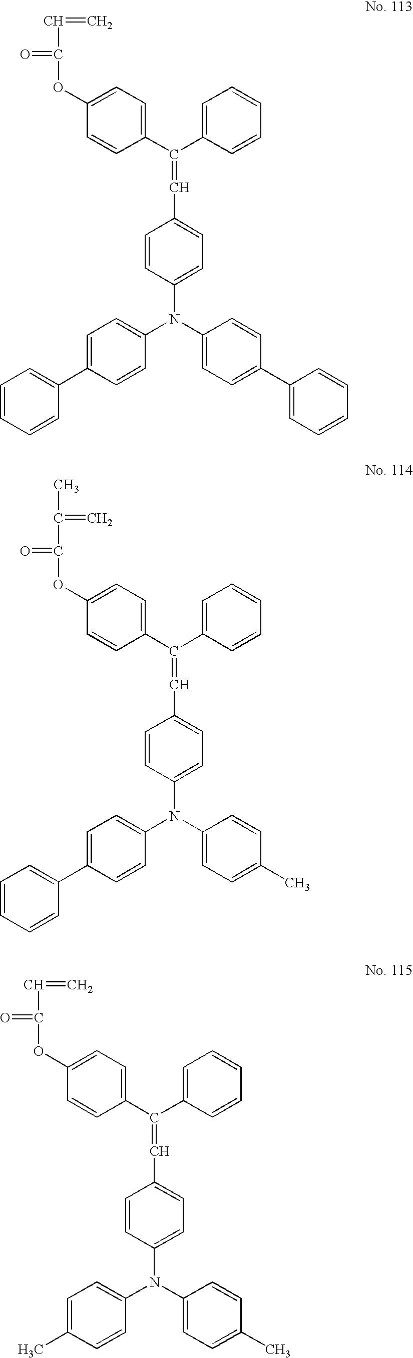

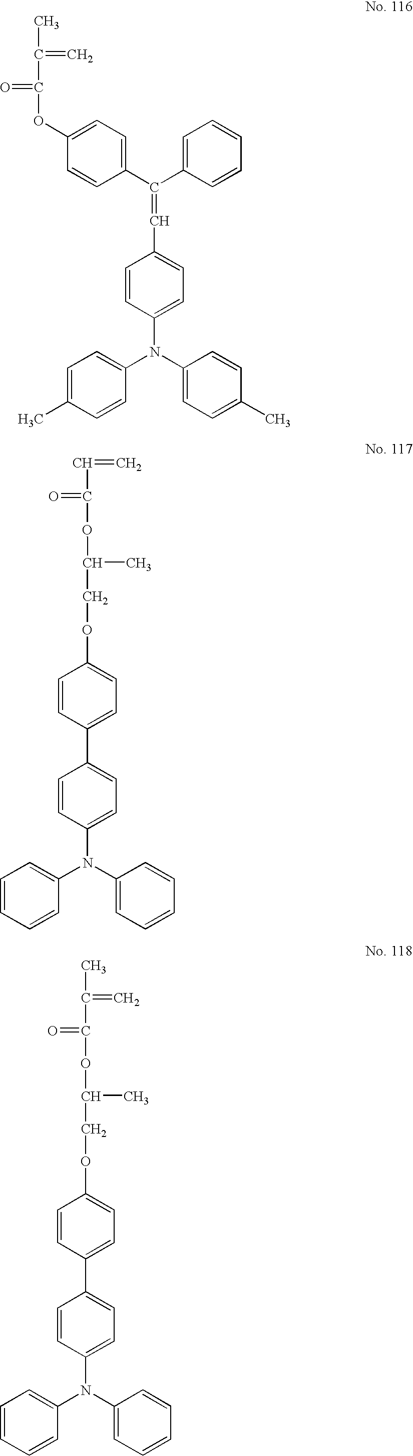

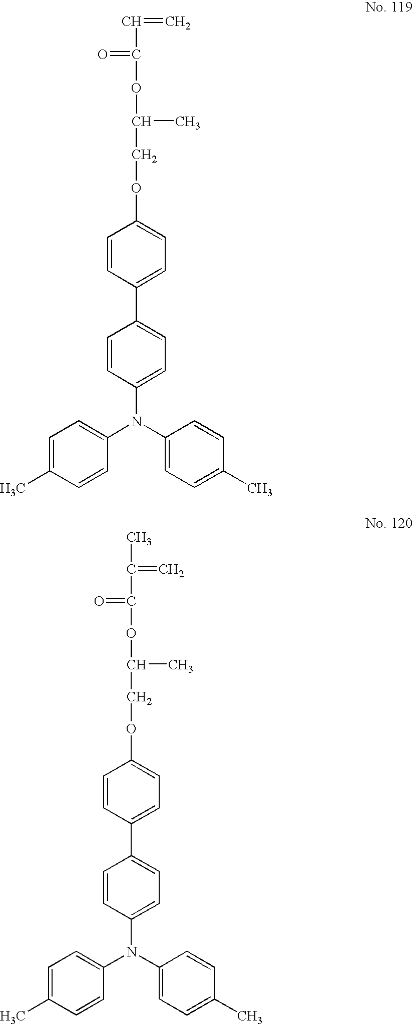

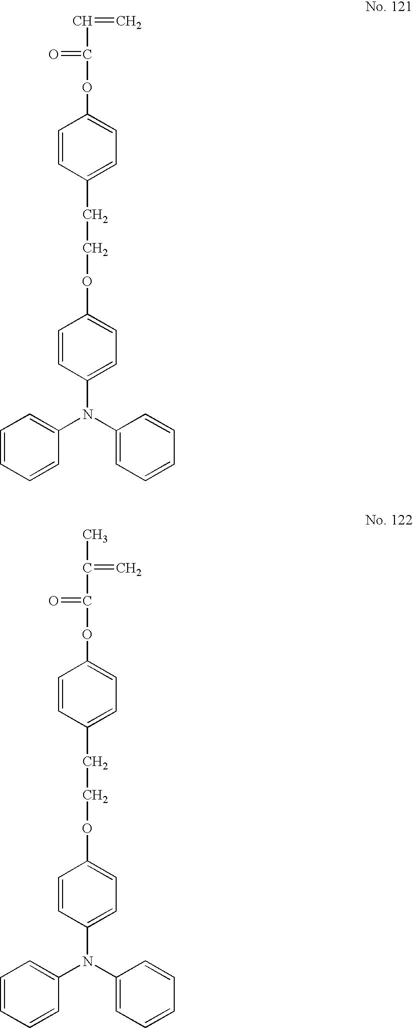

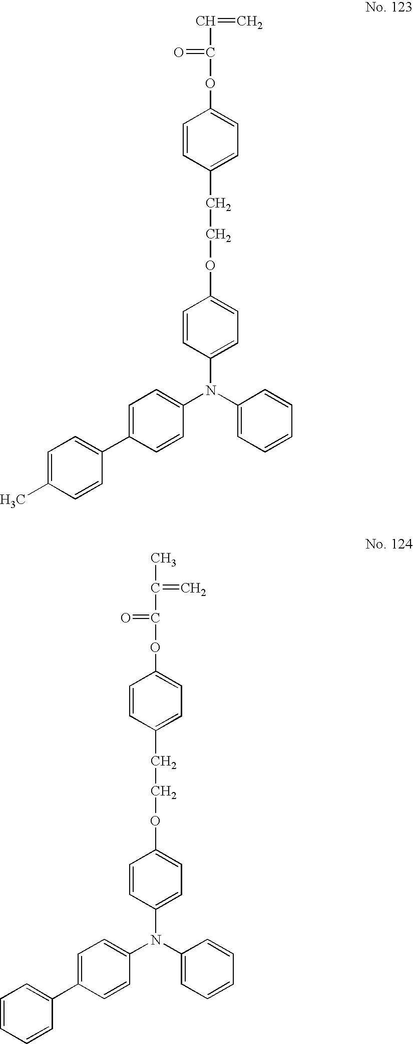

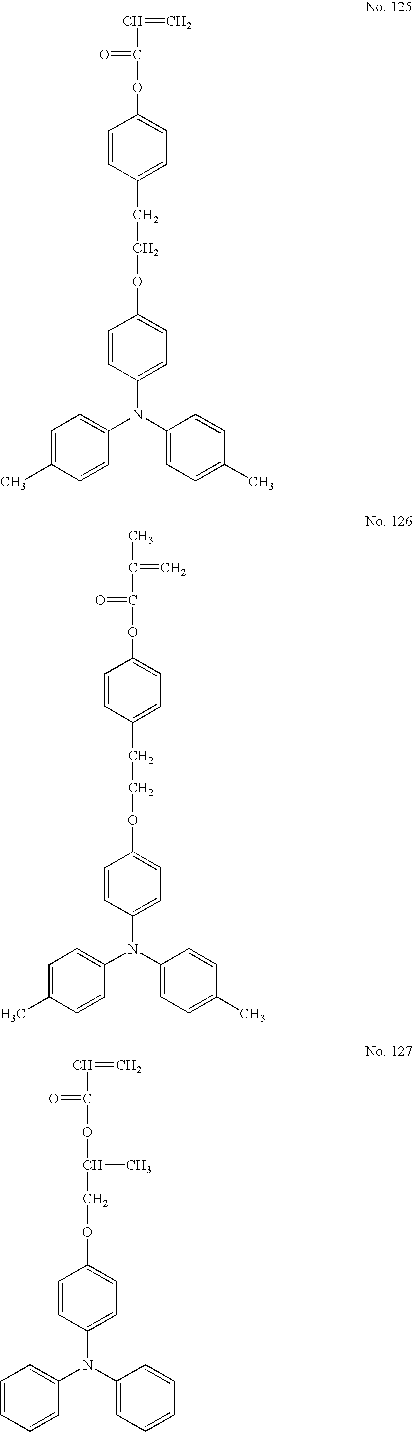

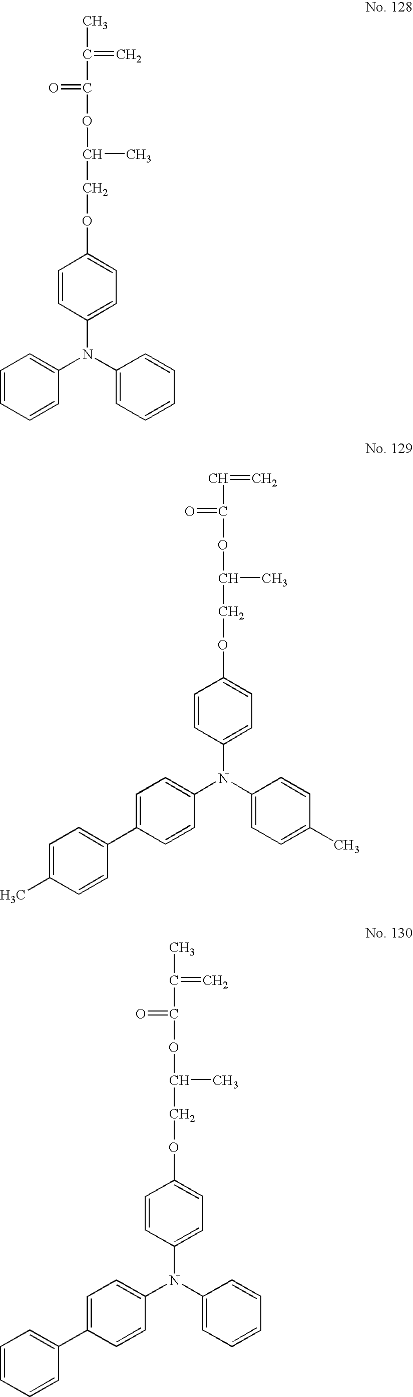

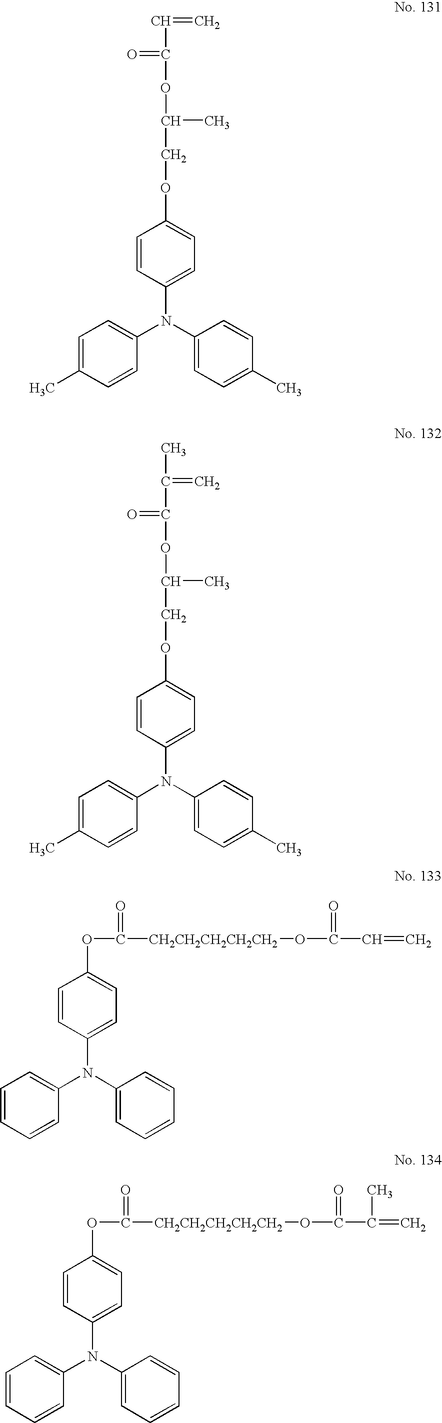

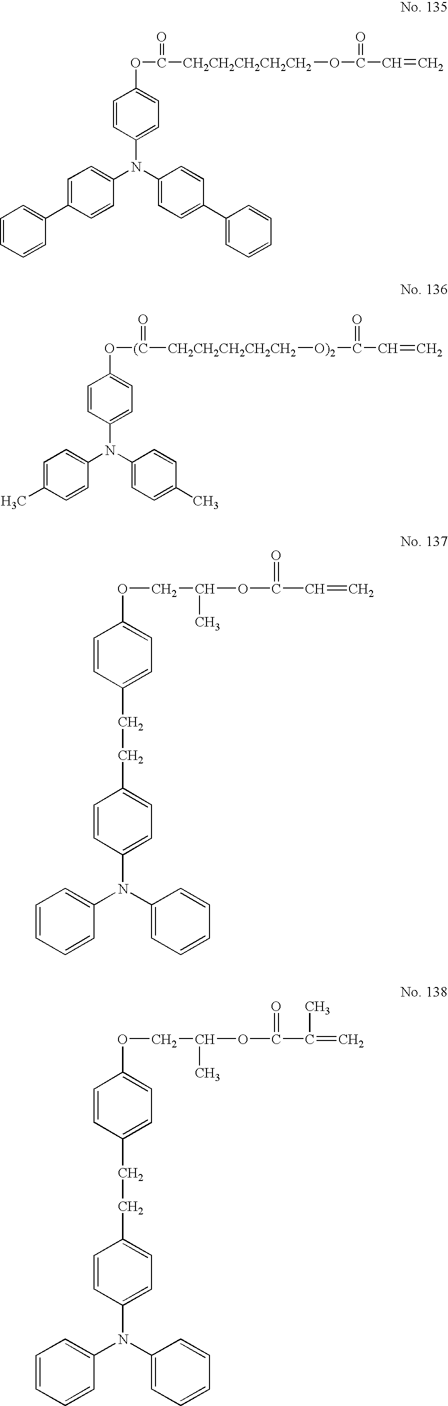

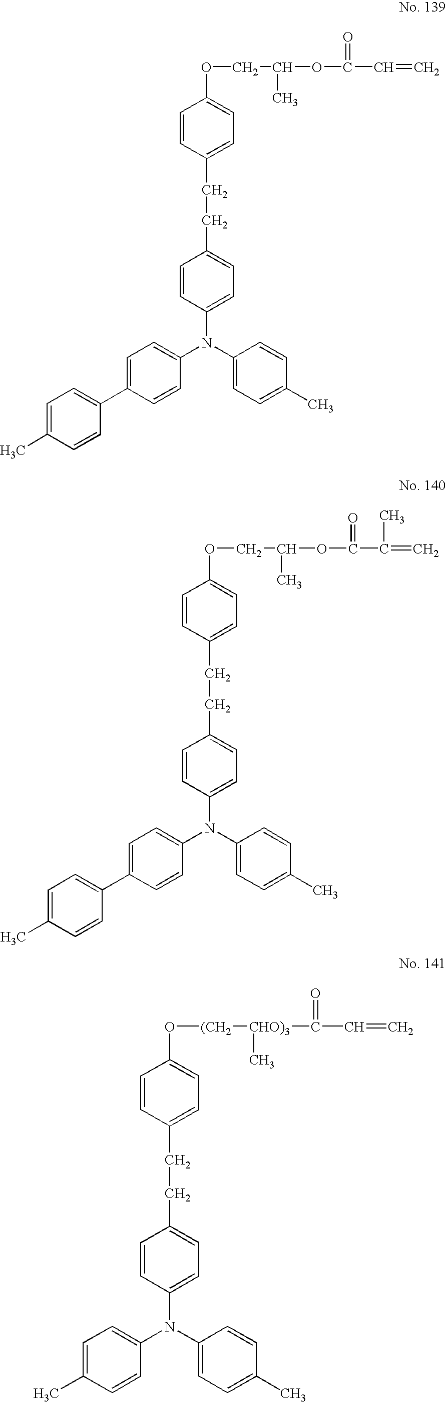

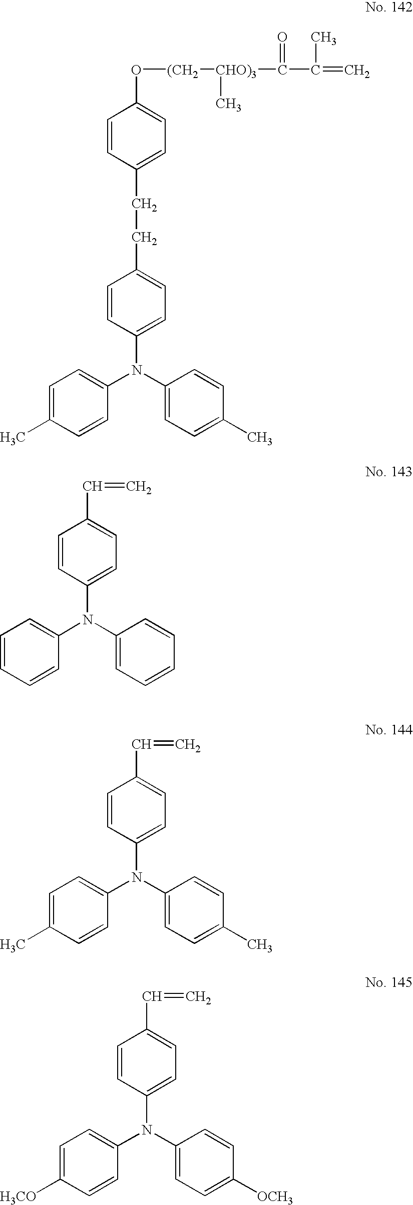

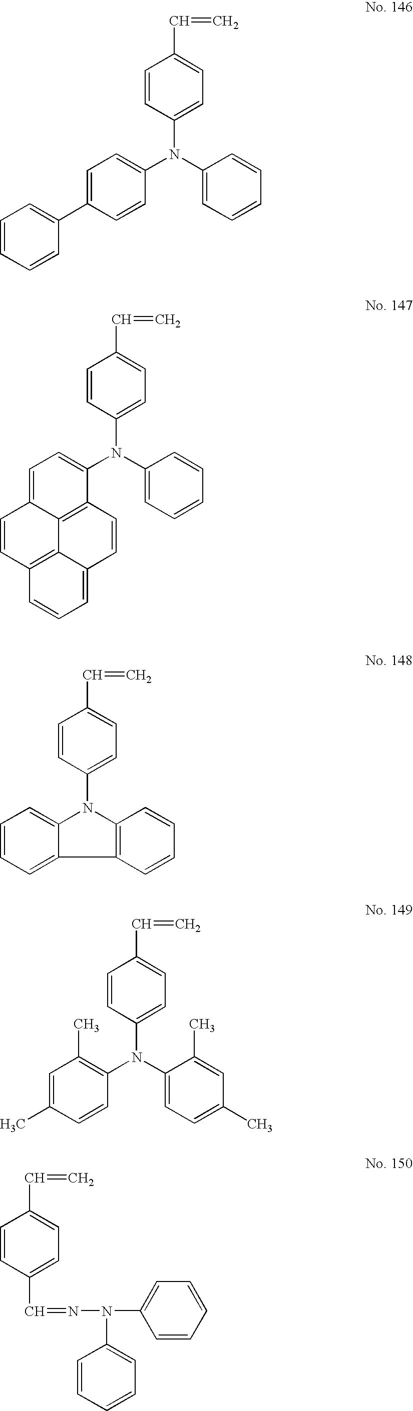

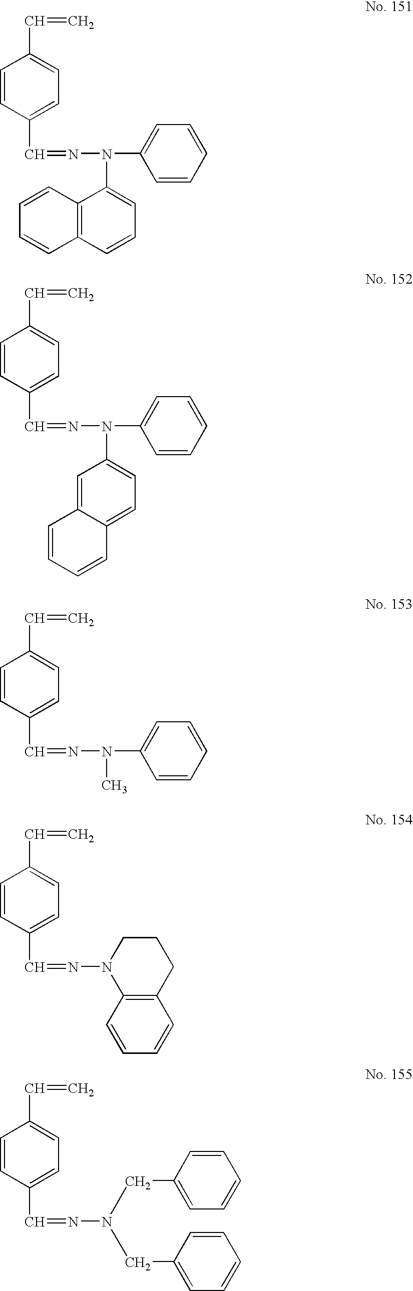

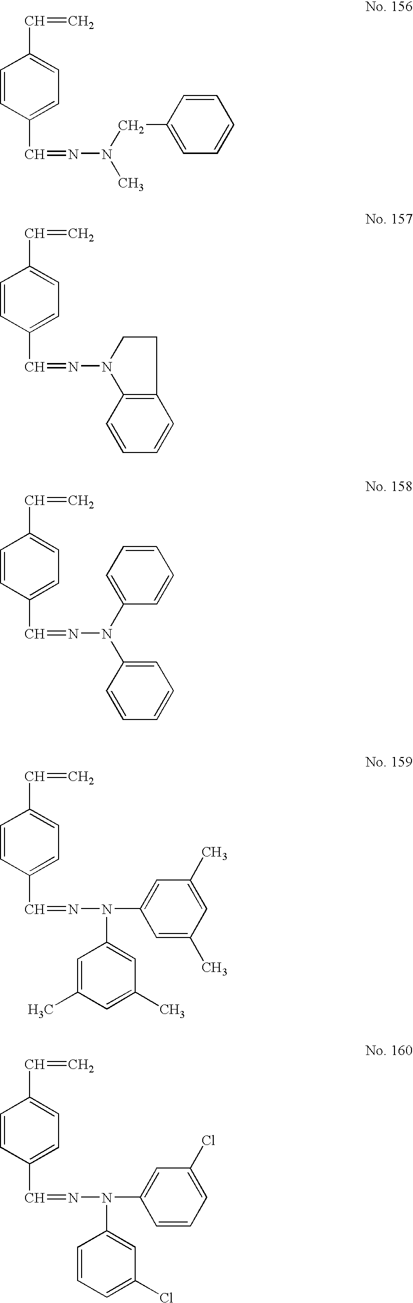

The polymerizable monofunctional compounds having a charge transport structure are used for imparting a charge transport property to the resultant protective layer. The added amount of such polymerizable monofunctional compounds is preferably from 20 to 80% by weight, and more preferably from 30 to 70% by weight, based on the total weight of the protective layer. When the added amount is too small, good charge transport property cannot be imparted to the resultant polymer, and thereby the electric properties (such as photosensitivity and residual potential) of the resultant photoreceptor are deteriorated. In contrast, when the added amount is too large, the crosslinking density of the resultant protective layer decreases, and thereby the abrasion resistance of the resultant photoreceptor is deteriorated. From this point of view, the added amount of the monofunctional compounds is from 30 to 70% by weight.

After the polymerizable compounds having a charge transport structure are crosslinked, the compounds (i.e., units in a crosslinked polymer) cannot be isolated. However, by using an analysis method such as FT-IR, the charge transport structure of the units can be determined. Therefore, the content of the compounds having a charge transport structure in the protective layer can be determined. Namely, charge transport materials dispersed in the form of molecules, charge transport units obtained from polymerizable compounds having a charge transport structure, and charge transport polymers included in the protective layer are considered as charge transport materials, as long as concentration thereof can be determined by such an analysis method as mentioned above.

The crosslinked protective layer is preferably prepared by reacting (crosslinking) at least a polymerizable tri- or more-functional monomer and a polymerizable monofunctional compound. However, in order to reduce the viscosity of the coating liquid, to relax the stress of the protective layer, and to reduce the surface energy and friction coefficient of the protective layer, known polymerizable mono- or di-functional monomers and oligomers having no charge transport structure can be used.

Specific examples of the polymerizable monofunctional monomers having no charge transport structure include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isostearyl acrylate, stearyl acrylate, styrene, etc.

Specific examples of the polymerizable di-functional monomers having no charge transport structure include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacryalte, neopentylglycol diacrylate, binsphenol A—ethyleneoxy-modified diacrylate, bisphenol F—ethyleneoxy-modified diacrylate, neopentylglycol diacryalte, etc.

Specific examples of the mon- or di-functional monomers for use in imparting a special function such as low surface energy and/or low friction coefficient to the crosslinked protective layer include fluorine-containing monomers such as octafluoropentyl acrylate, 2-perfluorooctylethyl acrylate, 2-perfluorooctylethyl methacrylate, and 2-perfluoroisononylethyl acrylate; and vinyl monomers, acrylates and methacrylates having a polysiloxane group such as siloxane units having a repeat number of from 20 to 70 which are described in JP-B 05-60503 and 06-45770 (e.g., acryloylpolydimethylsiloxaneethyl, methacryloylpolydimethylsiloxaneethyl, acryloylpolydimethylsiloxanepropyl, acryloylpolydimethylsiloxanebutyl, and diacryloylpolydimethylsiloxanediethyl).

Specific examples of the radical polymerizable oligomers include epoxyacryalte oligomers, urethane acrylate oligomers, polyester acrylate oligomers, etc.

In addition, in order to efficiently crosslink the protective layer, a polymerization initiator can be added to the protective layer coating liquid. Suitable polymerization initiators include heat polymerization initiators and photo polymerization initiators. The polymerization initiators can be used alone or in combination.

Specific examples of the heat polymerization initiators include peroxide initiators such as 2,5-dimethylhexane-2,5-dihydroperoxide, dicumyl peroxide, benzoyl peroxide, t-butylcumyl peroxide, 2,5-dimethyl-2,5-di(peroxybenzoyl)hexyne-3, di-t-butylperoxide, t-butylhydroperoxide, cumenehydroperoxide, lauroyl peroxide, and 2,2-bis(4,4-di-t-butylperoxycyclohexy)propane; and azo type initiators such as azobisisobutyronitrile, azobiscyclohexanecarbonitrile, azobisbutyric acid methyl ester, hydrochloric acid salt of azobisisobutylamidine, and 4,4′-azobis-cyanovaleric acid.

Specific examples of the photopolymerization initiators include acetophenone or ketal type photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoin ether type photopolymerization initiators such as benzoin, benzoin methyl ether, benzoin ethyl ether, benzoin isobutyl ether, and benzoin isopropyl ether; benzophenone type photopolymerization initiators such as benzophenone, 4-hydroxybenzophenone, o-benzoylbenzoic acid methyl ester, 2-benzoyl naphthalene, 4-benzoyl biphenyl, 4-benzoyl phenyl ether, acryalted benzophenone, and 1,4-benzoyl benzene; thioxanthone type photopolymerization initiators such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphineoxide, 2,4,6-trimethylbenzoylphenylethoxyphosphineoxide, bis(2,4,6-trimethylbenzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds, imidazole compounds, etc.

Photopolymerization accelerators can be used alone or in combination with the above-mentioned photopolymerization initiators. Specific examples of the photopolymerization accelerators include triethanolamine, methyldiethanolamine, ethyl 4-dimethylaminobenzoate, isoamyl 4-dimethylaminobenzoate, 2-dimethylaminoethyl benzoate, 4,4′-dimethylaminobenzophenone, etc.

The added amount of the polymerization initiators is preferably from 0.5 to 40 parts by weight, and more preferably from 1 to 20 parts by weight, per 100 parts by weight of the total weight of the polymerizable compounds used.

In order to relax the stress of the crosslinked protective layer and to improve the adhesion of the protective layer to the CTL, the protective layer coating liquid may include additives such as plasticizers, leveling agent, and low molecular weight charge transport materials having no radical polymerizability.

Specific examples of the plasticizers include known plasticizers for use in general resins, such as dibutyl phthalate, and dioctyl phthalate. The added amount of the plasticizers in the protective layer coating liquid is preferably not greater than 20% by weight, and more preferably not greater than 10% by weight, based on the total solid components included in the coating liquid.

Specific examples of the leveling agents include silicone oils (such as dimethylsilicone oils,and methylphenylsilicone oils), and polymers and oligomers having a perfluoroalkyl group in their side chains. The added amount of the leveling agents is preferably not greater than 3% by weight based on the total solid components included in the coating liquid.

The crosslinked protective layer of the photoreceptor can include a filler therein. By dispersing a filler in the crosslinked protective layer, the resistance of the layer to abrasion and scratches can be improved, resulting in improvement of the life of the image bearing member. Since the filler included in the crosslinked protective layer is hardly released therefrom, the life of the photoreceptor is much longer than that of photoreceptors having a protective layer including a thermoplastic resin and a filler. In addition, when a filler is included in the protective layer, the surface of the photoreceptor has a proper roughness, and thereby. occurrence of defective cleaning can be prevented. Further, a lubricant can be well coated on the surface of the crosslinked protective layer including a filler. By coating a lubricant on the surface of the protective layer, the behavior of the cleaning blade set on the protective layer can be stabilized. Therefore, the life of the photoreceptor can be extended and the photoreceptor can produce high quality images. Accordingly, the photoreceptor having a crosslinked protective layer including a filler is preferably used for the image forming apparatus of the present invention.

Specific examples of the fillers for use in the crosslinked protective layer include the fillers mentioned above for use in the filler-dispersed protective layer. Among the fillers, α-alumina is preferably used because the resultant photoreceptor has good combination of abrasion resistance and scratch resistance, and can stably produce high quality images. Similarly to the case of the filler-dispersed protective layer, the average primary particle diameter of the filler included in the crosslinked protective layer is preferably from 0.1 to 0.9 μm, and more preferably from 0.2 to 0.6 μm. The content of a filler in the crosslinked protective layer is preferably from 0.1 to 30% by weight, and more preferably from 5 to 20% by weight, based on the total weight of the solid components included in the protective layer. Since the crosslinked protective layer is typically crosslinked using ultraviolet light, it is preferable that the average primary particle diameter of the filler included in the protective layer is not larger than the necessary level, and the content of the filler is not higher than the necessary level.

The crosslinked protective layer is typically prepared by coating a coating liquid including a polymerizable compound having no charge transport structure and a polymerizable compound having a charge transport structure on the photosensitive layer or charge transport layer and then crosslinking the coated layer. When the polymerizable compounds are liquid, it is possible to dissolve other components (such as fillers) in the polymerizable compounds when preparing the protective layer coating liquid. The coating liquid can optionally include a solvent to well dissolve the other components and/or to reduce the viscosity of the coating liquid.

Specific examples of the solvents include alcohols such as methanol, ethanol, propanol, and butanol; ketones such as acetone, methyl ethyl ketone, methyl isobutyl ketone, and cyclohexanone; esters such as ethyl acetate, and butyl acetate; ethers such as tetrahydrofuran, dioxane, and propyl ether; halogenated solvents such as dichloromethane, dichloroethane, trichloroethane, and chlorobenzene; aromatic solvents such as benzene, toluene, and xylene; cellosolves such as methyl cellosolve, ethyl cellosolve and cellosolve acetate; etc. These solvents can be used alone or in combination. The added amount of a solvent is not particularly limited, and is determined depending on the solubility of the components, coating methods, and the target thickness of the protective layer. Suitable coating methods for use in coating the protective layer coating liquid include dip coating, spray coating, bead coating, and ring coating.

After a protective layer coating liquid is coated, an external energy is applied to the coated layer to form a crosslinked protective layer. In this regard, suitable external energy includes heat energy, light energy and radiation energy. When heat crosslinking is performed, methods in which the coated layer and/or the substrate supporting the coated layer are heated using a heated gas (such as air, nitrogen and steam), a heating medium, infrared rays or electromagnetic waves can be used. In this case, the temperature is preferably from 100 to 170° C. When the temperature is too low, the reaction speed is slow, and the crosslinking reaction is not completely performed. In contrast, when the temperature is too high, the crosslinking reaction unevenly proceeds, and thereby problems in that a large strain is formed in the resultant crosslinked protective layer; and a large number of unreacted functional groups (i.e., functional groups present at the ends of molecules) remain therein are caused. In order to prepare an evenly crosslinked protective layer, it is preferable to perform first heating at a relatively low temperature of lower than 100° C., followed by second heating at a relatively high temperature of not lower than 100° C.

When photocrosslinking is performed, light sources such as high pressure mercury lamps and metal halide lamps emitting UV light are preferably used. In this case, depending on the light absorption property of the polymerizable compounds and polymerization initiators, light source emitting visible light can also be used. The intensity of light is preferably from 50 mW/cm² to 1000 mW/cm². When the light intensity is too low, it takes a long time for crosslinking the protective layer. When the light intensity is too high, the crosslinking reaction unevenly proceeds, and thereby problems in that serious wrinkles are formed in the resultant crosslinked protective layer; and a large number of unreacted functional groups (i.e., functional groups present at the ends of molecules) remain therein are caused. In addition, due to rapid crosslinking, the internal stress increases in the resultant protective layer, and thereby problems in that cracks are formed in the layer, and the layer is peeled from the lower layer are caused.

When radiation crosslinking is performed, electron beams are typically used.

Among these crosslinking methods, heat crosslinking methods and photocrosslinking methods are preferably used because the reaction speed can be easily controlled and simple apparatus can be used therefor.

The crosslinked protective layer preferably has a thickness of from 1 to 10 μm, and more preferably from 2 to 8 μm. When the crosslinked protective layer is too thick, problems in that cracks are formed in the layer, and the layer is peeled from the lower layer are caused. When the thickness is not greater than 8 μm, the margin on prevention of the problems can be increased and thereby the crosslinking density can be enhanced. In addition, the margin on selection of the materials used for the protective layer and the margin for crosslinking conditions can be increased. On the other hand, polymerization reaction is easily influenced by oxygen. Specifically, there is a case where crosslinking of the surface of the coated protective layer exposed to the air is not well performed or is unevenly performed due to radical trapping caused by oxygen. Particularly, this phenomenon occurs in the outermost portion of the protective layer with a depth of about 1 μm. When the crosslinked protective layer has a thickness of less than 1 μm, the photoreceptor has poor abrasion resistance or causes uneven abrasion. In addition, when a protective layer coating liquid is coated on a photosensitive layer (or a charge transport layer), the components of the photosensitive layer (such as charge transport materials) are migrated into the protective layer. If the protective layer is too thin, the components are migrated into the entire protective layer, thereby causing problems in that the protective layer is not well crosslinked, and the crosslinking density decreases. Thus, when the crosslinked protective layer has a thickness of 1 μm, good resistance to abrasion and scratches can be imparted to the photoreceptor. However, when the protective layer having such a thickness is abraded after repeated use and a portion of the lower layer (such as charge transport layer) is exposed, the portion is seriously abraded, resulting in variation of charging property and photosensitivity, thereby forming half tone images having uneven image density. Therefore, the crosslinked protective layer preferably has a thickness of not less than 2 μm.

The photoreceptor for use in the image forming apparatus of the present invention preferably satisfies the following relationship (4):

T₁≧2T₂ (4),

wherein T₁ represents the thickness of the photosensitive layer or the charge transport layer of the photoreceptor in units of μm, and T₂ represents the thickness of the protective layer thereof in units of μm.

Satisfying relationship (4) is effective for preventing the first one-revolution charge problem, and stabilizing the electrostatic properties of the photoreceptors.

When a distyryl compound having formula (1), (2) or (3) is included in the photosensitive layer or the charge transport layer as a charge transport material, occurrence of the first one-revolution charge problem can be prevented and in addition the resultant photoreceptor can stably maintain good electrostatic properties. However, when such a distyl compound is included in the protective layer as a charge transport material, problems such that potential of the charged photoreceptor decreases and/or defective images (such as ghost images and background fouling) are produced tend to occur in an oxidizing atmosphere. One of the causes therefor is considered to be that the protective layer serving as an outermost layer is easily influenced by oxidizing gasses included in the atmosphere. It is possible to prevent occurrence of the problems by including one or more of the compounds having an alkylamino group and the antioxidants, which are mentioned above. However, it is more preferable to use a charge transport material having good resistance to oxidizing gasses for the protective layer.

In general, charge transport materials having a high charge transport property because of having a well-developed π-conjugation system have poor resistance to oxidizing gasses. In this case, when the thickness of the protective layer is increased to be greater than the necessary level in order to prevent occurrence of the problems in an oxidizing atmosphere, the charges injected into the charge transport layer are also injected into the protective layer, thereby extending the transit time (i.e., the time needed for the charges to reach the surface of the photoreceptor). Therefore, the effects of the present invention can be hardly produced. Therefore, the photoreceptor preferably satisfies the above-mentioned relationship (4) in order to produce the effects of the present invention.

When the photoreceptor of the image forming apparatus of the present invention has a layer structure such that a charge generation layer, a charge transport layer and a crosslinked protective layer are overlaid on a substrate in this order and the crosslinked protective layer is insoluble in organic solvents or has good resistance thereto, the photoreceptor has excellent resistance to abrasion and scratches. The method for determining whether the outermost layer of a photoreceptor is insoluble in organic solvents or has good resistance thereto is as follows.
(1) An organic solvent having high dissolving property such as tetrahydrofuran and dichloromethane is dropped on the surface of a photoreceptor; and
(2) after naturally drying the organic solvent, the portion of the surface of the photoreceptor receiving the drop of the solvent is observed with a stereo microscope.

If the outermost layer of the photoreceptor has poor resistance to the solvent, the surface is changed as follows.
1) The center of the drop receiving portion is recessed and in addition the portion surrounding the center is projected;
2) The charge transport material included in the outermost layer is precipitated on the surface and the surface looks opaque or tarnishes; and/or
3) Wrinkles are formed on the surface due to swelling of the surface, followed by shrinkage after drying.

When the outermost layer has good resistance to the solvent, the surface is not changed after the solvent is dropped and then dried.

In order to prepare a crosslinked protective layer having good resistance to organic solvents, the following is key factors:
1) Components of the protective layer coating liquid, and formulation of the coating liquid (i.e., mixing ratio of the components);
2) Solvents used for preparing the protective layer coating liquid, and solid content of the coating liquid;
3) Method used for coating the protective layer coating liquid; and
4) Crosslinking conditions for the protective layer.

It is preferable to control two or more of the factors 1) to 4).

When a large amount of auxiliary components (such as binder resins having no polymerizable functional group, and additives such as antioxidants and plasticizers) other than polymerizable compounds having no charge transport structure and polymerizable compounds having a charge transport structure are included in the protective layer coating liquid, problems such that the crosslinking density of the protective layer decreases, and/or the phase of the crosslinked material is separated from the phase including the auxiliary components, resulting in deterioration of the resistance to organic solvents (i.e., resulting in increase of solubility of the protective layer in organic solvents). Therefore, it is preferable that the content of such auxiliary components as mentioned above is not greater than 20% by weight based on the total weight of the protective layer. In addition, in order not to decrease the crosslinking density of the protective layer, the amount of the total of mono- or di-functional monomers, reactive oligomers and reactive polymers added to the protective layer coating liquid is preferably not greater than 20% by weight based on the polymerizable compounds having three or more functional groups added to the coating liquid.

Further, when a large amount of di- or more-functional polymerizable compounds having a charge transport structure is included in the protective layer coating liquid, the bulky groups are fixed in the crosslinked structure with plural bonds, thereby distorting the protective layer, resulting in formation of aggregation of micro crosslinked materials. In this case, the crosslinked protective layer tends to be soluble in organic solvents. Therefore, the content of di- or more-functional polymerizable compounds having a charge transport structure in the protective layer coating liquid is preferably not greater than 10% by weight based on the total weight of the monofunctional polymerizable compounds having a charge transport structure included in the protective layer coating liquid, although the content is changed depending on the structure of the di- or more-functional polymerizable compounds.

When the solvent used for the protective layer coating liquid has too low evaporation speed, the solvent remaining in the protective layer even after drying adversely affects crosslinking and/or a problem in that a large amount of the components included in the lower layer are migrated into the protective layer tends to occur. In this case, the resultant protective layer becomes soluble in organic solvents. Therefore, tetrahydrofuran, mixture solvents of tetrahydrofuran and methanol, ethyl acetate, methyl ethyl ketone and ethyl cellosolve are preferably used as the solvent. One or more proper solvents are selected and used while considering the coating method used.

Similarly, when the solid content of the protective layer coating liquid is too low, the resultant protective layer tends to become soluble in organic solvents. It is preferable to determine the solid content in consideration of the target thickness of the protective layer and the target viscosity of the protective layer coating liquid, and the solid content is preferably from 10 to 50% by weight. In order to prepare a well-crosslinked protective layer, the amount of the solvent used for the protective layer coating liquid is as small as possible and the time period during which the solvent included in the coating liquid is contacted with the lower layer is as short as possible. From this point of view, spray coating methods and ring coating methods in which the amount of the applied coating liquid is controlled to be small can be preferably used.

In addition, in order to decrease the amount of the components migrated into the protective layer from the lower layer, it is preferable to use a charge transport polymer for the photosensitive layer or the charge transport layer on which the protective layer is formed or to form an intermediate layer insoluble in the solvent used for the protective layer coating liquid between the protective layer and the lower layer.

In the crosslinking process, when the heat or light energy applied to crosslink the protective layer is too low, the protective layer is not completely crosslinked and thereby the solubility of the protective layer in solvent is increased. In contrast, when the heat or light energy is too high, uneven crosslinking is performed, resulting in increase of un-crosslinked portions or portions at which radicals are terminated, or resulting in formation of aggregation of micro crosslinked materials. In these cases, the resultant protective layer is soluble in organic solvents.

In order to prepare a crosslinked protective layer insoluble in organic solvents, the heating temperature is preferably from 100 to 170° C., and the heating time is preferably from 10 minutes to 3 hours when a heat crosslinking method is used. When an ultraviolet light crosslinking method is used, it is preferable that the intensity of light is from 50 to 1000 mW/cm², the irradiating time is from 5 seconds to 5 minutes, and the temperature is controlled so as not to increase by 50° C. or more, to prevent occurrence of an uneven crosslinking reaction.

One method for preparing a crosslinked protective layer insoluble in organic solvents will be explained.

When an acrylate monomer having three acryloyloxy groups serving as a polymerizable compound having no charge transport structure and a triarylamine compound having one acryloyloxy group serving as a polymerizable compound having a charge transport structure are used, the mixing ratio thereof is from 7/3 to 3/7 by weight. When a polymerization initiator is used, the initiator is added to the mixture of the acrylate compounds and a solvent in an amount is from 3 to 20% by weight based on the total weight of the acrylate compounds. When the thus prepared protective layer coating liquid is coated on a charge transport layer including a triarylamine compound serving as a charge transport material and a polycarbonate resin serving as a binder resin, the solvent of the protective layer is preferably tetrahydrofuran, 2-butanone or ethyl acetate. The added amount of the solvent is preferably from 3 to 10 times the total weight of the acrylate compounds.

For example, an undercoat layer, a charge generation layer and the charge transport layer are overlaid on an aluminum cylinder serving as an electroconductive substrate in this order. Next, the above-prepared protective layer coating liquid is coated on the charge transport layer by a spray coating method, followed by natural drying or drying at a relatively low temperature of from 25 to 80° C. for a relatively short drying time of from 1 to 10 minutes. Thereafter, the dried protective layer is exposed to UV light or heated to be crosslinked.

When UV light crosslinking is performed, metal halide lamps, etc., are used. The intensity of UV light is preferably from 50 mW/cm² to 1006 mW/cm². The irradiating time is preferably from 5 seconds to 5 minutes. In this case, the temperature of the aluminum cylinder is preferably controlled so as not to exceed 50° C.

When heat crosslinking is performed, the heating temperature is preferably from 100 to 170° C. When an oven with a fan is used as a heater, and the temperature is set to 150° C., the heating time is preferably from 20 minutes to 3 hours.

After crosslinking is performed, the aluminum cylinder having the layers thereon is further heated for 10 minute to 30 minutes at a temperature of from 100 to 150° C. to remove the solvent remaining in the protective layer. Thus, a photoreceptor for use as the image bearing member of the image forming apparatus of the present invention is prepared.

Next, a case where a polyurethane resin is used as a crosslinked resin of the crosslinked protective layer will be explained.

Any known crosslinking polyurethane resins, which typically have a good abrasion resistance, can be used for the crosslinked protective layer. Since urethane resins have a good combination of abrasion resistance, electrostatic properties and film properties, the resins can be preferably used for preparing a photoreceptor having high durability and capable of producing high quality images.

Urethane resins can be prepared by reacting a polyol having an active hydrogen atom and a polyisocyanate serving as a crosslinking agent. Specific examples of the polyol include polyether polyols such as polyalkylenoxides, polyester polyols such as aliphatic polyesters having a hydroxyl group at the end thereof, acrylic polymer based polyols such as hydroxymethacrylate copolymers, epoxy polyols such as epoxy resins, fluorine-containing polyols, polycarbonate diols having a polycarbonate skeleton, etc. The technique, which is disclosed in Japanese patent No. 3818584 and which uses a polyol having a hindered amine skeleton to prevent deterioration of the crosslinked resin and deterioration of resolution of images produced by the photoreceptor, can be preferably used for the photoreceptor of the image forming apparatus of the present invention. It is well known that hindered amines serve as light stabilizers or antioxidants. By crosslinking a polyol having such a hindered amine structure, the structure can be incorporated in the resultant crosslinked resin, thereby stabilizing the crosslinked resin. In this regard, the polyols having such a hindered amine structure can be used alone or in combination. One example of the hindered amine structure is as follows.

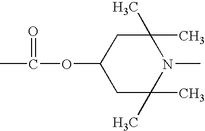

The above-mentioned polyols preferably have two or more functional groups, and more preferably have three or more functional groups because the crosslinking density increases, and a strong three dimensional network can be formed, resulting in formation of a protective layer having a high strength. The molecular weight of the polyol used for forming the protective layer is typically from 100 to 150. However, depending on the crosslinking conditions, large volume contraction is caused, thereby deteriorating the film properties of the protective layer. In order to prevent occurrence of such a problem, Japanese patent No. 3818585 discloses a technique in that another polyol having a molecular weight of not less than 1000 is included to be crosslinked. This technique can be preferably used for the photoreceptor of the image forming apparatus of the present invention.

Any known polyisocyanates can be used as crosslinking agents for forming the crosslinked protective layer. However, it is preferable that the resultant crosslinked polyurethane resin does not change color even after long repeated use to prevent change of photosensitivity of the photoreceptor.

Specific examples of such preferable polyisocyanates include isocyanate compounds such as tolylene diisocyanate (TDI), diphenylmethan diisocyanate (MDI), xylene diisocyanate (XDI), hexamethylene diisocyanate (HDI), isophorone diisocyanate (IPDI), bis(isocyanatemethyl)cyclohexane (HXDI), and trimethylhexamethylne diisocyanate (TMDI); other polyisocyante compounds such as HDI-trimethylolpropane adduct materials, HDI-isocyanate materials, HDI-biuret materials, XDI-trimethylolpropane adduct materials, IPDI-trimethylolpropane adduct materials, and IPDI-isocyanurate materials; etc. Specific examples of the isocyanates having an amino bond include HDI-trimethylol propane adduct materials, IPDI-trimethylol propane adduct materials, HDI-buret materials, etc. These polyisocyanates can be used alone or in combination.

The ratio (NCO/OH) of the number of isocyanate groups included in the isocyanate used to the number of hydroxyl groups included in the polyol used is preferably from 1.0 to 1.5.

Known reactive compounds having both a charge transport structure such as the above-mentioned charge transport structures and a functional group capable of performing a crosslinking reaction together with a polyol and an isocyanate can be used for preparing the crosslinked urethane protective layer. With respect to the charge transport structure, the reactive compounds have a hole transport property and/or an electron transport property, but preferably have a triarylamine structure. The functional group capable of performing a crosslinking reaction is preferably hydroxyl group. Specific examples of the reactive compounds having a triphenyl amine structure are as follows.

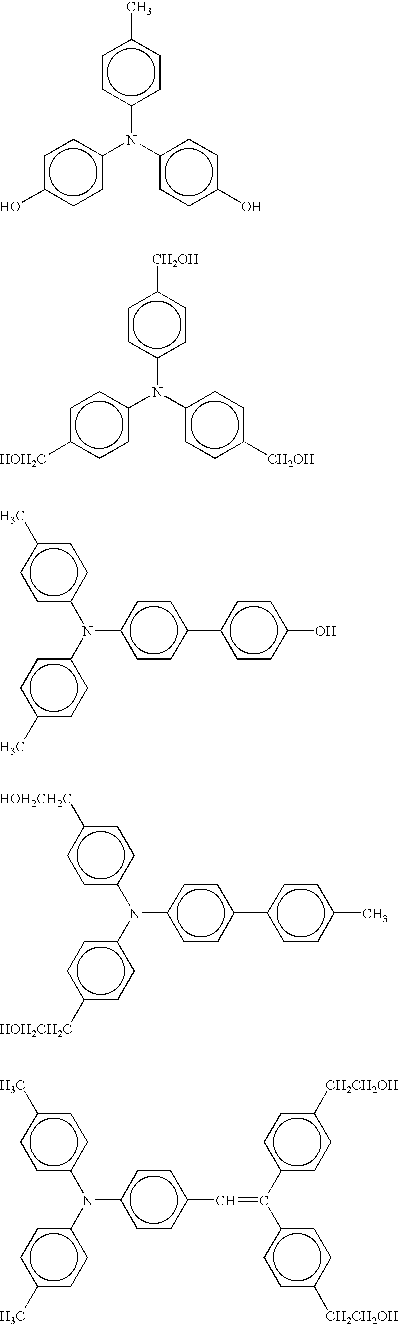

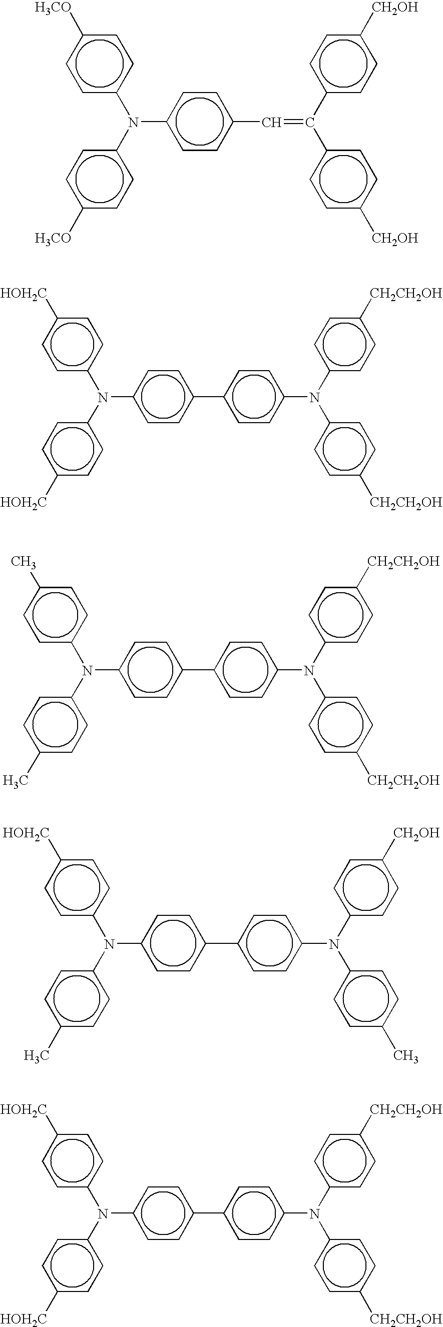

Next, a case where a polysiloxane resin is used as a crosslinked resin of the crosslinked protective layer will be explained.

Any known crosslinking polysiloxane resins can be used for the crosslinked protective layer. Since polysiloxane resins have good abrasion resistance, the resins can be preferably used for the crosslinked protective layer.

Crosslinked polysiloxane resins can be prepared by subjecting a monomer, oligomer or a polymer having a siloxane bond to a reaction (such as hydrolysis reactions and reactions using a catalyst or a crosslinking agent), resulting in formation of three dimensional network (i.e., resulting in crosslinking). It is typical that an organic silicon compound having a siloxane bond is subjected to a hydrolysis reaction, followed by a dehydration/condensation reaction to prepare a crosslinked polysiloxane resin having a three dimensional network structure. For example, a composition including an alkoxysilane compound or a combination of an alkoxysilane compound and a colloidal silica is subjected to a condensation reaction to form a crosslinked resin layer having a three dimensional network structure.

Suitable organic silicon compounds for use in preparing such a crosslinked polysiloxane resin layer include organic silicon compounds having a hydroxyl group or a group capable of performing hydrolysis. Specific examples of the group capable of performing hydrolysis include methoxy, ethoxy, methyl ethyl ketoxime, diethylamino, acetoxy, propenoxy, propoxy, butoxy, methoxyethoxy groups, etc. Among the groups, groups having a formula —OR are preferable, wherein R is an atom group constituting an alkoxyl group and has 1 to 6 carbon atoms.

The reactivity of organic silicon compounds used for preparing crosslinked siloxane resins changes depending on the number of the groups capable of performing hydrolysis, which are connected with the silicon atom. When the number of such groups is one, the crosslinking density is low (i.e., the crosslinking reaction is insufficiently performed). Namely, the polymerization reaction of the organic silicon compound is not well performed. When the number of the groups capable of performing hydrolysis is 2, 3 or 4, the polymerization reaction (crosslinking reaction) is well performed. Particularly, when the number is 3 or 4, the crosslinking reaction is highly performed. However, in this case, the resultant resin layer tends to be brittle although the layer has good hardness. Therefore, it is preferable to use a mixture of a compound having a small number of groups capable of performing hydrolysis and a compound having a large number of groups capable of performing hydrolysis. In addition, it is possible to use silicon oligomers prepared by subjecting an organic silicon compound to hydrolysis under an acidic or basic condition.

Known reactive compounds having both a charge transport structure and a functional group capable of performing a crosslinking reaction together with a siloxane resin can be used for forming a crosslinked polysiloxane protective layer. With respect to the charge transport structure, the reactive compounds have a hole transport property and/or an electron transport property, but preferably have a triaryl amine structure. Specific examples of the functional group capable of performing a crosslinking reaction include hydroxyl, amino, mercapto, and alkoxysilyl groups.

Next, a case where a phenolic resin is used as a crosslinked resin of the crosslinked protective layer will be explained.

Any known crosslinking phenolic resins can be used for the crosslinked protective layer. Since phenolic resins have good abrasion resistance, the resins can be preferably used for the crosslinked protective layer.

Crosslinked phenolic resins can be prepared by reacting a phenolic compound with an aldehyde. Phenolic resins are broadly classified into resole resins, which are prepared by reacting a phenolic compound with an excessive amount of formaldehyde using an alkaline catalyst; and novolac resins, which are prepared by reacting an excessive amount of phenolic compound with formaldehyde using an acidic catalyst.

Resole resins are soluble in solvents such as alcohols and ketones. When resole resins are heated, the resins perform three dimensional crosslinking and form crosslinked materials. In contrast, when novolac resins are heated, the resins do not perform crosslinking. However, when heated together with a formaldehyde generating material such as paraformaldehyde and hexamethylenetetramide, the novolac resins perform crosslinking and form crosslinked materials.

When preparing the crosslinked phenolic resin protective layer, both resole resins and novolac resins can be used. However, resole resins are preferably used because of having advantages such that crosslinking can be performed without using a crosslinking agent, and the coating liquid has good handling property because of being a single-liquid type coating liquid. For example, a crosslinked phenolic resin protective layer is prepared by coating a coating liquid, which is prepared by dissolving one or more resole resins in a solvent such as alcohols and ketones, and then heating the coated liquid to perform three dimensional crosslinking. It is possible to use a mixture of a resole resin and a novolac resin for preparing a crosslinked phenolic resin protective layer.

Known reactive compounds having both a charge transport structure and a functional group capable of performing a crosslinking reaction together with a phenolic resin can be used for forming a crosslinked phenolic resin protective layer. With respect to the charge transport structure, the reactive compounds have a hole transport property and/or an electron transport property, but preferably have a triaryl amine structure. Specific examples of the functional group capable of performing a crosslinking reaction include hydroxyl, carboxyl, alkoxysilyl, epoxy, carbonate, thiol and amino groups.

Next, a case where an epoxy resin is used as a crosslinked resin of the crosslinked protective layer will be explained.

Epoxy resins are broadly classified into bisphenol A form epoxy resins, bisphenol F form epoxy resins, bisphenol AD form epoxy resins, bromine-containing epoxy resins, novolac epoxy resins, cyclic aliphatic epoxy resins, glycidylacyl type resins, and heterocyclic epoxy resins. All these epoxy resins can be used for preparing the crosslinked epoxy protective layer. Suitable crosslinking agents for use in crosslinking epoxy resins include anhydrides (such as phthalic anhydride, tetrahydrophthalic anhydride, hexahydrophthalic anhydride, methyltetrahydrophthalic anhydride, succinic anhydride, maleic anhydride, pyromellitic anhydride, and trimellitic anhydride), acyl type crosslinking agents (such as aliphatic amines, aromatic primary amines, aromatic tertiary amines and modified polyamines), dicyanediamide, organic acid dihydrazide, etc.

Known reactive compounds having both a charge transport structure and a functional group capable of performing a crosslinking reaction together with an epoxy resin can be used for forming a crosslinked epoxy resin protective layer. With respect to the charge transport structure, the reactive compounds have a hole transport property and/or an electron transport property, but preferably have a triaryl amine structure. Specific examples of the functional group capable of performing a crosslinking reaction include hydroxylalkyl, hydroxyalkoxy, hydroxyalkylthio, and substituted or unsubstituted hydroxypheyl groups.

As mentioned above, various crosslinking resins can be used for the protective layer, but the crosslinked protective layer is not limited thereto. Any known crosslinking resins can be used for the protective layer.

The photoreceptor of the image forming apparatus of the present invention can include an undercoat layer between the electroconductive substrate and the photosensitive layer (or charge generation layer). The undercoat layer includes a resin as a main component. Since the upper layer (such as the photosensitive layer or charge generation layer) is formed on the undercoat layer typically by coating a liquid including an organic solvent, the resin in the undercoat layer preferably has good resistance to general organic solvents.

Specific examples of such resins include water-soluble resins such as polyvinyl alcohol resins, casein and polyacrylic acid sodium salts; alcohol soluble resins such as amide copolymers (nylon copolymers) and methoxymethylated polyamides; and thermosetting resins capable of forming a three-dimensional network such as polyurethane resins, melamine resins, alkyd-melamine resins, isocyanates, epoxy resins, etc.

The undercoat layer can include a powder of metal oxides to prevent occurrence of moiré in the resultant images and to decrease residual potential of the resultant photoreceptor. Moire is a defective image such that when image writing is performed using coherent light such as laser light, interference pattern (i.e., moiré fringe) is formed in the resultant image due to interference of the light in the photoreceptor. Occurrence of moiré can be prevented by scattering the incident laser light by the undercoat layer. Therefore, it is preferable to include a material having a large refractive index in the undercoat layer. From this point of view, it is more preferable to form an undercoat layer in which an inorganic pigment is dispersed in a binder resin. Among the inorganic pigments, white inorganic pigments are preferably used, and metal oxides are more preferably used. Specific examples of such inorganic pigments include titanium oxide, zinc oxide, calcium fluoride, calcium oxide, silica, magnesium oxide, alumina, tin oxide, zirconium oxide, indium oxide, etc.

In particular, it is preferable to include two different kinds of titanium oxides having different average primary particle diameters by 0.1 μm or more in the undercoat layer. In this case, the titanium oxides are densely arranged in the layer, which is effective for preventing occurrence of the first one-revolution charge problem, and preventing formation of images with moiré fringe.

It is preferable for the undercoat layer to have a function of transporting charges having the same polarity as that of charges formed on the surface of the photoreceptor from the photosensitive layer to the electroconductive substrate to reduce residual potential of the photoreceptor. The inorganic pigment included in the undercoat layer can have the function. For example, when the photoreceptor is negatively charged, the undercoat layer preferably has an electron conductive property to reduce residual potential. In this case, the metal oxides mentioned above can be preferably used. In this regard, when the added inorganic pigment has a relatively low resistance or the content of the added inorganic pigment is relatively high, the residual potential reducing effect can be enhanced, but the background fouling preventing effect is diminished. Therefore, it is preferable to select a proper inorganic pigment depending on the layer structure and thickness of the undercoat layer and to adjust the added amount of the inorganic pigment so that both the residual potential reducing effect and the background fouling preventing effect can be produced. In order to prevent occurrence of moiré, background fouling and first one-revolution charge problem, and increase of residual potential, titanium oxide is more preferably used for the undercoat layer.

The undercoat layer is typically prepared by coating a coating liquid, which is typically prepared by dispersing an inorganic pigment in a solvent together with a binder resin, on an electroconductive substrate, followed by drying. Specific examples of the solvent include acetone, methyl ethyl ketone, methanol, ethanol, butanol, cyclohexanone, dioxane, etc. These solvents can be used alone or in combination. When dispersing an inorganic pigment in a solvent, known dispersing devices such as ball mills, sand mills, attritors, etc., can be used. In this regard, the binder resin can be added before or after dispersing the inorganic pigment, but it is preferable to add a solution of the binder resin. If desired, additives such as agents necessary for crosslinking the layer (e.g., crosslinking agents and crosslinking accelerators) and dispersants can be added to the coating liquid. When coating the coating liquid, known coating methods such as dip coating, spray coating, ring coating, bead coating, and nozzle coating can be used. After drying the coated liquid by heating, the undercoat layer is optionally crosslinked using heat or light. The thickness of the undercoat layer, which is determined depending on the pigment used, is generally from 0 to 20 μm, and preferably from 2 to 10 μm.

An intermediate layer can be formed between the electroconductive substrate and the undercoat layer or between the undercoat layer and the photosensitive layer (or charge generation layer) to prevent injection of holes from the electroconductive substrate, resulting in prevention occurrence of background fouling. The intermediate layer includes a binder resin as a main component. Specific examples of the binder resin include polyamide, alcohol-soluble polyamide (alcohol-soluble nylon), water-soluble polyvinyl butyral, polyvinyl alcohol, etc.

Among these resins, polyamide resins can be preferably used because charge injection can be prevented, resulting in prevention of formation of images with background fouling. In particular, when distyryl compounds are used as charge transport materials, the compounds tend to enter into the undercoat layer, resulting in increase of charge injection, thereby causing background fouling. Even in this case,by forming an intermediate layer including a polyamide resin, occurrence of the problem can be prevented.

The intermediate layer can be formed by a method similar to the methods mentioned above for use in preparing the undercoat layer. The thickness of the intermediate layer is preferably from 0.05 to 2 μm.

When both the undercoat layer and intermediate layer are formed, the background fouling preventing effect can be dramatically heightened, but there is a possibility that residual potential increases, and the first one-revolution charge problem is caused. Therefore, it is necessary to select proper materials for the layers and to determine the thicknesses of the layers.

In order to improve coating properties and stability of the photoreceptor to withstand environmental conditions and to prevent deterioration of photosensitivity and charging properties, and increase of residual potential, the photoreceptor can include additives such as antioxidants, plasticizers, lubricants, ultraviolet absorbing agents, and leveling agents in one or more of the layers thereof (e.g., charge generation layer, charge transport layer, single-layered photosensitive layer, undercoat layer, intermediate layer, and protective layer).

Suitable antioxidants for use in the layers of the photoreceptor include the following compounds but are not limited thereto.

### (a) Phenolic Compounds

2,6-di-t-butyl-p cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, tocopherol compounds, etc.

### (b) Paraphenylenediamine Compounds

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

### (c) Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone, etc.

### (d) Organic Sulfur-Containing Compounds

dilauryl-3,3′-thiodipropionate, distearyl-3,3′-thiodipropionate, ditetradecyl-3,3′-thiodipropionate, etc.

### (e) Organic Phosphorus-Containing Compounds

triphenylphosphine, tri(nonylphenyl)phosphine, tri(dinonylphenyl)phosphine, tricresylphosphine, tri(2,4-dibutylphenoxy)phosphine, etc.

Suitable plasticizers for use in the layers of the photoreceptor include the following compounds, but are not limited thereto:

### (a) Phosphoric Acid Esters

triphenyl phosphate, tricresyl phosphate, trioctyl phosphate, octyldiphenyl phosphate, trichloroethyl phosphate, cresyldiphenyl phosphate, tributyl phosphate, tri-2-ethylhexyl phosphate, etc.

### (b) Phthalic Acid Esters

dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butylbenzyl phthalate, butyllauryl phthalate, methyloleyl phthalate, octyldecyl phthalate, dibutyl fumarate, dioctyl fumarate, etc.

### (c) Aromatic Carboxylic Acid Esters

trioctyl trimellitate, tri-n-octyl trimellitate, octyl oxybenzoate, etc.

### (d) Dibasic Fatty Acid Esters

dibutyl adipate, di-n-hexyl adipate, di-2-ethylhexyl adipate, di-n-octyl adipate, n-octyl-n-decyl adipate, diisodecyl adipate, dialkyl adipate, dicapryl adipate, di-2-etylhexyl azelate, dimethyl sebacate, diethyl sebacate, dibutyl sebacate, di-n-octyl sebacate, di-2-ethylhexyl sebacate, di-2-ethoxyethyl sebacate, dioctyl succinate, diisodecyl succinate, dioctyl tetrahydrophthalate, di-n-octyl tetrahydrophthalate, etc.

### (e) Fatty Acid Ester Derivatives

butyl oleate, glycerin monooleate, methyl acetylricinolate, pentaerythritol esters, dipentaerythritol hexaesters, triacetin, tributyrin, etc.

### (f) Oxyacid Esters

methyl acetylricinolate, butyl acetylricinolate, butylphthalylbutyl glycolate, tributyl acetylcitrate, etc.

### (g) Epoxy Compounds

epoxydized soybean oil, epoxydized linseed oil, butyl epoxystearate, decyl epoxystearate, octyl epoxystearate, benzyl epoxystearate, dioctyl. epoxyhexahydrophthalate, didecyl epoxyhexahydrophthalate, etc.

### (h) Dihydric Alcohol Esters

diethylene glycol dibenzoate, triethylene glycol di-2-ethylbutyrate, etc.

### (i) Chlorine-Containing Compounds

chlorinated paraffin, chlorinated diphenyl, methyl esters of chlorinated fatty acids, methyl esters of methoxychlorinated fatty acids, etc.

### (j) Polyester Compounds

polypropylene adipate, polypropylene sebacate, acetylated polyesters, etc.

### (k) Sulfonic Acid Derivatives

p-toluene sulfonamide, o-toluene sulfonamide, p-toluene sulfoneethylamide, o-toluene sulfoneethylamide, toluene sulfone-N-ethylamide, p-toluene sulfone-N-cyclohexylamide, etc.

### (1) Citric Acid Derivatives

triethyl citrate, triethyl acetylcitrate, tributyl citrate, tributyl acetylcitrate, tri-2-ethylhexyl acetylcitrate, n-octyldecyl acetylcitrate, etc.

### (m) Other Compounds

terphenyl, partially hydrated terphenyl, camphor, 2-nitro diphenyl, dinonyl naphthalene, methyl abietate, etc.

Suitable lubricants for use in the layers of the photoreceptor include the following compounds, but are not limited thereto.

### (a) Hydrocarbons

liquid paraffins, paraffin waxes, micro waxes, low molecular weight polyethylene, etc.

### (b) Fatty Acids

lauric acid, myristic acid, palmitic acid, stearic acid, arachidic acid, behenic acid, etc.

### (c) Fatty Acid Amides

Stearic acid amide, palmitic acid amide, oleic acid amide, methylenebisstearamide, ethylenebisstearamide, etc.

### (d) Ester Compounds

lower alcohol esters of fatty acids, polyhydric alcohol esters of fatty acids, polyglycol esters of fatty acids, etc.

### (e) Alcohols

cetyl alcohol, stearyl alcohol, ethylene glycol, polyethylene glycol, polyglycerol, etc.

### (f) Metallic Soaps

lead stearate, cadmium stearate, barium stearate, calcium stearate, zinc stearate, magnesium stearate, etc.

### (g) Natural Waxes

Carnauba wax, candelilla wax, beeswax, spermaceti, insect wax, montan wax, etc.

### (h) Other Compounds

silicone compounds, fluorine compounds, etc.

Suitable ultraviolet absorbing agents for use in the layers of the photoreceptor include the following compounds, but are not limited thereto.

### (a) Benzophenone Compounds

2-hydroxybenzophenone, 2,4-dihydroxybenzophenone, 2,2′,4-trihydroxybenzophenone, 2,2′,4,4′-tetrahydroxybenzophenone, 2,2′-dihydroxy-4-methoxybenzophenone, etc.

### (b) Salicylate Compounds

phenyl salicylate, 2,4-di-t-butylphenyl-3,5-di-t-butyl 4-hydroxybenzoate, etc.

### (c) Benzotriazole Compounds

(2′-hydroxyphenyl)benzotriazole, (2′-hydroxy-5′-methylphenyl)benzotriazole, (2′-hydroxy-3′-t-butyl-5′-methylphenyl)-5-chlorobenzotriazole, etc.

### (d) Cyano Acrylate Compounds

ethyl-2-cyano-3,3-diphenyl acrylate, methyl-2-carbomethoxy-3-(paramethoxy)acrylate, etc.

### (e) Quenchers (Metal Complexes)

nickel(2,2′-thiobis(4-t-octyl)phenolate)-n-butylamine, nickeldibutyldithiocarbamate, cobaltdicyclohexyldithiophosphate, etc.

### (f) HALS (Hindered Amines)

bis(2,2,6,6-tetramethyl-4-piperidyl)sebacate, bis(1,2,2,6,6-pentamethyl-4-piperidyl)sebacate, 1-[2-{3-(3,5-di-t-butyl-4-hydroxyphenyl)propionyloxy}ethyl]-4-{3-(3,5-di-t-butyl-4-hydroxyphenyl)propionyloxy}-2,2,6,6-tetrametylpyridine, 8-benzyl-7,7,9,9-tetramethyl-3-octyl-1,3,8-triazaspiro[4,5]undecane-2,4-dione, 4-benzoyloxy-2,2,6,6-tetramethylpiperidine, etc.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### (Synthesis of Titanyl Phthalocyanine for use as Charge Generation Material)

A titanyl phthalocyanine crystal was prepared by the method described in JP-A 2004-83859. Specifically, in a container 292 parts of 1,3-diiminoisoindoline and 1800 parts of sulfolane were mixed and agitated. Under a nitrogen gas flow, 204 parts of titanium tetrabutoxide was dropped therein. After titanium tetrabutoxide was added, the temperature of the mixture was gradually increased to 180° C. The temperature of the mixture was maintained in a range of from 170° C. to 180° C. for 5 hours while stirring the mixture to react the compounds. After the reaction was terminated, the reaction product was cooled. The reaction product was then filtered to obtain the precipitate. The precipitate was washed with chloroform until the precipitate colored blue. The precipitate was then washed with methanol several times, followed by washing with hot water of 80° C. several times. Thus, a crude titanyl phthalocyanine was prepared.

One part of the thus prepared crude titanyl phthalocyanine was gradually added to 20 parts of concentrated sulfuric acid to be dissolved therein. The solution was gradually added to 100 parts of ice water while agitated, to precipitate a titanyl phthalocyanine crystal. The titanyl phthalocyanine crystal was obtained by filtering. The crystal was washed with ion-exchange water (having pH of 7.0 and a conductivity of 1.0 μS/cm) until the filtrate became neutral. In this case, the pH and conductivity of the final filtrate were 6.8 and 2.6 μS/cm. Thus, an aqueous wet cake of the titanyl phthalocyanine pigment was prepared.

Forty (40) parts of the thus prepared aqueous wet cake of the titanyl phthalocyanine pigment was added to 200 parts of tetrahydrofuran and the mixture was strongly agitated using a homomixer (MODEL MARK IIf from Kenis Ltd.), which was rotated at 2,000 rpm. When the color of the paste was changed from dark blue to light blue (after agitation for about 20 minutes), agitation was stopped and the paste was subjected to filtering under a reduced pressure to obtain the crystal. In this regard, the solid content of the aqueous wet cake was 15% by weight. In this crystal change process, the ratio of the pigment to the crystal change solvent (tetrahydrofuran) was 1:33. The raw materials used for preparing the titanyl phthalocyanine pigment did not include a halogenated compound.

The crystal on the filter was washed with tetrahydrofuran to obtain a wet cake of a titanyl phthalocyanine crystal. The wet cake was dried for 2 days at 70° C. under a reduced pressure of 5 mmHg (0.67 Pa). Thus, 8.5 parts of a titanyl phthalocyanine crystal (hereinafter referred to as pigment 1) was prepared.

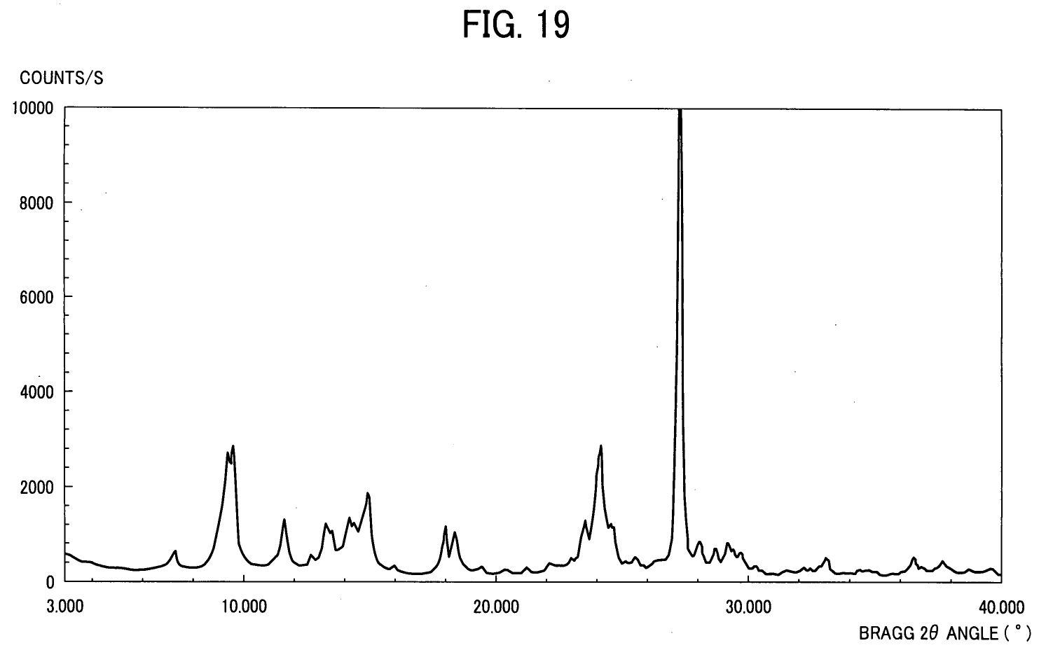

When the thus prepared pigment 1 was subjected to an X-ray diffraction analysis using a Cu—K α X-ray having a wavelength of 1.542 Å, the pigment had an X-ray diffraction spectrum such that a maximum peak is observed at a Bragg (2 θ) angle of 27.2±0.2°, a lowest angle peak is observed at an angle of 7.3±0.2°, and a main peak is observed at each of angles of 9.4±0.2°, 9.6±0.2°, and 24.0±0.2°, wherein no peak is observed between the peaks of 7.3° and 9.4° and at an angle of 26.3°±0.2°. The X-ray diffraction spectrum thereof is illustrated in FIG. 19.

The X-ray diffraction analysis was performed under the following conditions:
X-ray tube: Cu
Voltage: 50 kV
Current: 30 mA
Scanning speed: 2/min
Scanning range: 3° to 40°
Time constant: 2 seconds

### (Synthesis of Azo Pigment for use as Charge Generation Material)

The azo pigment mentioned below for use as a charge generation material was prepared by the method described in Japanese patent No. 3,026,645.

(Synthesis of Polymerizable Compound having Charge Transport Structure)

Polymerizable compounds having a charge transport structure can be prepared, for example, by the method described in Japanese Patent No. 3,164,426. One example thereof is as follows.

(1) Synthesis of Triarylamine Compound Substituted with Hydroxyl Group (i.e., a Compound Having the Below-Mentioned Formula (B))

At first, 113.85 g (0.3 mol) of a triarylamine compound which is substituted with a methoxy group and which has the below-mentioned formula (A), 138 g (0.92 mol) of sodium iodide, and 240 ml of sulfolane were mixed and heated at 60° C. under a nitrogen gas flow. Then, 99 g (0.91 mol) of trimethylchlorosilane was dropped thereto over 1 hour. The mixture was agitated for 4.5 hours at about 60° C. to complete the reaction. Next, about 1.5 liters of toluene was added to the reaction product, followed by cooling to room temperature. Further, the toluene solution of the reaction product was washed using water, followed by washing using an aqueous solution of sodium carbonate. These washing treatments were repeated several times. Then toluene was removed from the toluene solution of the reaction product, and the reaction product was subjected to column chromatography (absorbent: silica gel, solvent: toluene/ethyl acetate 20/1) to be refined. The thus prepared pale yellow oily material was mixed with cyclohexane to precipitate a crystal. Thus, 88.1 g of a white crystal having the below-mentioned formula (B) and a melting point of from 64.0 to 66.0° C. was prepared. In this reaction, the yield was 80.4%.

The crystal was then subjected to an elementary analysis. The results (i.e., the amounts (%) of the elements (C, H and N) in the crvstal) are shown in Table 1 below.

TABLE 1

| | C | H | N |
|---|---|---|---|
| Actual measurement | 85.06 | 6.41 | 3.73 |
| value | | | |
| Calculated value | 85.44 | 6.34 | 3.83 |

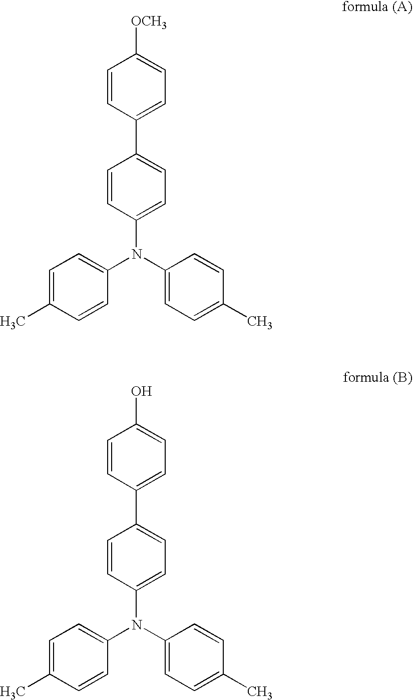

(2) Synthesis of Acrylate Compound Substituted with Triarylamine Group (i.e., Compound No. 54 Listed Above)

At first, 82.9 g (0.227 mol) of the compound having the above-mentioned formula (B) was dissolved in 400 ml of tetrahydrofuran. Next, an aqueous solution of sodium hydroxide including 12.4 g of sodium hydroxide and 100 ml of water was dropped into the above-prepared solution. After the mixture was cooled to 5° C., 25.2 g (0.272 mol) of acrylic acid chloride was dropped thereinto over 40 minutes. The mixture was agitated for 3 hours at 5° C. to complete the reaction. The reaction product was then added into water, and the mixture was subjected to extraction using toluene. The extraction liquid was subjected to washing using a sodium hydrogen carbonate aqueous solution, followed by washing using water. This washing treatment was performed several times.

After toluene was removed from the toluene solution of the reaction product, the reaction product was subjected to column chromatography (absorbent: silica gel, solvent: toluene) to be refined. The thus prepared colorless oily material was mixed with n-hexane to precipitate a crystal. Thus, 80.73 g of a white crystal which is the compound No. 54 listed above and has a melting point of from 117.5 to 119.0° C. was prepared. In this reaction, the yield was 84.8%.

The crystal was then subjected to an elementary analysis. The results (i.e., the amounts (%) of the elements (C, H and N) in the crystal) are shown in Table 2 below.

TABLE 2

| | C | H | N |
|---|---|---|---|
| Actual measurement | 83.13 | 6.01 | 3.16 |
| value | | | |
| Calculated value | 83.02 | 6.00 | 3.33 |

### PHOTORECEPTOR PREPARATION EXAMPLE 1

### (Preparation of Intermediate Layer)

The following components were mixed to prepare an intermediate layer coating liquid.

| | |
|---|---|
| N-methoxymethylated nylon | 5 parts |
| (FR101 from Namariichi Co., Ltd.) | |
| Methanol | 70 parts |
| n-butanol | 30 parts |

The intermediate layer coating liquid was coated on an aluminum cylinder having an outside diameter of 30 mm by a dip coating method, and the coated liquid was dried for 10 minutes in an oven heated to 130° C. Thus, an intermediate layer with a thickness of about 0.7 μm was prepared.

### (Preparation of Undercoat Layer)

The following components were mixed and the mixture was subjected to a dispersing treatment to prepare an undercoat layer coating liquid.

| | |
|---|---|
| Titanium oxide A | 50 parts |
| (CR-EL from Ishihara Sangyo Kaisha K.K., | |
| which has average primary particle | |
| diameter of about 0.25 μm) | |
| Titanium oxide B | 20 parts |
| (PT-401M from Ishihara Sangyo Kaisha K.K., | |
| which has average primary particle | |
| diameter of about 0.07 μm) | |
| Alkyd resin | 14 parts |
| (BEKKOLITE M6401-50 from Dainippon | |
| Ink And Chemicals, Inc., solid content of 50%) | |
| Melamine resin | 8 parts |
| (SUPER BEKKAMINE L-145-60 from | |
| Dainippon Ink And Chemicals, Inc., solid | |
| content of 60%) | |
| 2-Butanone | 70 parts |

The undercoat layer coating liquid was coated on the intermediate layer by a dip coating method, and the coated liquid was dried for 20 minutes in an oven heated to 130° C. Thus, an undercoat layer having a thickness of about 3 μm was prepared.

### (Preparation of Charge Generation Layer)

The formula of the charge generation layer coating liquid is as follows.

| | |
|---|---|
| Pigment 1 (titanyl phthalocyanine) prepared above | 8 parts |
| (having ionization potential of 5.27 eV, and X-ray | |
| diffraction spectrum illustrated in FIG. 19) | |
| Polyvinyl butyral | 4 parts |
| (S-LEC BX-1 from Sekisui Chemical Co., Ltd.) | |
| 2-Butanone | 400 parts |

At first, the polyvinyl butyral resin was dissolved in 2-butanone to prepare a polyvinyl butyral resin solution. Next, the pigment 1 was added to the resin solution and the mixture was dispersed for 30 minutes using a dispersing machine including PSZ balls with a particle diameter of 0.5 mm while the rotor was rotated at a revolution of 1,200 rpm. Thus, a charge generation layer coating liquid was prepared.

The charge generation layer coating liquid was coated on the undercoat layer by a dip coating method, and the coated liquid was dried for 20 minutes in an oven heated to 90° C. Thus, a charge generation layer having a thickness of about 0.2 μm was prepared.

### (Preparation of Charge Transport Layer)

The following components were mixed to prepare a charge transport layer coating liquid.

| | |
|---|---|
| Z-form polycarbonate | 10 parts |
| (from Teijin Chemicals Ltd.) | |
| Charge transport material | 12 parts |
| (Compound No. 14 listed above, ionization potential of 5.24 eV) | |
| Antioxidant A having the following formula | 0.6 parts |

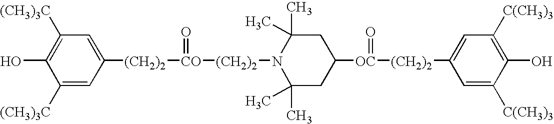

| | |
|---|---|
| Silicone oil | 0.002 parts |
| (KF50-100CS from Shin-Etsu Chemical Co., Ltd., viscosity of 1 cm²/ | |
| s (100 cSt)) | |
| Tetrahydrofuran | 100 parts |
| Antioxidant B having the following formula | 0.03 parts |
| 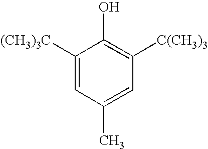 | |

The charge transport layer coating liquid was coated on the charge generation layer by a dip coating method, and the coated liquid was dried for 20 minutes in an oven heated to 120° C. Thus, a charge transport layer having a thickness of about 21 μm was prepared

### (Preparation of Crosslinked Protective Layer)

The following components were mixed to prepare a protective layer coating liquid.

| | |
|---|---|
| Trimethylolpropane triacrylate | 10 parts |
| (KAYARAD TMPTA from Nippon Kayaku Co., Ltd., | |
| serving as polymerizable compound having no | |
| charge transport structure, molecular weight | |
| (MW) of 296, number (N) of functional groups of 3, | |
| and ratio (MW/N) of 99) | |
| Compound No. 54 listed above | 14 parts |
| (serving as polymerizable monofunctional | |
| compound having a charge transport structure) | |
| Photopolymerization initiator | 1 part |
| (1-hydroxycyclohexyl phenyl ketone, | |
| IRGACURE 184 from Ciba Specialty Chemicals) | |
| Tetrahydrofuran | 100 parts |

The protective layer coating liquid was coated on the charge transport layer by a spray coating method, and the coated liquid was exposed to UV light to be crosslinked.

The light irradiation conditions were as follows.
Light source: metal halide lamp with 160 W/cm
Distance between light source and coated layer: 120 mm
Intensity of light: 500 mW/cm²
Irradiation time: 60 seconds

The protective layer was further heated for 30 minutes at 130° C.

Thus, a crosslinked protective layer having a thickness of about 4 μm was prepared.

Thus, a photoreceptor No. 1 was prepared.

### PHOTORECEPTOR PREPARATION EXAMPLE 2

The procedure for preparation of the photoreceptor in Photoreceptor Preparation Example 1 was repeated except that the charge transport material included in the charge transport layer was replaced with the compound No. 12 listed above, which has an ionization potential of 5.28 eV.

Thus, a photoreceptor No. 2 was prepared.

### PHOTORECEPTOR PREPARATION EXAMPLE 3

The procedure for preparation of the photoreceptor in Photoreceptor Preparation Example 1 was repeated except that the charge transport material included in the charge transport layer was replaced with the compound No. 7 listed above, which has an ionization potential of 5.20 eV.

Thus, a photoreceptor No. 3 was prepared.

### PHOTORECEPTOR PREPARATION EXAMPLE 4

The procedure for preparation of the photoreceptor in Photoreceptor Preparation Example 1 was repeated except that the charge transport material included in the charge transport layer was replaced with the compound No. 4 listed above, which has an ionization potential of 5.31 eV.

Thus, a photoreceptor No. 4 was prepared.

### PHOTORECEPTOR PREPARATION EXAMPLE 5

The procedure for preparation of the photoreceptor in Photoreceptor Preparation Example 1 was repeated except that the charge transport material included in the charge transport layer was replaced with the compound No. 13 listed above, which has an ionization potential of 5.24 eV.

Thus, a photoreceptor No. 5 was prepared.

### PHOTORECEPTOR PREPARATION EXAMPLE 6

The procedure for preparation of the photoreceptor in Photoreceptor Preparation Example 1 was repeated except that the charge transport material included in the charge transport layer was replaced with the compound No. 17 listed above, which has an ionization potential of 5.39 eV.

Thus, a photoreceptor No. 6 was prepared.

### PHOTORECEPTOR PREPARATION EXAMPLE 7

The procedure for preparation of the photoreceptor in Photoreceptor Preparation Example 1 was repeated except that the charge transport material included in the charge transport layer was replaced with the compound No. 41 listed above, which has an ionization potential of 5.27 eV.

Thus, a photoreceptor No. 7 was prepared.

### PHOTORECEPTOR PREPARATION EXAMPLE 8

The procedure for preparation of the photoreceptor in Photoreceptor Preparation Example 1 was repeated except that the charge transport material included in the charge transport layer was replaced with the compound No. 51 listed above, which has an ionization potential of 5.36 eV.

Thus, a photoreceptor No. 8 was prepared.

### PHOTORECEPTOR PREPARATION EXAMPLE 9

The procedure for preparation of the photoreceptor in Photoreceptor Preparation Example 1 was repeated except that the charge transport material included in the charge transport layer was replaced with an α-phenylstilbene derivative A, which has the following formula and has an ionization potential of 5.39 eV.

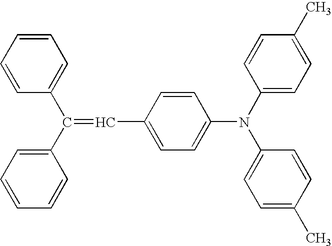

Thus, a photoreceptor No. 9 was prepared.

### PHOTORECEPTOR PREPARATION EXAMPLE 10

The procedure for preparation of the photoreceptor in Photoreceptor Preparation Example 1 was repeated except that the charge transport material included in the charge transport layer was replaced with an α-phenylstilbene derivative B, which has the following formula and has an ionization potential of 5.26 eV.

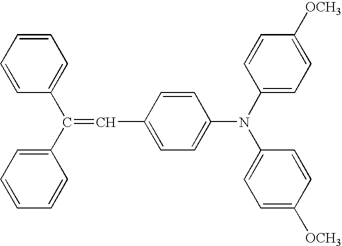

Thus, a photoreceptor No. 10 was prepared.

### PHOTORECEPTOR PREPARATION EXAMPLE 11

The procedure for preparation of the photoreceptor in Photoreceptor Preparation Example 1 was repeated except that the charge transport material included in the charge transport layer was replaced with an α-phenylstilbene derivative C, which has the following formula and has an ionization potential of 5.50 eV.

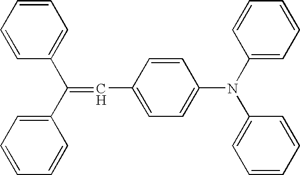

Thus, a photoreceptor No. 11 was prepared.

### PHOTORECEPTOR PREPARATION EXAMPLE 12

The procedure for preparation of the photoreceptor in Photoreceptor Preparation Example 1 was repeated except that the charge transport material included in the charge transport layer was replaced with an aminobiphenyl derivative A, which has the following formula and has an ionization potential of 5.38 eV.

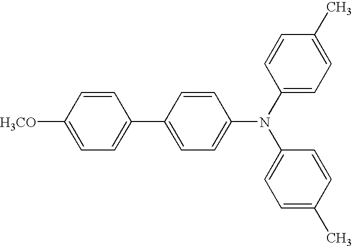

Thus, a photoreceptor No. 12 was prepared.

### PHOTORECEPTOR PREPARATION EXAMPLE 13

The procedure for preparation of the photoreceptor in Photoreceptor Preparation Example 1 was repeated except that the charge transport material included in the charge transport layer was replaced with a benzidine derivative A, which has the following formula and has an ionization potential of 5.37 eV.

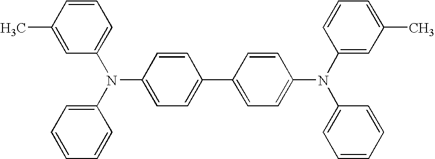

Thus, a photoreceptor No. 13 was prepared.

### PHOTORECEPTOR PREPARATION EXAMPLE 14

The procedure for preparation of the photoreceptor in Photoreceptor Preparation Example 1 was repeated except that the binder resin included in the charge transport layer was replaced with 10 parts of a polyarylate (U-POLYMER 100 from Unitica Ltd.).

Thus, a photoreceptor No. 14 was prepared.

### PHOTORECEPTOR PREPARATION EXAMPLE 15

The procedure for preparation of the photoreceptor in Photoreceptor Preparation Example 1 was repeated except that the charge transport layer coating liquid was replaced with the following charge transport layer coating liquid.

### (Charge Transport Layer Coating Liquid)

| | |
|---|---|
| Charge transport polymer A having the following formula | 20 parts |
| (weight average molecular weight of 175,000, ionization potential of 5.41 eV) | |

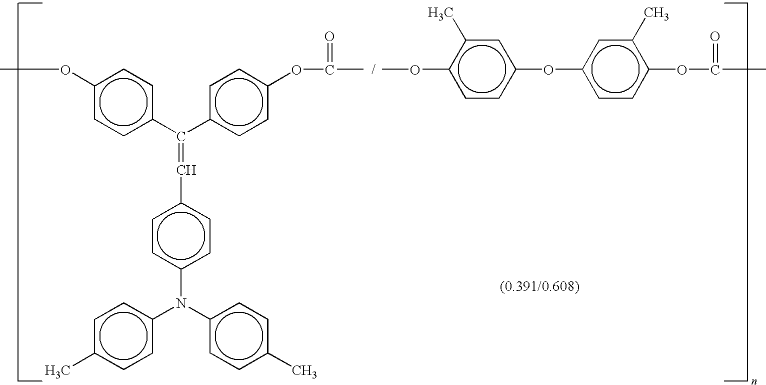

| | |
|---|---|
| Antioxidant A mentioned above | 0.3 parts |
| Silicone oil | 0.002 parts |
| (KF50-100CS from Shin-Etsu Chemical Co., Ltd., viscosity of 1 cm²/s (100 cSt)) | |
| Tetrahydrofuran | 100 parts |
| Antioxidant B mentioned above | 0.03 parts |

Thus, a photoreceptor No. 15 was prepared.

### PHOTORECEPTOR PREPARATION EXAMPLE 16

The procedure for preparation of the photoreceptor in Photoreceptor Preparation Example 1 was repeated except that the charge transport layer coating liquid was replaced with the following charge transport layer coating liquid.

### (Charge Transport Layer Coating Liquid)

| | |
|---|---|
| Charge transport polymer A mentioned above | 12 parts |
| Compound No. 17 mentioned above | 8 parts |
| (distyrylbenzene derivative, ionization potential of 5.38 eV) | |
| Alkylamino compound A having the following formula | 0.6 parts |

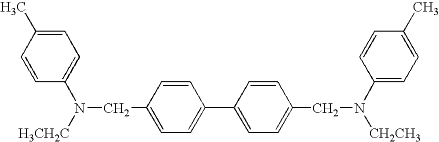

| | |
|---|---|
| Silicone oil | 0.002 parts |
| (KF50-100CS from Shin-Etsu Chemical Co., Ltd., viscosity | |
| of 1 cm²/s (100 cSt)) | |
| Tetrahydrofuran | 100 parts |
| Antioxidant B mentioned above | 0.03 parts |

Thus, a photoreceptor No. 16 was prepared.

### PHOTORECEPTOR PREPARATION EXAMPLE 17

The procedure for preparation of the photoreceptor in Photoreceptor Preparation Example 1 was repeated except that the polymerizable compound having no charge transport structure was replaced with 10 parts of caprolactone-modified dipentaerythritol hexaacrylate (KAYARAD DPCA-60 from Nippon Kayaku Co., Ltd., having molecular weight (MW) of 1263, number (N) of functional groups of 6, and ratio (MW/N) of 211), and the photopolymerization initiator was replaced with one part of 2,2-dimethoxy-1,2-diphenylethane-1one (IRGACURE 651 from Ciba Specialty Chemicals).

Thus, a photoreceptor No. 17 was prepared.

### PHOTORECEPTOR PREPARATION EXAMPLE 18

The procedure for preparation of the photoreceptor in Photoreceptor Preparation Example 17 was repeated except that the polymerizable compound having no charge transport structure was replaced with 10 parts of caprolactone-modified dipentaerythritol hexaacrylate (KAYARAD DPCA-120 from Nippon Kayaku Co., Ltd., having molecular weight (MW) of 1947, number (N) of functional groups of 6, and ratio (MW/N) of 325).

Thus, a photoreceptor No. 18 was prepared.

### PHOTORECEPTOR PREPARATION EXAMPLE 19

The procedure for preparation of the photoreceptor in Photoreceptor Preparation Example 1 was repeated except that the polymerizable compound having a charge transport structure included in the protective layer coating liquid was replaced with a combination of 7 parts of the compound No. 54 listed above, which is a monofunctional polymerizable compound having a charge transport structure, and 3 parts of a difunctional polymerizable compound having a charge transport structure, which has the following formula.

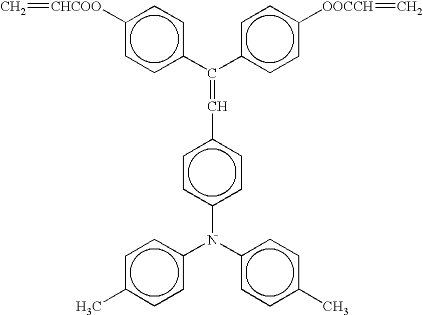

Thus, a photoreceptor No. 19 was prepared.

### PHOTORECEPTOR PREPARATION EXAMPLE 20

The procedure for preparation of the photoreceptor in Photoreceptor Preparation Example 1 was repeated except that the protective layer coating liquid was replaced with the following protective layer coating liquid, and the protective layer was prepared by coating the coating liquid and then heating the coated layer for 20 minutes at 150° C. without performing a crosslinking treatment using light irradiation.

### (Crosslinking Protective Layer Coating Liquid)

| | |
|---|---|
| Isocyanate | 3 parts |
| (SUMIDUR HT, HDI adduct, from Sumitomo Chemical- | |
| Bayer Co.) | |
| Polyol 1 having the following formula | 2 parts |
| 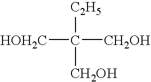 | |
| Polyol 2 | 8 parts |
| (LZR 170 from Fujikura Kasei Co., Ltd.) | |
| Reactive compound having charge transport structure | 10 parts |
| Tetrahydrofuran | 100 parts |
| Cyclohexanone | 30 parts |

Thus, a photoreceptor No. 20 was prepared.

### PHOTORECEPTOR PREPARATION EXAMPLE 21

The procedure for preparation of the photoreceptor in Photoreceptor Preparation Example 1 was repeated except that the protective layer coating liquid was replaced with the following protective layer coating liquid, and the protective layer was prepared by coating the coating liquid and then heating the coated layer for 20 minutes at 150° C. without performing a crosslinking treatment using light irradiation.

### (Filler-Dispersed Protective Layer Coating Liquid)

| | | |
|---|---|---|
| Particulate α-alumina | 5 | parts |
| (SUMICORUNDUM AA-03 from Sumitomo Chemical | | |
| Co., Ltd., having average primary particle diameter | | |
| of 0.3 μm) | | |
| Unsaturated polycarboxylic acid polymer solution | 0.1 | parts |
| (BYK P104 from Byk Chemie, content of | | |
| nonvolatile components of 50%) | | |
| Z-form polycarbonate | 10 | parts |
| (from Teijin Chemicals Ltd.) | | |
| Compound No. 17 listed above | 7 | parts |
| (charge transport material) | | |
| Alkylamino compound A mentioned above | 1 | part |
| Tetrahydrofuran | 500 | parts |
| Cyclohexanone | 150 | parts |

Thus, a photoreceptor No. 21 was prepared.

### PHOTORECEPTOR PREPARATION EXAMPLE 22

The procedure for preparation of the photoreceptor in Photoreceptor Preparation Example 9 was repeated except that the charge generation layer coating liquid was replaced with the below-mentioned charge generation layer coating liquid, and the charge transport layer coating liquid was replaced with the below-mentioned charge transport layer coating liquid.

### (Charge Generation Layer Coating Liquid)

A asymmetric bisazo pigment A having the following formula and ionization potential of 5.82 eV was synthesized by the method described in Japanese patent No. 3,164,426 incorporated by reference.

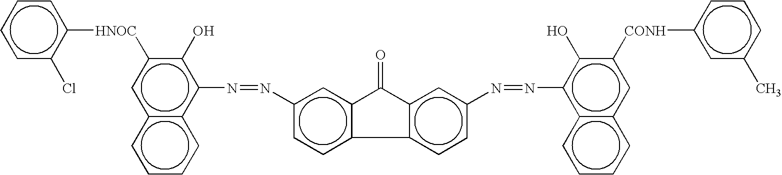

The asymmetric bisazo pigment was mixed with a solution of a polyvinyl butyral (S-LEC BMS from Sekisui Chemical Co., Ltd.) and the mixture was subjected to a dispersing treatment for 7 days using a ball mill including PSZ balls with a particle diameter of 10 mm while the ball mill was rotated at a revolution of 85 rpm to prepare a charge generation layer coating liquid. The formula of the charge generation layer coating liquid is as follows.

| | |
|---|---|
| Asymmetric bisazo pigment A prepared above | 5 parts |
| Polyvinyl butyral | 1.5 parts |
| Cyclohexanone | 250 parts |
| 2-butanone | 100 parts |

### (Charge Transport Layer Coating Liquid)

The formula of the charge transport layer coating liquid is as follows.

| | |
|---|---|
| Z-form polycarbonate | 10 parts |
| (from Teijin Chemicals Ltd.) | |
| α-phenylstilbene derivative A mentioned above | 7 parts |
| (ionization potential of 5.39 eV) | |
| Silicone oil | 0.002 parts |
| (KF50-100CS from Shin-Etsu Chemical Co., Ltd., viscosity | |
| of 1 cm²/s (100 cSt)) | |
| Tetrahydrofuran | 100 parts |
| Antioxidant B mentioned above | 0.03 parts |
| Antioxidant C having the following formula | 0.07 parts |
| 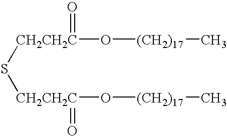 | |

Thus, a photoreceptor No. 22 was prepared.

### PHOTORECEPTOR PREPARATION EXAMPLE 23

The procedure for preparation of the photoreceptor in Photoreceptor Preparation Example 22 was repeated except that the charge transport material included in the charge transport layer was replaced with the compound No. 17 having an ionization potential of 5.39 eV.

Thus, a photoreceptor No. 23 was prepared.

### PHOTORECEPTOR PREPARATION EXAMPLE 24

The procedure for preparation of the photoreceptor in Photoreceptor Preparation Example 23 was repeated except that the protective layer coating liquid was replaced with the following protective layer coating liquid.

### (Filler-Dispersed Protective Layer Coating Liquid)

| | | |
|---|---|---|
| Particulate α-alumina | 2 | parts |
| (SUMICORUNDUM AA-05 from Sumitomo | | |
| Chemical Co., Ltd., having average | | |
| primary particle diameter of 0.5 μm) | | |
| Unsaturated polycarboxylic acid polymer solution | 0.1 | parts |
| (BYK P104 from Byk Chemie, content of | | |
| nonvolatile components of 50%) | | |
| Trimethylolpropane triacrylate | 10 | parts |
| (KAYARAD TMPTA from Nippon Kayaku Co., | | |
| Ltd., serving as polymerizable | | |
| compound having no charge transport structure, | | |
| molecular weight (MW) of 296, number | | |
| (N) of functional groups of 3, and ratio (MW/N) of 99) | | |
| Compound No. 54 listed above | 14 | parts |
| (serving as polymerizable monofunctional | | |
| compound having a charge transport structure) | | |
| Photopolymerization initiator | 1 | part |
| (1-hydroxycyclohexyl phenyl ketone, | | |
| IRGACURE 184 from Ciba Specialty Chemicals) | | |
| Tetrahydrofuran | 100 | parts |
| Antioxidant B mentioned above | 0.03 | parts |

Thus, a photoreceptor No. 24 was prepared.

### PHOTORECEPTOR PREPARATION EXAMPLE 25

The procedure for preparation of the photoreceptor in Photoreceptor Preparation Example 1 was repeated except that the thicknesses of the charge transport layer and the protective layer were changed to 1.7 μm and 8 μm, respectively.

Thus, a photoreceptor No. 25 was prepared.

### PHOTORECEPTOR PREPARATION EXAMPLE 26

The procedure for preparation of the photoreceptor in Photoreceptor Preparation Example 1 was repeated except that the thicknesses of the charge transport layer and the protective layer were changed to 16 μm and 9 μm, respectively.

Thus, a photoreceptor No. 26 was prepared.

### PHOTORECEPTOR PREPARATION EXAMPLE 27

The procedure for preparation of the photoreceptor in Photoreceptor Preparation Example 1 was repeated except that 0.3 parts of an alkylamino compound B having the following formula was added to the charge transport layer coating liquid.

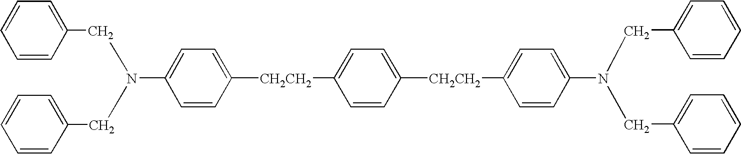

Thus a photoreceptor No. 27 was prepared.

### PHOTORECEPTOR PREPARATION EXAMPLE 28

The procedure for preparation of the photoreceptor in Photoreceptor Preparation Example 1 was repeated except that 0.2 parts of an antioxidant D having the following formula was added to the protective layer coating liquid.

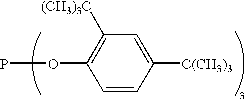

Thus, a photoreceptor No. 28 was prepared.

### PHOTORECEPTOR PREPARATION EXAMPLE 29

The procedure for preparation of the photoreceptor in Photoreceptor Preparation Example 1 was repeated except that the antioxidant A included in the charge transport layer coating liquid was replaced with 0.06 parts of an antioxidant E having the following formula was added to the protective layer coating liquid.

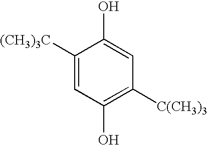

Thus, a photoreceptor No. 29 was prepared.

### PHOTORECEPTOR PREPARATION EXAMPLE 30

The procedure for preparation of the photoreceptor in Photoreceptor Preparation Example 16 was repeated except that the alkylamino compound A included in the charge transport layer coating liquid was replaced with 0.6 parts of an alkylamino compound C having the following formula.

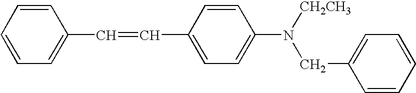

Thus, a photoreceptor No. 30 was prepared.

### PHOTORECEPTOR PREPARATION EXAMPLE 31

The procedure for preparation of the photoreceptor in Photoreceptor Preparation Example 1 was repeated except that the protective layer coating liquid was replaced with the following protective layer coating liquid.

### (Filler-Dispersed Protective Layer Coating Liquid)

| | | |
|---|---|---|
| Particulate α-alumina | 2 | parts |
| (SUMICORUNDUM AA-05 from Sumitomo | | |
| Chemical Co., Ltd., having average | | |
| primary particle diameter of 0.5 μm) | | |
| Unsaturated polycarboxylic acid polymer solution | 0.1 | parts |
| (BYK P104 from Byk Chemie, content | | |
| of nonvolatile components of 50%) | | |
| Trimethylolpropane triacrylate | 10 | parts |
| (KAYARAD TMPTA from Nippon Kayaku Co., | | |
| Ltd., serving as polymerizable compound | | |
| having no charge transport structure, | | |
| molecular weight (MW) of 296, number | | |
| (N) of functional groups of 3, and ratio (MW/N) of 99) | | |
| Compound No. 54 listed above | 10 | parts |
| (serving as polymerizable compound | | |
| having a charge transport structure) | | |
| Photopolymerization initiator | 1 | part |
| (1-hydroxycyclohexyl phenyl ketone, | | |
| IRGACURE 184 from Ciba Specialty | | |
| Chemicals) | | |
| Tetrahydrofuran | 100 | parts |
| Antioxidant B mentioned above | 0.03 | parts |
| Antioxidant D mentioned above | 0.03 | parts |

Thus, a photoreceptor No. 31 was prepared.

### PHOTORECEPTOR PREPARATION EXAMPLE 32

The procedure for preparation of the photoreceptor in Photoreceptor Preparation Example 31 was repeated except that the α-alumina included in the protective layer coating liquid was replaced with 1 part of another α-alumina (SUMICORUNDUM AA-07 from Sumitomo Chemical Co., Ltd., having an average primary particle diameter of 0.7 μm).

Thus, a photoreceptor No. 32 was prepared.

### PHOTORECEPTOR PREPARATION EXAMPLE 33

The procedure for preparation of the photoreceptor in Photoreceptor Preparation Example 31 was repeated except that the α-alumina included in the protective layer coating liquid was replaced with 1 part of another α-alumina (SUMICORUNDUM AA-1.5 from Sumitomo Chemical Co., Ltd., having an average primary particle diameter of 1.5 μm).

Thus, a photoreceptor No. 33 was prepared.

### PHOTORECEPTOR PREPARATION EXAMPLE 34

The procedure for preparation of the photoreceptor in Photoreceptor Preparation Example 31 was repeated except that the amount of the α-alumina included in the protective layer coating liquid was changed from 2 parts to 0.5 parts.

Thus, a photoreceptor No. 34 was prepared.

### PHOTORECEPTOR PREPARATION EXAMPLE 35

The procedure for preparation of the photoreceptor in Photoreceptor Preparation Example 31 was repeated except that the α-alumina included in the protective layer coating liquid was replaced with 1 part of titanium oxide (CR-EL from Ishihara Sangyo Kaisha K.K., which has an average primary particle diameter of 0.25 μm).

Thus, a photoreceptor No. 35 was prepared.

### PHOTORECEPTOR PREPARATION EXAMPLE 36

The procedure for preparation of the photoreceptor in Photoreceptor Preparation Example 31 was repeated except that the α-alumina included in the protective layer coating liquid was replaced with 1 part of silica (SO-E2 from Admatechs Co., Ltd., having an average primary particle diameter of 0.5 μm).

Thus, a photoreceptor No. 36 was prepared.

### PHOTORECEPTOR PREPARATION EXAMPLE 37

The procedure for preparation of the photoreceptor in Photoreceptor Preparation Example 1 was repeated except that the undercoat layer coating liquid was replaced with the following undercoat layer coating liquid, and the undercoat layer coating liquid was coated on the aluminum cylinder without forming the intermediate layer therebetween.

### (Undercoat Layer Coating Liquid)

| | |
|---|---|
| Titanium oxide A mentioned above | 50 parts |
| Alkyd resin | 14 parts |
| (BEKKOLITE M6401-50 from Dainippon Ink | |
| And Chemicals, Inc., solid content of 50%) | |
| Melamine resin | 8 parts |
| (SUPER BEKKAMINE L-145-60 from | |
| Dainippon Ink And Chemicals, Inc., solid | |
| content of 60%) | |
| 2-Butanone | 60 parts |

Thus, a photoreceptor No. 37 was prepared.

### PHOTORECEPTOR PREPARATION EXAMPLE 38

The procedure for preparation of the photoreceptor in Photoreceptor Preparation Example 1 was repeated except that the undercoat layer coating liquid was replaced with the following undercoat layer coating liquid.

### (Undercoat Layer Coating Liquid)

| | |
|---|---|
| Titanium oxide A mentioned above | 50 parts |
| Titanium oxide C | 20 parts |
| (PT-501R from Ishihara Sangyo Kaisha K.K., | |
| which has average primary particle | |
| diameter of about 0.18 μm) | |
| Alkyd resin | 14 parts |
| (BEKKOLITE M6401-50 from Dainippon Ink | |
| And Chemicals, Inc., solid content of 50%) | |
| Melamine resin | 8 parts |
| (SUPER BEKKAMINE L-145-60 from | |
| Dainippon Ink And Chemicals, Inc., solid | |
| content of 60%) | |
| 2-Butanone | 60 parts |

Thus, a photoreceptor No. 38 was prepared.

### PHOTORECEPTOR PREPARATION EXAMPLE 39

The procedure for preparation of the photoreceptor in Photoreceptor Preparation Example 1 was repeated except that the intermediate layer was not formed.

Thus, a photoreceptor No. 39 was prepared.

### PHOTORECEPTOR PREPARATION EXAMPLE 40

The procedure for preparation of the photoreceptor in Photoreceptor Preparation Example 2 was repeated except that the aluminum cylinder was replaced with an aluminum cylinder having an outside diameter of 100 mm.

Thus, a photoreceptor No. 40 was prepared.

### PHOTORECEPTOR PREPARATION EXAMPLE 41

The procedure for preparation of the photoreceptor in Photoreceptor Preparation Example 3 was repeated except that the aluminum cylinder was replaced with an aluminum cylinder having an outside diameter of 100 mm.

Thus, a photoreceptor No. 41 was prepared.

### PHOTORECEPTOR PREPARATION EXAMPLE 42

The procedure for preparation of the photoreceptor in Photoreceptor Preparation Example 9 was repeated except that the aluminum cylinder was replaced with an aluminum cylinder having an outside diameter of 100 mm.

Thus, a photoreceptor No. 42 was prepared.

### PHOTORECEPTOR PREPARATION EXAMPLE 43

The procedure for preparation of the photoreceptor in Photoreceptor Preparation Example 25 was repeated except that the aluminum cylinder was replaced with an aluminum cylinder having an outside diameter of 100 mm.

Thus, a photoreceptor No. 43 was prepared.

### PHOTORECEPTOR PREPARATION EXAMPLE 44

The procedure for preparation of the photoreceptor in Photoreceptor Preparation Example 31 was repeated except that the aluminum cylinder was replaced with an aluminum cylinder having an outside diameter of 100 mm.

Thus, a photoreceptor No. 44 was prepared.

### PHOTORECEPTOR PREPARATION EXAMPLE 45

The procedure for preparation of the photoreceptor in Photoreceptor Preparation Example 34 was repeated except that the aluminum cylinder was replaced with an aluminum cylinder having an outside diameter of 100 mm.

Thus, a photoreceptor No. 45 was prepared.

The above-prepared photoreceptors were evaluated with respect to the transit time. The evaluation method is as follows.

### (Measurement of Transit Time)

Each photoreceptor serving as an image bearing member is set in an apparatus which is disclosed in JP-A 2000-275872 and has a structure illustrated in FIG. 4. The conditions of the apparatus are as follows.

Linear speed of photoreceptor: 262 mm/sec

Angle between light irradiating device 3 and surface potential meter 6: 155°

Time from light irradiation to measurement of surface potential: 155 msec

Potential of photoreceptor charged by charging device 2: −800 V

Density of pixels of light image: 400 dpi

Wavelength of light emitted by light irradiating device 3: 655 nm (it was preliminarily confirmed that the transit time of a photoreceptor is not influenced by the wavelength of the light used, and the transit time determined by using light with a wavelength of 780 nm is almost the same as that determined by using light of a wavelength of 655 nm)

The procedure for determining the transit time of the photoreceptor is as follows.
1) A photoreceptor is set in the apparatus and is rotated at the linear speed mentioned above;
2) The photoreceptor is charged with the charging device 2 so that the potential of the photoreceptor is −800 V, which is measured with the surface potential meter 40;
3) The charged photoreceptor is exposed to light emitted by the light irradiating device 3;
4) The potential (P) of the irradiated portion of the photoreceptor is measured with the second surface potential meter 41;
5) The photoreceptor is then discharged using the discharging device 42;
6) The operations 2)-5) are repeated while the energy of irradiated light is slightly increased to obtain such a decay curve as illustrated in FIG. 5;
7) The potential of the irradiated portion at the inflection point (IPo) is determined from the curve;
8) The operations 2)-7) are repeated while changing the angle between the light irradiating device 3 and the second surface potential meter 6 (i.e., the time from light irradiation to measurement of surface potential) as follows: 155° (155 msec); 120° (120 msec); 100° (100 ms.ec); 90° (90 msec); 80° (80 smec); 70° (70 msec); 60° (60 msec); 55° (55 msec); 50° (50 msec); 45° (45 msec); 40° (40 msec); 35° (35 msec); 30° (30 msec); 25° (25 msec); and 20° (20 msec) to obtain 15 decay curves and 15 inflection points (i.e., potentials of irradiated portion) at 15 inflection points;
9) The data of the time from light irradiation to measurement of surface potential (20 to 155 msec) and the potentials of irradiated portion determined above are plotted in a graph to obtain the relationship therebetween, i.e., to obtain such a curve as illustrated in FIG. 6; and
10) The inflection point, which means the real transit time Tr, is determined from the curve, wherein when two or more inflection points (IP₁, IP₂, . . . ) are observed as illustrated in FIG. 6, the first inflection point (IP₁) is defined as the real transit time.

### EXAMPLES 1-31 AND COMPARATIVE EXAMPLES 1-8

Each of the above-prepared photoreceptors Nos. 1-41 was set in a modified version of a digital copier manufactured by Ricoh Co., Ltd. to be evaluated. The conditions of the modified digital copier are as follows.
1) Charging device: scorotron charger in which the width of grid is 10 mm;
2) Light irradiating device: laser diode emitting light with a wavelength of 655 mn;
3) Developing device: developing unit equipped with a probe connected with a surface potential meter is set while removing the original developing device of the copier;
4) Transfer device and cleaning device: the original transfer device and cleaning device of the copier are removed;
5) Discharging device: LED emitting light with a wavelength of 660 mn;
6) Linear speed of image bearing member (i.e., photoreceptor): 135 mm/sec (i.e., the rotation speed of the photoreceptor is 86 rpm, and the charging time is 74.1 msec); and
7) Applied voltage was determined in such a way that the non-irradiated portion of the charged photoreceptor has a potential of −800 V.

The evaluation method is as follows.

The photoreceptor was charged with the charging device, and light irradiation was not performed thereon to form an electrostatic latent image corresponding to a white solid image. After the potential (VD) of the electrostatic image (i.e., the non-irradiated portion of the photoreceptor) was measured with the surface potential meter provided in the developing unit, the electrostatic image was erased by the discharging device. This operation was repeated 5 times. The difference between the potential (VD1) of the first electrostatic image and the potential (VD3) of the third electrostatic image was determined. This potential difference is referred to as the first-revolution potential decrease (Δ VD).

Similarly, the photoreceptor was charged with the charging device, and light irradiation was then performed thereon to form an electrostatic latent image corresponding to a black solid image. After the potential (VL) of the electrostatic image (i.e., the light irradiated portion) was measured with the surface potential meter provided in the developing unit, the electrostatic image was erased by the discharging device. This operation was repeated 5 times. The potential (VL5) is referred to as the potential (VL) of irradiated portion of the photoreceptor.

Next, the original developing device, transfer device and cleaning device were set in the copier while removing the developing unit, and images are produced using each photoreceptor. All the images have good image qualities.

Next, a lubricant applying device is provided in the copier so as to be located on a downstream side from the cleaning device. The lubricant applying device includes a solid lubricant (i.e., zinc stearate), a brush for scraping the lubricant and then applying the lubricant on the surface of the photoreceptor, and a blade for spreading the lubricant along the surface of the photoreceptor. A running test in which 100,000 copies of an original image are continuously produced was performed using each photoreceptor. After the running test, the photoreceptor was allowed to settle in a dark place for 10 minutes. Next, the potential difference (Δ VD) and the potential (VL) of irradiated portion of the photoreceptor were determined by the method mentioned above. In addition, the thickness of the layers of the photoreceptor was measured before and after the running test to determine the abrasion loss of the protective layer of the photoreceptor.

Furthermore, after determining the potential difference (Δ VD) and the potential (VL), the photoreceptor was allowed to settle in a dark place for 10 minutes while setting the original developing device, transfer device and cleaning device to the copier. Next, a white solid image was produced as the first copy, and then a black solid image and a half tone image were continuously produced. The thus produced white solid image and half tone image were visually observed. The evaluation methods of the white solid image and the half tone image are as follows.

### (White Solid Image)

The white solid image is observed to determine whether the image has background fouling. The image quality is graded as follows.
⊚: The image has no background fouling (i.e., the background of the image is not soiled with the toner).
◯: The image has slight background fouling, but is hardly noticeable.
Δ: The image has background fouling, but the image is still acceptable.
×: The image has serious background fouling, and the image is not acceptable.

### (Half Tone Image)

The half tone image is observed to determine whether the image density of the image decreases, the resolution of the image deteriorates and the image has moiré fringe.

The image qualities are graded as follows.

### 1) Image Density (ID)

⊚: The image density does not decrease compared to the image density before the running test.
◯: The image density slightly decreases compared to the image density before the running test, but the decrease is hardly noticeable.
Δ: The image density decreases compared to the image density before the running test, but the image is still acceptable.
×: The image density seriously decreases compared to the image density before the running test, and the image is not acceptable.

### 2) Resolution (RES)

⊚: The resolution of the image does not deteriorate compared to the resolution of the image before the running test.
◯: The resolution slightly deteriorates compared to the resolution of the image before the running test but it is hardly noticeable.
Δ: The resolution decreases compared to the resolution of the image before the running test, but the image is still acceptable.
×: The resolution seriously deteriorates compared to the resolution of the image before the running test, and the image is not acceptable.
   3) Moiré (MOI)
⊚: The image does not have moiré.
◯: The image has slight moiré, but it is hardly noticeable.
Δ: The image has moiré in a portion of the image, but the image is still acceptable.
×: The image has moiré in the entire portion of the image, and the image is not acceptable.

The evaluation results are shown in Table 3.

TABLE 3

| | | Transit | | After 100,000-copy running test | | | | |
|---|---|---|---|---|---|---|---|---|
| | | time | Initial | | | White | Half | Abrasion |
| | Photoreceptor | (Tr) | VL | VL | Δ VD | solid | tone | loss |
| | No. | (msec) | (−V) | (−V) | (V) | image | image | (μm) |
| Ex. 1 | 1 | 54 | 81 | 73 | 10 | ⊚ | ⊚ | 0.7 |
| Ex. 2 | 2 | 58 | 86 | 81 | 12 | ⊚ | ⊚ | 0.7 |
| Ex. 3 | 3 | 71 | 68 | 54 | 20 | ⊚ | ⊚ | 0.7 |
| Ex. 4 | 4 | 65 | 90 | 94 | 17 | ⊚ | ⊚ | 0.7 |
| Ex. 5 | 5 | 58 | 82 | 71 | 14 | ⊚ | ⊚ | 0.7 |
| Ex. 6 | 6 | 64 | 116 | 129 | 9 | ⊚ | ◯ | 0.7 |
| | | | | | | | (ID) | |
| Ex. 7 | 7 | 60 | 85 | 76 | 11 | ⊚ | ⊚ | 0.7 |
| Ex. 8 | 8 | 67 | 94 | 112 | 14 | ⊚ | ⊚ | 0.7 |
| Comp. | 9 | 84 | 120 | 167 | 68 | Δ | Δ | 0.7 |
| Ex. 1 | | | | | | | (ID) | |
| Comp. | 10 | 88 | 91 | 96 | 89 | X | ⊚ | 0.7 |
| Ex. 2 | | | | | | | | |
| Comp. | 11 | 80 | 163 | 242 | 59 | Δ | X | 0.7 |
| Ex. 3 | | | | | | | (ID) | |
| Comp. | 12 | 92 | 117 | 161 | 79 | Δ | Δ | 0.7 |
| Ex. 4 | | | | | | | (ID) | |
| Comp. | 13 | 93 | 113 | 154 | 75 | Δ | Δ | 0.7 |
| Ex. 5 | | | | | | | (ID) | |
| Ex. 9 | 14 | 53 | 83 | 75 | 11 | ⊚ | ⊚ | 0.7 |
| Comp. | 15 | 90 | 151 | 198 | 93 | X | X | 0.7 |
| Ex. 6 | | | | | | | (ID) | |
| Ex. 10 | 16 | 61 | 106 | 113 | 7 | ⊚ | ⊚ | 0.7 |
| Ex. 11 | 17 | 64 | 84 | 74 | 13 | ⊚ | ⊚ | 0.7 |
| Ex. 12 | 18 | 65 | 80 | 68 | 6 | ◯ | ⊚ | 3.3 |
| Ex. 13 | 19 | 65 | 101 | 90 | 13 | ⊚ | ⊚ | 1.2 |
| Ex. 14 | 20 | 70 | 113 | 121 | 19 | ⊚ | ◯ | 0.9 |
| | | | | | | | (ID) | |
| Ex. 15 | 21 | 68 | 83 | 89 | 13 | ⊚ | ⊚ | 1.3 |
| Comp. | 22 | 86 | 68 | 91 | 70 | Δ | ⊚ | 1.3 |
| Ex. 7 | | | | | | | | |
| Ex. 16 | 23 | 66 | 65 | 83 | 13 | ⊚ | ⊚ | 1.3 |
| Ex. 17 | 24 | 65 | 67 | 70 | 12 | ⊚ | ⊚ | 0.1 |
| Ex. 18 | 25 | 71 | 95 | 85 | 21 | ◯ | ⊚ | 0.7 |
| Comp. | 26 | 78 | 128 | 110 | 46 | Δ | ⊚ | 0.7 |
| Ex. 8 | | | | | | | | |
| Ex. 19 | 27 | 54 | 81 | 79 | 6 | ⊚ | ⊚ | 0.7 |
| Ex. 20 | 28 | 54 | 80 | 77 | 8 | ⊚ | ⊚ | 0.7 |
| Ex. 21 | 29 | 54 | 90 | 108 | 19 | ⊚ | ⊚ | 0.7 |
| Ex. 22 | 30 | 61 | 110 | 131 | 15 | ⊚ | ⊚ | 0.7 |
| Ex. 23 | 31 | 54 | 83 | 78 | 10 | ⊚ | ⊚ | 0.1 |
| Ex. 24 | 32 | 54 | 85 | 79 | 13 | ⊚ | ⊚ | 0.1 |
| Ex. 25 | 33 | 54 | 91 | 85 | 21 | ⊚ | ◯ | 0.1 |
| | | | | | | | (RES) | |
| Ex. 26 | 34 | 54 | 82 | 74 | 10 | ⊚ | ⊚ | 0.3 |
| Ex. 27 | 35 | 54 | 89 | 81 | 17 | ⊚ | ◯ | 0.2 |
| | | | | | | | (RES) | |
| Ex. 28 | 36 | 54 | 82 | 70 | 9 | ⊚ | ◯ | 0.1 |
| | | | | | | | (RES) | |
| Ex. 29 | 37 | 54 | 81 | 69 | 12 | ◯ | ⊚ | 0.7 |
| Ex. 30 | 38 | 54 | 85 | 74 | 17 | ◯ | ⊚ | 0.7 |
| Ex. 31 | 39 | 54 | 85 | 74 | 12 | ◯ | ⊚ | 0.7 |

VL: Potential of irradiated portion of the photoreceptor.
Δ VD: Potential difference between the potential (VD1) of the first electrostatic image and the potential (VD3) of the third electrostatic image.
(ID): Image density decreases
(RES): Resolution of image deteriorates

The summary of the results illustrated in Table 3 is as follows.
(1) When the transit time of a photoreceptor is longer than the charging time (74.1 msec in this case), the photoreceptor causes a serious first one-revolution charge problem (i.e., the first copy produced by the photoreceptor has background fouling) after the running test. In contrast, when the transit time of a photoreceptor is not longer than the charging time, the photoreceptor hardly causes the first one-revolution charge problem.
(2) When the charge transport material included in the charge transport layer has formula (1), the transit time of the resultant photoreceptor is relatively short, and the photoreceptor does not cause the first one-revolution charge problem.
(3) When the charge transport material included in the charge transport layer has formula (1) and in addition a charge transport polymer is used as a binder resin of the layer, the transit time can be further shortened. Therefore, the first one-revolution charge problem preventing effect can be further enhanced.
(4) When the relationship (3) (i.e., IP_{CGM}−IP_{CTM}≧−0.1 (eV)) is satisfied, the potential (VL) of the irradiated portion of the photoreceptor after the running test can be dramatically decreased, and thereby high quality images can be stably produced.
(5) When the ratio (MW/N) of the molecular weight (MW) of the polymerizable compound having no charge transport structure to the number (N) of functional groups thereof is greater than 250, the abrasion loss seriously increases (i.e., the abrasion resistance of the photoreceptor deteriorates) although occurrence of the first one-revolution charge problem can be prevented. Therefore, the image produced after the running test has slight background fouling due to increase of the electric field strength for the photoreceptor, which is caused by abrasion of the protective layer.
(6) Even when an azo pigment is used as a charge generation material, the first one-revolution charge problem can be caused if the transit time is longer than the charging time. However, the azo pigment has almost the same effect as that of titanyl phthalocyanine.
(7) When two or more compounds having an alkyl amino compound such as compounds having formulae (4) and (5) or two or more of antioxidants having formulae (6), (7), (8) and (9) are used, the charge properties of the resultant photoreceptor are stabilized, and thereby high quality images can be produced even after a 100,000-copy running test.
(8) When a lubricant is applied to the surface of a photoreceptor having a protective layer including a filler or a crosslinked binder resin, the abrasion resistance of the photoreceptor can be dramatically improved and the charge properties of the photoreceptor can be stabilized, thereby extending the life of the photoreceptor.
(9) When the protective layer includes a filler and a crosslinked binder resin, the abrasion resistance of the photoreceptor can be improved to an extent such that the abrasion loss is almost 0, and in addition occurrence of problems such that a film of foreign materials (such as components of toner) is formed on the surface of the photoreceptor; and foreign materials (such as components of toner and paper dust) are adhered to the surface of the photoreceptor can be prevented, thereby further extending the life of the photoreceptor. Among fillers, α-alumina is preferable in view of abrasion resistance and stability of image qualities.
(10) When the relationship (4) (i.e., the thickness of the charge transport layer is twice or more that of the protective layer), the effect of the present invention can be well produced.
(11) Occurrence of the first one-revolution charge problem is also influenced by the undercoat layer. Specifically, when two or more kinds of titanium oxides having different average primary particle diameters by 0.1 μm or more are used, the first one-revolution charge problem preventing effect can be produced. In this case, when a resin layer (intermediate layer) is not formed below the undercoat layer, the image tends to have background fouling although the first one-revolution charge problem preventing effect can be produced. Namely, by forming a resin layer below the undercoat layer, formation of background fouling can be prevented while preventing occurrence of the first one-revolution charge problem.

Thus, it is confirmed that the photoreceptor having a specific protective layer and the image forming apparatus of the present invention using the photoreceptor can prevent occurrence of the first one-revolution charge problem without increasing the potential (VL) of the irradiated portion of the photoreceptor even after long repeated use. In addition, since the photoreceptor has excellent abrasion resistance, the first one-revolution charge problem preventing effect can be stably maintained for a long period of time while the photoreceptor has a long life.

### EXAMPLES 32-33 AND COMPARATIVE EXAMPLES 9-11

The procedure for evaluation of the photoreceptors Nos. 1-39 are repeated except that each of the above-prepared photoreceptors Nos. 39-45 was used, the modified copier used for evaluation was replaced with a modified version of a digital copier manufactured by Ricoh Co., Ltd., and the number of copies produced in the running test is 1,000,000. The conditions of the modified digital copier are as follows.
1) Charging device: double-wire scorotron charger in which the width of grid is 33 mm;
2) Light irradiating device: multi-beam light irradiation head (vertical-cavity surface-emitting laser) in which four laser diodes each emitting light with a wavelength of 780 nm are arranged in the sub-scanning direction;
3) Developing device: developing unit equipped with a probe connected with a surface potential meter is set while removing the original developing device of the copier;
4) Transfer device and cleaning device: the original transfer device and cleaning device of the copier are removed;
5) Discharging device: LED emitting light with a wavelength of 780 nm;
6) Linear speed of image bearing member (i.e., photoreceptor): 500 mm/sec (i.e., the rotation speed of the photoreceptor is 95.5 rpm, and the charging time is 66 msec); and
7) Applied voltage was determined in such a way that the non-irradiated portion of the charged photoreceptor has a potential of −800 V.

The evaluation results are shown in Table 4.

TABLE 4

| | | Transit | | After 1,000,000-copy running test | | | | |
|---|---|---|---|---|---|---|---|---|
| | | time | Initial | | | White | Half | Abrasion |
| | Photoreceptor | (Tr) | VL | VL | Δ VD | solid | tone | loss |
| | No. | (msec) | (−V) | (−V) | (V) | image | image | (μm) |
| Ex. 32 | 39 | 58 | 90 | 81 | 18 | ⊚ | ⊚ | 2.4 |
| Comp. | 40 | 71 | 71 | 53 | 49 | Δ | ⊚ | 2.4 |
| Ex. 9 | | | | | | | | |
| Comp. | 41 | 84 | 147 | 268 | 103 | X | X | 2.6 |
| Ex. 10 | | | | | | | (ID) | |
| Comp. | 42 | 71 | 110 | 98 | 44 | Δ | ⊚ | 2.4 |
| Ex. 11 | | | | | | | | |
| Ex. 33 | 43 | 54 | 88 | 79 | 19 | ⊚ | ⊚ | 0.6 |
| Ex. 34 | 44 | 54 | 86 | 77 | 18 | ⊚ | ⊚ | 1.0 |

The summary of the results illustrated in Table 4 is as follows.
(1) Even when the photoreceptor for use in the present invention is used for high speed image forming apparatus using a vertical-cavity surface-emitting laser, occurrence of the first one-revolution charge problem can be prevented if the transit time of the photoreceptor is not longer than the charging time. It is confirmed that photoreceptors having a transit time longer than the charging time cause the first one-revolution charge problem.
(2) Even after the 1,000,000-copy running test, the photoreceptor including a charge transport material having formula (1) can prevent occurrence of the first one-revolution charge problem without increasing the potential (VL) of the irradiated portion, namely the photoreceptor can stably maintain good electrostatic properties.
(3) By using a protective layer in which a filler is dispersed in a crosslinked resin, the resistance of the photoreceptor to abrasion and scratches can be dramatically improved without deteriorating the stability of electrostatic properties.

Thus, it is confirmed that the photoreceptor having a specific protective layer and the image forming apparatus of the present invention using the photoreceptor can prevent occurrence of the first one-revolution charge problem without increasing the potential (VL) of the irradiated portion of the photoreceptor even after long repeated use. In addition, the photoreceptor has excellent resistance to abrasion and scratches. Therefore, the image forming apparatus of the present invention can produce high quality color images at a high speed while having a small size and a long life. In addition, the waiting time can be shortened.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Applications Nos. 2008-003115 and 2008-190965, filed on Jan. 10, 2008, and Jul. 24, 2008, respectively, the entire contents of which are herein incorporated by reference.

What is claimed is:

1. An image forming apparatus comprising:
an image bearing member configured to bear an electrostatic latent image thereon, wherein the image bearing member includes an electroconductive substrate, a photosensitive layer located overlying the electroconductive substrate, and a protective layer located overlying the photosensitive layer;
a charging device configured to charge the image bearing member;
a light irradiating device configured to irradiate the charged image bearing member with light to form the electrostatic latent image on a surface of the image bearing member; and
a developing device configured to develop the electrostatic latent image with a developer including a toner to form a toner image on the surface of the image bearing member,
wherein the image forming apparatus satisfies the following relationship (1):
T1≦T2 (1)
wherein T1 represents a transit time of the image bearing member, and T2 represents a charging time,
wherein the transit time T1 is determined by a method in which the image bearing member is charged and then irradiated with light to measure a potential of an irradiated portion of the image bearing member with a surface potential meter, and the procedure is repeated while shortening an interval between the light irradiation and the potential measurement to obtain a curve showing a relationship between the interval and the potential of the irradiated portion, wherein the transit time is defined as a time at which an inflection point is firstly observed in the curve when the curve is drawn while shortening the interval; and
wherein the charging time T2 is defined by the following equation (2):
T2 (msec)=W (mm)/LV (mm/msec) (2)
wherein W represents a width of a charging area charged by the charging device in units of millimeter, and LV represents a linear velocity of the image bearing member in units of millimeter per millisecond.

2. The image forming apparatus according to claim 1, wherein the photosensitive layer of the image bearing member is a layered photosensitive layer including a charge generation layer and a charge transport layer located on the charge generation layer.

3. The image forming apparatus according to claim 1, wherein the photosensitive layer includes, as a charge transport material, a distyryl compound having the following formula (1): 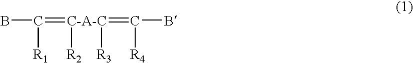
wherein R₁ to R₄ independently represent a hydrogen atom, an alkyl group having 1 to 4 carbon atoms, an alkoxyl group having 1 to 4 carbon atoms, or a phenyl group which is optionally substituted with an alkyl group having 1 to 4 carbon atoms or an alkoxyl group having 1 to 4 carbon atoms, wherein R₁ to R₄ may be the same as or different from the others; A represents a substituted or unsubstituted arylene group or a group having the below-mentioned formula (1a); B and B′ independently represent a substituted or unsubstituted arylene group or a group having the below-mentioned formula (1b), wherein B and B′ may be the same as or different from each other,
wherein formula (1a) is the following: 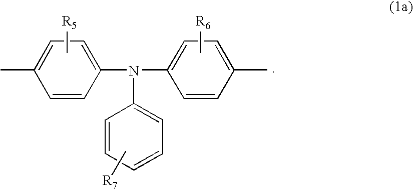
wherein R₅, R₆ and R₇ independently represent a hydrogen atom, an alkyl group having 1 to 4 carbon atoms, an alkoxyl group having 1 to 4 carbon atoms, or a phenyl group, which is optionally substituted with an alkyl group having 1 to 4 carbon atoms or an alkoxyl group having 1 to 4 carbon atoms, and
wherein formula (1b) is the following: 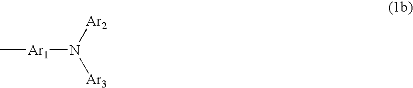
wherein Ar₁ represents an arylene group, which optionally has an alkyl group having 1 to 4 carbon atoms or an alkoxyl group having 1 to 4 carbon atoms; and Ar₂ and Ar₃ independently represent an aryl group which is optionally substituted with an alkyl group having 1 to 4 carbon atoms or an alkoxyl group having 1 to 4 carbon atoms.

4. The image forming apparatus according to claim 3, wherein the distyryl compound has the following formula (2): 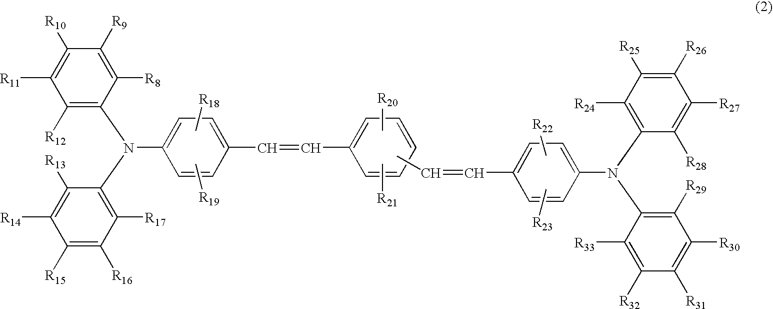
wherein R₈ to R₃₃ independently represent a hydrogen atom, an alkyl group having 1 to 4 carbon atoms, an alkoxyl group having 1 to 4 carbon atoms, or a substituted or unsubstituted phenyl group, wherein R₈ to R₃₃ may be the same as or different from the others.

5. The image forming apparatus according to claim 1, wherein the photosensitive layer includes a charge generation material and a charge transport material, and wherein the following relationship (3) is satisfied:
IP_{CGM}−IP_{CTM}≧−0.1 (eV) (3)
wherein IP_{CGM} represents an ionization potential of the charge generation material; and IP_{CTM} represents an ionization potential of the charge transport material.

6. The image forming apparatus according to claim 1, wherein the at least one of the photosensitive layer and the protective layer includes at least one compound having an alkylamino group and having the following formula (4) or (5): 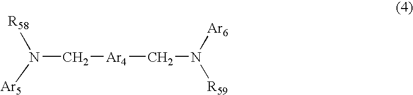
wherein Ar₄ represents a substituted or unsubstituted arylene group; Ar₅ and Ar₆ independently represent a substituted or unsubstituted aryl group, a substituted or unsubstituted alkyl group, or a substituted or unsubstituted aralkyl group; R₅₈ and R₅₉ independently represent a substituted or unsubstituted alkyl group, or a substituted or unsubstituted aralkyl group, wherein Ar₅ and R₅₈ optionally share bond connectivity to form a ring having a nitrogen atom, and Ar₆ and R₅₉ optionally share bond connectivity to form a ring having a nitrogen atom; or 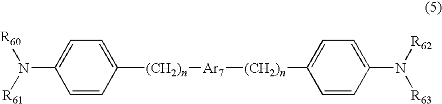
wherein Ar₇ represents a substituted or unsubstituted arylene group; R₆₀ to R₆₃ independently represent a substituted or unsubstituted alkyl group, or a substituted or unsubstituted aralkyl group; and n is 1 or 2.

7. The image forming apparatus according to claim 1, wherein the at least one of the photosensitive layer and the protective layer includes at least two of antioxidants having following formulae (6), (7), (8) and (9): 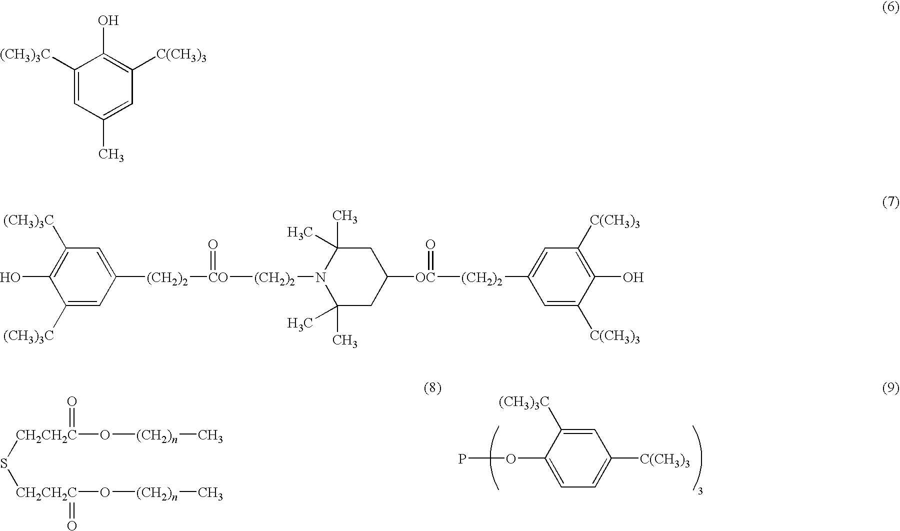
wherein n is an integer of from 12 to 18.

8. The image forming apparatus according to claim 1, wherein the photosensitive layer includes a titanyl phthalocyanine pigment as a charge generation material.

9. The image forming apparatus according to claim 1, wherein the protective layer includes a filler.

10. The image forming apparatus according to claim 1, wherein the protective layer is prepared by subjecting at least a first polymerizable compound having no charge transport structure and a second polymerizable compound having a charge transport structure to a crosslinking reaction.

11. The image forming apparatus according to claim 10, wherein at least one of the first polymerizable compound and the second polymerizable compound has an acryloyloxy group or a methacryloyloxy group.

12. The image forming apparatus according to claim 10, wherein the charge transport structure of the second polymerizable compound is a triarylamine structure.

13. The image forming apparatus according to claim 10, wherein the first polymerizable compound has three or more functional groups, and the second polymerizable compound has one functional group, and wherein a ratio (MW/F) of a molecular weight (MW) of the first polymerizable compound to a number of functional groups (F) thereof is not greater than 250.

14. The image forming apparatus according to claim 1, wherein the image bearing member further includes an undercoat layer located between the photosensitive layer and the electroconductive substrate and contacted with the photosensitive layer, and wherein the undercoat layer includes at two different titanium oxide pigments having different average primary particle diameters by 0.1 μm or more.

15. The image forming apparatus according to claim 1, wherein the image bearing member further includes an intermediate layer located between the photosensitive layer and the electroconductive substrate and contacted with the electroconductive substrate, and wherein the intermediate layer includes a polyamide resin.

16. The image forming apparatus according to claim 1, wherein the charging device is a scorotron charging device.

17. The image forming apparatus according to claim 1, wherein the light irradiating device includes a vertical-cavity surface-emitting laser emitting plural laser beams.

18. The image forming apparatus according to claim 1, further comprising:
a lubricant applying device configured to apply a lubricant on a surface of the image bearing member.

19. The image forming apparatus according to claim 1, further comprising:
a transferring device configured to transfer the toner image on a receiving material;
a cleaning device configured to clean the surface of the image bearing member;
a discharging device configured to reduce charges remaining on the image bearing member, and
wherein the image forming apparatus is a tandem image forming apparatus including plural image forming units each including the image bearing member, and at least one of the image bearing member, charging device, light irradiating device, developing device, transferring device, cleaning device, and discharging device.

20. An image forming method comprising:
charging an image bearing member;
irradiating the image bearing member with light to form an electrostatic latent image on a surface of the image bearing member; and
developing the electrostatic latent image with a developer including a toner to form a toner image on the surface of the image bearing member,
wherein the following relationship (1) is satisfied:
T1≦T2 (1)
wherein T1 represents a transit time of the image bearing member, and T2 represents a charging time,
wherein the transit time T1 is determined by a method in which the image bearing member is charged and then irradiated with light to measure a potential of an irradiated portion of the image bearing member with a surface potential meter, and the procedure is repeated while shortening an interval between the light irradiation and the potential measurement to obtain a curve showing a relationship between the interval and the potential of the irradiated portion, wherein the transit time is defined as a time at which an inflection point is firstly observed in the curve when the curve is drawn while shortening the interval;
wherein the charging time T2 is defined by the following equation (2):
T2 (msec)=W (mm)/LV (mm/msec) (2)
wherein W represents a width of a charging area charged by the charging device in units of millimeter, and LV represents a linear velocity of the image bearing member in units of millimeter per millisecond.
